(19) United States
(12) Patent Application Publication
(10) Pub. No.: US 2013/0332133 A1
(43) Pub. Date: Dec. 12, 2013

(54) Classification of Protein Sequences and Uses of Classified Proteins

(71) Applicants: David Horn, Tel-Aviv (IL); Eytan Ruppin, Reut (IL); Vered Kunik, Ramat-HaSharon (IL); Zach Solan, Tel-Aviv (IL); Ben Sandbank, Ganei Tikva (IL); Yasmine Meroz, Tel-Aviv (IL); Uri Weinbart, Herzlia (IL)

(72) Inventors: David Horn, Tel-Aviv (IL); Eytan Ruppin, Reut (IL); Vered Kunik, Ramat-HaSharon (IL); Zach Solan, Tel-Aviv (IL); Ben Sandbank, Ganei Tikva (IL); Yasmine Meroz, Tel-Aviv (IL); Uri Weinbart, Herzlia (IL)

(73) Assignee: Ramot At Tel Aviv University Ltd., Tel-Aviv (IL)

(21) Appl. No.: 12/227,183

(22) PCT Filed: May 13, 2007
(86) PCT No.: PCT/IL2007/000585

§ 371 Date: Apr. 10, 2009

Related U.S. Application Data
(60) Provisional application No. 60/799,318, filed on May 11, 2006.
(60) Provisional application No. 60/861,746, filed on Nov. 30, 2006.

(51) Int. Cl. G06F 19/28

(52) U.S. Cl. CPC G06F 19/28
USPC 703/11

(57) ABSTRACT

A searchable protein database is disclosed. The protein database comprises a plurality of entries, each entry having a sufficiently short predicting sequence and a protein classifier corresponding to the predicting sequence. An unclassified protein sequence can be classifiable by the database via searching therein for a motif of amino acids matching a predicting sequence of the database, thereby attributing to the unclassified protein a protein classifier.

### FIELD AND BACKGROUND OF THE INVENTION

The present invention relates to bioinformatics and, more particularly, but not exclusively, to a method and apparatus for classification of proteins according to amino acid primary sequences. The invention also relates to uses of polypeptides annotated according to the teachings of the present invention.

Informatics is the study and application of computer and statistical techniques for the management of information. In Genome projects, bioinformatics includes the development of methods to search databases fast and efficiently, to analyze nucleic acid sequence information, to predict protein function from sequence data and the like. Increasingly, molecular biology is shifting from the laboratory bench to the computer desktop. Advanced quantitative analyses, database comparisons and computational algorithms are needed to explore the relationships between sequence, function, structure and phenotype.

Proteins are linear polymers of amino acids. The polymerization reaction, which produces a protein, results in the loss of one molecule of water from each peptide bond formed (linking two adjacent amino acids), and hence proteins are often said to be composed of amino acid residues. Natural protein molecules may contain as many as 20 different types of amino acid residues, the sequence of which defines the so-called “primary sequence” of the protein. Proteins perform all the processes defining life, including enzymatic catalysis, transport and storage, coordinated motion, mechanical/structural support, immune protection, generation and transmission of nerve impulses, and control of growth and differentiation. This immense range of functions is accomplished by a seemingly boundless variety of protein sequences which translate into three-dimensional structures.

Enzymes comprise a large protein category of interest for biologists and/or protein chemists. One widely accepted method of classifying enzymes is the Enzyme Commission commonly referred to as “EC” Hierarchy which consists of four numbers, n1:n2:n3:n4, corresponding to four levels of classification. For example, the oxidoreductases class corresponds to n1=1, one of the six main divisions. For this class, n2 (subclass) specifies electron donors, n3 (subsubclass) specifies electron acceptors and n4 indicates the exact enzymatic activity.

The properties of a protein are determined by its covalently-linked amino acid sequence. Genes encode proteins by providing a sequence of nucleotides that is translated into a sequence of amino acids. Proteins fold into a three-dimensional structure, which results substantially from non-covalent interactions (van der Waals forces, ionic bonds, hydrogen bonds, and hydrophobic and aromatic interactions) between the various amino acid side-chains within the molecule and with the water and ligand molecules within it. Examination of the three-dimensional structure of numerous natural proteins has revealed a number of recurring patterns, the most common are known as alpha helices, parallel beta sheets and anti-parallel beta sheets, which define a second level of structural organization.

The biological properties of proteins are mainly affected by the proteins' three-dimensional structure, which determines the function of enzymes, the capacity and specificity of binding proteins such as receptors and antibodies, and the structural attributes of receptor/ligand molecules. For example, the function of an enzyme relies on the structure of its active site, a regional locus in the protein having a shape and a size that enables it to fit the intended substrate snugly at the molecular level. It also has a specific arrangement of chemical moieties with particular properties at the atomic level which govern the binding and catalysis of the substrate efficiently. This specific arrangement of chemical moieties, typically referred to as the chromophore, stem from atoms of certain amino acids in the enzyme's primary structure, and in some cases comprise atoms from one or more other small molecules called coenzymes, which are also held in place by the protein.

Similarly to enzymes, all protein functions rely on molecular recognition. Transport proteins such as haemoglobin must recognize the molecules they carry (in this case oxygen), receptors on the cell surface must recognize particular signaling molecules called ligands, transcription factors must recognize particular DNA sequences and antibodies must recognize specific epitopes in antigens, and the functional integrity of the cell depends critically on protein-protein interactions, particularly on the formation of multi-protein complexes.

Protein three-dimensional structures have evolved to address the vast functions carried out by proteins, and over the past decades, thousands of these structures have been elucidated to atomic resolution, mainly by X-ray diffraction and NMR techniques. Most of the presently known structures are stored in the Protein Data Bank (PDB), and with them emerged the field of structure-function relationship research.

Known in the art are algorithms which attempt to predict three-dimensional structures based on the primary sequence of a protein. Based on the predicted three-dimensional structure and prior knowledge regarding the relation between a particular three-dimensional structure and certain biological properties, unclassified proteins having a known primary sequence can be classified into predetermined protein classes, such as reactivity classes, specific binding classes, functional classes and the like. These algorithms, however, make correct predictions only in limited number of cases in which the number of available homology proteins is sufficiently large.

The problem of classifying proteins from their primary sequence, has defied solution for over decades. One of the earliest classification methods is known as homology modeling. Homology modeling is applicable only for cases in which three-dimensional structures of similar primary sequences are already known. In this technique, a three-dimensional model for a protein of unknown structure (the target) is constructed based on one or more related proteins of known structure (the templates). The necessary conditions for getting a useful model are (i) detectable similarity and (ii) availability of a correct alignment between the target amino acid sequence and the template structures. Homology modeling is based on the notion that new proteins evolve gradually by amino acid substitution, addition and/or deletion, and that the three-dimensional structures and, therefore, affinity and functional classes are often strongly conserved during the evolution. In homology modeling, structural similarity is assumed between two proteins if there exist a similarity of at least 40% between the proteins at the sequence level.

However, even though the paradigm “structure determines function” holds generally true, presently known data-mining algorithms which use the structural and sequence databases for proteins are limited in automatically classifying and assigning function to new and unknown proteins solely on the basis of structural similarity to proteins of known structure and function.

In the field of genetic research, for example, the first step following the sequencing of a new gene is an effort to identify that gene's function. The most popular and straightforward methods to achieve that goal exploit the observation that if two peptide stretches exhibit sufficient similarity at the sequence level (i.e., one can be obtained from the other by a small number of insertions, deletions and/or amino acid mutations), then they probably are biologically related. Within this framework, the question of getting clues about the function of a new gene becomes one of identifying homologies in strings of amino acids. Generally, a homology refers to a similarity, likeness or relation between two or more sequences or strings. Thus, one is given a query sequence and a set of well characterized proteins and is looking for all regions of the query sequence which are similar to regions of sequences in the set.

The first approaches used for realizing this task were based on a technique known as dynamic programming. Unfortunately, the computational requirements of this method quickly render it impractical, especially when searching large databases. Generally, the problem is that dynamic programming variants spend a good part of their time computing homologies which eventually turn out to be unimportant. In an effort to work around this issue, a number of algorithms have been proposed which focus on discovering only extensive local similarities.

Identifying the similar regions between the query and the database sequences is, nevertheless, only the first part of the process. It is the second part of the process which is of interest to biologists. In the second part, the similarities are evaluated so as to properly classify the query sequence, according to its binding characteristics, function, three-dimensional structure and the like. Such evaluations are typically performed by combining biological information and statistical reasoning. Nonetheless, it is appreciated that there is a limit to how well a statistical model can approximate the biological reality.

A representative example of such evaluation relates to the classification of enzymes, which is typically according to their function. There are various known techniques for dealing with enzyme functional classification according to their primary sequence. One approach combines pairwise sequence similarity with the Support Vector Machine (SVM) classification method to obtain a remote homology detection [Liao, L. and Noble, W. S., 2003, “Combining pairwise sequence analysis and support vector machines for detecting remote protein evolutionary and structural relationships”, J. of Comp. Biology, 10, 857-868].

In another technique, a feature selection algorithm is applied to regular-expression eMOTIFs [Huang, J. Y. and Brutlag, D. L., 2001, “The eMOTIF database”, Nuclear Acids research, 29, 202-204; Neville-Manning et al., 1998, “Highly specific protein sequence motifs for genome analysis”, Proc. Natl. Acad. Sci. USA 95, 5865-5871]. This approach results in a high classification success rate at the second level of the EC classification.

In an additional technique exploits a sequence recognition algorithm disclosed in International Patent Application, Publication No. WO/2005010642, to classify enzyme functionality at the second level of the EC classification [Cai et al., 2003, “SVM-Prot: web-based support vector machine software for functional classification of a protein from its primary sequence”, Nuclear Acids Research, 31, 3692-3697].

Other methods of ascertaining functional data pertaining to primary sequence data are described by Ben-Hur and Brutlag (2006; Protein sequence motifs: Highly predictive features of protein function. In: Feature extraction, foundations and applications. I. Guyon, S. Gunn, M. Nikravesh, and L. Zadeh (eds.) Springer Verlag0 and by Liao and Noble (2003; Combining pairwise sequence analysis and support vector machines for detecting remote protein evolutionary and structural relationships. J. of Comp. Biology, 10:857-868).

The present invention provides solutions to the problems associated with prior art protein classification technique and provides searchable protein databases, tools to produce such databases, and method and apparatus for classifying protein sequences.

### SUMMARY OF THE INVENTION

According to one aspect of the present invention there is provided a searchable protein database, comprising a plurality of entries, each of the plurality of entries having a predicting sequence which comprises less than L amino acids and a protein classifier corresponding to the predicting sequence, wherein an unclassified protein sequence is classifiable by the database via searching therein for a motif of amino acids matching a predicting sequence of the database, thereby attributing to the unclassified protein a protein classifier.

According to further features in preferred embodiments of the invention described below, the database is a searchable enzyme database. According to still further features in the described preferred embodiments the protein classifier represents a branch of an EC hierarchical classification. According to still further features in the described preferred embodiments the predicting sequence is present exclusively in entries having protein classifier representing the branch or descending branch thereof.

According to another aspect of the present invention there is provided a readable data storage medium, carrying the database.

According to further features in preferred embodiments of the invention described below, the database comprises at least one of the files Table-11.txt, Table-37.txt and Table-42.txt on enclosed CD-ROM.

LENGTHY TABLES
The patent application contains a lengthy table section. A copy of the table is available in electronic form from the USPTO web site (http://seqdata.uspto.gov/?pageRequest=docDetail&DocID=US20130332133A1). An electronic copy of the table will also be available from the USPTO upon request and payment of the fee set forth in 37 CFR 1.19(b)(3).

According to yet another aspect of the present invention there is provided a method of classifying a protein sequence, comprising searching the protein sequence for a motif of amino acids matching a predicting sequence present in the protein database, and using the protein classifier corresponding to the predicting sequence for classifying the protein sequence.

According to further features in preferred embodiments of the invention described below, the method further comprises repeating the search at least once, thereby providing a plurality of motifs of amino acids matching predicting sequences present in the protein database.

According to still further features in the described preferred embodiments the method further comprises issuing a report containing classification of the protein sequence.

According to still further features in the described preferred embodiments the classifying the protein sequence comprises determining presence or absence of at least one active pocket or active site on the protein sequence.

According to still further features in the described preferred embodiments the method further comprises determining the location of the active pocket(s) or active site(s).

According to still another aspect of the present invention there is provided apparatus for classifying a protein sequence, comprising: a searcher, capable of accessing the protein database, the searcher being operable to search the protein sequence for a motif of amino acids matching a predicting sequence present in the protein database; and a classification functionality capable of accessing the protein database and providing a protein classifier corresponding to the predicting sequence, so as to classify the protein sequence by the protein classifier.

According to further features in preferred embodiments of the invention described below, the classification functionality determines presence or absence of at least one active pocket or active site on the protein sequence.

According to still further features in the described preferred embodiments the classification functionality determines the location of the at least one active pocket or active site.

According to an additional aspect of the present invention there is provided a method of characterizing a predetermined collection of protein classes defining a classification system for classifying a plurality of proteins, the method comprises: (a) extracting repeatedly occurring motifs from amino acid sequences of the plurality of proteins, thereby providing a set of motifs; and (b) for each protein class: searching the set of motifs for at least one motif which comprises less than L amino acids, the at least one motif being present in at least a few proteins belonging to the protein class but not in proteins belonging to other protein classes, and defining the at least one motif as a predicting sequence characterizing the protein class; thereby characterizing the collection of protein classes.

According to yet an additional aspect of the present invention there is provided a method of classifying a plurality of proteins into protein classes, comprising: (a) extracting repeatedly occurring motifs from the sequences of the plurality of proteins, thereby providing a set of motifs; and (b) using the set of motifs for defining protein classes, each being characterized by at least one motif which comprises less than L amino acids; thereby classifying the plurality of proteins according to the protein classes.

According to further features in preferred embodiments of the invention described below, the predicting sequence predicts protein affinity, and the protein classifier describes an affinity class of the protein.

According to still further features in the described preferred embodiments the predicting sequence predicts protein function, and the protein classifier describes a functional class of the protein.

According to still further features in the described preferred embodiments the protein classifier indicates presence of active site of active pocket at a location on the unclassified protein corresponding to the motif of amino acids.

According to still further features in the described preferred embodiments the extracting the repeatedly occurring motifs comprises, for each sequence of the plurality of proteins: searching for partial overlaps between the sequence and other sequences, applying a significance test on the partial overlaps, and defining a most significant partial overlap as a repeatedly occurring motif.

According to still further features in the described preferred embodiments the search for partial overlaps is by constructing a graph having a plurality of paths representing the sequences of the plurality of proteins, and searching for partial overlaps between paths of the graph.

According to still further features in the described preferred embodiments the search for partial overlaps between paths of the graph comprises: defining, for each path, a set of sub-paths of variable lengths, thereby defining a plurality of sets of sub-paths; and for each set of sub-paths, comparing each sub-path of the set with sub-paths of other sets.

According to still further features in the described preferred embodiments the application of the significance test comprises calculating, for each path, a set of probability functions characterizing the partial overlaps, and evaluating a statistical significance of the set of probability functions.

According to still an additional aspect of the present invention there is provided apparatus for characterizing a predetermined protein class being a member of a collection of protein classes defining a classification system for classifying a plurality of proteins, the apparatus comprises: (a) a motif extraction unit capable of extracting repeatedly occurring motifs from amino acid sequences of the plurality of proteins, thereby providing a set of motifs; (b) a searcher capable of searching the set of motifs for at least one motif which comprises less than L amino acids, the at least one motif being present in at least a few proteins belonging to the predetermined protein class but not in proteins belonging to other protein classes of the collection; and (c) a characterization unit capable of defining the at least one motif as a predicting sequence characterizing the predetermined protein class.

According to further features in preferred embodiments of the invention described below, the plurality of proteins comprises a plurality of enzymes. According to still further features in the described preferred embodiments the classification system is an EC hierarchical classification system. According to still further features in the described preferred embodiments the protein classes are branches of an EC hierarchical classification system.

According to further features in preferred embodiments of the invention described below, the method further comprises employing a screening procedure for reducing the number of predicting sequences.

According to a further aspect of the present invention there is provided apparatus for classifying a plurality of proteins into protein classes, comprising: (a) a motif extraction unit capable of extracting repeatedly occurring motifs from amino acid sequences of the plurality of proteins, thereby providing a set of motifs; and (b) a protein class definition unit, capable of defining protein classes using the set of motifs, wherein each protein class is characterized by at least one motif which comprises less than L amino acids.

According to further features in preferred embodiments of the invention described below, the motif extraction unit is operable to search each sequence for partial overlaps between the sequence and other sequences, to apply a significance test on the partial overlaps, and to define a most significant partial overlap as a repeatedly occurring motif.

According to still further features in the described preferred embodiments the motif extraction unit comprises a graph constructor capable of constructing a graph having a plurality of paths representing the sequences of the plurality of proteins.

According to still further features in the described preferred embodiments the graph comprises a plurality of vertices, each representing one type of amino acid, and wherein each path of the plurality of paths comprises a sequence of vertices respectively corresponding to an amino acid sequence of one protein of the plurality of proteins.

According to still further features in the described preferred embodiments L is selected from the group consisting of 5, 6, 7, 8, 9, 10, 11, 12, 13, 14 and 15.

In an exemplary embodiment of the invention, there is provided a method of processing a substrate, the method comprising:

contacting the substrate with at least one polypeptide selected from the group consisting of the polypeptides set forth in SEQ ID Nos.: 77,838 to 198,923 under conditions which allow processing of the substrate by said at least one polypeptide, wherein said at least one polypeptide is selected capable of processing the substrate.

Optionally, the reaction conditions include a temperature of at least 45°. centigrade.

Optionally, the substrate is selected from the group consisting of a lipid, a protein, a carbohydrate and a nucleic acid.

Optionally, the at least one peptide affects reaction kinetics of a lipid hydrolysis reaction.

Optionally, the at least one peptide affects reaction kinetics of a protein hydrolysis reaction.

Optionally, the at least one peptide affects reaction kinetics of a carbohydrate hydrolysis reaction.

Optionally, the at least one peptide affects reaction kinetics of a reaction with a nucleic acid substrate.

Optionally, said conditions comprise the presence of a detergent.

In an exemplary embodiment of the invention, there is provided a method of producing an enzyme, the method comprising:

(a) growing cells expressing a polypeptide selected from the group consisting of polypeptides as set forth in SEQ ID Nos.: 77,838 to 198,923; and

(b) harvesting said polypeptide from the culture.

Optionally, the method comprises:

(c) assaying a functional activity of said peptide.

Optionally, the method comprises:

(c) purifying said peptide at least 50% purity by weight.

Optionally, the method comprises:

(c) purifying said peptide to medical grade purity.

Optionally, the cells express said polypeptide because they have been transformed or transfected with an A nucleic acid construct comprising a nucleic acid sequence encoding a polypeptide selected from the group consisting of polypeptides as set forth in SEQ ID Nos.: 77,838 to 198,923 and a cis-acting regulatory element for expressing said polypeptide in a host cell

In an exemplary embodiment of the invention, there is provided a nucleic acid construct comprising a nucleic acid sequence encoding a polypeptide selected from the group consisting of polypeptides as set forth in SEQ ID Nos.: 77,838 to 198,923 and a cis-acting regulatory element for expressing said polypeptide in a host cell.

In an exemplary embodiment of the invention, there is provided a host cell comprising the construct.

Optionally, the host cell comprises a eukaryotic cell.

Optionally, the host cell comprises a prokaryotic cell.

In an exemplary embodiment of the invention, there is provided a transgenic plant expressing an exogenous polypeptide selected from the group consisting of polypeptides as set forth in SEQ ID Nos.: 77,838 to 198,923.

In an exemplary embodiment of the invention, there is provided a transgenic animal expressing an exogenous polypeptide selected from the group consisting of polypeptides as set forth in SEQ ID Nos.: 77,838 to 198,923.

In an exemplary embodiment of the invention, there is provided a method of producing a specific enzyme, the method comprising:

(a) growing a culture of host cells according to claim 52; and

(b) harvesting the polypeptide from the culture.

In an exemplary embodiment of the invention, there is provided a pharmaceutical composition comprising a pharmaceutically acceptable carrier and, as an active ingredient, at least one polypeptide selected from the group consisting of polypeptides as set forth in SEQ ID Nos.: 77,838 to 198,923.

In an exemplary embodiment of the invention, there is provided a isolated composition comprising a polypeptide selected from the group consisting of polypeptides as set forth in SEQ ID Nos.: 77,838 to 198,923.

Optionally, the composition comprises a cleaning agent.

Optionally, the cleaning agent comprises at least one member selected from the group consisting of a detergent, a solvent and a surfactant.

In an exemplary embodiment of the invention, there is provided a method of laundering fabric, the method comprising:

(a) mixing a composition according to any of claims 59-62 with water to produce a washing solution; and

(b) wetting the fabric with the washing solution.

Optionally, the method comprises heating to a temperature of at least 45° centigrade.

In an exemplary embodiment of the invention, there is provided a chemical reagent comprising:

(a) catalytic molecules comprising at least one peptide selected from the group consisting of SEQ ID Nos.: 77,838 to 198,923; and

(b) an insoluble support with the catalytic molecules bound thereto.

In an exemplary embodiment of the invention, there is provided a industrial process comprising:

(a) contacting a plurality of substrate molecules with a reagent according to claim 64; and

(b) adjusting reaction conditions to contribute to activity of the catalytic molecules in processing the substrate molecules.

Optionally, the process is conducted batchwise.

Optionally, the insoluble support is immobilized and the process is conducted as a flow-through process.

Optionally, the process is conducted at a temperature of at least 45° centigrade.

In an exemplary embodiment of the invention, there is provided a method of identifying an inhibitor of a catalytic activity of an enzyme of interest, the method comprising:

(a) contacting an enzyme comprising a polypeptide as set forth in one of SEQ ID nos.: 77,838 to 198,923 having an activity as set forth in one of tables 38 and 39 with a substrate thereof and an agent to be evaluated under conditions which allow catalytic processing of the substrate by the enzyme; and

(b) monitoring said catalytic processing of said substrate and:
(i) concluding that the agent is an inhibitor if a reduction in catalytic processing is observed; and
(ii) concluding that the agent is not an inhibitor if a reduction in catalytic processing is not observed.

The present invention successfully addresses the shortcomings of the presently known configurations by providing a method and apparatus for classifying protein sequences.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flowchart diagram describing a method suitable for classifying a target sequence of a protein, according to various exemplary embodiments of the present invention;

FIG. 2 is a schematic illustration of an apparatus for classifying a target protein sequence, according to various exemplary embodiments of the present invention;

FIG. 3 is a flowchart diagram of a method for characterizing a predetermined collection of protein classes, according to various exemplary embodiments of the present invention;

FIG. 4 is a schematic illustration of an apparatus for characterizing a protein class being a member of a collection of protein classes, according to various exemplary embodiments of the present invention;

FIG. 5 is a flowchart diagram of a method for classifying a plurality of proteins into protein classes, according to various exemplary embodiments of the present invention;

FIGS. 6a-b are simplified illustrations a structured graph (FIG. 6a) and a random graph (FIG. 6b), according to a preferred embodiment of the present invention;

FIG. 7a illustrates a representative example of a portion of a graph with a search-path going through five vertices, according to a preferred embodiment of the present invention;

FIG. 7b illustrates a pattern-vertex having three vertices which are identified as significant pattern of the trial path of FIG. 7a, according to a preferred embodiment of the present invention;

FIG. 8 is a histogram of motifs as function of their length as calculated according to a preferred embodiment of the present invention for the six main classes of the EC hierarchical classification;

FIGS. 9a-c are histograms of percentage identity of pairs of enzymes that contain the same predicting sequences which comprise less than 9 amino acids (FIG. 9a), between 9 and 12 amino acids (FIG. 9b) and more than 12 amino acids (FIG. 9c);

FIG. 10 is a histogram of number of proteins in an additional exemplary set of previously characterized proteins as a function of number of predicting sequence matches;

FIG. 11 is a histogram of number of proteins in same set of protein as in FIG. 10 as a function of number of predicting sequence matches indicating how many consistent and inconsistent matches for each number of predicting sequences;

FIG. 12 is a histogram similar to FIG. 11 showing 5 to 15 predicting sequence matches in greater detail;

FIG. 13 is a histogram indicating percentage of various combinations of consistent and inconsistent predicting sequence matches per protein;

FIG. 14 is a histogram depicting percentage of true predictions as a function of predicting sequence match category;

FIG. 15 is a histogram depicting number of proteins as a function of length of coverage (L) by number of consistent predicting sequences;

FIG. 16 is a histogram depicting number of proteins as a function of predicting sequence match category for a dataset of previously uncharacterized sequences;

FIG. 17 is a tree diagram illustrating representative portions of the EC hierarchy and the assignments of predicting sequences (PS) to predictive sequence classes to form exemplary predictive sequences according to some embodiments of the invention;

FIG. 18 shows aligned sequences of two groups of enzymes of level 4 that share the same 3rd level assignment. The organisms in the upper group, 5.1.3.20, belong to proteobacteria, while those of the lower group, 5.1.3.2, contain also eukaryotes (ARATH, CYATE and PEA); Bold-faced substrings denote predictive sequences; amino-acids flanked by spaces denote active sites and binding sites, as indicated above; a list of all predictive sequences and their assignments to predictive sequence classes is presented below the sequences.

FIG. 19 is a three dimensional spacefilling model of enzyme P67910 depicting the active sites of (1) S, (2) Y and (3) K and the motif RYFNV in location (4). Clearly the latter shares with the loci (1) and (2) the same pocket, thus indicating its possible importance in the function of this enzyme. Visualization was done using the tool described in Moreland, et al (2005; The molecular biology toolkit (mbt): A modular platform for developing molecular visualization applications. BMC Bioinformatics., 6:21);

FIG. 20a is a three-dimensional display of enzyme P07649 (PDB code 1DJ0), belonging to EC 5.4.99.12, showing [1] an active site D at sequence location 60, [2] a binding site Y at location 118, [3] a binding site L at location 245. The active site is common to two predicting sequences [4] containing (CAGRT(D)AGVH). Other shown predicting sequences are [5] GQVVH at locations 67-71, [6] FHARF at locations 107-111, known to be a tentative RNA-binding peptide, [7] ENDFTS at locations 157-163 and [8] HMVRNI at 201-207, sharing a pocket with the active and binding sites. GQVVH and ENDFTS belong to PS3, all other motifs belong to PS4.

FIG. 20b shows a different display of the same enzyme focuses on the pocket containing the active site.

FIG. 20c shows the relevant section of the enzyme sequence, with highlighted residues corresponding to the pocket and underlined residues corresponding to predicting sequences.

FIG. 21 is a histogram of number of enzyme sequences as a function of number of predicting sequences occurring on enzymes; the median is indicated on the Figure and the mean average is 9.5 predicting sequences/enzyme;

FIG. 22 is a pie chart illustrating the relation between the data of Swiss-Prot releases 45 and 48.3

FIG. 23 is histogram of number of enzymes as a function of number of predictive sequences with median and mean number of predictive sequences indicated;

FIG. 24 is a Venn diagram illustrating the intersection of enzymes characterized by an exemplary embodiment of the invention and PROsite data of Swiss-Prot; and

FIG. 25 is a histogram of coverage of ProSite motifs by PSs plotted as a function of the required minimal amount (in percents) of amino-acids shared by the two motifs.

### DESCRIPTION OF THE PREFERRED EMBODIMENTS

One aspect of the invention relates to an algorithm which employs a large number of short predictive sequences generally indicated as Sj, to determine a function (e.g. an enzymatic function) of a subject amino acid (AA) sequence which has not been previously characterized. A classifier Cj indicating Classification information (e.g. a classification in the Enzyme Commission Hierarchy) is associated with each predictive sequence Sj. In an exemplary embodiment of the invention, each Cj provides a position in the EC hierarchy.

In an exemplary embodiment of the invention, the algorithm searches the subject AA sequence to provide all the Sj hits thereon. The Sj hits can be either consistent (c) or inconsistent (i) where consistency indicates assignment to a same EC class or classes which share a parent/offspring relationship.

In an exemplary embodiment of the invention, 2 to 20 predictive sequences are used to assign an EC number to an AA sequence. Optionally, 3 to 5 predictive sequences are sufficient to reliably assign an EC number to an AA sequence. In some exemplary embodiments of the invention predictive sequences have significant predictive value even when they do not all consistently indicate a single EC classification.

Another aspect of the invention relates to automated analysis of AA sequences by a machine to identify predicting sequences within the sequence, analyze the identified predicting sequences and assign an EC classification based upon the identified predicting sequences. In an exemplary embodiment of the invention, the automated analysis assigns EC classifications which have low homology (e.g. 70%, or 60% or 50% or intermediate or lesser homologies at the AA level) to the most homologous enzyme in the assigned EC class. Optionally, the analysis assigns a single AA sequence to two EC classes. In an exemplary embodiment of the invention, assignment to two EC classifications indicates that there are two distinct enzymatic activities. Optionally, the two activities reside in distinct AA sequence domains or in overlapping AA sequence domains.

An additional aspect of the invention relates to use AA sequences which were previously isolated to perform a function revealed by analysis of predicting sequences residing in the sequence. According to various exemplary embodiments of the invention, large numbers of previously unknown enzymes for hydrolysis (e.g. of proteins and/or carbohydrates and/or lipids) are made available. According to other exemplary embodiments of the invention, large numbers of previously unknown enzymes for laboratory analytic use (e.g. nuclease and/or ligases and/or polymerases) and/or medical use are made available. Optionally, enzymes are made available in a variety of forms including but not limited to, chemical reagents comprising specific enzymes immobilized on an insoluble support, pharmaceutical compositions and cleaning preparations. Exemplary insoluble supports include, but are not limited to, cellulose, agarose, sephadex, sepharose, nitrocellulose, nylon, polycarbonate, polystyrene and glass. Immobilization is optionally transient (e.g. by ionic binding) or permanent (e.g. by covalent binding).

In an exemplary embodiment of the invention, the enzymes are isolated from thermophilic organisms. Optionally, such enzymes remain active at 45° centigrade or are chemically modified to obtain such thermal stability.

Another aspect of the invention relates to isolated nucleic acid sequence encoding at least a functional portion of an AA sequence which was previously isolated but whose function was only revealed by analysis of predicting sequences residing in the sequence. Optionally, analysis of large groups of newly characterized polypeptides gives rise to a smaller, but still significant, group of products. In an exemplary embodiment of the invention, isolated nucleic acid sequences which encode the polypeptides of the present invention are incorporated into an expression vector. Optionally, the expression vector can be used to transfect bacteria and/or to transform cells and recombinantly express the exogenous polypeptide therein. According to various exemplary embodiments of the invention, the cells can be prokaryotic or eukaryotic cells (e.g., mammalian cells, insect cells, yeast or plant cells) which are amenable to transformation. Optionally, the transformed cells comprise at least a portion of a transgenic animal or a transgenic plant.

In an exemplary embodiment of the invention, there is provided a detergent composition comprising one or more enzymes characterized according to a method according to an exemplary embodiment of the invention and/or a method of use of the composition. Optionally, enzymes characterized according to a method according to an exemplary embodiment of the invention are set forth in SEQ ID Nos.: 77,838 to 198,923. XXX try to limit??

In an exemplary embodiment of the invention, there is provided a food composition and/or a food processing composition comprising one or more enzymes characterized according to a method according to an exemplary embodiment of the invention and/or a method of use of the composition. Optionally, enzymes characterized according to a method according to an exemplary embodiment of the invention are set forth in SEQ ID Nos.: 77,838 to 198,923. XXX try to limit??

The present invention also encompasses compositions useful for the preparation of ethanol comprising one or more enzymes characterized according to a method according to an exemplary embodiment of the invention and/or a method of use of the composition. Optionally, enzymes characterized according to a method according to an exemplary embodiment of the invention are set forth in SEQ ID Nos.: 77,838 to 198,923. XXX try to limit??

The present embodiments comprise a searchable protein database which can be used for classifying a protein according to its amino acid primary sequence. Specifically, the present invention can be used to predict a class of an unclassified protein for the purpose of, e.g., predicting its affinity or function. The present embodiments further comprise readable data storage medium carrying the protein database, method and apparatus for classifying protein sequences, and method and apparatus for characterizing a collection of protein classes for the purpose, e.g., building or updating the database.

The principles and operation of a method and apparatus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It has long been recognized that in numerous cases proteins exhibit a high correlation between their three-dimensional structure and their function; however other cases revealed no such correlation.

For example, the enzyme lysozyme (PDB entry 8lyz and EC 3.2.1.17) and the enzyme α-lactalbumin (PDB entry 1alc and EC 2.4.1.22) share only 44% sequence identity, but their backbones superpose with a root-mean-square-deviation (RMSD) of only 1.55 Å, meaning these two enzymes share a very similar three-dimensional structure. Interestingly, their functions are mutually exclusive: α-lactalbumin can not hydrolyze glycosides and lysozyme can not participate in lactose synthesis.

A more impressive example of this phenomenon is the structural family known as the TIM barrel fold family, named after triosephosphate isomerase (PDB entry 1amk and EC 5.3.1.1). The eight-stranded a/13 TIM barrel is by far the most common tertiary fold observed in high resolution protein crystal structures. It is estimated that 10% of all known enzymes have this domain. The members of this large family of proteins catalyze very different reactions. Such diversity in function has made this family an attractive target for protein structure-function relationship research, and the evolutionary history of this protein family has been the subject of rigorous debate. Arguments have been made in favor of both convergent and divergent evolution, yet due to the lack of sequence homology, the ancestry of this molecule is still not understood.

Table 1 below presents some 84 members of the TIM barrel family sorted by their EC number, which represent the function of the enzyme, as further detailed hereinafter. As shown in Table 1 the enzymes of the TIM barrel family span over all classes of the EC hierarchical classification. These examples illustrate that mere backbone structural similarity does not necessarily imply functional similarity.

TABLE 1
TIM barrel family enzymes by EC class.

| | Enzyme/Protein name | EC Number |
|---|---|---|
| 1 | CHO reductase | 1.1.1.2 |
| 2 | Inosine monophosphate dehydrogenase | 1.1.1.205 |
| 3 | Aldehyde reductase | 1.1.1.21 |
| 4 | Aldose reductase | 1.1.1.21 |
| 5 | 3-alpha-hydroxy steroid dehydrogenase | 1.1.1.50 |
| 6 | Flavocytochrome B2 | 1.1.2.3 |
| 7 | Glycholate oxidase | 1.1.3.1 |
| 8 | 2-5-diketo D-gluconic acid reductase | 1.1.99.3 |
| 9 | Luciferase (flavin mono oxygenase) | 1.14.14.3 |
| 10 | Di hydro orotate dehydrogenase | 1.3.3.1 |
| 11 | Tetrahydromethanopterin reductase | 1.5.99.11 |
| 12 | Trimethylamine dehydrogenase | 1.5.99.7 |
| 13 | Old yellow enzyme | 1.6.99.1 |
| 14 | Methyltetrahydrofolate corrinoid | 2.1.1.13 |
| 15 | Transaldolase B | 2.2.1.2 |
| 16 | Cyclodextrin glycosyl transferase | 2.4.1.19 |
| 17 | Quinolinate phosphoribosyl transferase | 2.4.2.19 |
| 18 | tRNA- Guanine transglycosylase | 2.4.2.29 |
| 19 | Dihydropteroate synthase | 2.5.1.15 |
| 20 | Thiamin phosphate synthase | 2.5.1.3 |
| 21 | Pyruvate kinase | 2.7.1.40 |
| 22 | Pyruvate phosphate dikinase | 2.7.9.1 |
| 23 | Endonuclease IV | 3.1.21.2 |
| 24 | His A protein | 3.1.3.15 |
| 25 | Phosphoinositide-Specific Phospholipase C, Isozyme d1 | 3.1.4.11 |
| 26 | Phosphotriesterase | 3.1.8.1 |
| 27 | α-amylase | 3.2.1.1 |
| 28 | Oligo 1-6 glucosidase | 3.2.1.10 |
| 29 | Hevamine | 3.2.1.14 |
| 30 | chitinase A | 3.2.1.14 |
| 31 | β-amylase | 3.2.1.2 |
| 32 | β-glycosidase | 3.2.1.21 |
| 33 | 1-3 β glucanase | 3.2.1.39 |
| 34 | Endocellulase E1 | 3.2.1.4 |
| 35 | Chitobiase | 3.2.1.52 |
| 36 | 1,4 a D-glucan maltotetrahydrolase) | 3.2.1.60 |
| 37 | Isoamylase | 3.2.1.68 |
| 38 | 1-3, 1-4 β glucanase | 3.2.1.73 |
| 39 | β mannanase | 3.2.1.78 |
| 40 | Endo-β-1-4-xylanase | 3.2.1.8 |
| 41 | Exo-1-4-β-D- glycanase | 3.2.1.91 |
| 42 | Endo-β-N-acetyl glucose aminidase | 3.2.1.96 |
| 43 | Myrosinase (thioglucoside glucohydratase) | 3.2.3.1 |
| 44 | Urease (c subunit) | 3.5.1.5 |
| 45 | Adenosine deaminase | 3.5.4.4 |
| 46 | Ornithine decarboxylase | 4.1.1.17 |
| 47 | orotidine-5′-phosphate decarboxylase | 4.1.1.23 |
| 48 | Phosphoenol pyruvate carboxylase | 4.1.1.31 |
| 49 | Uroporphyrinogen decarboxylase | 4.1.1.37 |
| 50 | ribulose-bisphosphate carboxylase (large subunit) | 4.1.1.39 |
| 51 | Indole-3 glycerol phosphate synthase | 4.1.1.48 |
| 52 | Fructose bis-phosphate aldolase | 4.1.2.13 |
| 53 | Arabino-heptulosonate-7-phosphate synthase | 4.1.2.15 |
| 54 | 3-deoxy-D-manno-Octulosonate 8 phosphate synthase | 4.1.2.16 |
| 55 | Isocitrate Lyase | 4.1.3.1 |
| 56 | Malate synthase G | 4.1.3.2 |
| 57 | N-acetyl neuraminate lyase | 4.1.3.3 |
| 58 | 3-dehydroquinate dehydratase | 4.2.1.10 |
| 59 | Enolase | 4.2.1.11 |
| 60 | Tryptophan synthase (α subunit) | 4.2.1.20 |
| 61 | 5-Amino laevulinate dehydratase | 4.2.1.24 |
| 62 | propane Diol dehydratase | 4.2.1.28 |
| 63 | D-glucarate dehydratase | 4.2.1.40 |
| 64 | 2-Dehydro-3-Deoxy-Galactarate Aldolase | 4.2.1.42 |
| 65 | Dihydropicolinate Synthase | 4.2.1.52 |
| 66 | His F protein | 4.3.2.4 |
| 67 | Alanine racemase | 5.1.1.1 |
| 68 | Mandelate racemase | 5.1.2.2 |
| 69 | D-ribulose-5-phosphate 3-epimerase | 5.1.3.1 |
| 70 | Triosephosphate Isomerase | 5.3.1.1 |
| 71 | Rhamnose isomerase | 5.3.1.14 |
| 72 | N-5-phosphoryl anthranilate isomerase | 5.3.1.24 |
| 73 | Xylose isomerase | 5.3.1.5 |
| 74 | Phosphoenol pyruvate mutase | 5.4.2.9 |
| 75 | Glutamate Mutase | 5.4.99.1 |
| 76 | Methylmalonyl CoA mutase | 5.4.99.2 |
| 77 | Muconate cyclo isomerase | 5.5.1.1 |
| 78 | Chloromuconate isomerase | 5.5.1.7 |
| 79 | Yeast Hypothetical protein | — |
| 80 | FR-1 Protein | — |
| 81 | Potassium channel β subunit | — |
| 82 | Methylene tetrahydrofolate reductase | — |
| 83 | Narbonin | — |
| 84 | Concanavalin B | — |

Conversely, structural dissimilarity does not necessarily imply functional dissimilarity, as demonstrated among many proteins. For example, carbonic anhydrases (EC 4.2.1.1) from the archaebacteria Methanosarcina thermophila (PDB entry 1thj) is utterly structurally dissimilar to carbonic anhydrases from the mammal Mus musculus (PDB entry 1dmx).

In a search for classification techniques, the present inventors have devised a searchable protein database which can be used for efficiently classifying protein according to its amino acid primary sequence. The protein database of a preferred embodiment of the present invention comprises a plurality of entries, where each entry j has a predicting sequence Sⱼ and a protein classifier Cⱼ corresponding to the predicting sequence Sⱼ.

In some of the priority documents of the instant Application (U.S. Application No. 60/799,318 filed on May 11, 2006, and U.S. Application No. 60/861,746 filed on Nov. 30, 2006), “predicting sequences” or “PS” were also referred to as “specific peptides” or “SP”.

Exemplary databases according to the teachings of the present embodiments are provided in Appendix 1 and Tables 11, 37 and 42 on enclosed CD-ROM (files “Table-11.txt”, “Table-37.txt” and “Table-42.txt”). Methods suitable for constructing the database according to various exemplary embodiments of the present invention are provided hereinbelow.

As is further detailed hereinunder, the predicting sequence of each entry predicts the class to which a target protein belongs, while the corresponding classifier provides classification information of the respective class, subclass, sub-subclass etc. For example, in one embodiment, Sⱼ predicts the affinity of a protein and Cⱼ describes the affinity class of the protein.

The term “affinity”, as used herein, refers to a specific distinguishing property of a given protein which relate to the molecule(s) that bind and interact with it in a specific and characteristic mode, and thereby at least partially describe the protein's function. A set of one or more molecules which bind and interact with a protein in a specific manner, (e.g., substrates, ligands, coenzymes, co-factors, affinity-pair protein counterpart and the likes), is referred to herein as an “interacting set”.

The affinity of a protein according to the present embodiments correlates strongly to the protein's chromophore, which comprises a specific set of chemical moieties which are specifically positioned in three-dimensional space so as to fit a complementary arrangement of chemical moieties which is characteristic of a member of the interacting set. The binding and interaction between the protein and the members of its interacting set is therefore governed by structural recognition patterns which effect reversible binding and exhibit a high binding (dissociation) constant relative to molecules which are not members of the binding set.

The EC hierarchical classification system discussed in details in Appendix 2 below is one example for protein classification by affinity. For example, an enzyme which belongs to the hydrolases class (EC 3.-.-.-), acting on carbon-nitrogen bonds other than peptide bonds (EC 3.5.-.-) in cyclic amides (EC 3.5.2.-), is classified by affinity to cyclic amides such as, for example, cyanuric acid, and hence cyanuric acid amidohydrolase (EC 3.5.2.15) is uniquely identified by affinity to cyanuric acid. Thus, according to a preferred embodiment of the present invention Sⱼ predicts the branch of the EC tree to which the protein belongs and Cⱼ provides classification information in the form of the EC number defining the respective branch.

Receptor-ligand affinity is another example in which the predicting sequence predicts the affinity of a protein. Like enzymes, receptors interact with one or more ligands by binding which is governed by molecular recognition. The receptor exhibits one or more binding sites which are structurally and chemically compatible to bind the ligand, namely possess a unique chromophore comprising atoms of its amino acid chain. Therefore, a collection of receptor sequences wherein each receptor is associated with a known ligand can be classified according to the type of ligand that each receptor recognizes and binds. Thus, according to the presently preferred embodiment of the invention Cⱼ describes ligands to which a protein having the predicting sequence Sⱼ binds. Representative examples of such ligands, include, without limitation, peptide-type ligands, charge-type ligands, phosphate-type ligand, nucleotide-type ligands and the like.

Receptor classes can be attributed to specific ligand/activity types such as G-protein-coupled receptors (GPCRs), guanylyl cyclase receptors, tyrosine kinase receptors, erythropoietin receptor, growth factors receptors, cytokines receptors, nicotinic receptors, acetylcholine receptors, atrial-natriuretic peptide (ANP) receptors, natriuretic peptides receptors, guanylin receptors, glycine receptor, GABA receptors, glutamate (kainate) receptors, NMDA receptors, AMPA receptors, serotonin (5-HT3) receptors and the likes.

Within the large group of receptors, one particular class of receptors is the GPCRs super-family, also known as seven transmembrane receptors (7TMRs). This family is a protein family of transmembrane receptors that transduce an extracellular signal (ligand binding) into an intracellular signal (G protein activation). The GPCRs are the largest protein family known, and members of this family are involved in all types of stimulus-response pathways, from intercellular communication to physiological senses. The diversity of functions is matched by the wide range of ligands recognized by members of the family, including photons (rhodopsin, the archetypal GPCR), small molecules (in the case of the histamine receptors) and proteins (for example, chemokine receptors). This pervasive involvement in normal biological processes has the consequence of involving GPCRs in many pathological conditions, which has led to GPCRs being the target of 40% to 50% of modern medicinal drugs. The GPCRs can be further subdivided into subclasses and the present embodiments can be used to sub-classify receptors of the GPCR super-family.

Thus, according to a preferred embodiment of the present invention Sⱼ predicts the specific binding of a GPCR and Cⱼ comprises classification information which describes ligands to which the GPCR binds. For example, the classification information which can be provided by the classifier can include specific ligand/activity types, such as, but not limited to, “muscarinic”, acetylcholine receptors (acetylcholine and muscarine), adenosine receptors (adenosine), adrenoceptors (also known as adrenergic receptors, for adrenaline, and other structurally related hormones and drugs), GABA receptors, type-B (γ-aminobutyric acid or GABA), angiotensin receptors (angiotensin), cannabinoid receptors (cannabinoids), cholecystokinin receptors (cholecystokinin), dopamine receptors (dopamine), glucagon receptors (glucagon), metabotropic glutamate receptors (glutamate), histamine receptors (histamine), olfactory receptors (for the sense of smell), opioid receptors (opioids), rhodopsin (a photoreceptor), secretin receptors (secretin), serotonin receptors (except type-3), somatostatin receptors (somatostatin), calcium-sensing receptor (calcium) and the likes.

In an additional embodiment, Sⱼ predicts the three-dimensional structure of the protein or a portion thereof. In this embodiment, Cⱼ describes a class or family of proteins having sufficient structural homology. One example of such protein class is the aforementioned TIM barrel super-family, which include a large number of proteins which share a fold (main feature of the tertiary structure).

In still another embodiment, Sⱼ predicts the function of the protein. In this embodiment, Cⱼ describes a class or family of proteins that share functional attributes, such as, for example, proteins which are derived from a common ancestor. For example, a classification according to an ancestor can be used to classify proteins which contain a catalytic triads and which are related by convergent evolution towards a stable, useful active site. Among these are found the α/β hydrolase fold family, the eukaryotic serine protease family, the cysteine protease family and the subtilisin family. For example, the class of proteins associated with the α/β hydrolase fold comprises several hydrolytic enzymes of widely differing phylogenetic origin and catalytic function. The core of each member of this group is an α/β-sheet and not a barrel, of eight β-sheets connected by α-helices. These proteins have diverged from a common ancestor so as to preserve the arrangement of the catalytic residues, not the binding site. They all have a catalytic triad, the elements of which are borne on loops which are the best-conserved structural features in the fold. The unique topological and sequence arrangement of the triad residues produces a catalytic triad which is, in a sense, a mirror-image of the serine protease catalytic triad.

The classifier Cⱼ can also describe a class or family of proteins that share communication transmittance attributes, such as, but not limited to, the cytokines. Cytokines are soluble proteinaceous substances, such as the interleukins and lymphokines, produced by a wide variety of haemopoietic and non-haemopoietic cell types, and are critical to the functioning of both innate and adaptive immune responses.

Cytokines can be classified into four different classes based on structural homology. A first cytokines class includes the cytokines with four bundles of alpha-helices. This class is subdivided into three sub-classes, known as the Interleukin (IL) 2 subclass, the interferon (INF) subclass and the IL-10 subclass. A second cytokines class is known as the IL-1 family and primarily includes the IL-1 and IL-18. A third cytokines class, known as the IL-17 class, includes cytokines which have a specific effect in promoting proliferation of T-cells that cause cytotoxic effects. A fourth cytokines class includes the chemokines.

Cytokines, and particularly immunological cytokines, can also be classified according to the target cells and/or the cells for which they stimulate proliferation and differentiation. With respect to immunological cytokines, for example, these can be classified to several classes. One such class can include cytokines which activate T cells, another class can include cytokines which stimulate proliferation of antigen-activated T and B cells, an additional class can include cytokines which stimulate proliferation and differentiation of B cells, an additional class can include cytokines which activate macrophages, and an additional class can include cytokines which stimulate hematopoiesis. Thus, in this embodiment Sⱼ predicts the function of the cytokine and Cⱼ describes this function.

Also contemplated are embodiments in which Sⱼ predicts other protein attributes such as, but not limited to, electrostatic traits, cellular placement locus, motion capacity and the like. Depending on the protein attributes Cⱼ describes the class of proteins which share the respective attribute.

It is to be understood that the database of the present embodiments is not limited to one classification criterion. It is intended to embrace all combinations and sub-combinations of any of the aforementioned protein classification criteria.

For example, as will be appreciated by one of ordinary skill in the art, when the classifier Cⱼ comprises an EC number, the classification can be according to function and/or affinity. Thus, a particular entry in the database can comprise a predicting sequence which predicts, e.g., the ability of the enzyme to catalyze oxidoreduction reactions. In this case the corresponding classifier can be EC 1 which stands for the oxidoreductases main class in the EC hierarchical classification. Another entry in the database can comprise a predicting sequence which predicts, e.g., the ability of the enzyme to act on carbon-nitrogen bonds in the cyclic amide in cyanuric acid. In this case the corresponding classifier can be EC 3.5.2.15, which describes, inter alia, function (catalyzing hydrolytic cleavage) and affinity (to the carbon-nitrogen bond in the cyclic amide in cyanuric acid).

Another combination of classification criteria which is contemplated is the combination of classification by function and fold. For example, a particular entry in the database can comprise a predicting sequence which predicts, e.g., communication transmittance attributes. In this case the classifier comprises information regarding these attributes (for example the classifier can point to the cytokines class of proteins). Another entry can comprise a predicting sequence which predicts, e.g., one of the four structural types of the cytokines (e.g., the four α-helix bundle). In this case the classifier can point to the respective type of cytokine. Other combinations of classification criteria are also contemplated.

The protein database of the present embodiments can be embodied in any electronically readable data storage medium, including, without limitation, a memory medium (e.g., RAM, ROM, EEPROM, flash memory, etc.), an optical storage medium (e.g., CD-ROM, DVD, etc.), a magnetic storage medium (e.g., magnetic cassettes, magnetic tape, magnetic disk storage device, etc.), or any other medium which can be used to store the matrix and which can be accessed electronically, e.g., by a data processor. The protein database of the present embodiments can also be embodied on a printed medium, e.g., a paper.

The number of entries in the protein database of the present embodiments is referred to herein as the size V of the protein database. There is no limitation on the numerical value of V. Preferably, the number of entries is large so as to facilitate classification of many types of proteins. According to a preferred embodiment of the present invention the protein database comprises at least T entries (i.e., V≧T), where T can be any number disclosed either explicitly or implicitly in the specification. For example, T can be any number from 1 to the size of the exemplified protein databases provided in Appendix 1 below and further in Tables 11, 37 and 42 on enclosed CD-ROM.

If desired, the database can be parsimonious in the sense that its size V is reduced compared to the size Vₜ of the training set used for constructing the database. This embodiment is advantageous from the standpoint of data storage volume and/or processing time. It was found by the Inventors of the present invention that the size of the database can be significantly reduced by introducing further screening to the database according to additional information, e.g., biological data. For example, a parsimonious database can be obtained from a larger database by screening the larger database according to three-dimension structural information of known classified proteins, such as the proteins from which the entries of the larger database were extracted.

In preferred embodiment of the invention, a larger database is screened according to biological information, such as, but not limited to, existence of specific sites, secondary structure, DNA and RNA binding, metal binding, protein-protein interactions, etc. For example, screening can be done by keeping only entries corresponding to binding and active sites in known proteins, while removing all other entries. The size of the resulting parsimonious database is preferably less than half, more preferably less than third, more preferably less than quarter, more preferably less than fifth, more preferably less than sixth, more preferably less than seventh, more preferably less than eighth, more preferably less than ninth, more preferably less than tenth of the size of the larger database. As demonstrated in the Examples section that follows, such procedure can reduce a database of over 50,000 entries (e.g., the database provided in Table 11 of 37 on enclosed CD-ROM) to a database of less than 2500 entries, thus reducing the size of the database by a factor of about 20. A representative Example of a database in which all predicting sequence cover active and/or binding sites is provided in Appendix 1 and further in Table 42 on enclosed CD-ROM.

The advantage of the protein database of the present embodiments is in its canonical predicting sequences. The present Inventors have found that it is sufficient to attribute classification information to a target protein based on a relatively short class-predicting sequence. In various exemplary embodiments of the invention the predicting sequence comprises less than L amino acids, where L is an integer which is typically not larger than 15, e.g., L=5, L 6, L=7, L=8, L=9, L=10, L=11, L=12, L=13, L=14 or L=15. The number of amino acids in a predicting sequence is referred to herein as the length of the predicting sequence. A preferred method which can be used for constructing the protein database of the present embodiments is provided hereinunder.

The present Inventors have found that it is sufficient to classify an unclassified target protein, particularly, but not exclusively an enzyme, by searching in its primary sequence for a motif of amino acids matching one of the predicting sequences Sⱼ of the database. It will be appreciated that since the predicting sequences are generally short, the search for a matching motif over the primary sequence is a simple and fast task. In particular, the database of present embodiments is superior to prior art techniques because according to a preferred embodiment of the present invention it is not necessary to determine the similarity level (e.g., number of insertions, deletions and/or mutations) between the entire sequence of the target protein and the entire sequence of each individual protein of the database. Once a matching motif is found, the unclassified protein is classified by attributing the target protein with the protein classifier Cⱼ which corresponds to the matched predicting sequence Sⱼ. Once the protein is classified, its classification can be displayed, e.g., on a display device or hardcopy, recorded on a memory medium, or transmitted over a communication network.

When the database is an enzyme database, the protein classifiers of the database preferably represent branches of the EC hierarchical classification (EC tree). In various exemplary embodiments of the invention each predicting sequence Sⱼ is present exclusively in entries having protein classifier representing a specific EC branch or descending branch thereof. In other words, the predicting sequences are preferably specific to one, and only one, branch of the EC hierarchical classification, excluding uniqueness within its descending branches. For example, as is evident from the database provided in Appendix 1 below and further in Table 11 on enclosed CD-ROM, the predicting sequence SSFGSY (SEQ. ID No. 1907) is present in the EC branch 1.9.3.1 but not in any other EC branch because there are no descending branches to this EC branch. On the other hand, predicting sequence LEGEYG (SEQ. ID No. 13270) corresponds to the EC branch 1.1.1, and is therefore present only on EC branches beginning with the three EC numbers 1.1.1, but not necessarily on all of them.

Database in which protein classifiers representing branches of the EC tree can also be used for determining whether or not a target protein has enzymatic function. Thus, the primary sequence of an unclassified target protein can be searched for one or more motifs of amino acids matching one or more of the predicting sequences of the database. If such motif(s) exist, the protein can be identified as an enzyme. Moreover, the protein classifiers associated with the found motifs can be used for classifying the enzyme according to the EC classification.

Typically, the search over the primary sequence of the target protein results in a plurality of hits, each corresponding to a different entry of the database. In this case, a confidence or likelihood test is preferably employed so as to determine whether or not the target protein has enzymatic function. Optionally and preferably the confidence or likelihood test is employed to exclude one or more predicting sequence hits which are more likely to be accidentals. That is to say, predicting sequence hit corresponding to protein classifiers representing a branch of the EC tree which is likely to be false is excluded from the list of predicting sequence hits. Protein classifiers associated with the remaining predicting sequence hits can then be used for classifying the protein according to the EC classification.

The likelihood test preferably comprises a thresholding procedure in which the number of predicting sequence hits on the target protein is compared to one or more predetermined confidence thresholds. The simplest case is a procedure in which a single threshold is used, whereby if the number of hits is higher than the threshold the target protein is predicted as having enzymatic function, and if the number of predicting sequence hits equals or lower than the threshold, the hits are declared as false positive, and the target protein remains unclassified. A preferred value of the threshold in this embodiment is 2 more preferably 3, more preferably 4, even more preferably 5 or more.

In another embodiment, two or more predetermined thresholds are used. In this embodiment each threshold is associated with an expected error. If the number of predicting sequence hits is higher than the ith threshold but is lower than or equals the (i+1)th threshold, the target protein is predicted as having enzymatic function, and the prediction is associated with the ith expected error.

The expected errors can be obtained as follows: The database of the present embodiments can be tested against a database of random sequences, and a probability can be assigned to each number of hits. Additionally, the primary sequence of a plurality of classified proteins can be searched for motifs of amino acids matching predicting sequences of the database of the present embodiments so as to determine a set of observations, whereby each observation corresponds to a different number of predicting sequence hits. For example, one observation can be the number of classified proteins with no hits, another observation can be the number of classified proteins with one hit, and so on. A set of linear equations can then be constructed for using the sets of probabilities and observations as coefficients. The linear equations can be used for calculating the expected errors. For example, as demonstrated in the Examples section that follows, the expected error associated with a threshold of 2 hits is about 24%.

The database of the present embodiments can also be used for classification according to active sites or active pockets. Thus, a particular entry in the database can comprise a predicting sequence which predicts existence of an active site or an active pocket. For example, the primary sequence of an unclassified target protein (e.g., an enzyme), can be searched for a motif of amino acids matching one of the predicting sequences of the database. Once one or more such predicting sequences of the unclassified target protein are found, the location of one or more of the predicting sequences can be tagged as belonging to an active site or an active pocket of the target protein. Thus, the database of the present embodiments can be used to predict secondary or tertiary structure from primary sequence.

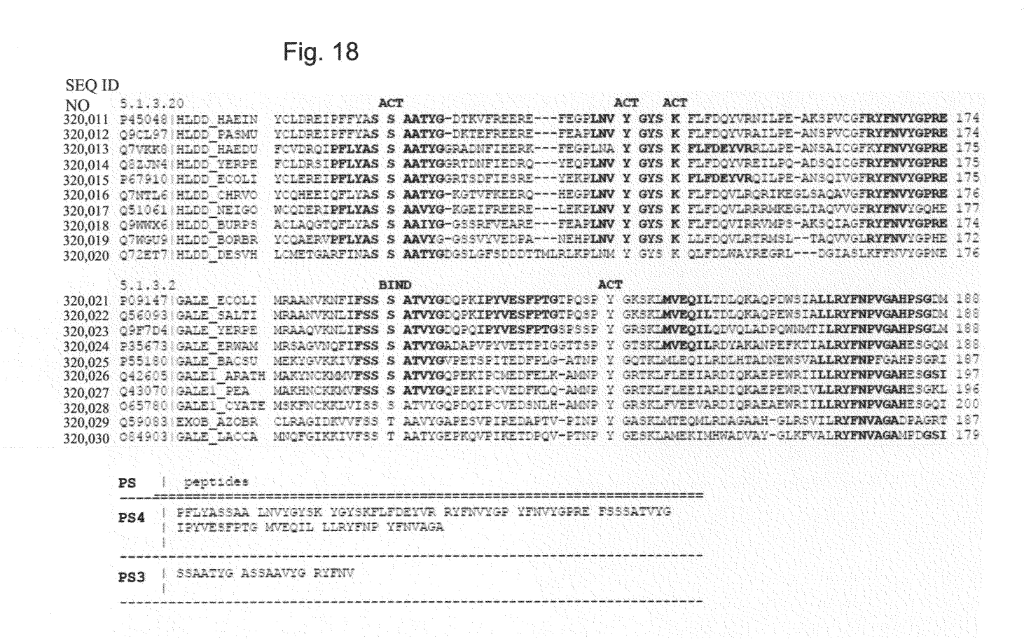

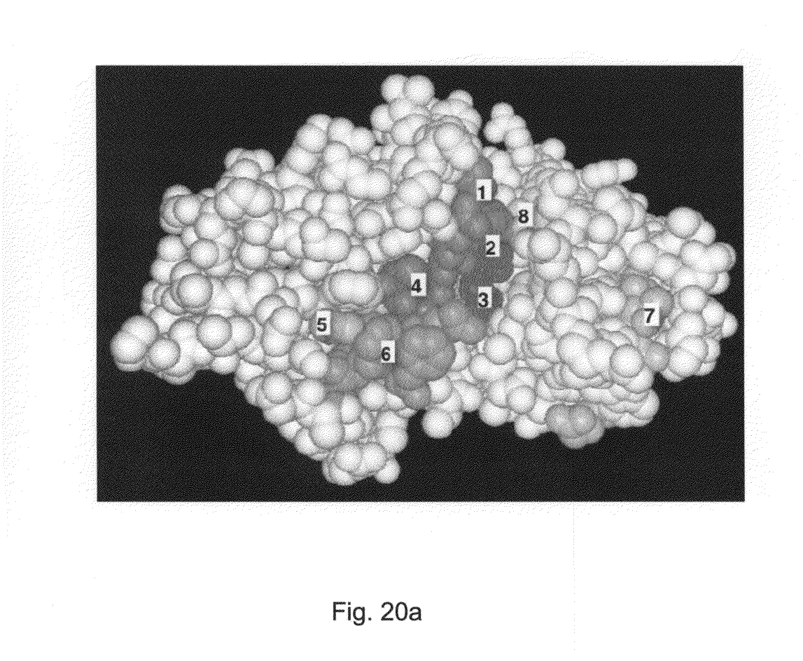

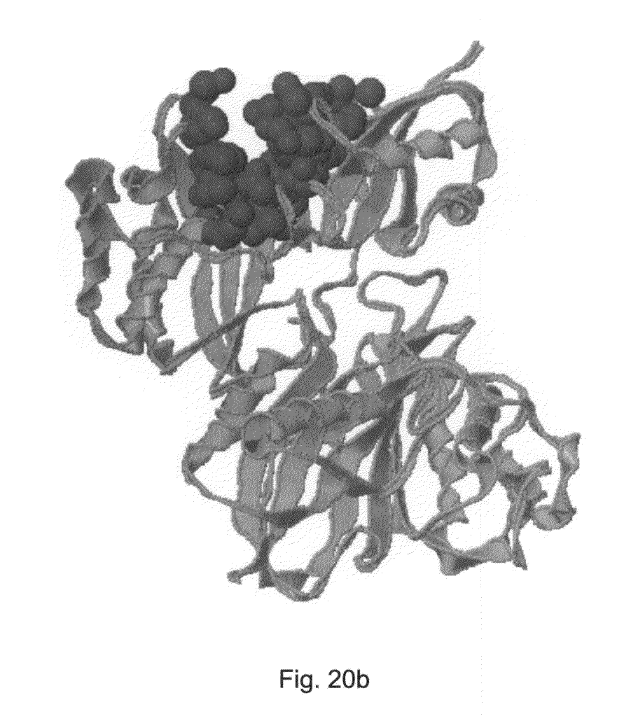

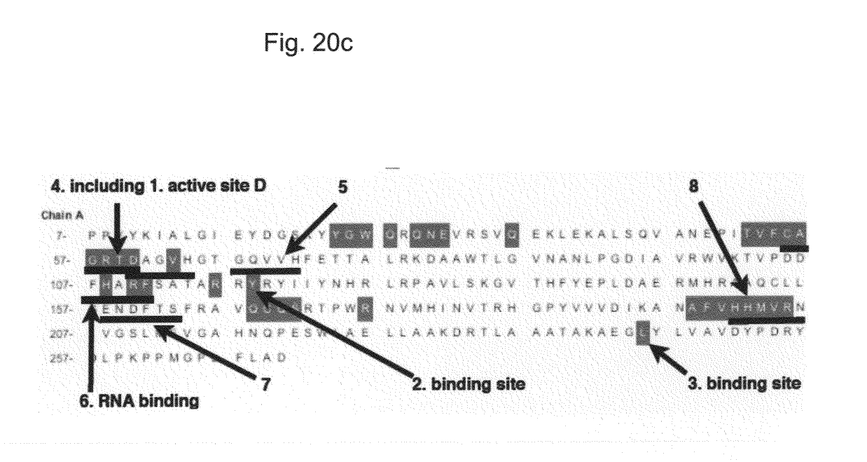

The term “active pocket” as used herein refers to any spatial region on the protein which includes at least one site capable of facilitating a biological or chemical effect. Typically, “active pocket” is a common term to binding pocket and catalytic pocket. For example, an active pocket of a protein can be a volume in the three-dimensional structure of the protein which includes one or more binding sites and/or active sites. Representative examples of loci of active sites and binding sites are shown in FIGS. 18 and 20 in the Examples section that follows.

Also contemplated is the use of the database of the present embodiments for classification according to DNA and RNA binding, metal binding, protein-protein interactions, and the like.

Following is a description of various applications for which the present embodiments can be useful. Each of the following applications can be in a form of a method, which comprises one or more method steps to be executed, or in the form of an apparatus having one or more components capable of performing various method steps.

Methods of the present embodiments can be embodied in many forms. For example, the methods can be embodied in a tangible medium such as a computer for performing the method steps. The methods can be embodied on a computer readable medium, comprising computer readable instructions for carrying out the method steps. The methods can also be embodied in electronic device having digital computer capabilities arranged to run the computer program on the tangible medium or execute the instruction on a computer readable medium.

Apparatus for implementing methods of the present embodiments can commonly be distributed to users on a distribution medium such as an electronically readable data storage medium in a form of computer programs. From the distribution medium, the computer programs can be copied to a hard disk or a similar intermediate storage medium. The computer programs can be run by loading the computer instructions either from their distribution medium or their intermediate storage to medium into the execution memory of the computer, configuring the computer to act in accordance with the method of the present embodiments. All these operations are well-known to those skilled in the art of computer systems.

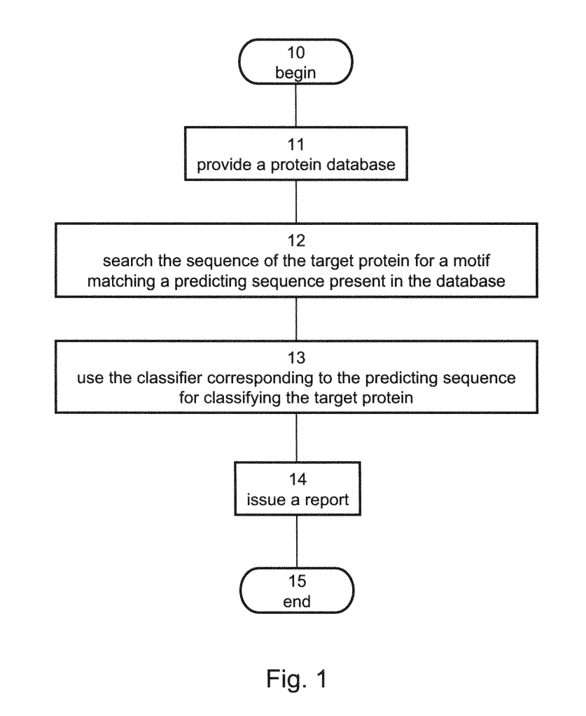

Referring now to the drawings, FIG. 1 is a flowchart diagram describing a method suitable for classifying a target sequence of a protein, according to various exemplary embodiments of the present invention. The method begins at step 10 and continues to step 11 in which the readable protein database is provided. The method continues to step 12 in which the target sequence of the protein is searched for a motif of amino acids matching one or more of the predicting sequences of the database. The search over the target sequence of the protein can be repeated one or more time so as to provide a plurality of motifs, each matching one or more of the predicting sequences of the database. Since the protein primary sequence can be expressed as a one-dimensional vector of characters the search for matching motif can be easily achieved by the ordinarily skilled person, for example, by traversing the one-dimensional vector and comparing its elements with the elements of the predicting sequences of the database.

The method continues to step 13 in which the protein classifier corresponding to the predicting sequence is used for classifying the target protein sequence. The classification depends on the type of protein classifier. Specifically, when the predicting sequences of the database predict protein affinities, the target protein sequence is classified according to the protein classifier into a protein affinity class; when the predicting sequences of the database predict protein functions, the target protein sequence is classified according to the protein classifier into a protein functional class. Other classes are also contemplated. For example, the classification can be according to active sites or active pockets. Specifically, the presence or absence of one or more active sites or active pockets of the target protein can be determined. This can be achieved by using a database which covers active sites or active pockets to a sufficiently high degree of confidence (e.g., more than 50%, more preferably more than 60%). A representative database suitable for the presently preferred embodiment of the invention is provided in Table 42 on enclosed CD-ROM, see also Appendix 1 below.

The existence on the target sequence of motifs matching predicting sequences of such or similar database can be interpreted as presence of active sites or active pockets. Further, the number of matching motifs can be used for estimating the likelihood of such interpretation. Optionally and preferably the location of one or more of the motifs of the target protein which match predicting sequences of the database can be tagged as belonging to an active site or an active pocket.

Classification can also be according to DNA and RNA binding, metal binding, protein-protein interactions and the like.

Once the protein is classified, the method optionally and preferably continues to step 14 in which a report containing its classification is issued. The report can be displayed, recorded or transmitted as further detailed hereinabove. The method ends at step 15.

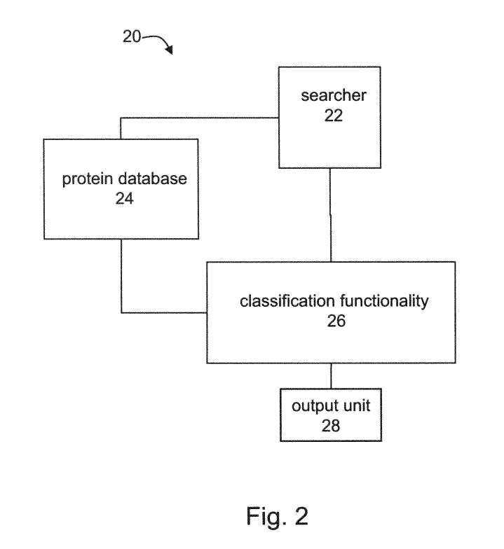

Reference is now made to FIG. 2 which is a schematic illustration of an apparatus 20 for classifying a target protein sequence. Apparatus 20 can be used for executing selected steps of the method described above and in the flowchart diagram in FIG. 1. Apparatus 20 comprises a searcher 22 which is capable of accessing the protein database of the present embodiments, generally shown at 24. Searcher 22 searches the target sequence for a motif of amino acids which matches a predicting sequence present in database 24, as further detailed above. Apparatus 20 further comprises a classification functionality 26 which also accesses database 24 and provides a protein classifier corresponding to the predicting sequence matched by searcher 22. Thus, in use, searcher 22 traverses the target sequence and compares motifs extracted from the target sequence to the predicting sequences of the database. Once a match is found between the extracted motif and a predicting sequence, searcher 22 passes the information to classification functionality 26 which pulls the respective classifier from database 24 and classifies the target sequence according to the classifier.

According to a preferred embodiment of the present invention classification functionality 26 determines the presence or absence and optionally the location of active pockets or active sites on the protein sequence, as further detailed hereinabove.

Classification functionality 26 is optionally and preferably operatively associated with an output unit 28 which displays, record and/or transmits a report containing the classification of the target sequence. Output unit 28 can comprise a display device, a printing device, a recording device and/or a transmitting device. Output unit can also comprise means suitable either for storing information in a computer readable medium or for communicating with functionalities which store the information in the computer readable medium.

The present embodiments successfully provide a method for characterizing protein classes. The method can be used to construct a protein database by assigning one or more predicting sequences for each protein class. Once the classes are assigned with predicting sequences, the database can be constructed, e.g., as a searchable table in which each entry comprises one predicting sequence and information regarding the protein class to which the predicting sequence is assigned. The constructed database can be recorded on a computer readable medium for further use. The method of this embodiment is supervised in the sense that it can be employed on any collection of protein classes provided each class in the collection includes a known number of protein sequences. A description of an unsupervised method according to another aspect of the present invention is provided hereinunder.

The supervised method can be employed on any collection of protein classes which defines a classification system. In one embodiment, the method is employed on a collection of enzyme classes which is spanned by the EC hierarchical classification system or a portion (selected branches) thereof.

More generally, the method can be used for providing efficient characterization to proteins which are already clustered by some protein clustering technique.

The term “cluster” refers to a protein sequence cluster, which is a group of protein sequences sharing a requisite level of homology and/or other similar traits according to a given clustering criterion. A process and/or method to group protein sequences as such is referred to as clustering, and is typically performed by a clustering application program implementing a cluster algorithm. Many cluster algorithms are known, including, without limitation hierarchical clustering, K-means clustering, Bayesian clustering and the like.

Thus, suppose for example, that many proteins are subjected to a clustering procedure which produces a collection of protein classes (cluster in this example) such that for each protein it is known (to a certain degree of confidence, say, at least 50%) to which class it belongs. The method of the present embodiments can be employed on the collection of classes and assign the classes predicting sequences. A representative example of such clustering procedure is a procedure which defines clusters of proteins which share a known fold. In this embodiment, the method of the present embodiments assigns sequences which predict the shared folds.

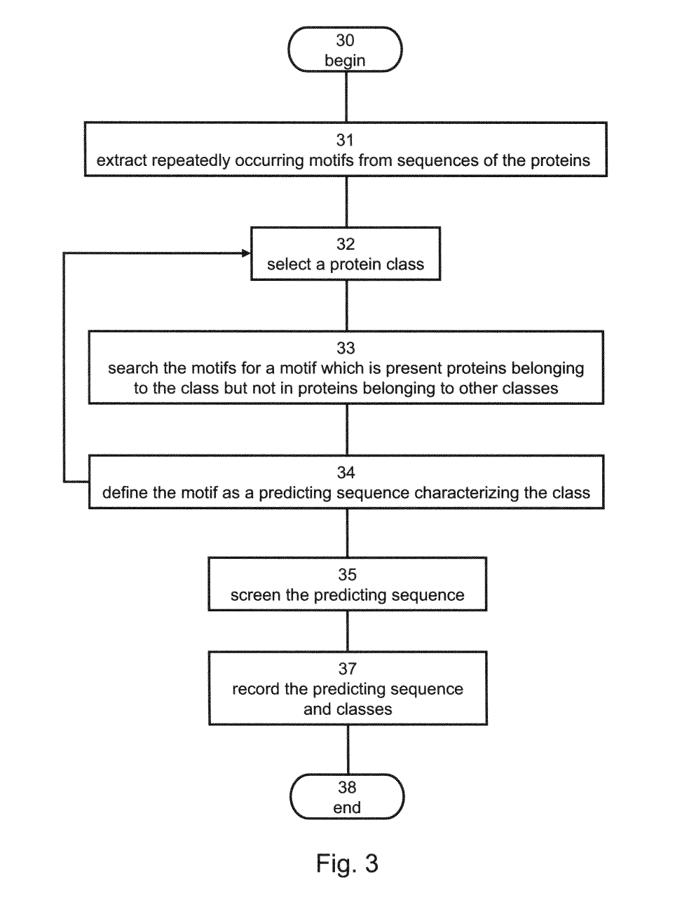

Reference is now made to FIG. 3 which is a flowchart diagram of a method for characterizing a predetermined collection of protein classes, according to various exemplary embodiments of the present invention.

The method begins at step 30 and continues to step 31 in which repeatedly occurring motifs are extracted from the amino acid sequences of the proteins. Preferably, but not obligatorily step 31 is executed on all the proteins of all the classes. The repeatedly occurring motifs can be extracted in any way known in the art. According to a preferred embodiment of the present invention step 31 employs a sequence recognition algorithm, such as, but not limited to, the algorithm disclosed in International Patent Application, Publication No. WO/2005010642, the contents of which are hereby incorporated by reference. A preferred technique for extracting the repeatedly occurring motifs is provided hereinunder. In any event, once step 31 is completed a set of motifs are provided.

The method continues to steps 32-34 in which each class is characterized by a predicting sequence, as follows. In step 32, a class is selected from the collection of protein classes. In step 33 the set of motifs is searched for one or more motifs present in at least a few (e.g., the majority of) proteins belonging to the selected class but not in proteins belonging to other protein classes. According to a preferred embodiment of the present invention step 33 is directed to search for motifs which are sufficiently short. Specifically, step 33 is directed to search for motifs which comprises less than L amino acids, where L is an integer which is typically not larger than 15, as further detailed hereinabove. In step 34 the (sufficiently short) motif which was found is defined as the predicting sequence which characterizes the set.

Once the predicting sequence is defined, the method loops back to step 32 and steps 32-34 are preferably repeated for another class of the collection. Optionally and preferably the method continues to step 35 in which biological information is used to screen the predicting sequences obtained in steps 32-34. Preferably, the screening step is performed so as to reduce the number of predicting sequences by at least a factor of R where R is a number greater than 1, more preferably greater than 2, e.g., R=5, R=10, R=15 or R=20. The biological information can comprise for example, active sites annotations, secondary structure and the like, and the screening can comprise keeping only predicting sequences which cover the biological information and discarding all other predicting sequences. A representative example of a screening process is provided in the Examples section that follows. Once all the classes of the collection are characterized by predicting sequences, the method optionally and preferably moves to step 36 in which the predicting sequences and classifiers providing classification information of the corresponding classes are recoded on a computer readable medium.

The method ends at step 37.

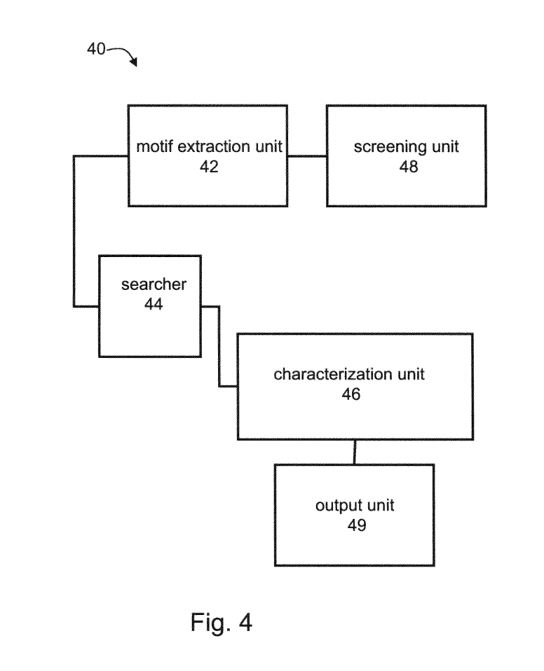

FIG. 4 is a schematic illustration of an apparatus 40 for characterizing a protein class being a member of a collection of protein classes, according to various exemplary embodiments of the present invention. Apparatus 40 can be used for executing selected steps of the method described hereinabove and in the flowchart diagram of FIG. 3. Apparatus 40 comprises a motif extraction unit 42 which extracts repeatedly occurring motifs as delineated above and further exemplified hereinunder. Apparatus 40 further comprises a searcher 44 which searches the set of motifs provided by unit 42 for motif or motifs present in several proteins belonging to the protein class but not in proteins belonging to other protein classes in the collection. The searcher 44 is preferably configured to provide sufficiently small motifs, as further detailed hereinabove. Apparatus 40 further comprises a characterization unit 46 which defines the motif or motifs found by searcher 44 as predicting sequence(s) characterizing the protein class. Optionally and preferably apparatus 40 comprises a screening unit 48 which screens the predicting sequences according to biological information as further detailed hereinabove and exemplified in the Examples section that follows.

In use, apparatus 40 can be employed for all or a portion of the classes in the collection, such that each class is assigned with one or more predicting sequences, and a database of predicting sequences Sⱼ and classifiers Cⱼ can be constructed as explained above. In various exemplary embodiments of the invention apparatus 40 comprises an output unit 49 which records the database on a computer readable medium or transmits the database to a functionality which records the database on a computer readable medium.

Repeatedly occurring motifs extracted from amino acid sequences of proteins can also be used for unsupervised classification of proteins.

As used herein, “unsupervised classification” refers to classification into a plurality of classes without any a-priori knowledge of the distribution of the proteins within the classes. Thus, unlike the supervised method described above in which the classes as well as the proteins of each class are known, in the unsupervised classification, all the proteins are initially unclassified and an unsupervised classification method is executed to define classes and the distribution of proteins within the defined classes.

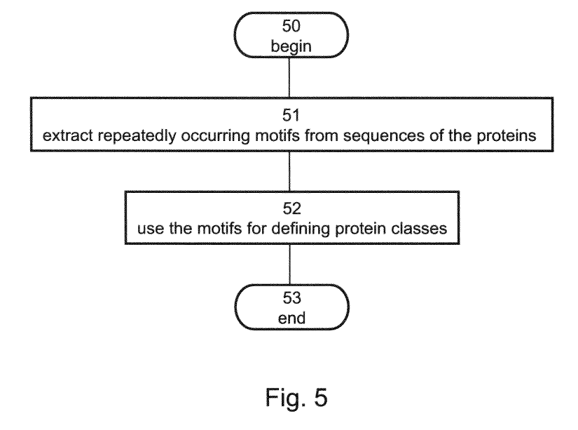

Reference is now made to FIG. 5 which is a flowchart diagram of a method for classifying a plurality of proteins into protein classes, according to various exemplary embodiments of the present invention. The method of the presently preferred embodiments is unsupervised.

The method begins at step 50 and continues to step 51 in which repeatedly occurring motifs are extracted from the amino acid sequences of the proteins as delineated above and further exemplified hereinunder. The method continues to step 52 in which the motifs are used for defining protein classes. The definition of classes is according to the extracted motifs. Specifically, two or more proteins are declared as belonging to class Cⱼ if they all include the same motif Sⱼ. Preferably, but not obligatorily, the motifs can be used to define the classes in an exclusive manner. In this embodiment, two or more proteins are declared as belonging to class Cⱼ if they include the motif Sⱼ and if there is no other class Cᵢ (i≠j) which includes proteins having the motif Sⱼ. It is to be understood that the exclusive definition can be combined with a non-exclusive definition. Thus, the method can define both motifs which are exclusive to the respective classes and motifs which are present in more than one class. Such definition of classes is particularly useful for defining a hierarchical classification system (e.g., a tree) whereby a motif which is present in an ancestor class is also present in its descending classes. On the other hand, a descending class includes at least one motif which is not present in its ancestor or any other class having a non-descending relation therewith.

The method ends at step 53.

Following is a description of a preferred procedure for extracting repeatedly occurring motifs. The procedure is based on the sequence recognition algorithm disclosed in International Patent Application, Publication No. WO/2005010642.

The procedure beings with a search for overlaps between the sequences. Specifically, for each amino acid sequence, partial overlaps between the sequence and other sequences are searched. Each sequence is considered as “trial-sequence” which is compared, segment by segment, to all other sequences.

This can be done for example, by constructing a graph which represents the dataset. Such graph may include a plurality of vertices and paths of vertices, where each vertex represent one amino acid and each path of vertices represent a primary sequence of one protein. Thus, according to a preferred embodiment of the present invention, for 20 amino acids there are 20 vertices on the graph. These 20 vertices are connected thereamongst by edges, preferably directed edges, in many combinations, depending on the sequences of the proteins.

The endpoints of each path of the graph are preferably marked, e.g., by adding marking vertices, such as a “begin” vertex before its first vertex and an “end” vertex after its last vertex. These marking vertices represent the beginning and end of the respective sequence of the dataset. Thus, each vertex which represents an amino acid has at least one incoming path and at least one outgoing path, preferably an equal number of incoming and outgoing paths.

Once the graph is constructed, overlaps between the paths thereof can be searched, for example, by considering different sub-paths of different lengths for each path and comparing these sub-paths with sub-paths of other paths of the graph. It was found by the inventors of the present invention that such graph is not a random graph. Rather, the graph typically includes bundles of sub-paths, signifying a relatively high probability associated with a given sub-structure which can be identified as a motif.

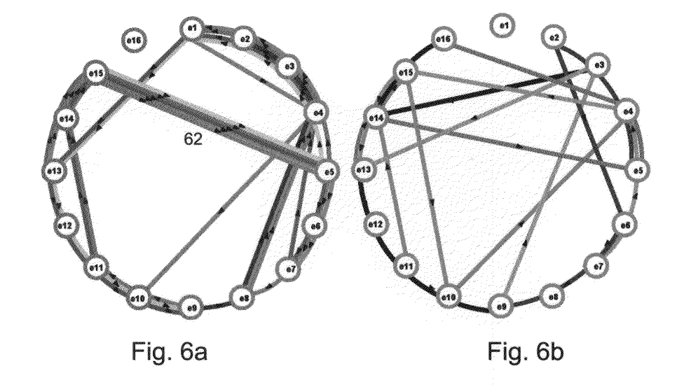

FIGS. 6a-b, show simplified illustrations of a structured graph (FIG. 6a) and a random graph (FIG. 6b). Shown in FIGS. 6a-b, a plurality of vertices e1, e2, . . . , e16, each representing one amino acid. Referring to FIG. 6a, of particular interest are vertex e1 and vertex e15 which are connected by many sub-paths of the graph, hence defining an overlap 62 therebetween.

The procedure continues by applying a significance test on the partial overlaps. Significance tests are known in the art and can include, for example, statistical evaluation of flow quantities, such as, but not limited to, probability functions or conditional probability functions which characterize the partial overlaps between paths on the graph.

According to a preferred embodiment of the present invention a set of probability functions is defined using the number of paths connecting particular vertices on the graph. For example, considering a single vertex, e₁, on the graph, a probability, p(e₁), can be defined as the number of paths leaving e₁ divided by the total number of paths. Similarly, considering two vertices, e₁ and e₂, a (conditional) probability, p(e₂|e₁), can be defined as the number of paths leading from e₁ to e₂ divided by the total number of paths leaving e₁. This prescription is preferably applied to all combinations of vertices on the graph, defining, e.g., p(e₁), p(e₂|e₁), p(e₃|e₁ e₂), for paths leaving e₁ and going through e₂ and e₃, and p(e₁), p(e₁|e₂), p(e₁|e₂ e₃), for paths going through e₃ and e₂ and entering e₁. In terms of all the conditional probabilities, the graph can define a Markov model. Thus, a “search-path,” of length K, going through vertices e₁ e₂ . . . e_{K} on the graph (corresponding to a trial-sequence of K amino acids), can be used to define a variable order Markov model up to order K, represented by the following matrix:

$$M = ( \begin{matrix}p ( {e}_{1} ) & p ( {e}_{1} \vert {e}_{2} ) & p ( {e}_{1} \vert {e}_{2} {e}_{3} ) & … & p ( {e}_{1} \vert {e}_{2} … {e}_{K} ) \\ p ( {e}_{2} \vert {e}_{1} ) & p ( {e}_{2} ) & p ( {e}_{2} \vert {e}_{1} ) & … & p ( {e}_{2} \vert {e}_{3} … {e}_{K} ) \\ p ( {e}_{3} \vert {e}_{1} {e}_{2} ) & p ( {e}_{3} \vert {e}_{2} ) & p ( {e}_{3} ) & … & p ( {e}_{3} \vert {e}_{4} … {e}_{K} ) \\ ⋮ & & & ⋱ & ⋮ \\ p ( {e}_{K} \vert {e}_{1} {e}_{2} … {e}_{K - 1} ) & p ( {e}_{K} \vert {e}_{2} … {e}_{K - 1} ) & p ( {e}_{K} \vert {e}_{3} … {e}_{K - 1} ) & … & p ( {e}_{K} )\end{matrix} ) \qquad ( EQ . 1 )$$

For any sub-path of e1e2 . . . em having a length m<K, a similar Markov model can be obtained from an m×m diagonal sub-matrix of M. It will be appreciated that whereas the collection of all paths which represent a sequence of the dataset defines all the conditional probabilities appearing in M, the search-path e1e2 . . . eK used in M does not necessarily represent a sequence of the dataset. The definition of the search-path is based on conditional probabilities, such as p(e₂|e₁), which are predetermined by those paths which represent the sequences of the dataset.

An occurrence of a significant overlap (e.g., overlap 62 in FIG. 6a), along a search-path can be identified by observing some extreme values of the relevant conditional probabilities. According to a preferred embodiment of the present invention, the probability functions comprise probability functions characterizing a rightward direction on each path and probability function characterizing a leftward direction on each path. Thus, for a search-path e₁e₂ . . . , eₙ, . . . eₖ, a probability function, P_{R}, characterizing a rightward direction, is preferably defined by the first column of M, moving top down, and a probability function, P_{L}, characterizing a leftward direction, is preferably defined by the last column of M, moving bottom up. Specifically,

P_{R}(n)=p(eₙ|e₁e₂ . . . eₙ₁) and P_{L}(n)=p(eₙ|eₙ₁eₙ₊₂ . . . eₖ). (EQ. 2)

As will be appreciated by one ordinarily skilled in the art, both P_{R} and P_{L} vary between 0 and 1 and are specific to the path in question.

In terms of the number of paths, P_{R} and P_{L} can be understood considering, for simplicity, that the path in question is e1e2e3e4 (K=4). Hence, according to a preferred embodiment of the present invention, P_{R}(3)=p(e3|e1e2), the rightward direction probability corresponding to the sub-path e1e2e3 equals the number of paths moving from e1 through e2 into e3 divided by the number of paths moving from e1 to e2, and P_{L}(3)=p(e3|e4), the leftward direction probability corresponding to the sub-path e3e4 equals the number of paths moving from e3 to e4 divided by the number of paths entering e4. It is convenient to define the aforementioned probabilities in the explicit notations P_{R}(e1; e3) and P_{L}(e4; e3), respectively.

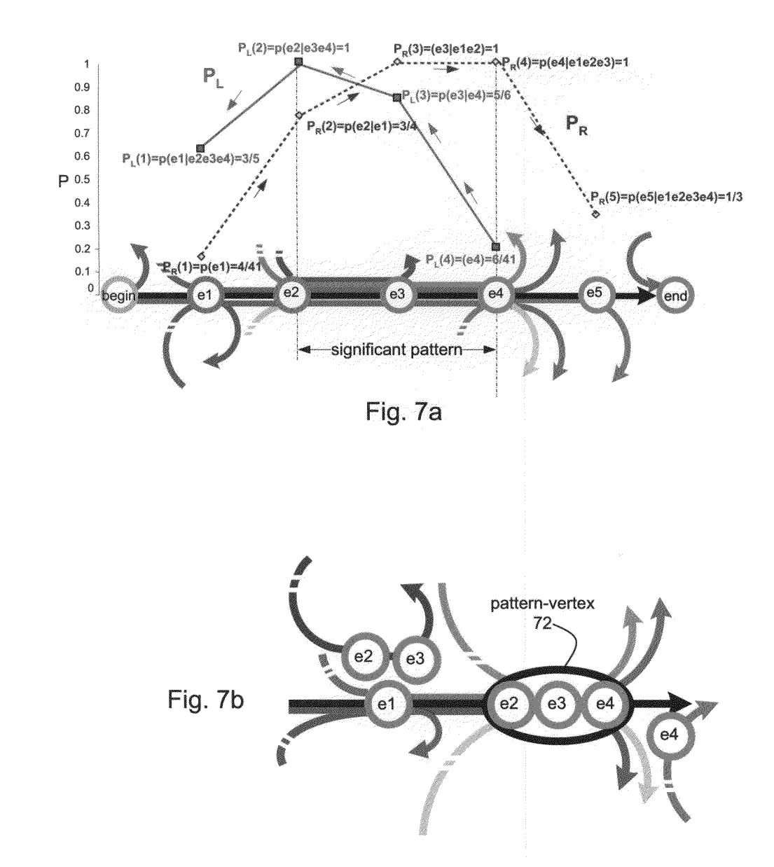

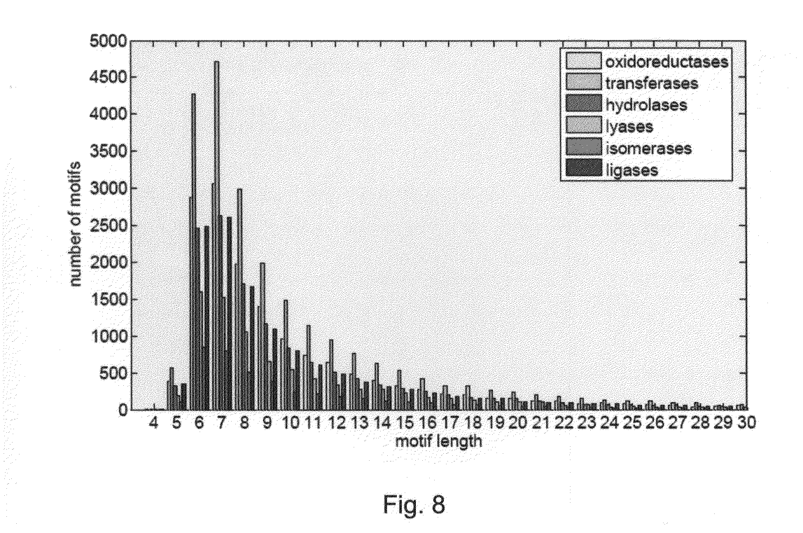

FIG. 7a illustrates a representative example of a portion of a graph in which a search-path, going through e1e2e3e4e5 and marked with a “begin” vertex at its beginning and an “end” vertex on its end, is selected. Also shown in FIG. 7a, are other paths, joining and leaving the search-path at various vertices. The bundle of sub-paths between vertex e2 and vertex e4 displays certain coherence, possibly indicating the presence of a significant pattern in the dataset.

To illustrate the use of the probabilities P_{R} and P_{L}, the portion of the graph is positioned in a rectangle coordinate system in which the vertices are conveniently arranged along the abscissa while the ordinate represent probability values. Progressing from e1 rightwards, P_{R}(n), n=1, 2, 3, 4, 5, has the values 4/41, ¾, 1, 1 and ⅓ respectively. Progressing from e4 leftwards, Pan), n=4, 3, 2, 1 has the values 6/41, 5/6, 1 and ⅗.

Thus, P_{R} first increases because some other paths join to form a coherent bundle, then decreases at e5, because many paths leave the path at e4. Similarly, progressing leftward, P_{L} first increases because other paths join as e4 and then decreases because paths leave the path at e2. The decline of P_{R} or P_{L} is preferably interpreted as an indication of the end and beginning of the candidate pattern respectively. The overlaps can be identified by requiring that the values of P_{R} and P_{L} within a candidate overlap are sufficiently large. Thus, a candidate overlap can be defined as a sub-sequence represented by a path or a sub-path on the graph in which P_{R}>1−ε_{R} and P_{L}>1−ε_{L} where ε_{R} and ε_{L} are two parameters smaller than unity. A typical value for ε_{R} and ε_{R} is from about 0.01 to about 0.99.

As used herein the term “about” refers to ±10%.

Optionally and preferably, the decrement of P_{R} and P_{L} can be quantified by defining decrease functions and comparing their values with predetermined cutoffs hence to identify overlaps between paths or sub-paths. According to a preferred embodiment of the present invention, the decrease functions are defined as ratios between probabilities of paths having some common vertices. In the example shown in FIG. 7a the decrement of P_{R} at e4 can be quantified using a rightward direction decrease function, D_{R}, defined as D_{R}(e1; e4)=P_{R}(e1; e5)/P_{R}(e1; e4), and the decrement of P_{L} at e2 can be quantified using a leftward direction decrease function, D_{L}, defined as D_{L}(e4; e2)=P_{L}(e4; e1)/P_{L}(e4; e2). Denoting the predetermined cutoffs by η_{R} and η_{L}, respectively, a partial overlap can be identified when both D_{R}<η_{R} and D_{L}<η_{L}. A typical value for both η_{R} and η_{L} is from about 0.3 to about 0.9.

Thus, the statistical significance of the decreases in P_{R} and P_{L} can be evaluated, for example, by defining their significance in terms a null hypothesis and requiring that the corresponding p-values are, on the average, smaller than a predetermined threshold, α. A typical value for α is from 0.001 to 0.1.

The null hypothesis depends on the choice of the functions which characterize the overlaps. For example, when the ratios are used, the null hypothesis can be P_{R}(e1; e5)≧η_{R}P_{R}(e1; e4) and P_{L}(e4; e1)≧η_{1L}P_{L}(e4; e2). Alternatively, the null hypothesis can be P_{R}>1−ε_{R} and P_{L}>1−ε_{L} or any other combination of the above conditions.

For a given search-path, P_{L} and P_{R} are preferably calculated from many starting points (such as e1 and e4 in the present example), more preferably from all starting points on the search-path, traversing each sub-path both leftward and rightward. This procedure defines many search-sections on the search-path, from which several partial overlaps can be identified. Once the partial overlaps have been identified, the most significant partial overlap is defined as a significant pattern.

In an alternative, yet preferred, embodiment, a set of cohesion coefficients, cᵢⱼ, i>j, are calculated, for each trial path, as follows:

cᵢⱼ=Mᵢⱼ log Mᵢⱼ/(M_{i1,j}M_{i,j+1}) (EQ. 3)

where Mᵢⱼ are elements of the variable order Markov model matrix (see Equation 1). For a given search-path there are many sub-paths, each represented by an element in the set cᵢⱼ, which can be considered as an “overlap score.” Once the set cᵢⱼ is calculated, its supremum is selected and the sub-path which corresponds to the supremum is preferably defined as the significant pattern of the search-path.

It is to be understood that it is not intended to limit the scope of the present invention to the above statistical significance tests, and that other significance tests as well as other probability functions or cohesion coefficients can be implemented.

The procedure in which overlaps are searched along a search-path is preferably repeated for more than one path of the original graph, more preferably on all the paths of the original path (hence on all the sequences). It will be appreciated that significant patterns can be found, depending on the degree by which the search-path overlaps with other paths.

According to a preferred embodiment of the present invention, the graph is “rewired” by merging each, or at least a few, significant patterns into a new vertex, referred to hereinafter as a pattern-vertex. This is equivalent to a redefinition of one or more sequences whereby several amino acids are grouped according to the significant patterns to which they belong. This rewiring process reduces the length of the paths of the graph, nonetheless the contents of the paths in terms of the original sequences of the proteins is conserved.

In principle, the identification of the significant patterns can depend on other vertices of the search-path, and not only on the vertices belonging to the overlapping sub-paths. The extent of this dependence is dictated by the selected identification procedure (e.g., the choice of the probability functions, the significant test, etc.). Referring to the example of FIG. 7a, a sub-path e2e3e4 is defined as a significant pattern of the search-path “begin”→e1→ . . . →e5→“end.” By definition, the vertices e2, e3 and e4, also belong to other paths on the graph, each in turn can also be selected as a search-path along which partial overlaps are searched. Being dependent on other vertices of the search-path, the sub-path e2e3e4 may be accepted as a significant pattern for one search-path and may be rejected, on account of failing to pass the selected significance test, for another search-path.

The definition of the pattern-vertices of the graph can therefore be done in more than one way.

In one embodiment, significant patterns are merged only on the path for which they turned out to be significant, while leaving the vertices unmerged on other paths.

In another embodiment, after each search on each search-path, sub-paths which are identified as significant patterns are merged into pattern-vertex, irrespectively whether or not these sub-paths are defined as significant patterns also in other paths.

In still another embodiment, after each search on each search-path, the sub-paths which are identified as significant patterns are merged into a pattern-vertex.

In yet another embodiment, after each search on each search-path, the sub-paths which are identified as significant patterns are merged into pattern-vertices.

In a further embodiment, after all paths are searched, the sub-paths which are identified as significant patterns are merged into pattern-vertices.

FIG. 7a illustrate a pattern-vertex 72 having vertices e2, e3 and e4, which are identified as significant pattern for the trial path of FIG. 7a. Note that vertices e2, e3 and e4 remain on the graph in addition to pattern-vertex 72, because, in the present example, there is a path which goes through e2 and e3 but not through e4, and a path which goes through e4 and e5 (see FIG. 7a) but not through e2 and e3.

The rewiring procedure can be used as a supplementary procedure, for example, when it is desired to provide new sequences which are not present originally. Generalization of the dataset is preferably achieved by defining equivalence classes of amino acids and allowing, for a given sequence, the replacement of one or more amino acids of the sequence with other amino acids which are members of the same equivalence class.

For example, suppose that an equivalence class, E, of two vertices, e3 and e6, is defined, i.e., E={e3, e6}. Suppose further that among the protein sequences there are two sequences, say, e1e2e3e4e5 and e1e2e6e4e7, which include the members of E. These sequences can be replaced with the generalized sequences e1e2Ee4e5 and e1e2Ee4e7, which, in addition to the original sequences, also include the new sequences e1e2e6e4e5 and e1e2e3e4e7, not necessarily present in any of the original proteins.

Using the above described databases, methods and apparatus, the present inventors were able to annotate polypeptides for the first time as having enzymatic activity. These polypeptides can find wide use in commodity, food, agrotec, cosmetic and pharma industries as outlined below.

Thus, according to a further aspect of the present invention there is provided a method of processing a substrate. The method comprising contacting the substrate with at least one polypeptide selected from the group consisting of the polypeptides set forth in EQ ID nos.: 77,838 to 198,923 under conditions which allow processing of the substrate by said at least one polypeptide, wherein said at least one polypeptide is selected capable of processing the substrate.

As used herein the phrase “processing a substrate” refers to enzymatic-dependent conversion (catalysis) of a substrate from a given chemical form to a distinct one. Examples of such catalysis reactions include, but are not limited to degradation, digestion, hydrolysis, nucleic acid cleavage, nucleic acid ligation, proteolytic cleavage, polymerization, transfer of an atom or functional group from one molecule to another and addition of a chemical group to a molecule.

The identity of the substrate will naturally dictate the selection of the polypeptide enzyme.

Information on correspondence between enzyme and substrate is readily available to one of ordinary skill in the art, for example from:

PRECISE (Predicted and Consensus Interaction Sites in Enzymes; structural bioinformatics lab; <http://precise.bu.edu/precisedb/default.aspx>) which is a database of interactions between the amino acid residues of an enzyme and its various ligands, i.e., substrate and transition state analogues, cofactors, inhibitors, and products; and/or from

The Catalytic Site Atlas (European Bioinformatics Institute; Hinxton; UK) described in “The Catalytic Site Atlas: a resource of catalytic sites and residues identified in enzymes using structural data. (Porter et al. (2004) Nucl. Acids. Res. 32: D129-D133). or CSA database (http://www.ebi.ac.uk/thornton-srv/databases/CSA/); and/or from

The KEGG LIGAND Database <http://www.genome.jp/ligand/> which is a composite database comprising three sections. The COMPOUND section provides information about metabolites and chemical compounds. The REACTION section provides a collection of substrate-product relations representing metabolic and other reactions. The ENZYME section provides for information about enzyme molecules. The Sep. 7, 2001 release includes 7298 compounds, 5166 reactions and 3829 enzymes. In addition to the keyword search provided by the DBGET/LinkDB system, a substructure search to the COMPOUND and REACTION sections is available through the World Wide Web (http://www.genome.ad.jp/ligand/). LIGAND may be also downloaded by anonymous FTP (ftp://ftp.genome.ad.jp/pub/kegg/ligand/); and/or from

The MetaCyc Encyclopedia of Metabolic Pathways (Caspi et al., 2006, “MetaCyc: A multiorganism database of metabolic pathways and enzymes”, Nucleic Acids Res., 34:D511-D516 2006) which is a database of nonredundant, experimentally elucidated metabolic pathways containing over 900 pathways from more than 900 different organisms curated from the scientific experimental literature. MetaCyc contains pathways involved in both primary and secondary metabolism, as well as associated compounds, enzymes, and genes. MetaCyc aims to catalog the universe of metabolism by storing a representative sample of each experimentally elucidated pathway. MetaCyc is used in a variety of scientific applications, such as providing a reference data set for computationally predicting the metabolic pathways of organisms from their sequenced genomes, supporting metabolic engineering, helping to compare biochemical networks, and serving as an encyclopedia of metabolism. MetaCyc pathways can be browsed from a list, from ontologies, or queried directly when searching for pathways, proteins, reactions or compounds. MetaCyc can also be queried programmatically using Java or PERL when installed locally; and or

The Human Protein Reference Database (Peri, S. et al. (2003) Development of human protein reference database as an initial platform for approaching systems biology in humans. Genome Research. 13:2363-2371.) which is centralized platform to visually depict and integrate information pertaining to domain architecture, post-translational modifications, interaction networks and disease association for each protein in the human proteome. Information in HPRD <http://www.hprd.org/> is manually extracted from the literature by expert biologists who read, interpret and analyze the published data. HPRD has been created using an object oriented database in Zope, an open source web application server, that provides versatility in query functions and allows data to be displayed dynamically. The database currently comprises 37,581 entries on protein/protein interactions; and/or

The Lipase Engineering Database (LED) (Jürgen Pleiss; Institute of Technical Biochemistry, University of Stuttgart, Stuttgart, Germany; http://www.led.uni-stuttgart.de) integrates information on sequence, structure, and function of lipases, esterases, and related proteins. The LED facilitates systematica analysis of sequence-structure-function relationships and is a useful tool to identify functionally relevant residues apart from the active site residues, and to design mutants with desired substrate specificity.

Table 38 comprises SEQ ID Nos.: 77,838 to 137,952 comprising polypeptide enzymes classified according to exemplary methods described herein. Table 40 comprises SEQ ID Nos.: 198,933 to 259039 with polynecleotide sequences corresponding to the polypeptide enzymes of table 38.

Table 39 comprises SEQ ID Nos.: 137,953 to 198,923 comprising polypeptide enzymes classified according to exemplary methods described herein. Table 41 comprises SEQ ID Nos.: 259,040 to 320,010 with polynecleotide sequences corresponding to the polypeptide enzymes of table 39.

The Polypeptides of SEQ ID Nos.: 77,838 to 198,923 set forth in Tables 38 and 39 included enzymes in all 6 major EC classes and many important subclasses. Polynucleotide sequences comprising SEQ ID Nos.: 198,933 to 320,009 set forth in tables 40 and 41 make available for the first time, a functional link between these sequences and their biological activity.

The potential utility of tables 38-41 and/or similar tables produced according to exemplary methods of the invention is huge. Using tables of this type and available databases, one of ordinary skill in the art can begin with a defined physiologic or industrial process, identify a problematic (e.g. rate limiting) step therein, determine the substrate of an enzymatic reaction in the problematic step, and select an appropriate enzyme from the table. Selection of the appropriate enzyme from the table can optionally be as a polypeptide sequence or a nucleotide sequence. Optionally, polypeptide sequences can be produced synthetically or biologically. Optionally, biological production includes isolation of PPM desired peptides from cells. Optionally, the cells are wild type cells or carry an expression vector. In an exemplary embodiment of the invention, an expression vector comprising regulatory sequences and at least a portion of a polynucleotide sequence comprising one of SEQ ID Nos.: 198,933 to 320,009 and encoding at least a functional portion of a corresponding polypeptide sequence comprising one of SEQ ID Nos.: 77,838 to 198,923.

The Nomenclature Committee of the International Union of Biochemistry and Molecular Biology (NC-IUBMB) is responsible for the maintenance of the enzyme list first published in 1961 and with the last printed edition in 1992 (IUBMB (1992), Enzyme Nomenclature 1992, Academic Press, San Diego). Since 1992 the list has been updated electronically by use of the web. In parallel with this process all published recommendations by the Committee were also converted to a web readable form. More recent changes to Enzyme Nomenclature and new recommendations have only been prepared for the web and are not available in hard copy.

The Enzyme Nomenclature list is an amplified and updated version of the 1992 edition. It currently contains details of over 3700 enzymes. It was prepared from the last printed edition, Enzyme Nomenclature 1992 (1) which was converted into html with additional data added. In many cases the reaction is given in words and illustrated with a reaction diagram (which may be part of a metabolic pathway). Other names for each enzyme are added and links are provided to other databases (BRENDA, EXPASY, KEGG, WIT, etc) and the CAS registry number provided when known. The references now have titles and link where relevant to the PubMed entry.

The EC hierarchy divides enzymes into six main classes—EC 1 oxidoreductases, EC 2 transferases, EC 3 hydrolases, EC 4 lyases, EC 5 isomersaes and EC 6 ligases which are described in greater detail hereinbelow in APPENDIX 2.

Tables 38 and 39 of polypeptide sequences and Tables 40 and 41 of nucleotide sequences specify the EC classification for each sequence in the table.

As used herein the phrase “polypeptide” refers to a naturally occurring or synthetic amino acid polymer which comprise at least an active portion which is sufficient to process the substrate of interest. Optionally the polypeptide also comprises a substrate recognition domain, optionally separate from the catalytic domain.

In an exemplary embodiment of the invention, an active portion of a polypeptide (e.g. as set forth in SEQ ID Nos.: 77,838 to 198,923) is identified using methods well known in the art (e.g. serial mutations followed by assays of activity and/or queries of available database to identify homologous active portions). Thus, an active portion of any of SEQ ID Nos.: 77,838 to 198,923 can be employed in exemplary embodiments of the invention.

Polypeptides used in accordance with the present invention refer to polypeptides having an amino acid sequence as further described hereinbelow. at least about 40%, at least about 50%, at least about 60%, at least about 70%, at least about 75%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 93%, at least about 94%, at least about 95%, at least about 96%, at least about 97%, at least about 98%, at least about 99%, or more say 100% homologous to an amino acid sequence selected from the group consisting of SEQ ID Nos.: 77,838 to 198,923.

Homology (e.g., percent homology) can be determined using any homology comparison software, including for example, the BlastP software of the National Center of Biotechnology Information (NCBI) such as by using default parameters.

The present invention also encompasses fragments of the above described polypeptides and polypeptides having mutations, such as deletions, insertions or substitutions of one or more amino acids, either naturally occurring or man induced, either randomly or in a targeted fashion.

Thus, polypeptides (also referred to as peptides) of the present invention encompasses native polypeptides (either degradation products, synthetically synthesized peptides, or recombinant peptides), peptidomimetics (typically, synthetically synthesized peptides), and the peptide analogues peptoids and semipeptoids, and may have, for example, modifications rendering the peptides more stable while in a body or more capable of penetrating into cells. Such modifications include, but are not limited to: N-terminus modifications; C-terminus modifications; peptide bond modifications, including but not limited to CH₂—NH, CH₂—S, CH₂—S═O, O═C—NH, CH₂—O, CH₂—CH₂, S═C—NH, CH═CH, and CF═CH; backbone modifications; and residue modifications. Methods for preparing peptidomimetic compounds are well known in the art and are specified, for example, in Ramsden, C. A., ed. (1992), Quantitative Drug Design, Chapter 17.2, F. Choplin Pergamon Press, which is incorporated by reference as if fully set forth herein. Further details in this respect are provided hereinbelow.

Peptide bonds (—CO—NH—) within the peptide may be substituted, for example, by N-methylated bonds (—N(CH3)—CO—); ester bonds (—C(R)H—C—O-β-C(R)—N—); ketomethylene bonds (—CO—CH2—); α-aza bonds (—NH—N(R)—CO—), wherein R is any alkyl group, e.g., methyl; carba bonds (—CH2—NH—); hydroxyethylene bonds (—CH(OH)—CH2—); thioamide bonds (—CS—NH—); olefinic double bonds (—CH═CH—); retro amide bonds (—NH—CO—); and peptide derivatives (—N(R)—CH2—CO—), wherein R is the “normal” side chain, naturally presented on the carbon atom. These modifications can occur at any of the bonds along the peptide chain and even at several (2-3) at the same time.

Natural aromatic amino acids, Trp, Tyr, and Phe, may be substituted for synthetic non-natural acids such as, for instance, tetrahydroisoquinoline-3-carboxylic acid (TIC), naphthylelanine (Nol), ring-methylated derivatives of Phe, halogenated derivatives of Phe, and o-methyl-Tyr.

In addition to the above, the peptides of the present invention may also include one or more modified amino acids or one or more non-amino acid monomers (e.g., fatty acids, complex carbohydrates, etc.).

The term “amino acid” or “amino acids” is understood to include the 20 naturally occurring amino acids; those amino acids often modified post-translationally in vivo, including, for example, hydroxyproline, phosphoserine, and phosphothreonine; and other less common amino acids, including but not limited to 2-aminoadipic acid, hydroxylysine, isodesmosine, nor-valine, nor-leucine, and ornithine. Furthermore, the term “amino acid” includes both D- and L-amino acids.

The peptides of the present invention are preferably utilized in a linear form, although it will be appreciated that in cases where cyclization does not severely interfere with peptide characteristics, cyclic forms of the peptide can also be utilized.

The peptides of the present invention may be synthesized by any techniques that are known to those skilled in the art of peptide synthesis. For solid phase peptide synthesis, a summary of the many techniques may be found in: Stewart, J. M. and Young, J. D. (1963), “Solid Phase Peptide Synthesis,” W. H. Freeman Co. (San Francisco); and Meienhofer, J (1973). “Hormonal Proteins and Peptides,” vol. 2, p. 46, Academic Press (New York). For a review of classical solution synthesis, see Schroder, G. and Lupke, K. (1965). The Peptides, vol. 1, Academic Press (New York).

In general, peptide synthesis methods comprise the sequential addition of one or more amino acids or suitably protected amino acids to a growing peptide chain. Normally, either the amino or the carboxyl group of the first amino acid is protected by a suitable protecting group. The protected or derivatized amino acid can then either be attached to an inert solid support or utilized in solution by adding the next amino acid in the sequence having the complimentary (amino or carboxyl) group suitably protected, under conditions suitable for forming the amide linkage. The protecting group is then removed from this newly added amino acid residue and the next amino acid (suitably protected) is then added, and so forth; traditionally this process is accompanied by wash steps as well. After all of the desired amino acids have been linked in the proper sequence, any remaining protecting groups (and any solid support) are removed sequentially or concurrently, to afford the final peptide compound. By simple modification of this general procedure, it is possible to add more than one amino acid at a time to a growing chain, for example, by coupling (under conditions which do not racemize chiral centers) a protected tripeptide with a properly protected dipeptide to form, after deprotection, a pentapeptide, and so forth.

Further description of peptide synthesis is disclosed in U.S. Pat. No. 6,472,505. A preferred method of preparing the peptide compounds of the present invention involves solid-phase peptide synthesis, utilizing a solid support. Large-scale peptide synthesis is described by Andersson Biopolymers 2000, 55(3), 227-50.

### Exemplary Peptide Synthesis Protocols

Peptides can be produced synthetically by either Liquid-phase or solid-phase synthesis. Liquid-phase synthesis is generally preferred in large-scale production of peptides for industrial purposes. These synthesis protocols are described in greater detail in for example, by Atherton and Sheppard (Solid Phase peptide synthesis: a practical approach. IRL Press, Oxford, England, 1989) and by Stewart and Young (Solid phase peptide synthesis, 2nd edition, Pierce Chemical Company, Rockford, 1984, pp 91)

Solid-phase peptide synthesis (SPPS), allows the synthesis of natural peptides which are difficult to express in bacteria and/or the incorporation of unnatural amino acids, peptide/protein backbone modification, and the synthesis of D-proteins, which consist of D-amino acids.

### SPPS

In SPPS small solid beads, insoluble yet porous, are treated with functional units (‘linkers’) on which peptide chains can be built. The peptide will remain covalently attached to the bead until cleaved from it by a reagent such as trifluoroacetic acid. The peptide is thus ‘immobilized’ on the solid-phase and can be retained during a filtration process, whereas liquid-phase reagents and by-products of synthesis are flushed away.

The general principle of SPPS is one of repeated cycles of coupling-deprotection. The free N-terminal amine of a solid-phase attached peptide is coupled to a single N-protected amino acid unit. This unit is then deprotected, revealing a new N-terminal amine to which a further amino acid may be attached.

There are two common types of SPPS—Fmoc and Boc which proceed in a C-terminal to N-terminal fashion. The N-termini of amino acid monomers is protected by either Fmoc or Boc and added onto a deprotected amino acid chain. Automated synthesizers are available for both Fmoc and Boc techniques.

Stepwise elongation, in which the amino acids are connected step-by-step in turn, is ideal for small peptides containing between 2 and 100 amino acid residues. Another method is fragment condensation, in which peptide fragments are coupled. Although the stepwise method can elongate the peptide chain without racemization, the yield in creation of long or highly polar peptides tends to be poor. Fragment condensation is better than stepwise elongation for synthesizing sophisticated long peptides, but racemization can be problematic. In order to maintain acceptable kinetics in a fragment condensation reaction, the coupled fragment must be in gross excess.

A new development for producing longer peptide chains is chemical ligation: Unprotected peptide chains react chemoselectively in aqueous solution. A first kinetically controlled product rearranges to form the amide bond. The most common form native chemical ligation uses a peptide thioester that reacts with a terminal cystein residue.

### Boc SPPS

t-Boc (or Boc) stands for (tert)-(B)utyl (o)xy (c)arbonyl. To remove Boc from a growing peptide chain, acidic conditions are used (e.g. neat TFA). Removal of side-chain protecting groups and the peptide from the resin at the end of the synthesis is achieved by incubating in hydrofluoric acid (which can be dangerous). This danger represents a significant disadvantage to Boc. However Boc offers significant advantages in complex syntheses. When synthesizing nonnatural peptide analogs which are base-sensitive (such as depsipeptides), Boc is necessary.

### Fmoc SPPS

Fmoc stands for (F)luorenyl-(m)eth(o)xy-(c)arbonyl which serves as a protecting group instead of Boc. To remove Fmoc from a growing peptide chain, basic conditions (e.g, 20% piperidine in DMF) are used. Removal of side-chain protecting groups and peptide from the resin is achieved by incubating in trifluoroacetic acid (TFA). Fmoc deprotection is usually slow because the anionic nitrogen produced at the end is not a particularly favorable product, although the whole process is thermodynamically driven by the evolution of carbon dioxide. The main advantage of Fmoc chemistry is that no hydrofluoric acid is needed which contributes to safety. Fmoc is generally preferred for most routine synthesis because if this safety consideration.

Exemplary Solid supports

The physical properties of the solid support, and the applications to which it can be utilized, vary with the material from which the support is constructed, the amount of crosslinking, as well as the linker and handle being used. Commonly used solid supports include polystyrene and polyamide.

### General Synthesis Protocol

Due to amino acid excesses used to ensure complete coupling during each synthesis step, polymerization of amino acids is common in reactions where each amino acid is not protected. In order to prevent this polymerization, protective groups are used. A typical Fmoc or Boc synthesis involves cyclic repletion of the following steps:

Protective group is removed from trailing amino acids in a deprotection reaction;

Deprotection reagents washed away to provide clean coupling environment;

Protected amino acids dissolved in a solvent such as dimethylformamide (DMF) are combined with coupling reagents pumped through the synthesis column; and

Coupling reagents are washed away to provide a clean deprotection environment.

While Fmoc and Boc are the most commonly used protective groups, other groups such as benzyloxy-carbonyl (Z), allyloxycarbonyl (alloc) and lithographic protecting groups can also be used for protection.

Coupling the peptides typically involves activation of the carboxyl group to improve reaction kinetics. Activation is most commonly by carbodiimides and/or aromatic oximes.

In another embodiment polypeptide synthesis is effected by recombinant DNA technology. This is specifically preferred when large amounts of the polypeptide are needed.

Thus for example, a polynucleotide which comprise a nucleic acid sequence encoding the polypeptide of interest is ligated into a nucleic acid construct which comprise a cis-acting regulatory element positioned so as to drive transcription of the nucleic acid sequence when introduced into a host cell

Thus the polynucleotide of the present invention encodes a polypeptide having an amino acid sequence as described herein above. Such a polynucleotide may comprise a nucleic acid sequence at least about 40%, optionally about 70%, optionally about 75%, optionally about 80%, optionally about 81%, optionally about 82%, optionally about 83%, optionally about 84%, optionally about 85%, optionally about 86%, optionally about 87%, optionally about 88%, optionally about 89%, optionally about 90%, optionally about 91%, optionally about 92%, optionally about 93%, optionally about 93%, optionally about 94%, optionally about 95%, optionally about 96%, optionally about 97%, optionally about 98%, optionally about 99%, optionally about 100% homologou or identical (or intermediate degrees of homology or identity) to a nucleic acid sequence selected from the group consisting of SEQ ID nos.: 198,933 to 320,009.

The present invention also encompasses fragments of the above described polynucleotides and polynucleotides having mutations, such as deletions, insertions or substitutions of one or more amino acids, either naturally occurring or man induced, either randomly or in a targeted fashion.

The polynucleotide of the present invention refers to a single or double stranded nucleic acid sequences which is isolated and provided in the form of an RNA sequence, a complementary polynucleotide sequence (cDNA), a genomic polynucleotide sequence and/or a composite polynucleotide sequences (e.g., a combination of the above).

As used herein the phrase “complementary polynucleotide sequence” refers to a sequence, which results from reverse transcription of messenger RNA using a reverse transcriptase or any other RNA dependent DNA polymerase. Such a sequence can be subsequently amplified in vivo or in vitro using a DNA dependent DNA polymerase.

As used herein the phrase “genomic polynucleotide sequence” refers to a sequence derived (isolated) from a chromosome and thus it represents a contiguous portion of a chromosome.

As used herein the phrase “composite polynucleotide sequence” refers to a sequence, which is at least partially complementary and at least partially genomic. A composite sequence can include some exonal sequences required to encode the polypeptide of the present invention, as well as some intronic sequences interposing therebetween. The intronic sequences can be of any source, including of other genes, and typically will include conserved splicing signal sequences. Such intronic sequences may further include cis acting expression regulatory elements.

### Exemplary Construction of Polynucletide Expression Vectors

Considerations and methods relevant to construction of expression vectors are described in, for example, Sambrook, J. and D. W. Russell (2001; Molecular Cloning: A Laboratory Manual, 3rd ed., vol. 1-3, Cold Spring Harbor Press, Cold Spring Harbor N.Y.), Ausubel, F. M. et al. (1999; Short Protocols in Molecular Biology, 4.sup.th ed., John Wiley & Sons, New York N.Y.). One of ordinary skill in the art will be able to begin from an amino acid sequence encoding a gene, determine a polynucleotide sequence encoding the amino acid sequence, design and produce suitable oligo-nucleotide primers for isolation of the determined polynucleotide sequence (e.g. using computer programs intended for that purpose such as Primer Version 0.5, 1991, Whitehead Institute for Biomedical Research, Cambridge Mass.)., and clone the sequence into a suitable expression vector.

Expression vectors are available commercially (e.g from New England Biolabs; Ipswich, Mass., USA and Clontech laboratories; Mountainview Calif., USA). Selection of appropriate regulatory sequences can contribute to expression levels of the protein encoded by the cloned nucleotide sequence. Regulatory sequences can include promoters and/or enhancers and are optionally positioned upstream and/or downstream of the cloned nucleotide sequence. Regulatory sequences can be constitutive and/or tissue specific and/or inducible. Optionally, regulatory sequences are included in a commercially available or previously constructed vector. Alternatively, or additionally, regulatory sequences can be added to a vector during its construction using techniques known in the art.

Expression vectors can be DNA or RNA based and include, but are not limited to phage, plasmids, cosmids, phagemids, yeast artificial chromosomes (YACS), murine artificial chromosomes (MACS), Human artificial chromosomes (HACS) and viral vectors.

Vectors are typically transfected (e.g. by electroporation) into prokaryotic cells or transformed into eukaryotic cells (e.g. using calcium phosphate precipitation or lipofectin) so that the cells express the polypeptide encoded by the vector at a high level.

### Exemplary Culture and Harvest Conditions

Thus, the isolated polynucleotides of the present invention can be expressed in variety of single cell or multicell expression systems and the recombinant polypeptides recovered therefrom used in pharmaceutical and agricultural applications as described hereinabove with respect to the enzymatic composition of the present invention.

For expression in a single cell system, the polynucleotides of the present invention are cloned into an appropriate expression vector (i.e., construct).

Depending on the host/vector system utilized, any of a number of suitable transcription and translation elements including constitutive and inducible promoters, transcription enhancer elements, transcription terminators, and the like, can be used in the expression vector [see, e.g., Bitter et al., (1987) Methods in Enzymol. 153:516-544].

Other then containing the necessary elements for the transcription and translation of the inserted coding sequence, the expression construct of this aspect of the present invention can also include sequences engineered to enhance stability, production, purification, yield or toxicity of the expressed polypeptide. For example, the expression of a fusion protein or a cleavable fusion protein comprising a polypeptide of the present invention and a heterologous protein can be engineered. Such a fusion protein can be designed so as to be readily isolated by affinity chromatography; e.g., by immobilization on a column specific for the heterologous protein. Where a cleavage site is engineered between the protein of interest and the heterologous protein, the protein of interest can be released from the chromatographic column by treatment with an appropriate enzyme or agent that disrupts the cleavage site [e.g., see Booth et al. (1988) Immunol. Lett. 19:65-70; and Gardella et al., (1990) J. Biol. Chem. 265:15854-15859].

A variety of cells can be used as host-expression systems to express the coding sequence of the protein of interest. These include, but are not limited to, microorganisms, such as bacteria transformed with a recombinant bacteriophage DNA, plasmid DNA or cosmid DNA expression vector containing the coding sequence for the protein of interest; yeast transformed with recombinant yeast expression vectors containing the coding sequence for the protein of interest; plant cell systems infected with recombinant virus expression vectors (e.g., cauliflower mosaic virus, CaMV; tobacco mosaic virus, TMV) or transformed with recombinant plasmid expression vectors, such as Ti plasmid, containing the coding sequence (e.g. at least a portion of one or more of SEQ ID Nos.: 198,933 to 320,009). Mammalian expression systems can also be used to express the protein of interest. Bacterial systems are preferably used to produce recombinant proteins of interest, according to the present invention, thereby enabling a high production volume at low cost.

In bacterial systems, a number of expression vectors can be advantageously selected depending upon the use intended for the protein expressed. For example, when large quantities of protein are desired, vectors that direct the expression of high levels of protein product, possibly as a fusion with a hydrophobic signal sequence, which directs the expressed product into the periplasm of the bacteria or the culture medium where the protein product is readily purified may be desired. Certain fusion protein engineered with a specific cleavage site to aid in recovery of the protein may also be desirable. Such vectors adaptable to such manipulation include, but are not limited to, the pET series of E. coli expression vectors [Studier et al. (1990) Methods in Enzymol. 185:60-89).

It will be appreciated that when codon usage for proteins cloned from plants is inappropriate for expression in E. coli, the host cells can be co-transformed with vectors that encode species of tRNA that are rare in E. coli but are frequently used by plants. For example, co-transfection of the gene dnaY, encoding tRNA. _{ArgAGA/AGG}, a rare species of tRNA in E. coli, can lead to high-level expression of heterologous genes in E. coli. [Brinkmann et al., Gene 85:109 (1989) and Kane, Curr. Opin. Biotechnol. 6:494 (1995)]. The dnaY gene can also be incorporated in the expression construct such as for example in the case of the pUBS vector (U.S. Pat. No. 6,270,0988).

In yeast, a number of vectors containing constitutive or inducible promoters can be used, as disclosed in U.S. Pat. No. 5,932,447. Alternatively, vectors can be used which promote integration of foreign DNA sequences into the yeast chromosome.

Other expression systems such as insects and mammalian host cell systems, which are well known in the art can also be used by the present invention.

Transformed cells are cultured under conditions, which allow for the expression of high amounts of recombinant protein. Such conditions include, but are not limited to, media, bioreactor, temperature, pH and oxygen conditions that permit protein production. Media refers to any medium in which a cell is cultured to produce the recombinant protein of the present invention. Such a medium typically includes an aqueous solution having assimilable carbon, nitrogen and phosphate sources, and appropriate salts, minerals, metals and other nutrients, such as vitamins. Cells of the present invention can be cultured in conventional fermentation bioreactors, shake flasks, test tubes, microtiter dishes, and petri plates. Culturing can be carried out at a temperature, pH and oxygen content appropriate for a recombinant cell. Such culturing conditions are within the expertise of one of ordinary skill in the art.

Depending on the vector and host system used for production, resultant proteins of the present invention may either remain within the recombinant cell; be secreted into the fermentation medium; be secreted into a space between two cellular membranes, such as the periplasmic space in E. coli; or be retained on the outer surface of a cell or viral membrane.

Recovery of the recombinant protein is effected following an appropriate time in culture. The phrase “recovering the recombinant protein refers to collecting the whole fermentation medium containing the protein and need not imply additional steps of separation or purification. Not withstanding from the above, proteins of the present invention can be purified using a variety of standard protein purification techniques, such as, but not limited to, affinity chromatography, ion exchange chromatography, filtration, electrophoresis, hydrophobic interaction chromatography, gel filtration chromatography, reverse phase chromatography, concanavalin A chromatography, chromatofocusing and differential solubilization.

The recombinant proteins of the present invention are preferably retrieved in “substantially pure” form to be used in pharmaceutical compositions and/or agricultural compositions, described below. As used herein, “substantially pure” refers to a purity that allows for the effective use of the protein in the diverse applications, described hereinabove optionally, 50%, 60%, 70%, 80%, 90%, 95%, 99% or effectively 100% pure (or lesser or intermediate levels of purity).

In an exemplary embodiment of the invention, thermophilic bacteria (e.g. those listed in table 12) are cultured under suitable temperatures for optimal growth. Optionally, the thermophilic bacteria can be wild type or transformants carrying an expression vector. In an exemplary embodiment of the invention, extreme temperature conditions favor high level production of an enzyme of interest. Optionally, the enzyme of interest is purified from culture medium or from a bacterial lysate harvested from the culture using known purification strategies.

Although classification of enzymes isolated from Sargasso sea thermophiles is described herein as an illustrative example, application of exemplary analytic methods described herein can be applied to other datasets. Additional bacterial genomic datasets which are currently available, or expected to become available as a result of ongoing research efforts include, but are mot limited to Acidihiobacillus ferrooxidans (hiobacillus ferrooxidans), Acidobacerium capsulaum, Acinomyces naeslundii, Aeromonas hydrophila, Anaplasma phagocyophilum, Arhrobacer aurescens, Aspergillus fumigaus, Bacillus anhracis (numerous subspecies and field isolaes), Bacillus cereus (multiple sub-species) B, Bacillus mojavensis, Bacillus subilis subsp. spizizenii U-B-, Bacillus subilis subsp. subilis RO-NN-, Baceroides forsyhus, Baumannia cicadellinicola, Brucella ovis, Brugia wolbachia, Burkholderia hailandensis E, Campylobacer coli, Campylobacer lari, Campylobacer upsaliensis, Campylobacer jejuni, Carboxydoheus hydrogenofoans, Chlamydophila psiaci, Chrysiogenes arsenais, Closridium perfringens, Closridium perfringens, Coccidioides posadasii, Colwellia sp. Coproheobacer proeolyicus, Cyanobaceria sp., Cyanobaceria sp. Dichelobacer nodosus. Dicyoglomus heophilum, Ehrlichia chaffeensis, Enamoeba hisolyica, Epulopiscium sp., Erwinia chrysanhemi, Escherichia coli (numerous sub-species and strains), Fibrobacer succinogenes S, Geovibrio hiophilus, Gemmaa obscuriglobus, Haloferax volcanii, Hyphomonas nepunium, Klebsiella pneumoniae, Methylococcus capsulaus, Mycobacerium avium, Mycobacerium smegmais, Mycobacerium tuberculosis, Mycoplasma arhriidis, Mycoplasma bovis. Mycoplasma capricolumn, Myxococcus xanhus DK, Neorickesia sennesu Miyayama, Neosarorya fischeri, Persephonella marina EX-H, Plasmodium vivax Salvador I Prevoella ineedia, Prevoella ruminicola, Prochloron didemni, Ruminococcus albus, Shigella boydii BS, Shigella dyseneriae, Simkania negevensis, Sigmaella auraniaca DW/-, Srepococcus agalaciae A, Srepococcus gordonii Challis, Srepococcus miis, Srepococcus pneumoniae-B, Srepococcus sobrinus, Sulfurihydrogenibium azorense, Synechococcus sp. CC, Synergises jonesii, Thermodesulfobacerium commune DSM, Thermodesulfovibrio yellowsonii DSM, Thermomicrobium roseum DSM, Thermotoga neapoliana DSM, Toxoplasma gondii B, Trichomonas vaginalis G, Trypanosoma brucei Gua., Verrucomicrobium spinosum DSM, Yersinia pesis Angola, Yersinia pesis IP, Yersinia pseudouberculosis IP.

Alternatively, or additionally, exemplary analytic methods according to various embodiments of the invention can be applied to plant genome datasets which are currently available, or expected to become available as a result of ongoing research efforts including, but not limited to Arabidopsis, Maize, Rice, Cotton, Sorghum and Tobacco.

Alternatively, or additionally, exemplary analytic methods according to various embodiments of the invention can be applied to plant genome datasets which are currently available, or expected to become available as a result of ongoing research efforts including, but not limited to mouse, rat, guinea pig, pig, horse, cow, chicken, Xenopus laevis, and human.

Alternatively, or additionally, exemplary analytic methods according to various embodiments of the invention can be applied to determine function of non-enzyme molecules, such as enzymatic inhibitors (e.g. substrate analogs).

Once an EC number of an enzyme is known, one of ordinary skill in the art can easily ascertain the preferred substrate(s) using available information resources (e.g. BRENDA; The Comprehensive Enzyme Information System; Prof. Dr. D. Schomburg, Institut fuer Biochemie, Universitaet zu Köln, Zülpicher Str. 47, 50674 Köln, Germany <www.brenda.uni-koeln.de>). Additionally, Sigma-Aldrich Chemical Co. (St. Louis, Mo., USA) makes available a database of enzyme assay protocols searchable by EC number:

<http://www.sigmaaldrich.com/Area_of Interest/Biochemicals/Enzyme_Explorer/Key_Resources/Assay_Library/EC_Number.html>

Kits for assaying of enzyme activity are available commercially (e.g. from NOVASCREEN, Hanover Md., USA).

However, enzymatic assays are expensive to perform, with commercial kits typically costing in the range of $20 to $150 per assay. In an exemplary embodiment of the invention, assay costs are reduced by determining an EC classification according to exemplary methods disclosed herein and conducting a single assay to verify enzymatic activity.

In general, assay conditions are defined in terms of one or more of pH, osmolarity, temperature, time, substrate enzyme ratio and concentration of non peptide catalysts or inhibitors (e.g. divalent cations).

While the body of available gene sequences and regulatory sequences is constantly growing, the number of available useful gene expression constructs is limited to a large degree by difficulty in ascertaining a function of a gene sequence. In an exemplary embodiment of the invention, a known polypeptide with unknown function is rapidly and reliably characterized with respect to its function. Once characterized with respect to function, significant quantities (e.g. grams, kilos or even tons) of a desired polypeptide can be produced using recombinant DNA technology and/or bioreactors and/or synthetic protocols as outlined above.

This makes available, for the first time, useful quantities of a wide variety of polypeptides (e.g. enzymes) for use in industry, medicine and agriculture.

### Exemplary Industrial Applications of Enzymes

Enzymes are used in a wide variety of industrial and research applications which are briefly reviewed here. This review does not purport to be exhaustive and does not limit the scope of the invention.

Use of enzymes in industrial processes is well known to those of ordinary skill in the art. Exemplary industrial use of enzymes are described, for example, in “Industrial Enzymes and their Applications” (Helmut Uhlig; Translated by Elfriede M. Linsmaier-Bednar (1998) Wiley-IEEE:Technology & Industrial Arts). Exemplary applications include carbohydrate hydrolysis, proteolysis, ester cleavage (e.g. fat hydrolysis or lipolysis), glucose isomerization and oxido-reduction. The contents of this book are fully incorporated herein by reference.

In general, industrial enzymes can be divided into two broad categories: commodity enzymes and specialty enzymes.

Commodity enzymes are those which are used in large amounts (e.g. tens to hundreds to thousands of kilos/year). Typically, commodity enzymes can be employed in a relatively crude state (e.g. 10, 20, 30, 40 or 50% pure or lesser or intermediate degrees of purity) without complex purification prior to use. In general, preparation of commodity enzymes is conducted with a low profit margin and prices are relatively low (e.g. 5 to 40$/Kg).

In contrast, specialty enzymes are used in smaller amounts (e.g. grams to kilos). Typically, specialty enzymes are employed at a relatively high level of purity. In general, preparation of specialty enzymes is conducted with a high profit margin and prices are relatively high (e.g. 5 to 10,000$/g).

Protein hydrolysis accounts for the largest percentage of industrial enzyme use (approximately 59%). Carbohydrate hydrolysis is second (approximately 28%) and lipid hydrolysis accounts for about 3% of industrial enzyme use. The remaining 10% of industrial enzyme use is in specialty areas such as, for example, analytic use (e.g. nucleic acid “restriction enzymes”), pharmaceutical use and research (e.g. thermophilic polymerases).

The industrial market for enzymes is growing with an annual increase in volume of 10 to 15%. Total revenues increase by about 4 to 5% annually. Profit margins for commodity enzymes continue to fall. This trend is offset by increased use of specialty enzymes in, for example, diagnostics, fine chemical manufacture and chiral separation.

Industrial uses of enzymes in the food industry include, but are not limited to, use of amylases in bread-making, use of lipases in flavour development, use of proteases in cheese making and use of pectinases in clarifying fruit juices.

In the textile industry, cellulases are commonly employed in treating denim to generate a ‘stone-washed’ texture/appearance.

Another common industrial use of enzymes is in grain processing, for example to convert corn starch to high fructose syrups.

In agriculture, enzymes are commonly used to treat animal feeds to make the more digestible (e.g. cellulase, xylanase, phytase).

In waste management, lipases are frequently employed as drain cleaning agents.

In the laboratory diagnostic enzymes and polymerases play a prominent role in many molecular analytic protocols (e.g. restriction digestion and PCR). Other common molecular biology techniques rely upon reporter enzymes (e.g. alkaline phosphatase, glucose oxidase, β-glucosidase and horseradish peroxidase).

Specialized uses of enzymes in biotransformations is a small but lucrative field. For example, lipases, esterases and oxidoreductases can be employed in chiral separations, glucotransferases can be employed in synthesis of oligosaccharides, thermolysin can be employed in aspartame synthesis, nitrile hydratases can be employed in acrylamide and/or nicotinamide synthesis, proteases can be employed in peptide synthesis, penicillin acylase can be employed in manufacture of semisynthetic penicillins and aspartase can be employed in the manufacture of L-aspartate.

In processing of cornstarch to produce glucose, there are three enzymatic reactions commonly employed in sequence.

In a first enzymatic reaction, starch is hydrolyzed, for example using an α-amylase (cleaves a-1-4 glucosidic bonds in starch). Often, a high temperature is applied to expand starch granules, making amylose and amylopectin chains more accessible. Here is therefore an advantage to a thermostable enzyme in this process. In many cases the starch hydrolysis is a batch process and the enzyme is not reused.

In a second enzymatic reaction, maltose is converted to glucose, for example using an amyloglucosidase. In many cases amyloglucosidase has a pH optimum of 6.5 so that reaction conditions must be adjusted after the starch hydrolysis reaction by reducing the pH.

In a third enzymatic reaction, glucose is converted to fructose, for example using a xylose isomerase. Fructose is sweeter than glucose and is commonly used as sweetening agent in foodstuffs. Fructose commands a higher price than glucose. and is more profitable than glucose. Xylose isomerase converts glucose to fructose, in an equilibrium reaction: Glucose⇄Fructose.

For many commercial applications, it is sufficient to produce a 50:50 mixture of glucose:fructose. This mixture is commonly known as “high fructose syrup” (HFS). Optionally, reaction conditions are adjusted by binding or removing Calcium ions which can inhibit xylose isomerase.

There is also a large industry devoted to production of artificial sweeteners. One commoner artificial sweetener is aspartame (L-phenylalanyl-L-aspartyl-methyl ester). Aspartame can is often produced biocatalytically by peptide synthesis using a thermostable protease which normally hydrolyses the N-terminal amide bonds of hydrophobic amino acid residues in a peptide. Optionally, use of an immobilised enzyme allows continuous process and enzyme reuse.

In aspartame manufacture, a low water activity solvent system (organic solvent based) reverses the normal equilibrium to produce a CBZ-L-Phe-L-Asp-OMe intermediate which crystallizes out of solution. Chemical removal of the CBZ group (deblocking) produces L-Phe-L-Asp-OMe (Aspartame).

Another important industrial use of enzymes is in nitrile biotransformations, for example synthesis of acrylamide. About 45 thousand tons per year of acrylamide is synthesised biologically, using a whole cell catalyst. The catalyst is an engineered Rhodococcus strain containing high levels of the enzyme nitrile hydratase (NHase). Initially the wild type Rhodococcus was used. Subsequently a recombinant Rhodococcus expressing the NHase gene at high levels was employed. Currently, a recombinant Rhodococcus with an NHase gene engineered to increase stability, and to reduce substrate and product inhibitions employed. The Rhodococcus is typically grown in a stirred tank bioreactor.

The biological production of acrylamide has advantages over the chemical synthesis because of the absence of side-reactions, and the simpler recovery of the reaction product.

Another important industrial use of enzymes is in production of nicotinamide. Nicotinamide is an essential vitamin, and is widely used in the health-food and animal food-and-feed industries. Biological production, using the same Rhodococcus biocatalyst as for acrylamide production, produces about 5 thousand tons per year of nicotinamide. Whole cell cultures of Rhodococcus convert 3-cyanopyridine to nicotinamide.

Another important industrial use of enzymes is in production of penicillin derivatives. Penicillin is produced industrially at high yields by Streptomyces fermentations. The Penicillin is converted enzymatically by penicillin acylase to 6-aminopenicillanic acid. The 6-Aminopenicillanic acid is a substrate for chemical or microbial conversion to valuable commercial antibiotics (e.g. Ampicillin)

### Exemplary Composition Types

### Agricultural Compositions

In an exemplary embodiment of the invention, enzymatic compositions of the present invention can also be included in agricultural compositions, which also preferably include an agricultural acceptable carrier.

An agriculturally acceptable carrier can be a solid or a liquid, preferably a liquid, more preferably water. While not required, the agricultural composition of the invention may also contain other additives such as fertilizers, inert formulation aids, i.e. surfactants, emulsifiers, defoamers, dyes, extenders and the like. Reviews describing methods of preparation and application of agricultural compositions are available. See, for example, Couch and Ignoffo (1981) in Microbial Control of Pests and Plant Disease 1970-1980, Burges (ed.), chapter 34, pp. 621-634; Corke and Rishbeth, ibid, chapter 39, pp. 717-732; Brockwell (1980) in Methods for Evaluating Nitrogen Fixation, Bergersen (ed.) pp. 417-488; Burton (1982) in Biological Nitrogen Fixation Technology for Tropical Agriculture, Graham and Harris (eds.) pp. 105-114; and Roughley (1982) ibid, pp. 115-127; The Biology of Baculoviruses, Vol. II, supra, and references cited in the above. Wettable powder compositions incorporating baculoviruses for use in insect control are described in EP 697,170 incorporated by reference herein.

Preferred methods of applying the agricultural compositions of the present invention are leaf application, seed coating and soil application, as disclosed in U.S. Pat. No. 5,039,523, which is fully incorporated herein.

### Pharmaceutical Compositions

Polypeptides identified according to exemplary analytic methods of the invention can be administered to an organism per se, or in a pharmaceutical composition where it is mixed with suitable carriers or excipients.

As used herein, a “pharmaceutical composition” refers to a preparation of one or more of the active ingredients described herein with other chemical components such as physiologically suitable carriers and excipients. The purpose of a pharmaceutical composition is to facilitate administration of a compound to an organism.

As used herein, the term “active ingredient” refers to the polypeptide accountable for the intended biological effect.

Hereinafter, the phrases “physiologically acceptable carrier” and “pharmaceutically acceptable carrier,” which may be used interchangeably, refer to a carrier or a diluent that does not cause significant irritation to an organism and does not abrogate the biological activity and properties of the administered compound. An adjuvant is included under these phrases.

Herein, the term “excipient” refers to an inert substance added to a pharmaceutical composition to further facilitate administration of an active ingredient. Examples, without limitation, of excipients include calcium carbonate, calcium phosphate, various sugars and types of starch, cellulose derivatives, gelatin, vegetable oils, and polyethylene glycols.

Techniques for formulation and administration of drugs may be found in the latest edition of “Remington's Pharmaceutical Sciences,” Mack Publishing Co., Easton, Pa., which is herein fully incorporated by reference.

Suitable routes of administration may, for example, include oral, rectal, transmucosal, especially transnasal, intestinal, or parenteral delivery, including intramuscular, subcutaneous, and intramedullary injections, as well as intrathecal, direct intraventricular, intravenous, inrtaperitoneal, intranasal, or intraocular injections.

Alternately, one may administer the pharmaceutical composition in a local rather than systemic manner, for example, via injection of the pharmaceutical composition directly into a tissue region of a patient.

Pharmaceutical compositions of the present invention may be manufactured by processes well known in the art, e.g., by means of conventional mixing, dissolving, granulating, dragee-making, levigating, emulsifying, encapsulating, entrapping, or lyophilizing processes.

Pharmaceutical compositions for use in accordance with the present invention thus may be formulated in conventional manner using one or more physiologically acceptable carriers comprising excipients and auxiliaries, which facilitate processing of the active ingredients into preparations that can be used pharmaceutically. Proper formulation is dependent upon the route of administration chosen.

For injection, the active ingredients of the pharmaceutical composition may be formulated in aqueous solutions, preferably in physiologically compatible buffers such as Hank's solution, Ringer's solution, or physiological salt buffer. For transmucosal administration, penetrants appropriate to the barrier to be permeated are used in the formulation. Such penetrants are generally known in the art.

For oral administration, the pharmaceutical composition can be formulated readily by combining the active compounds with pharmaceutically acceptable carriers well known in the art. Such carriers enable the pharmaceutical composition to be formulated as tablets, pills, dragees, capsules, liquids, gels, syrups, slurries, suspensions, and the like, for oral ingestion by a patient. Pharmacological preparations for oral use can be made using a solid excipient, optionally grinding the resulting mixture, and processing the mixture of granules, after adding suitable auxiliaries as desired, to obtain tablets or dragee cores. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, and sodium carbomethylcellulose; and/or physiologically acceptable polymers such as polyvinylpyrrolidone (PVP). If desired, disintegrating agents, such as cross-linked polyvinyl pyrrolidone, agar, or alginic acid or a salt thereof, such as sodium alginate, may be added.

Dragee cores are provided with suitable coatings. For this purpose, concentrated sugar solutions may be used which may optionally contain gum arabic, talc, polyvinyl pyrrolidone, carbopol gel, polyethylene glycol, titanium dioxide, lacquer solutions, and suitable organic solvents or solvent mixtures. Dyestuffs or pigments may be added to the tablets or dragee coatings for identification or to characterize different combinations of active compound doses.

Pharmaceutical compositions that can be used orally include push-fit capsules made of gelatin, as well as soft, sealed capsules made of gelatin and a plasticizer, such as glycerol or sorbitol. The push-fit capsules may contain the active ingredients in admixture with filler such as lactose, binders such as starches, lubricants such as talc or magnesium stearate, and, optionally, stabilizers. In soft capsules, the active ingredients may be dissolved or suspended in suitable liquids, such as fatty oils, liquid paraffin, or liquid polyethylene glycols. In addition, stabilizers may be added. All formulations for oral administration should be in dosages suitable for the chosen route of administration.

For buccal administration, the compositions may take the form of tablets or lozenges formulated in conventional manner.

For administration by nasal inhalation, the active ingredients for use according to the present invention are conveniently delivered in the form of an aerosol spray presentation from a pressurized pack or a nebulizer with the use of a suitable propellant, e.g., dichlorodifluoromethane, trichlorofluoromethane, dichloro-tetrafluoroethane, or carbon dioxide. In the case of a pressurized aerosol, the dosage may be determined by providing a valve to deliver a metered amount. Capsules and cartridges of, for example, gelatin for use in a dispenser may be formulated containing a powder mix of the compound and a suitable powder base, such as lactose or starch.

The pharmaceutical composition described herein may be formulated for parenteral administration, e.g., by bolus injection or continuous infusion. Formulations for injection may be presented in unit dosage form, e.g., in ampoules or in multidose containers with, optionally, an added preservative. The compositions may be suspensions, solutions, or emulsions in oily or aqueous vehicles, and may contain formulatory agents such as suspending, stabilizing, and/or dispersing agents.

Pharmaceutical compositions for parenteral administration include aqueous solutions of the active preparation in water-soluble form. Additionally, suspensions of the active ingredients may be prepared as appropriate oily or water-based injection suspensions. Suitable lipophilic solvents or vehicles include fatty oils such as sesame oil, or synthetic fatty acid esters such as ethyl oleate, triglycerides, or liposomes. Aqueous injection suspensions may contain substances that increase the viscosity of the suspension, such as sodium carboxymethyl cellulose, sorbitol, or dextran. Optionally, the suspension may also contain suitable stabilizers or agents that increase the solubility of the active ingredients, to allow for the preparation of highly concentrated solutions.

Alternatively, the active ingredient may be in powder form for constitution with a suitable vehicle, e.g., a sterile, pyrogen-free, water-based solution, before use.

The pharmaceutical composition of the present invention may also be formulated in rectal compositions such as suppositories or retention enemas, using, for example, conventional suppository bases such as cocoa butter or other glycerides.

Pharmaceutical compositions suitable for use in the context of the present invention include compositions wherein the active ingredients are contained in an amount effective to achieve the intended purpose. More specifically, a “therapeutically effective amount” means an amount of active ingredients (e.g., a nucleic acid construct) effective to prevent, alleviate, or ameliorate symptoms of a disorder (e.g., ischemia) or prolong the survival of the subject being treated.

Determination of a therapeutically effective amount is well within the capability of those skilled in the art, especially in light of the detailed disclosure provided herein.

For any preparation used in the methods of the invention, the dosage or the therapeutically effective amount can be estimated initially from in vitro and cell culture assays. For example, a dose can be formulated in animal models to achieve a desired concentration or titer. Such information can be used to more accurately determine useful doses in humans.

Toxicity and therapeutic efficacy of the active ingredients described herein can be determined by standard pharmaceutical procedures in vitro, in cell cultures or experimental animals. The data obtained from these in vitro and cell culture assays and animal studies can be used in formulating a range of dosage for use in human. The dosage may vary depending upon the dosage form employed and the route of administration utilized. The exact formulation, route of administration, and dosage can be chosen by the individual physician in view of the patient's condition. (See, e.g., Fingl, E. et al. (1975), “The Pharmacological Basis of Therapeutics,” Ch. 1, p. 1.)

Dosage amount and administration intervals may be adjusted individually to provide sufficient plasma or brain levels of the active ingredient to induce or suppress the biological effect (i.e., minimally effective concentration, MEC). The MEC will vary for each preparation, but can be estimated from in vitro data. Dosages necessary to achieve the MEC will depend on individual characteristics and route of administration. Detection assays can be used to determine plasma concentrations.

Depending on the severity and responsiveness of the condition to be treated, dosing can be of a single or a plurality of administrations, with course of treatment lasting from several days to several weeks, or until cure is effected or diminution of the disease state is achieved.

The amount of a composition to be administered will, of course, be dependent on the subject being treated, the severity of the affliction, the manner of administration, the judgment of the prescribing physician, etc.

Compositions of the present invention may, if desired, be presented in a pack or dispenser device, such as an FDA-approved kit, which may contain one or more unit dosage forms containing the active ingredient. The pack may, for example, comprise metal or plastic foil, such as a blister pack. The pack or dispenser device may be accompanied by instructions for administration. The pack or dispenser device may also be accompanied by a notice in a form prescribed by a governmental agency regulating the manufacture, use, or sale of pharmaceuticals, which notice is reflective of approval by the agency of the form of the compositions for human or veterinary administration. Such notice, for example, may include labeling approved by the U.S. Food and Drug Administration for prescription drugs or of an approved product insert. Compositions comprising a preparation of the invention formulated in a pharmaceutically acceptable carrier may also be prepared, placed in an appropriate container, and labeled for treatment of an indicated condition, as further detailed above.

### Food Additives

In an exemplary embodiment of the invention, food compositions comprise one or more polypeptides of the present invention as food additives.

The phrase “food additive” [defined by the FDA in 21 C.F.R. 170.3(e)(1)] includes any liquid or solid material intended to be added to a food product. This material can, for example, include an agent having a distinct taste and/or flavor or physiological effect (e.g., vitamins).

Thus, the food additive composition, may comprise the polypeptide of the present invention.

The food additive composition of the present invention can include the polypeptide per se, or an encapsulated form of the polypeptide (described hereinabove with respect to pharmaceutical compositions). The food additive composition of the present invention can be added to a variety of food products.

As used herein, the phrase “food product” describes a material consisting essentially of protein, carbohydrate and/or fat, which is used in the body of an organism to sustain growth, repair and vital processes and to furnish energy. Food products may also contain supplementary substances such as minerals, vitamins and condiments. See Merriani-Webster's Collegiate Dictionary, 10th Edition, 1993. The phrase “food product” as used herein further includes a beverage adapted for human or animal consumption.

Representative examples of food products in which the food additive of the present invention can be incorporated include, without limitation, baked goods, soft drinks, cereals, candy, jams, jellies, tofu, cheese and ice cream.

A food product containing the food additive of the present invention can also include additional additives such as, for example, antioxidants, sweeteners, flavorings, colors, preservatives, enzymes, nutritive additives such as vitamins and minerals, emulsifiers, pH control agents such as acidulants, hydrocolloids, antifoams and release agents, flour improving or strengthening agents, raising or leavening agents, gases and chelating agents, the utility and effects of which are well-known in the art.

The polypeptide of the present invention can also be expressed in edible portions of commercially grown crops.

For example, the polypeptide of the present invention can be expressed in dicot or monocot plants, with a preference to moncot plants such as rice, wheat or barley. Methods of expressing exogenous polynucleotide sequences in plants are described hereinabove with respect to synthesis of a recombinant polypeptide in plant cells.

### Cosmetical Compositions

Such compositions are usually prepared for aesthetic use and may comprise the polypeptides of the present invention as either the active ingredient or as a carrier.

As used herein, the term “cosmetically or cosmeceutically acceptable carrier” describes a carrier or a diluent that does not cause significant irritation to an organism and does not abrogate the biological activity and properties of the applied active ingredient(s).

Examples of acceptable carriers that are usable in the context of the present invention include carrier materials that are well-known for use in the cosmetic and medical arts as bases for e.g., emulsions, creams, aqueous solutions, oils, ointments, pastes, gels, lotions, milks, foams, suspensions, aerosols and the like, depending on the final form of the composition.

Representative examples of suitable carriers according to the present invention therefore include, without limitation, water, liquid alcohols, liquid glycols, liquid polyalkylene glycols, liquid esters, liquid amides, liquid protein hydrolysates, liquid alkylated protein hydrolysates, liquid lanolin and lanolin derivatives, and like materials commonly employed in cosmetic and medicinal compositions.

Other suitable carriers according to the present invention include, without limitation, alcohols, such as, for example, monohydric and polyhydric alcohols, e.g., ethanol, isopropanol, glycerol, sorbitol, 2-methoxyethanol, diethyleneglycol, ethylene glycol, hexyleneglycol, mannitol, and propylene glycol; ethers such as diethyl or dipropyl ether; polyethylene glycols and methoxypolyoxyethylenes (carbowaxes having molecular weight ranging from 200 to 20,000); polyoxyethylene glycerols, polyoxyethylene sorbitols, stearoyl diacetin, and the like.

By selecting the appropriate carrier and optionally other ingredients that can be included in the composition, as is detailed hereinbelow, the compositions of the present invention may be formulated into any pharmaceutical, cosmetic or cosmeceutical form normally employed for topical application. Hence, the compositions of the present invention can be, for example, in a form of a cream, an ointment, a paste, a gel, a lotion, a milk, a suspension, an aerosol, a spray, a foam, a shampoo, a hair conditioner, a serum, a swab, a pledget, a pad and a soap.

The compositions of the present invention can optionally further comprise a variety of components that are suitable for rendering the compositions more cosmetically or aesthetically acceptable or to provide the compositions with additional usage benefits. Such conventional optional components are well known to those skilled in the art and are referred to herein as “ingredients”. These include any cosmetically acceptable ingredients such as those found in the CTFA International Cosmetic Ingredient Dictionary and Handbook, 8th edition, edited by Wenninger and Canterbery, (The Cosmetic, Toiletry, and Fragrance Association, Inc., Washington, D.C., 2000). Some non-limiting representative examples of these ingredients include humectants, deodorants, antiperspirants, sun screening agents, sunless tanning agents, hair conditioning agents, pH adjusting agents, chelating agents, preservatives, emulsifiers, occlusive agents, emollients, thickeners, solubilizing agents, penetration enhancers, anti-irritants, colorants, propellants (as described above) and surfactants.

Thus, for example, the compositions of the present invention can comprise, in combination with ammonium lactate and urea, one or more additional humectants or moisturizing agents. Representative examples of humectants that are usable in this context of the present invention include, without limitation, guanidine, glycolic acid and glycolate salts (e.g. ammonium slat and quaternary alkyl ammonium salt), aloe vera in any of its variety of forms (e.g., aloe vera gel), allantoin, urazole, polyhydroxy alcohols such as sorbitol, glycerol, hexanetriol, propylene glycol, butylene glycol, hexylene glycol and the like, polyethylene glycols, sugars and starches, sugar and starch derivatives (e.g., alkoxylated glucose), hyaluronic acid, lactamide monoethanolamine, acetamide monoethanolamine and any combination thereof.

The compositions of the present invention can further comprise a pH adjusting agent. As is discussed hereinabove, although the ammonium lactate or any corresponding ammonium salt may serve as a pH adjusting agent, it is preferable for the compositions of the invention to have a pH value of between about 4 and about 7, preferably between about 5 and about 6, most preferably about 5.5 or substantially 5.5 and hence the presence of a pH adjusting agent is preferred. Suitable pH adjusting agents include, for example, one or more of adipic acids, glycines, citric acids, calcium hydroxides, magnesium aluminometasilicates, buffers or any combinations thereof.

Representative examples of deodorant agents that are usable in the context of the present invention include, without limitation, quaternary ammonium compounds such as cetyl-trimethylammonium bromide, cetyl pyridinium chloride, benzethonium chloride, diisobutyl phenoxy ethoxy ethyl dimethyl benzyl ammonium chloride, sodium N-lauryl sarcosine, sodium N-palmIthyl sarcosine, lauroyl sarcosine, N-myristoyl glycine, potassium N-lauryl sarcosine, stearyl, trimethyl ammonium chloride, sodium aluminum chlorohydroxy lactate, tricetylmethyl ammonium chloride, 2,4,4′-trichloro-2′-hydroxy diphenyl ether, diaminoalkyl amides such as L-lysine hexadecyl amide, heavy metal salts of citrate, salicylate, and piroctose, especially zinc salts, and acids thereof, heavy metal salts of pyrithione, especially zinc pyrithione and zinc phenolsulfate. Other deodorant agents include, without limitation, odor absorbing materials such as carbonate and bicarbonate salts, e.g. as the alkali metal carbonates and bicarbonates, ammonium and tetraalkylammonium carbonates and bicarbonates, especially the sodium and potassium salts, or any combination of the above.

Antiperspirant agents can be incorporated in the compositions of the present invention either in a solubilized or a particulate form and include, for example, aluminum or zirconium astringent salts or complexes.

Representative examples of sun screening agents usable in context of the present invention include, without limitation, p-aminobenzoic acid, salts and derivatives thereof (ethyl, isobutyl, glyceryl esters; p-dimethylaminobenzoic acid); anthranilates (i.e., o-amino-benzoates; methyl, menthyl, phenyl, benzyl, phenylethyl, linalyl, terpinyl, and cyclohexenyl esters); salicylates (amyl, phenyl, octyl, benzyl, menthyl, glyceryl, and di-pro-pyleneglycol esters); cinnamic acid derivatives (menthyl and benzyl esters, a-phenyl cinnamonitrile; butyl cinnamoyl pyruvate); dihydroxycinnamic acid derivatives (umbelliferone, methylumbelliferone, methylaceto-umbelliferone); trihydroxy-cinnamic acid derivatives (esculetin, methylesculetin, daphnetin, and the glucosides, esculin and daphnin); hydrocarbons (diphenylbutadiene, stilbene); dibenzalacetone and benzalacetophenone; naphtholsulfonates (sodium salts of 2-naphthol-3,6-disulfonic and of 2-naphthol-6,8-disulfonic acids); di-hydroxynaphthoic acid and its salts; o- and p-hydroxybiphenyldisulfonates; coumarin derivatives (7-hydroxy, 7-methyl, 3-phenyl); diazoles (2-acetyl-3-bromoindazole, phenyl benzoxazole, methyl naphthoxazole, various aryl benzothiazoles); quinine salts (bisulfate, sulfate, chloride, oleate, and tannate); quinoline derivatives (8-hydroxyquinoline salts, 2-phenylquinoline); hydroxy- or methoxy-substituted benzophenones; uric and violuric acids; tannic acid and its derivatives (e.g., hexaethylether); (butyl carbotol) (6-propyl piperonyl)ether; hydroquinone; benzophenones (oxybenzene, sulisobenzone, dioxybenzone, benzoresorcinol, 2,2′,4,4′-tetrahydroxybenzophenone, 2,2′-dihydroxy-4,4′-dimethoxybenzophenone, octabenzone; 4-isopropyldibenzoylmethane; butylmethoxydibenzoylmethane; etocrylene; octocrylene; [3-(4′-methylbenzylidene bornan-2-one) and 4-isopropyl-di-benzoylmethane, and any combination thereof.

Representative examples of sunless tanning agents usable in context of the present invention include, without limitation, dihydroxyacetone, glyceraldehyde, indoles and their derivatives. The sunless tanning agents can be used in combination with the sunscreen agents.

Suitable hair conditioning agents that can be used in the context of the present invention include, for example, one or more collagens, cationic surfactants, modified silicones, proteins, keratins, dimethicone polyols, quaternary ammonium compounds, halogenated quaternary ammonium compounds, alkoxylated carboxylic acids, alkoxylated alcohols, alkoxylated amides, sorbitan derivatives, esters, polymeric ethers, glyceryl esters, or any combinations thereof.

The chelating agents are optionally added to the compositions of the present invention so as to enhance the preservative or preservative system. Preferred chelating agents are mild agents, such as, for example, ethylenediaminetetraacetic acid (EDTA), EDTA derivatives, or any combination thereof.

Suitable preservatives that can be used in the context of the present composition include, without limitation, one or more alkanols, disodium EDTA (ethylenediamine tetraacetate), EDTA salts, EDTA fatty acid conjugates, isothiazolinone, parabens such as methylparaben and propylparaben, propylene glycols, sorbates, urea derivatives such as diazolindinyl urea, or any combinations thereof.

Suitable emulsifiers that can be used in the context of the present invention include, for example, one or more sorbitans, alkoxylated fatty alcohols, alkylpolyglycosides, soaps, alkyl sulfates, monoalkyl and dialkyl phosphates, alkyl sulphonates, acyl isothionates, or any combinations thereof.

Suitable occlusive agents that can be used in the context of the present invention include, for example, petrolatum, mineral oil, beeswax, silicone oil, lanolin and oil-soluble lanolin derivatives, saturated and unsaturated fatty alcohols such as behenyl alcohol, hydrocarbons such as squalane, and various animal and vegetable oils such as almond oil, peanut oil, wheat germ oil, linseed oil, jojoba oil, oil of apricot pits, walnuts, palm nuts, pistachio nuts, sesame seeds, rapeseed, cade oil, corn oil, peach pit oil, poppyseed oil, pine oil, castor oil, soybean oil, avocado oil, safflower oil, coconut oil, hazelnut oil, olive oil, grape seed oil and sunflower seed oil.

Suitable emollients, other than ammonium lactate, that can be used in the context of the present invention include, for example, dodecane, squalane, cholesterol, isohexadecane, isononyl isononanoate, PPG Ethers, petrolatum, lanolin, safflower oil, castor oil, coconut oil, cottonseed oil, palm kernel oil, palm oil, peanut oil, soybean oil, polyol carboxylic acid esters, derivatives thereof and mixtures thereof.

Suitable thickeners that can be used in the context of the present invention include, for example, non-ionic water-soluble polymers such as hydroxyethylcellulose (commercially available under the Trademark Natrosol® 250 or 350), cationic water-soluble polymers such as Polyquat 37 (commercially available under the Trademark Synthalen® CN), fatty alcohols, fatty acids and their alkali salts and mixtures thereof.

Representative examples of solubilizing agents that are usable in this context of the present invention include, without limitation, complex-forming solubilizers such as citric acid, ethylenediamine-tetraacetate, sodium meta-phosphate, succinic acid, urea, cyclodextrin, polyvinylpyrrolidone, diethylammonium-ortho-benzoate, and micelle-forming solubilizers such as TWEENS and spans, e.g., TWEEN 80. Other solubilizers that are usable for the compositions of the present invention are, for example, polyoxyethylene sorbitan fatty acid ester, polyoxyethylene n-alkyl ethers, n-alkyl amine n-oxides, poloxamers, organic solvents, phospholipids and cyclodextrines.

Suitable penetration enhancers usable in context of the present invention include, but are not limited to, dimethylsulfoxide (DMSO), dimethyl formamide (DMF), allantoin, urazole, N,N-dimethylacetamide (DMA), decylmethylsulfoxide (C₁₀ MSO), polyethylene glycol monolaurate (PEGML), propylene glycol (PG), propylene glycol monolaurate (PGML), glycerol monolaurate (GML), lecithin, the 1-substituted azacycloheptan-2-ones, particularly 1-n-dodecylcyclazacycloheptan-2-one (available under the trademark Azone® from Whitby Research Incorporated, Richmond, Va.), alcohols, and the like. The permeation enhancer may also be a vegetable oil. Such oils include, for example, safflower oil, cottonseed oil and corn oil.

Suitable anti-irritants that can be used in the context of the present invention include, for example, steroidal and non steroidal anti-inflammatory agents or other materials such as aloe vera, chamomile, alpha-bisabolol, cola nitida extract, green tea extract, tea tree oil, licoric extract, allantoin, caffeine or other xanthines, glycyrrhizic acid and its derivatives.

Although a wide variety of ingredients can be included in the compositions of the present invention, in addition to the active ingredients, the compositions are preferably devoid of an enduring perfume composition. The incorporation of such a perfume composition in pharmaceutical compositions is considered in the art disadvantageous for skin and scalp medical treatment, as it oftentimes cause undesirable irritation of a sensitive skin.

As used herein, the phrase “an enduring perfume composition” describes a composition that comprises one or more perfumes that provide a long lasting aesthetic benefit with a minimum amount of material. Enduring perfume compositions are substantially deposited and remain on the body throughout any rinse and/or drying steps. Representative examples of such compositions are described, for example, in U.S. Pat. No. 6,086,903.

However, it should be noted that fragrances other than enduring perfume compositions, perfumes or perfume compositions, which are fast removable from the surface they are deposited on, can be included in the compositions of the present invention.

### Exemplary Medical Applications of Enzymes

Use of enzymes a wide variety of medical applications is contemplated and/or practiced. Exemplary medical applications which are briefly reviewed here. This review does not purport to be exhaustive and does not limit the scope of the invention. The cellular processes of biogenesis and biodegradation involve a number of key enzyme classes including oxidoreductases, transferases, hydrolases, lyases, isomerases, ligases, and others. Each class of enzyme comprises many substrate-specific enzymes having precise and well regulated functions. Enzymes facilitate metabolic processes such as glycolysis, the tricarboxylic cycle, and fatty acid metabolism; synthesis or degradation of amino acids, steroids, phospholipids, and alcohols; regulation of cell signaling, proliferation, inflammation, and apoptosis; and through catalyzing critical steps in DNA replication and repair and the process of translation. Once an enzyme has been classified according to EC nomenclature it is possible to predict with a high degree of certainty which substrate(s) the enzyme is specific to and/or what type of reaction the enzyme catalyzes.

### Oxidoreductases

Many pathways of biogenesis and biodegradation require oxidoreductase (dehydrogenase or reductase) activity, coupled to reduction or oxidation of a cofactor. Potential cofactors include cytochromes, oxygen, disulfide, iron-sulfur proteins, Ravin adenine dinucleotide (FAD), and the nicotinamide adenine dinucleotides NAD and NADP (Newsholme, E. A. and A. R. Leech (1983) Biochemistry for the Medical Sciences, John Wiley and Sons, Chichester, U. K. pp. 779-793). Reductase activity catalyzes transfer of electrons between substrate(s) and cofactor(s) with concurrent oxidation of the cofactor. Reverse dehydrogenase activity catalyzes the reduction of a cofactor and consequent oxidation of the substrate. Oxidoreductase enzymes are a broad superfamily that catalyze reactions in all cells of organisms, including metabolism of sugar, certain detoxification reactions, and synthesis or degradation of fatty acids, amino acids, glucocorticoids, estrogens, androgens, and prostaglandins. Different family members may be referred to as oxidoreductases, oxidases, reductases, or dehydrogenases, and they often have distinct cellular locations such as the cytosol, the plasma membrane, mitochondrial inner or outer membrane, and peroxisomes.

Short-chain alcohol dehydrogenases (SCADs) are a family of dehydrogenases that share only 15% to 30% sequence identity, with similarity predominantly in the coenzyme binding domain and the substrate binding domain. In addition to their role in detoxification of ethanol, SCADs are involved in synthesis and degradation of fatty acids, steroids, and some prostaglandins, and are therefore implicated in a variety of disorders such as lipid storage disease, myopathy, SCAD deficiency, and certain genetic disorders. For example, retinol dehydrogenase is a SCAD-family member (Simon, A. et al. (1995) J. Biol. Chem. 270:1107-1112) that converts retinol to retinal, the precursor of retinoic acid. Retinoic acid, a regulator of differentiation and apoptosis, has been shown to down-regulate genes involved in cell proliferation and inflammation (Chai, X. et al. (1995) J. Biol. Chem. 270:3900-3904). In addition, retinol dehydrogenase has been linked to hereditary eye diseases such as autosomal recessive childhood-onset severe retinal dystrophy (Simon, A. et al. (1996) Genomics 36:424-430).

Membrane-bound succinate dehydrogenases (succinate:quinone reductases, SQR) and fumarate reductases (quinol:fumarate reductases, QFR) couple the oxidation of succinate to fumarate with the reduction of quinone to quinol, and also catalyze the reverse reaction. QFR and SQR complexes are collectively known as succinate:quinone oxidoreductases (EC 1.3.5.1) and have similar compositions. The complexes consist of two hydrophilic and one or two hydrophobic, membrane-integrated subunits. The larger hydrophilic subunit A carries covalently bound flavin adenine dinucleotide; subunit B contains three iron-sulphur centers (Lancaster, C. R. and A. Kroger (2000) Biochim. Biophys. Acta 1459:422-431). The full-length cDNA sequence for the flavoprotein subunit of human heart succinate dehydrogenase (succinate: (acceptor) oxidoreductase; EC 1.3.99.1) is similar to the bovine succinate dehydrogenase in that it contains a cysteine triplet and in that the active site contains an additional cysteine that is not present in yeast or prokaryotic SQRs (Morris, A. A. et al. (1994) Biochim. Biophys. Acta 29:125-128).

Propagation of nerve impulses, modulation of cell proliferation and differentiation, induction of the immune response, and tissue homeostasis involve neurotransmitter metabolism (Weiss, B. (1991) Neurotoxicology 12:379-386; Collins, S. M. et al. (1992) Ann. N.Y. Acad. Sci. 664:415-424; Brown, J. K. and H. Imam (1991) J. Inherit. Metab. Dis. 14:436-458). Many pathways of neurotransmitter metabolism require oxidoreductase activity, coupled to reduction or oxidation of a cofactor, such as NAD⁺/NADH (Newsholme and Leech, supra, pp. 779-793). Degradation of catecholamines (epinephrine or norepinephrine) requires alcohol dehydrogenase (in the brain) or aldehyde dehydrogenase (in peripheral tissue). NAD⁺-dependent aldehyde dehydrogenase oxidizes 5-hydroxyindole-3-acetate (the product of 5-hydroxytryptamine (serotonin) metabolism) in the brain, blood platelets, liver and pulmonary endothelium (Newsholme and Leech, supra, p. 786). Other neurotransmitter degradation pathways that utilize NAD⁺/NADH-dependent oxidoreductase activity include those of L-DOPA (precursor of dopamine, a neuronal excitatory compound), glycine (an inhibitory neurotransmitter in the brain and spinal cord), histamine (liberated from mast cells during the inflammatory response), and taurine (an inhibitory neurotransmitter of the brain stem, spinal cord and retina) (Newsholme and Leech, supra, pp. 790, 792). Epigenetic or genetic defects in neurotransmitter metabolic pathways can result in diseases including Parkinson disease and inherited myoclonus (McCance, K. L. and S. E. Huether (1994) Pathophysiology, Mosby-Year Book, Inc., St. Louis, Mo. pp. 402-404; Gundlach, A. L. (1990) FASEB J. 4:2761-2766).

Tetrahydrofolate is a derivatized glutamate molecule that acts as a carrier, providing activated one-carbon units to a wide variety of biosynthetic reactions, including synthesis of purines, pyrimidines, and the amino acid methionine. Tetrahydrofolate is generated by the activity of a holoenzyme complex called tetrahydrofolate synthase, which includes three enzyme activities: tetrahydrofolate dehydrogenase, tetrahydrofolate cyclohydrolase, and tetrahydrofolate synthetase. Thus, tetrahydrofolate dehydrogenase plays an important role in generating building blocks for nucleic and amino acids, crucial to proliferating cells.

3-Hydroxyacyl-CoA dehydrogenase (3HACD) is involved in fatty acid metabolism. It catalyzes the reduction of 3-hydroxyacyl-CoA to 3-oxoacyl-CoA, with concomitant oxidation of NAD to NADH, in the mitochondria and peroxisomes of eukaryotic cells. In peroxisomes, 3HACD and enoyl-CoA hydratase form an enzyme complex called bifunctional enzyme, defects in which are associated with peroxisomal bifunctional enzyme deficiency. This interruption in fatty acid metabolism produces accumulation of very-long chain fatty acids, disrupting development of the brain, bone, and adrenal glands. Infants born with this deficiency typically die within 6 months (Watkins, P. et al. (1989) J. Clin. Invest. 83:771-777; Online Mendelian Inheritance in Man (OMIM), #261515). The neurodegeneration characteristic of Alzheimer's disease involves development of extracellular plaques in certain brain regions. A major protein component of these plaques is the peptide amyloid-β (Aβ), which is one of several cleavage products of amyloid precursor protein (APP). 3HACD has been shown to bind the Aβ peptide, and is overexpressed in neurons affected in Alzheimer's disease. In addition, an antibody against 3HACD can block the toxic effects of Aβ in a cell culture model of Alzheimer's disease (Yan, S. et al. (1997) Nature 389:689-695; OMIM, #602057).

Steroids such as estrogen, testosterone, and corticosterone are generated from a common precursor, cholesterol, and interconverted. Enzymes acting upon cholesterol include dehydrogenases. Steroid dehydrogenases, such as the hydroxysteroid dehydrogenases, are involved in hypertension, fertility, and cancer (Duax, W. L. and D. Ghosh (1997) Steroids 62:95-100). One such dehydrogenase is 3-oxo-5-a-steroid dehydrogenase (OASD), a microsomal membrane protein highly expressed in prostate and other androgen-responsive tissues. OASD catalyzes the conversion of testosterone into dihydrotestosterone, which is the most potent androgen. Dihydrotestosterone is essential for the formation of the male phenotype during embryogenesis, as well as for proper androgen-mediated growth of tissues such as the prostate and male genitalia. A defect in OASD leads to defective formation of the external genitalia (Andersson, S. et al. (1991) Nature 354:159-161; Labrie, F. et al. (1992) Endocrinology 131:1571-1573; OMIM #264600).

17β.-hydroxysteroid dehydrogenase (17βHSD6) plays an important role in the regulation of the male reproductive hormone, dihydrotestosterone (DHTT). 17βHSD6 acts to reduce levels of DHTT by oxidizing a precursor of DHTT, 3α-diol, to androsterone which is readily glucuronidated and removed. 17βHSD6 is active with both androgen and estrogen substrates in embryonic kidney 293 cells. Isozymes of 17βHSD catalyze oxidation and/or reduction reactions in various tissues with preferences for different steroid substrates (Biswas, M. G. and D. W. Russell (1997) J. Biol. Chem. 272:15959-15966). For example, 17βHSD1 preferentially reduces estradiol and is abundant in the ovary and placenta. 17βHSD2 catalyzes oxidation of androgens and is present in the endometrium and placenta. 17βHSD3 is exclusively a reductive enzyme in the testis (Geissler, W. M. et al. (1994) Nature Genet. 7:34-39). An excess of androgens such as DHTT can contribute to diseases such as benign prostatic hyperplasia and prostate cancer.

The oxidoreductase isocitrate dehydrogenase catalyzes the conversion of isocitrate to a-ketoglutarate, a substrate of the citric acid cycle. Isocitrate dehydrogenase can be either NAD or NADP dependent, and is found in the cytosol, mitochondria, and peroxisomes. Activity of isocitrate dehydrogenase is regulated developmentally, and by hormones, neurotransmitters, and growth factors.

Hydroxypyruvate reductase (HPR), a peroxisomal 2-hydroxyacid dehydrogenase in the glycolate pathway, catalyzes the conversion of hydroxypyruvate to glycerate with the oxidation of both NADH and NADPH. The reverse dehydrogenase reaction reduces NAD⁺ and NADP⁺. HPR recycles nucleotides and bases back into pathways leading to the synthesis of ATP and GTP, which are used to produce DNA and RNA and to control various aspects of signal transduction and energy metabolism. Purine nucleotide biosynthesis inhibitors are used as antiproliferative agents to treat cancer and viral diseases. HPR also regulates biochemical synthesis of serine and cellular serine levels available for protein synthesis.

The mitochondrial electron transport (or respiratory) chain is the series of oxidoreductase-type enzyme complexes in the mitochondrial membrane that is responsible for the transport of electrons from NADH to oxygen and the coupling of this oxidation to the synthesis of ATP (oxidative phosphorylation). ATP provides energy to drive energy-requiring reactions. The key respiratory chain complexes are NADH:ubiquinone oxidoreductase (complex I), succinate:ubiquinone oxidoreductase (complex II), cytochrome c₁-b oxidoreductase (complex III), cytochrome c oxidase (complex IV), and ATP synthase (complex V) (Alberts, B. et al. (1994) Molecular Biology of the Cell, Garland Publishing, Inc., New York, N.Y., pp. 677-678). All of these complexes are located on the inner matrix side of the mitochondrial membrane except complex II, which is on the cytosolic side where it transports electrons generated in the citric acid cycle to the respiratory chain. Electrons released in oxidation of succinate to fumarate in the citric acid cycle are transferred through electron carriers in complex II to membrane bound ubiquinone (Q). Transcriptional regulation of these nuclear-encoded genes controls the biogenesis of respiratory enzymes. Defects and altered expression of enzymes in the respiratory chain are associated with a variety of disease conditions.

Other dehydrogenase activities using NAD as a cofactor include 3-hydroxyisobutyrate dehydrogenase (3HBD), which catalyzes the NAD-dependent oxidation of 3-hydroxyisobutyrate to methylmalonate semialdehyde within mitochondria. 3-hydroxyisobutyrate levels are elevated in ketoacidosis, methylmalonic acidemia, and other disorders (Rougraff, P. M. et al. (1989) J. Biol. Chem. 264:5899-5903). Another mitochondrial dehydrogenase important in amino acid metabolism is the enzyme isovaleryl-CoA-dehydrogenase (IVD). IVD is involved in leucine metabolism and catalyzes the oxidation of isovaleryl-CoA to 3-methylcrotonyl-CoA. Human IVD is a tetrameric flavoprotein synthesized in the cytosol with a mitochondrial import signal sequence. A mutation in the gene encoding IVD results in isovaleric acidemia (Vockley, J. et al. (1992) J. Biol. Chem. 267:2494-2501).
The family of glutathione peroxidases encompass tetrameric glutathione peroxidases (GPx1-3) and the monomeric phospholipid hydroperoxide glutathione peroxidase (PHGPx/GPx4). Although the overall homology between the tetrameric enzymes and GPx4 is less than 30%, a pronounced similarity has been detected in clusters involved in the active site and a common catalytic triad has been defined by structural and kinetic data (Epp, O. et al. (1983) Eur. J. Biochem. 133:51-69). GPx1 is ubiquitously expressed in cells, whereas GPx2 is present in the liver and colon, and GPx3 is present in plasma. GPx4 is found at low levels in all tissues but is expressed at high levels in the testis (Ursini, F. et al (1995) Meth. Enzymol. 252:38-53). GPx4 is the only monomeric glutathione peroxidase found in mammals and the only mammalian glutathione peroxidase to show high affinity for and reactivity with phospholipid hydroperoxides, and to be membrane associated. A tandem mechanism for the antioxidant activities of GPx4 and vitamin E has been suggested. GPx4 has alternative transcription and translation start sites which determine its subcellular localization (Esworthy, R. S. et al. (1994) Gene 144:317-318; and Maiorino, M. et al. (1990) Meth. Enzymol. 186:448-450).

The glutathione S-transferases (GST) are a ubiquitous family of enzymes with dual substrate specificities that perform important biochemical functions of xenobiotic biotransformation and detoxification, drug metabolism, and protection of tissues against peroxidative damage. They catalyze the conjugation of an electrophile with reduced glutathione (GSH) which results in either activation or deactivation/detoxification. The absolute requirement for binding reduced GSH to a variety of chemicals necessitates a diversity in GST structures in various organisms and cell types. GSTs are homodimeric or heterodimeric proteins localized in the cytosol. The major isozymes share common structural and catalytic properties and include four major classes, Alpha, Mu, Pi, and Theta. Each GST possesses a common binding site for GSH, and a variable hydrophobic binding site specific for its particular electrophilic substrates. Specific amino acid residues within GSTs have been identified as important for these binding sites and for catalytic activity. Residues Q67, T68, D101, E104, and R131 are important for the binding of GSH (Lee, H.-C. et al. (1995) J. Biol. Chem. 270:99-109). Residues R13, R20, and R69 are important for the catalytic activity of GST (Stenberg, G. et al. (1991) Biochem. J. 274:549-555).

GSTs normally deactivate and detoxify potentially mutagenic and carcinogenic chemicals. Some forms of rat and human GSTs are reliable preneoplastic markers of carcinogenesis. Dihalomethanes, which produce liver tumors in mice, are believed to be activated by GST (Thier, R. et al. (1993) Proc. Natl. Acad. Sci. USA 90:8567-8580). The mutagenicity of ethylene dibromide and ethylene dichloride is increased in bacterial cells expressing the human Alpha GST, A1-1, while the mutagenicity of aflatoxin B1 is substantially reduced by enhancing the expression of GST (Simula, T. P. et al. (1993) Carcinogenesis 14:1371-1376). Thus, control of GST activity may be useful in the control of mutagenesis and carcinogenesis.

GST has been implicated in the acquired resistance of many cancers to drug treatment, the phenomenon known as multi-drug resistance (MDR). MDR occurs when a cancer patient is treated with a cytotoxic drug such as cyclophosphamide and subsequently becomes resistant to this drug and to a variety of other cytotoxic agents as well. Increased GST levels are associated with some drug resistant cancers, and it is believed that this increase occurs in response to the drug agent which is then deactivated by the GST catalyzed GSH conjugation reaction. The increased GST levels then protect the cancer cells from other cytotoxic agents for which GST has affinity. Increased levels of A1-1 in tumors has been linked to drug resistance induced by cyclophosphamide treatment (Dirven, H. A. et al. (1994) Cancer Res. 54:6215-6220). Thus control of GST activity in cancerous tissues may be useful in treating MDR in cancer patients.

The reduction of ribonucleotides to the corresponding deoxyribonucleotides, needed for DNA synthesis during cell proliferation, is catalyzed by the enzyme ribonucleotide diphosphate reductase. Glutaredoxin is a glutathione (GSH)-dependent hydrogen donor for ribonucleotide diphosphate reductase and contains the active site consensus sequence -C-P-Y-C-. This sequence is conserved in glutaredoxins from such different organisms as Escherichia coli, vaccinia virus, yeast, plants, and mammalian cells. Glutaredoxin has inherent GSH-disulfide oxidoreductase (thioltransferase) activity in a coupled system with GSH, NADPH, and GSH-reductase, catalyzing the reduction of low molecular weight disulfides as well as proteins. Glutaredoxin has been proposed to exert a general thiol redox control of protein activity by acting both as an effective protein disulfide reductase, similar to thioredoxin, and as a specific GSH-mixed disulfide reductase (Padilla, C. A. et al. (1996) FEBS Lett. 378:69-73).

In addition to their important role in DNA synthesis and cell division, glutaredoxin and other thioproteins provide effective antioxidant defense against oxygen radicals and hydrogen peroxide (Schalireuter, K. U. and J. M. Wood (1991) Melanoma Res. 1:159-167). Glutaredoxin is the principal agent responsible for protein dethiolation in vivo and reduces dehydroascorbic acid in normal human neutrophils (Jung, C. H. and J. A. Thomas (1996) Arch. Biochem. Biophys. 335:61-72; Park, J. B. and M. Levine (1996) Biochem. J. 315:931-938). T

The thioredoxin system serves as a hydrogen donor for ribonucleotide reductase and as a regulator of enzymes by redox control. It also modulates the activity of transcription factors such as NF-.kappa.B, AP-1, and steroid receptors. Several cytokines or secreted cytokine-like factors such as adult T-cell leukemia-derived factor, 3B6-interleukin-1, T-hybridoma-derived (MP-6) B cell stimulatory factor, and early pregnancy factor have been reported to be identical to thioredoxin (Holmgren, A. (1985) Annu. Rev. Biochem. 54:237-271; Abate, C. et al. (1990) Science 249:1157-1161; Tagaya, Y. et al. (1989) EMBO J. 8:757-764; Wakasugi, H. (1987) Proc. Natl. Acad. Sci. USA 84:804-808; Rosen, A. et al. (1995) Int. Immunol. 7:625-633). Thus thioredoxin secreted by stimulated lymphocytes (Yodoi, J. and T. Tursz (1991) Adv. Cancer Res. 57:381-411; Tagaya, N. et al. (1990) Proc. Natl. Acad. Sci. USA 87:8282-8286) has extracellular activities including a role as a regulator of cell growth and a mediator in the immune system (Miranda-Vizuete, A. et al. (1996) J. Biol. Chem. 271:19099-19103; Yamauchi, A. et al. (1992) Mol. Immunol. 29:263-270). Thioredoxin and thioredoxin reductase protect against cytotoxicity mediated by reactive oxygen species in disorders such as Alzheimer's disease (Lovell, M. A. (2000) Free Radic. Biol. Med. 28:418-427).

The selenoprotein thioredoxin reductase is secreted by both normal and neoplastic cells and has been implicated as both a growth factor and as a polypeptide involved in apoptosis (Soderberg, A. et al. (2000) Cancer Res. 60:2281-2289). An extracellular plasmin reductase secreted by hamster ovary cells (HT-1080) has been shown to participate in the generation of angiostatin from plasmin. In this case, the reduction of the plasmin disulfide bonds triggers the proteolytic cleavage of plasmin which yields the angiogenesis inhibitor, angiostatin (Stathakis, P. et al. (1997) J. Biol. Chem. 272:20641-20645). Low levels of reduced sulfhydryl groups in plasma has been associated with rheumatoid arthritis. The failure of these sulfhydryl groups to scavenge active oxygen species (e.g., hydrogen peroxide produced by activated neutrophils) results in oxidative damage to surrounding tissues and the resulting inflammation (Hall, N. D. et al. (1994) Rheumatol. Int. 4:35-38).

Another example of the importance of redox reactions in cell metabolism is the degradation of saturated and unsaturated fatty acids by mitochondrial and peroxisomal beta-oxidation enzymes which sequentially remove two-carbon units from Coenzyme A (CoA)-activated fatty acids. The main beta-oxidation pathway degrades both saturated and unsaturated fatty acids while the auxiliary pathway performs additional steps required for the degradation of unsaturated fatty acids.

The pathways of mitchondrial and peroxisomal beta-oxidation use similar enzymes, but have different substrate specificities and functions. Mitochondria oxidize short-, medium-, and long-chain fatty acids to produce energy for cells. Mitochondrial beta-oxidation is a major energy source for cardiac and skeletal muscle. In liver, it provides ketone bodies to the peripheral circulation when glucose levels are low as in starvation, endurance exercise, and diabetes (Eaton, S. et al. (1996) Biochem. J. 320:345-357). Peroxisomes oxidize medium-, long-, and very-long-chain fatty acids, dicarboxylic fatty acids, branched fatty acids, prostaglandins, xenobiotics, and bile acid intermediates. The chief roles of peroxisomal beta-oxidation are to shorten toxic lipophilic carboxylic acids to facilitate their excretion and to shorten very-long-chain fatty acids prior to mitochondrial beta-oxidation (Mannaerts, G. P. and P. P. Van Veldhoven (1993) Biochimie 75:147-158).

The auxiliary beta-oxidation enzyme 2,4-dienoyl-CoA reductase catalyzes the following reaction:

trans-2, cis/trans-4-dienoyl-CoA+NADPH+H⁺→trans-3-enoyl-CoA+NA-DP⁺

This reaction removes even-numbered double bonds from unsaturated fatty acids prior to their entry into the main beta-oxidation pathway (Koivuranta, K. T. et al. (1994) Biochem. J. 304:787-792). The enzyme may also remove odd-numbered double bonds from unsaturated fatty acids (Smeland, T. E. et al. (1992) Proc. Natl. Acad. Sci. USA 89:6673-6677).

Rat 2,4-dienoyl-CoA reductase is located in both mitochondria and peroxisomes (Dommes, V. et al. (1981) J. Biol. Chem. 256:8259-8262). Two immunologically different forms of rat mitochondrial enzyme exist with molecular masses of 60 kDa and 120 kDa (Hakkola, E. H. and J. K. Hiltunen (1993) Eur. J. Biochem. 215:199-204). The 120 kDa mitochondrial rat enzyme is synthesized as a 335 amino acid precursor with a 29 amino acid N-terminal leader peptide which is cleaved to form the mature enzyme (Hirose, A. et al. (1990) Biochim. Biophys. Acta 1049:346-349). A human mitochondrial enzyme 83% similar to rat enzyme is synthesized as a 335 amino acid residue precursor with a 19 amino acid N-terminal leader peptide (Koivuranta et al., supra). These cloned human and rat mitochondrial enzymes function as homotetramers (Koivuranta et al., supra). A Saccharomyces cerevisiae peroxisomal 2,4-dienoyl-CoA reductase is 295 amino acids long, contains a C-terminal peroxisomal targeting signal, and functions as a homodimer (Coe, J. G. S. et al. (1994) Mol. Gen. Genet. 244:661-672; and Gurvitz, A. et al. (1997) J. Biol. Chem. 272:22140-22147). All 2,4-dienoyl-CoA reductases have a fairly well conserved NADPH binding site motif (Koivuranta et al., supra).

The main pathway beta-oxidation enzyme enoyl-CoA hydratase catalyzes the reaction:

2-trans-enoyl-CoA+H₂O3-hydroxyacyl-CoA

This reaction hydrates the double bond between C-2 and C-3 of 2-trans-enoyl-CoA, which is generated from saturated and unsaturated fatty acids (Engel, C. K. et al. (1996) EMBO J. 15:5135-5145). This step is downstream from the step catalyzed by 2,4dienoyl-reductase. Different enoyl-CoA hydratases act on short-, medium-, and long-chain fatty acids (Eaton et al., supra). Mitochondrial and peroxisomal enoyl-CoA hydratases occur as both mono-functional enzymes and as part of multi-functional enzyme complexes. Human liver mitochondrial short-chain enoyl-CoA hydratase is synthesized as a 290 amino acid precursor with a 29 amino acid N-terminal leader peptide (Kanazawa, M. et al. (1993) Enzyme Protein 47:9-13; and Janssen, U. et al. (1997) Genomics 40:470-475). Rat short-chain enoyl-CoA hydratase is 87% identical to the human sequence in the mature region of the protein and functions as a to homohexamer (Kanazawa et al., supra; and Engel et al., supra). A mitochondrial trifunctional protein exists that has long-chain enoyl-CoA hydratase, 3-hydroxyacyl-CoA dehydrogenase, and long-chain 3-oxothiolase activities (Eaton et al., supra). In human peroxisomes, enoyl-CoA hydratase activity is found in both a 327 amino acid residue mono-functional enzyme and as part of a multi-functional enzyme, also known as bifunctional enzyme, which possesses enoyl-CoA hydratase, enoyl-CoA isomerase, and 3-hydroxyacyl-CoA hydrogenase activities (FitzPatrick, D. R. et al. (1995) Genomics 27:457-466; and Hoefler, G. et al. (1994) Genomics 19:60-67). A 339 amino acid residue human protein with short-chain enoyl-CoA hydratase activity also acts as an AU-specific RNA binding protein (Nakagawa, J. et al. (1995) Proc. Natl. Acad. Sci. USA 92:2051-2055). All enoyl-CoA hydratases share homology near two active site glutamic acid residues, with 17 amino acid residues that are highly conserved (Wu, W.-J. et al. (1997) Biochemistry 36:2211-2220).

Inherited deficiencies in mitochondrial and peroxisomal beta-oxidation enzymes are associated with severe diseases, some of which manifest soon after birth and lead to death within a few years. Mitochondrial beta-oxidation associated deficiencies include, e.g., carnitine palmitoyl transferase and carnitine deficiency, very-long-chain acyl-CoA dehydrogenase deficiency, medium-chain acyl-CoA dehydrogenase deficiency, short-chain acyl-CoA dehydrogenase deficiency, electron transport flavoprotein and electron transport flavoprotein:ubiquinone oxidoreductase deficiency, trifunctional protein deficiency, and short-chain 3-hydroxyacyl-CoA dehydrogenase deficiency (Eaton et al., supra). Mitochondrial trifunctional protein (including enoyl-CoA hydratase) deficient patients have reduced long-chain enoyl-CoA hydratase activities and suffer from non-ketotic hypoglycemia, sudden infant death syndrome, cardiomyopathy, hepatic dysfunction, and muscle weakness, and may die at an early age (Eaton et al., supra).

Defects in mitochondrial beta-oxidation are associated with Reye's syndrome, a disease characterized by hepatic dysfunction and encephalopathy that sometimes follows viral infection in children. Reye's syndrome patients may have elevated serum levels of free fatty acids (Cotran, R. S. et al. (1994) Robbins Pathologic Basis of Disease, W.B. Saunders Co., Philadelphia Pa., p. 866). Patients with mitochondrial short-chain 3-hydroxyacyl-CoA dehydrogenase deficiency and medium-chain 3-hydroxyacyl-CoA dehydrogenase deficiency also exhibit Reye-like illnesses (Eaton et al., supra; and Egidio, R. J. et al. (1989) Am. Fam. Physician 39:221-226).

Inherited conditions associated with peroxisomal beta-oxidation include Zellweger syndrome, neonatal adrenoleukodystrophy, infantile Refsum's disease, acyl-CoA oxidase deficiency, peroxisomal thiolase deficiency, and bifunctional protein deficiency (Suzuki, Y. et al. (1994) Am. J. Hum. Genet. 54:36-43; Hoefler et al., supra). Patients with peroxisomal bifunctional enzyme deficiency, including that of enoyl-CoA hydratase, suffer from hypotonia, seizures, psychomotor defects, and defective neuronal migration; accumulate very-long-chain fatty acids; and typically die within a few years of birth (Watkins, P. A. et al. (1989) J. Clin. Invest. 83:771-777).

Peroxisomal beta-oxidation is impaired in cancerous tissue. Although neoplastic human breast epithelial cells have the same number of peroxisomes as do normal cells, fatty acyl-CoA oxidase activity is lower than in control tissue (el Bouhtoury, F. et al. (1992) J. Pathol. 166:27-35). Human colon carcinomas have fewer peroxisomes than normal colon tissue and have lower fatty-acyl-CoA oxidase and bifunctional enzyme (including enoyl-CoA hydratase) activities than normal tissue (Cable, S. et al. (1992) Virchows Arch. B Cell Pathol. Incl. Mol. Pathol. 62:221-226).

6-phosphogluconate dehydrogenase (6-PGDH) catalyses the NADP⁺-dependent oxidative decarboxylation of 6-phosphogluconate to ribulose 5-phosphate with the production of NADPH. The absence or inhibition of 6-PGDH results in the accumulation of 6-phosphogluconate to toxic levels in eukaryotic cells. 6-PGDH is the third enzyme of the pentose phosphate pathway (PPP) and is ubiquitous in nature. In some heterofermentatative species, NAD+ is used as a cofactor with the subsequent production of NADH.

The reaction proceeds through a 3-keto intermediate which is decarboxylated to give the enol of ribulose 5-phosphate, then converted to the keto product following tautomerization of the enol (Berdis A. J. and P. F. Cook (1993) Biochemistry 32:2041-2046). 6-PGDH activity is regulated by the inhibitory effect of NADPH, and the activating effect of 6-phosphogluconate (Rippa, M. et al. (1998) Biochim. Biophys. Acta 1429:83-92). Deficiencies in 6-PGDH activity have been linked to chronic hemolytic anemia.

The targeting of specific forms of 6-PGDH (e.g., enzymes found in trypanosomes) has been suggested as a means for controlling parasitic infections (Tetaud, E. et al. (1999) Biochem. J. 338:55-60). For example, the Trypanosoma brucei enzyme is markedly more sensitive to inhibition by the substrate analogue 6-phospho-2-deoxygluconate and the coenzyme analogue adenosine 2′,5′-bisphosphate, compared to the mammalian enzyme (Hanau, S. et al. (1996) Eur. J. Biochem. 240:592-599).

Ribonucleotide diphosphate reductase catalyzes the reduction of ribonucleotide diphosphates (i.e., ADP, GDP, CDP, and UDP) to their corresponding deoxyribonucleotide diphosphates (i.e., dADP, dGDP, dCDP, and dUDP) which are used for the synthesis of DNA. Ribonucleotide diphosphate reductase thereby performs a crucial role in the de novo synthesis of deoxynucleotide precursors. Deoxynucleotides are also produced from deoxynucleosides by nucleoside kinases via the salvage pathway.

Mammalian ribonucleotide diphosphate reductase comprises two components, an effector-binding component (E) and a non-heme iron component (F). Component E binds the nucleoside triphosphate effectors while component F contains the iron radical necessary for catalysis. Molecular weight determinations of the E and F components, as well as the holoenzyme, vary according to the methods used in purification of the proteins and the particular laboratory. Component E is approximately 90-100 kDa, component F is approximately 100-120 kDa, and the holoenzyme is 200-250 kDa.

Ribonucleotide diphosphate reductase activity is adversely effected by iron chelators, such as thiosemicarbazones, as well as EDTA. Deoxyribonucleotide diphosphates also appear to be negative allosteric effectors of ribonucleotide diphosphate reductase. Nucleotide triphosphates (both ribo- and deoxyribo-) appear to stimulate the activity of the enzyme. 3-methyl-4-nitrophenol, a metabolite of widely used organophosphate pesticides, is a potent inhibitor of ribonucleotide diphosphate reductase in mammalian cells. Some evidence suggests that ribonucleotide diphosphate reductase activity in DNA virus (e.g., herpes virus)-infected cells and in cancer cells is less sensitive to regulation by allosteric regulators and a correlation exists between high ribonucleotide diphosphate reductase activity levels and high rates of cell proliferation (e.g., in hepatomas). This observation suggests that virus-encoded ribonucleotide diphosphate reductases, and those present in cancer cells, are capable of maintaining an increased supply deoxyribonucleotide pool for the production of virus genomes or for the increased DNA synthesis which characterizes cancers cells. Ribonucleotide diphosphate reductase is thus a target for therapeutic intervention (Nutter, L. M. and Y.-C. Cheng (1984) Pharmac. Ther. 26:191-207; and Wright, J. A. (1983) Pharmac. Ther. 22:81-102).

Dihydrodiol dehydrogenases (DD) are monomeric, NAD(P)⁺-dependent, 34-37 kDa enzymes responsible for the detoxification of trans-dihydrodiol and anti-diol epoxide metabolites of polycyclic aromatic hydrocarbons (PAH) such as benzo[α]yrene, benz[α]anthracene, 7-methyl-benz[α]anthracene, 7,12-dimethyl-benz[α]anthracene, chrysene, and 5-methyl-chrysene. In mammalian cells, an environmental PAH toxin such as benzo[α]yrene is initially epoxidated by a microsomal cytochrome P450 to yield 7R,8R-arene-oxide and subsequently (−)-7R,8R-dihydrodiol ((−)-trans-7,8-dihydroxy-7,8-dihydrobenzo[α]pyrene or (−)-trans-B [α]P-diol) This latter compound is further transformed to the anti-diol epoxide of benzo[α]pyrene (i.e., (.+−.)-anti-7β,8α-dihydroxy-9α,10α-epoxy-7,8,9,10-tetrahydrobenzol[α]pyrene), by the same enzyme or a different enzyme, depending on the species. This resulting anti-diol epoxide of benzo[α]yrene, or the corresponding derivative from another PAH compound, is highly mutagenic. DD efficiently oxidizes the precursor of the anti-diol epoxide (i.e., trans-dihydrodiol) to transient catechols which auto-oxidize to quinones, also producing hydrogen peroxide and semiquinone radicals. This reaction prevents the formation of the highly carcinogenic anti-diol. Anti-diols are not themselves substrates for DD yet the addition of DD to a sample comprising an anti-diol compound results in a significant decrease in the induced mutation rate observed in the Ames test. In this instance, DD is able to bind to and sequester the anti-diol, even though it is not oxidized. Whether through oxidation or sequestration, DD plays an important role in the detoxification of metabolites of xenobiotic polycyclic compounds (Penning, T. M. (1993) Chemico-Biological Interactions 89:1-34).

15-oxoprostaglandin 13-reductase (PGR) and 15-hydroxyprostaglandin dehydrogenase (15-PGDH) are enzymes present in the lung that are responsible for degrading circulating prostaglandins. Oxidative catabolism via passage through the pulmonary system is a common means of reducing the concentration of circulating prostaglandins. 15-PGDH oxidizes the 15-hydroxyl group of a variety of prostaglandins to produce the corresponding 15-oxo compounds. The 15-oxo derivatives usually have reduced biological activity compared to the 15-hydroxyl molecule. PGR further reduces the 13,14 double bond of the 15-oxo compound which typically leads to a further decrease in biological activity. PGR is a monomer with a molecular weight of approximately 36 kDa. The enzyme requires NADH or NADPH as a cofactor with a preference for NADH. The 15-oxo derivatives of prostaglandins PGE₁, PGE₂, and PGE₂a, are all substrates for PGR; however, the non-derivatized prostaglandins (i.e., PGE₁, PG₂, and PGE₂α) are not substrates (Ensor, C. M. et al. (1998) Biochem. J. 330:103-108).

15-PGDH and PGR also catalyze the metabolism of lipoxin A₂ (LXA₄). Lipoxins (LX) are autacoids, lipids produced at the sites of localized inflammation, which down-regulate polymorphonuclear leukocyte (PMN) function and promote resolution of localized trauma. Lipoxin production is stimulated by the administration of aspirin in that cells displaying cyclooxygenase II (COX II) that has been acetylated by aspirin and cells that possess 5-lipoxygenase (5-LO) interact and produce lipoxin. 15-PGDH generates 15-oxo-LXA₄ with PGR further converting the 15-oxo compound to 13,14-dihydro-15-oxo-LXA₄ (Clish, C. B. et al. (2000) J. Biol. Chem. 275:25372-25380). This finding suggests a broad substrate specificity of the prostaglandin dehydrogenases and has implications for these enzymes in drug metabolism and as targets for therapeutic intervention to regulate inflammation.

The GMC (glucose-methanol-choline) oxidoreductase family of enzymes was defined based on sequence alignments of Drosophila melanogaster glucose dehydrogenase, Escherichia coli choline dehydrogenase, Aspergillus niger glucose oxidase, and Hansenula polymorpha methanol oxidase. Despite their different sources and substrate specificities, these four flavoproteins are homologous, being characterized by the presence of several distinctive sequence and structural features. Each molecule contains a canonical ADP-binding, beta-alpha-beta mononucleotide-binding motif close to the amino terminus. This fold comprises a four-stranded parallel beta-sheet sandwiched between a three-stranded antiparallel beta-sheet and alpha-helices. Nucleotides bind in similar positions relative to this chain fold (Cavener, D. R. (1992) J. Mol. Biol. 223:811-814; Wierenga, R. K. et al. (1986) J. Mol. Biol. 187:101-107). Members of the GMC oxidoreductase family also share a consensus sequence near the central region of the polypeptide. Additional members of the GMC oxidoreductase family include cholesterol oxidases from Brevibacterium sterolicum and Streptomyces; and an alcohol dehydrogenase from Pseudomonas oleovorans (Cavener, supra; Henikoff, S, and J. G. Henikoff (1994) Genomics 19:97-107; van Beilen, J. B. et al. (1992) Mol. Microbiol. 6:3121-3136).

IMP dehydrogenase and GMP reductase are two oxidoreductases which share many regions of sequence similarity. IMP dehydrogenase (EC 1.1.1.205) catalyes the NAD-dependent reduction of IMP (inosine monophosphate) into XMP (xanthine monophosphate) as part of de novo GTP biosynthesis (Collart, F. R. and E. Huberman (1988) J. Biol. Chem. 263:15769-15772). GMP reductase catalyzes the NADPH-dependent reductive deamination of GMP into IMP, helping to maintain the intracellular balance of adenine and guanine nucleotides (Andrews, S.C. and J. R. Guest (1988) Biochem. J. 255:35-43).

Pyridine nucleotide-disulphide oxidoreductases are FAD flavoproteins involved in the transfer of reducing equivalents from FAD to a substrate. These flavoproteins contain a pair of redox-active cysteines contained within a consensus sequence which is characteristic of this protein family (Kurlyan, J. et al. (1991) Nature 352:172-174). Members of this family of oxidoreductases include glutathione reductase (C 1.6.4.2); thioredoxin reductase of higher eukaryotes (EC 1.6.4.5); trypanothione reductase (EC 1.6.4.8); lipoamide dehydrogenase (EC 1.8.1.4), the E3 component of alpha-ketoacid dehydrogenase complexes; and mercuric reductase (EC 1.16.1.1).

### Transferases

Transferases are enzymes that catalyze the transfer of molecular groups. The reaction may involve an oxidation, reduction, or cleavage of covalent bonds, and is often specific to a substrate or to particular sites on a type of substrate. Transferases participate in reactions essential to such functions as synthesis and degradation of cell components, and regulation of cell functions including cell signaling, cell proliferation, inflammation, apoptosis, secretion and excretion. Transferases are involved in key steps in disease processes involving these functions. Transferases are frequently classified according to the type of group transferred. For example, methyl transferases transfer one-carbon methyl groups, amino transferases transfer nitrogenous amino groups, and similarly denominated enzymes transfer aldehyde or ketone, acyl, glycosyl, alkyl or aryl, isoprenyl, saccharyl, phosphorous-containing, sulfur-containing, or selenium-containing groups, as well as small enzymatic groups such as Coenzyme A.

Acyl transferases include peroxisomal carnitine octanoyl transferase, which is involved in the fatty acid beta-oxidation pathway, and mitochondrial carnitine palmitoyl transferases, involved in fatty acid metabolism and transport. Choline O-acetyl transferase catalyzes the biosynthesis of the neurotransmitter acetylcholine. N-acyltransferase enzymes catalyze the transfer of an amino acid conjugate to an activated carboxylic group. Endogenous compounds and xenobiotics are activated by acyl-CoA synthetases in the cytosol, microsomes, and mitochondria. The acyl-CoA intermediates are then conjugated with an amino acid (typically glycine, glutamine, or taurine, but also ornithine, arginine, histidine, serine, aspartic acid, and several dipeptides) by N-acyltransferases in the cytosol or mitochondria to form a metabolite with an amide bond. One well-characterized enzyme of this class is the bile acid-CoA:amino acid N-acyltransferase (BAT) responsible for generating the bile acid conjugates which serve as detergents in the gastrointestinal tract (Falany, C. N. et al. (1994) J. Biol. Chem. 269:19375-19379; Johnson, M. R. et al. (1991) J. Biol. Chem. 266:10227-10233). BAT is also useful as a predictive indicator for prognosis of hepatocellular carcinoma patients after partial hepatectomy (Furutani, M. et al. (1996) Hepatology 24:1441-1445).

### Acetyltransferases

Acetyltransferases have been extensively studied for their role in histone acetylation. Histone acetylation results in the relaxing of the chromatin structure in eukaryotic cells, allowing transcription factors to gain access to promoter elements of the DNA templates in the affected region of the genome (or the genome in general). In contrast, histone deacetylation results in a reduction in transcription by closing the chromatin structure and limiting access of transcription factors. To this end, a common means of stimulating cell transcription is the use of chemical agents that inhibit the deacetylation of histones (e.g., sodium butyrate), resulting in a global (albeit artifactual) increase in gene expression. The modulation of gene expression by acetylation also results from the acetylation of other proteins, including but not limited to, p53, GATA-1, MyoD, ACTR, TFIIE, TFIIF and the high mobility group proteins (HMG). In the case of p53, acetylation results in increased DNA binding, leading to the stimulation of transcription of genes regulated by p53. The prototypic histone acetylase (HAT) is Gcn5 from Saccharomyces cerevisiae. Gcn5 is a member of a family of acetylases that includes Tetrahymena p55, human Gcn5, and human p300/CBP. Histone acetylation is reviewed in (Cheung, W. L. et al. (2000) Curr. Opin. Cell Biol. 12:326-333 and Berger, S. L. (1999) Curr. Opin. Cell Biol. 11:336-341). Some acetyltransferase enzymes possess the alpha/beta hydrolase fold (Center of Applied Molecular Engineering Inst. of Chemistry and Biochemistry—University of Salzburg, http://predict.sanger.ac.uk/irbm-co-urse97/Docs/ms/) common to several other major classes of enzymes, including but not limited to, acetylcholinesterases and carboxylesterases (Structural Classification of Proteins, http:flscop.mrc-1mb.cam.ac.u1c/sco-p/index.html).

N-acetyltransferases are cytosolic enzymes which utilize the cofactor acetyl-coenzyme A (acetyl-CoA) to transfer the acetyl group to aromatic amines and hydrazine containing compounds. In humans, there are two highly similar N-acetyltransferase enzymes, NAT1 and NAT2; mice appear to have a third form of the enzyme, NAT3. The human forms of N-acetyltransferase have independent regulation (NAT1 is widely-expressed, whereas NAT2 is in liver and gut only) and overlapping substrate preferences. Both enzymes appear to accept most substrates to some extent, but NAT1 does prefer some substrates (para-aminobenzoic acid, para-aminosalicylic acid, sulfamethoxazole, and sulfanilamide), while NAT2 prefers others (isoniazid, hydralazine, procainamide, dapsone, aminoglutethimide, and sulfamethazine). A recently isolated human gene, tubedown-1, is homologous to the yeast NAT-1 N-acetyltransferases and encodes a protein associated with acetyltransferase activity. The expression patterns of tubedown-1 suggest that it may be involved in regulating vascular and hematopoietic development (Gendron, R. L. et al. (2000) Dev. Dyn. 218:300-315).

Amino transferases comprise a family of pyridoxal 5′-phosphate (PLP)-dependent enzymes that catalyze transformations of amino acids. Amino transferases play key roles in protein synthesis and degradation, and they contribute to other processes as well. For example, GABA aminotransferase (GABA-T) catalyzes the degradation of GABA, the major inhibitory amino acid neurotransmitter. The activity of GABA-T is correlated to neuropsychiatric disorders such as alcoholism, epilepsy, and Alzheimer's disease (Sherif, F. M. and S. S. Ahmed (1995) Clin. Biochem. 28:145-154). Other members of the family include pyruvate aminotransferase, branched-chain amino acid aminotransferase, tyrosine aminotransferase, aromatic aminotransferase, alanine:glyoxylate aminotransferase (AGT), and kynurenine aminotransferase (Vacca, R. A. et al. (1997) J. Biol. Chem. 272:21932-21937). Kynurenine aminotransferase catalyzes the irreversible transamination of the L-tryptophan metabolite L-kynurenine to form kynurenic acid. The enzyme may also catalyzes the reversible transamination reaction between L-2-aminoadipate and 2-oxoglutarate to produce 2-oxoadipate and L-glutamate. Kynurenic acid is a putative modulator of glutamatergic neurotransmission, thus a deficiency in kynurenine aminotransferase may be associated with pleiotropic effects (Buchli, R. et al. (1995) J. Biol. Chem. 270:29330-29335).

Glycosyl transferases include the mammalian UDP-glucouronosyl transferases, a family of membrane-bound microsomal enzymes catalyzing the transfer of glucouronic acid to lipophilic substrates in reactions that play important roles in detoxification and excretion of drugs, carcinogens, and other foreign substances. Another mammalian glycosyl transferase, mammalian UDP-galactose-ceramide galactosyl transferase, catalyzes the transfer of galactose to ceramide in the synthesis of galactocerebrosides in myelin membranes of the nervous system. The UDP-glycosyl transferases share a conserved signature domain of about 50 amino acid residues (PROSITE: PD0000359, http://expasy.hcuge.ch/sprot/pro-site.html).

Methyl transferases are involved in a variety of pharmacologically important processes. Nicotinamide N-methyl transferase catalyzes the N-methylation of nicotinamides and other pyridines, an important step in the cellular handling of drugs and other foreign compounds. Phenylethanolamine N-methyl transferase catalyzes the conversion of noradrenalin to adrenalin. 6-O-methylguanine-DNA methyl transferase reverses DNA methylation, an important step in carcinogenesis. Uroporphyrin-III C-methyl transferase, which catalyzes the transfer of two methyl groups from S-adenosyl-L-methionine to uroporphyrinogen III, is the first specific enzyme in the biosynthesis of cobalamin, a dietary enzyme whose uptake is deficient in pernicious anemia. Protein-arginine methyl transferases catalyze the posttranslational methylation of arginine residues in proteins, resulting in the mono- and dimethylation of arginine on the guanidino group. Substrates include histones, myelin basic protein, and heterogeneous nuclear ribonucleoproteins involved in mRNA processing, splicing, and transport. Protein-arginine methyl transferase interacts with proteins upregulated by mitogens, with proteins involved in chronic lymphocytic leukemia, and with interferon, suggesting an important role for methylation in cytokine receptor signaling (Lin, W.-J. et al. (1996) J. Biol. Chem. 271:15034-15044; Abramovich, C. et al. (1997) EMBO J. 16:260-266; and Scott, H. S. et al. (1998) Genomics 48:330-340).

Phospho transferases catalyze the transfer of high-energy phosphate groups and are important in energy-requiring and -releasing reactions. The metabolic enzyme creatine kinase catalyzes the reversible phosphate transfer between creatine/creatine phosphate and ATP/ADP. Glycocyamine kinase catalyzes phosphate transfer from ATP to guanidoacetate, and arginine kinase catalyzes phosphate transfer from ATP to arginine. A cysteine-containing active site is conserved in this family (PROSITE: PD0000103).

Prenyl transferases are heterodimers, consisting of an alpha and a beta subunit, that catalyze the transfer of an isoprenyl group. The Ras farnesyltransferase (FTase) enzyme transfers a farnesyl moiety from cytosolic farnesylpyrophosphate to a cysteine residue at the carboxyl terminus of the Ras oncogene protein. This modification is required to anchor Ras to the cell membrane so that it can perform its role in signal transduction. FTase inhibitors block Ras function and demonstrate antitumor activity (Buolamwini, J. K. (1999) Curr. Opin. Chem. Biol. 3:500-509). Ftase, which shares structural similarity with geranylgeranyl transferase, or Rab GG transferase, prenylates Rab proteins, allowing them to perform their roles in regulating vesicle transport (Seabra, M. C. (1996) J. Biol. Chem. 271:14398-14404).

Saccharyl transferases are glycating enzymes involved in a variety of metabolic processes. Oligosaccharyl transferase-48, for example, is a receptor for advanced glycation endproducts, which accumulate in vascular complications of diabetes, macrovascular disease, renal insufficiency, and Alzheimer's disease (Thornalley, P. J. (1998) Cell Mol. Biol. (Noisy-Le-Grand) 44:1013-1023).

Coenzyme A (CoA) transferase catalyzes the transfer of CoA between two carboxylic acids. Succinyl CoA:3-oxoacid CoA transferase, for example, transfers CoA from succinyl-CoA to a recipient such as acetoacetate. Acetoacetate is essential to the metabolism of ketone bodies, which accumulate in tissues affected by metabolic disorders such as diabetes (PROSITE: PD0000980).

Transglutaminase transferases (Tgases) are Ca²⁺ dependent enzymes capable of forming isopeptide bonds by catalyzing the transfer of the γ-carboxy group from protein-bound glutamine to the .epsilon.-amino group of protein-bound lysine residues or other primary amines. Tgases are the enzymes responsible for the cross-lining of cornified envelope (CE), the highly insoluble protein structure on the surface of corneocytes, into a chemically and mechanically resistant protein polymer. Seven known human Tgases have been identified. Individual transglutaminase gene products are specialized in the cross-linking of specific proteins or tissue structures, such as factor XIIIa which stabilizes the fibrin clot in hemostasis, prostrate transglutaminase which functions in semen coagulation, and tissue transglutaminase which is involved in GTP-binding in receptor signaling. Four (Tgases 1, 2, 3, and X) are expressed in terminally differentiating epithelia such as the epidermis. Tgases are critical for the proper cross-inking of the CE as seen in the pathology of patients suffering from one form of the skin diseases referred to as congenital ichthyosis which has been linked to mutations in the keratinocyte transglutaminase (TG_{K}) gene (Nemes, Z. et al. (1999) Proc. Natl. Acad. Sci. U.S.A. 96:8402-8407, Aeschlimann, D. et al. (1998) J. Biol. Chem. 273:3452-3460.)

### Hydrolases

Hydrolases are a class of enzymes that catalyze the cleavage of various covalent bonds in a substrate by the introduction of a molecule of water. The reaction involves a nucleophilic attack by the water molecule's oxygen atom on a target bond in the substrate. The water molecule is split across the target bond, breaking the bond and generating two product molecules. Hydrolases participate in reactions essential to such functions as synthesis and degradation of cell components, and for regulation of cell functions including cell signaling, cell proliferation, inflammation, apoptosis, secretion and excretion. Hydrolases are involved in key steps in disease processes involving these functions. Hydrolytic enzymes, or hydrolases, may be grouped by substrate specificity into classes including phosphatases, peptidases, lysophospholipases, phosphodiesterases, glycosidases, glyoxalases, aminohydrolases, carboxylesterases, sulfatases, phosphohydrolases, nucleotidases, lysozymes, and many others.

Phosphatases hydrolytically remove phosphate groups from proteins, an energy-providing step that regulates many cellular processes, including intracellular signaling pathways that in turn control cell growth and differentiation, cell-cell contact, the cell cycle, and oncogenesis.

Peptidases, also called proteases, cleave peptide bonds that form the backbone of peptide or protein chains. Proteolytic processing is essential to cell growth, differentiation, remodeling, and homeostasis as well as inflammation and the immune response. Since typical protein half-lives range from hours to a few days, peptidases are continually cleaving precursor proteins to their active form, removing signal sequences from targeted proteins, and degrading aged or defective proteins. Peptidases function in bacterial, parasitic, and viral invasion and replication within a host. Examples of peptidases include trypsin and chymotrypsin (components of the complement cascade and the blood-clotting cascade) lysosomal cathepsins, calpains, pepsin, renin, and chymosin (Beynon, R. J. and J. S. Bond (1994) Proteolytic Enzymes: A Practical Approach, Oxford University Press, New York, N.Y., pp. 1-5). Lysophospholipases (LPLs) regulate intracellular lipids by catalyzing the hydrolysis of ester bonds to remove an acyl group, a key step in lipid degradation. Small LPL isoforms, approximately 15-30 kD, function as hydrolases; larger isoforms function both as hydrolases and transacylases. A particular substrate for LPLs, lysophosphatidylcholine, causes lysis of cell membranes. LPL activity is regulated by signaling molecules important in numerous pathways, including the inflammatory response.

The phosphodiesterases catalyze the hydrolysis of one of the two ester bonds in a phosphodiester compound. Phosphodiesterases are therefore crucial to a variety of cellular processes. Phosphodiesterases include DNA and RNA endo- and exo-nucleases, which are essential to cell growth and replication as well as protein synthesis. Endonuclease V (deoxyinosine 3′-endonuclease) is an example of a type II site-specific deoxyribonuclease, a putative DNA repair enzyme that cleaves DNAs containing hypoxanthine, uracil, or mismatched bases. Escherichia coli endonuclease V has been shown to cleave DNA containing deoxyxanthosine at the second phosphodiester bond 3′ to deoxyxanthosine, generating a 3′-hydroxyl and a 5′-phosphoryl group at the nick site (He, B. et al. (2000) Mutat. Res. 459:109-114). It has been suggested that Escherichia coli endonuclease V plays a role in the removal of deaminated guanine, i.e., xanthine, from DNA, thus helping to protect the cell against the mutagenic effects of nitrosative deamination (Schouten, K. A. and B. Weiss (1999) Mutat. Res. 435:245-254). In eukaryotes, the process of tRNA splicing requires the removal of small tRNA introns that interrupt the anticodon loop 1 base 3′ to the anticodon. This process requires the stepwise action of an endonuclease, a ligase, and a phosphotransferase (Hong, L. et al. (1998) Science 280:279-284). Ribonuclease P (RNase P) is a ubiquitous RNA processing endonuclease that is required for generating the mature tRNA 5′-end during the tRNA splicing process. This is accomplished through the catalysis of the cleavage of P-3′O bonds to produce 5′-phosphate and 3′-hydroxyl end groups at a specific site on pre-tRNA. Catalysis by RNase P is absolutely dependent on divalent cations such as Mg²⁺ or Mn²⁺ (Kurz, J. C. et al. (2000) Curr. Opin. Chem. Biol. 4:553-558). Substrate recognition mechanisms of RNase P are well conserved among eukaryotes and bacteria (Fan enzymei, S. et al. (1998) Science 280:284-286). In Saccharomyces cerevisiae, POP1 (‘processing of precursor RNAs’) encodes a protein component of both RNase P and RNase MRP, another RNA processing protein. Mutations in yeast POP1 are lethal (Lygerou, Z. et al. (1994) Genes Dev. 8:1423-1433). Another phosphodiesterase, acid sphingomyelinase, hydrolyzes the membrane phospholipid sphingomyelin to ceramide and phosphorylcholine. Phosphorylcholine functions in synthesis of phosphatidylcholine, which is involved in intracellular signaling pathways. Ceramide is an essential precursor for the generation of gangliosides, membrane lipids found in high concentration in neural tissue. Defective acid sphingomyelinase phosphodiesterase leads to Niemann-Pick disease.

Glycosidases catalyze the cleavage of hemiacetyl bonds of glycosides, which are compounds that contain one or more sugar. Mammalian lactase-phlorizin hydrolase, for example, is an intestinal enzyme that splits lactose. Mammalian beta-galactosidase removes the terminal galactose from gangliosides, glycoproteins, and glycosaminoglycans, and deficiency of this enzyme is associated with a gangliosidosis known as Morquio disease type B (PROSITE PCD0000910). Vertebrate lysosomal alpha-glucosidase, which hydrolyzes glycogen, maltose, and isomaltose, and vertebrate intestinal sucrase-isomaltase, which hydrolyzes sucrose, maltose, and isomaltose, are widely distributed members of this family with highly conserved sequences at their active sites.

The glyoxylase system is involved in gluconeogenesis, the production of glucose from storage compounds in the body. It consists of glyoxylase I, which catalyzes the formation of S-D-lactoylglutathione from methyglyoxal, a side product of triose-phosphate energy metabolism, and glyoxylase II, which hydrolyzes S-D-lactoylglutathione to D-lactic acid and reduced glutathione. Glyoxylases are involved in hyperglycemia, non-insulin-dependent diabetes mellitus, the detoxification of bacterial toxins, and in the control of cell proliferation and microtubule assembly. NG,NG-dimethylarginine dimethylaminohydrolase (DDAH) is an enzyme that hydrolyzes the endogenous nitric oxide synthase (NOS) inhibitors, NG-monomethyl-arginine and NG,NG-dimethyl-L-arginine, to L-citrulline. Inhibiting DDAH can cause increased intracellular concentration of NOS inhibitors to levels sufficient to inhibit NOS. Therefore, DDAH inhibition may provide a method of NOS inhibition, and changes in the activity of DDAH could play a role in pathophysiological alterations in nitric oxide generation (MacAllister, R. J. et al. (1996) Br. J. Pharmacol. 119:1533-1540). DDAH was found in neurons displaying cytoskeletal abnormalities and oxidative stress in Alzheimer's disease. In age-matched control cases, DDAH was not found in neurons. This suggests that oxidative stress- and nitric oxide-mediated events play a role in the pathogenesis of Alzheimer's disease (Smith, M. A. et al. (1998) Free Rad. Biol. Med. 25:898-902).

Acyl-CoA thioesterase is another member of the carboxylesterase family (Alexson, S. E. et al. (1993) Eur. J. Biochem. 214:719-727). Evidence suggests that acyl-CoA thioesterase has a regulatory role in steroidogenic tissues (Finkielstein, C. et al. (1998) Eur. J. Biochem. 256:60-66).

The alpha/beta hydrolase protein fold is common to several hydrolases of diverse phylogenetic origin and catalytic function. Enzymes with the alpha/beta hydrolase fold have a common core structure consisting of eight beta-sheets connected by alpha-helices. The most conserved structural feature of this fold is the loops of the nucleophile-histidine-acid catalytic triad. The histidine in the catalytic triad is completely conserved, while the nucleophile and acid loops accommodate more than one type of amino acid (Ollis, D. L. et al. (1992) Protein Eng. 5:197-211).

Sulfatases are members of a highly conserved gene family that share extensive sequence homology and a high degree of structural similarity. Sulfatases catalyze the cleavage of sulfate esters. To perform this function, sulfatases undergo a unique post-translational modification in the endoplasmic reticulum that involves the oxidation of a conserved cysteine residue. A human disorder called multiple sulfatase deficiency is due to a defect in this post-translational modification step, leading to inactive sulfatases (Recksiek, M. et al. (1998) J. Biol. Chem. 273:6096-6103). Phosphohydrolases are enzymes that hydrolyze phosphate esters. Some phosphohydrolases contain a mutT domain signature sequence. MutT is a protein involved in the GO system responsible for removing an oxidatively damaged form of guanine from DNA. A region of about 40 amino acid residues, found in the N-terminus of mutT, is also found in other proteins, including some phosphohydrolases (PROSITE PD0000695).

Serine hydrolases are a large functional class of hydrolytic enzymes that contain a serine residue in their active site. This class of enzymes contains proteinases, esterases, and lipases which hydrolyze a variety of substrates and, therefore, have different biological roles. Proteins in this superfamily can be further grouped into subfamilies based on substrate specificity or amino acid similarities (Puente, X. S, and C. Lopez-Otin (1995) J. Biol. Chem. 270:12926-12932).

Neuropathy target esterase (NTE) is an integral membrane protein present in all neurons and in some non-neural-cell types of vertebrates. NTE is involved in a cell-signaling pathway controlling interactions between neurons and accessory glial cells in the developing nervous system. NTE has serine esterase activity and efficiently catalyses the hydrolysis of phenyl valerate (PV) in vitro, but its physiological substrate is unknown. NTE is not related to either the major serine esterase family, which includes acetylcholinesterase, nor to any other known serine hydrolases. NTE contains at least two functional domains: an N-terminal putative regulatory domain and a C-terminal effector domain which contains the esterase activity and is, in part, conserved in proteins found in bacteria, yeast, nematodes and insects. NTE's effector domain contains three predicted transmembrane segments, and the active-site serine residue lies at the center of one of these segments. The isolated recombinant domain shows PV hydrolase activity only when incorporated into phospholipid liposomes. NTE's esterase activity is largely redundant in adult vertebrates, but organophosphates which react with NTE in vivo initiate unknown events which lead to a neuropathy with degeneration of long axons. These neuropathic organophosphates leave a negatively charged group covalently attached to the active-site serine residue, which causes a toxic gain of function in NTE (Glynn, P. (1999) Biochem. J. 344:625-631). Further, the Drosophila neurodegeneration gene swiss-cheese encodes a neuronal protein involved in glia-neuron interaction and is homologous to the above human NTE (Moser, M. et al. (2000) Mech. Dev. 90:279-282).

Chitinases are chitin-degrading enzymes present in a variety of organisms and participate in processes including cell wall remodeling, defense and catabolism. Chitinase activity has been found in human serum, leukocytes, granulocytes, and in association with fertilized oocytes in mammals (Escott, G. M. (1995) Infect. Immunol. 63:4770-4773; DeSouza, M. M. (1995) Endocrinology 136:2485-2496). Glycolytic and proteolytic molecules in humans are associated with tissue damage in lung diseases and with increased tumorigenicity and metastatic potential of cancers (Mulligan, M. S. (1993) Proc. Natl. Acad. Sci. 90:11523-11527; Matrisian, L. M. (1991) Am. J. Med. Sci. 302:157-162; Witty, J. P. (1994) Cancer Res. 54:4805-4812). The discovery of a human enzyme with chitinolytic activity is noteworthy given the lack of endogenous chitin in the human body (Raghavan, N. (1994) Infect. Immun. 62:1901-1908). However, there is a group of mammalian proteins that share homology with chitinases from various non-mammalian organisms, such as bacteria, fungi, plants, and insects. The members of this family differ in their ability to hydrolyze chitin or chitin-like substrates. Some of the mammalian members of the family, such as a bovine whey chitotriosidase and human cartilage proteins which do not demonstrate specific chitinolytic activity, are expressed in association with tissue remodeling events (Rejman, J. J. (1988) Biochem. Biophys. Res. Commun. 150:329-334, Nyirkos, P. (1990) Biochem. J. 268:265-268). Elevated levels of human cartilage proteins have been reported in the synovial fluid and cartilage of patients with rheumatoid arthritis, a disease which produces a severe degradation of the cartilage and a proliferation of the synovial membrane in the affected joints (Hakala, B. E. (1993) J. Biol. Chem. 268:25803-25810).

A small subclass of hydrolases acting on ether bonds includes the thioether hydrolases. S-adenosyl-L-homocysteine hydrolase, also known as AdoHcyase or SAHH(PROSITE PDOC00603; EC 3.3.1.1), is a thioether hydrolase first described in rat liver extracts as the activity responsible for the reversible hydrolysis of S-adenosyl-L-homocysteine (AdoHcy) to adenosine and homocysteine (Sganga, M. W. et al. (1992) PNAS 89:6328-6332). SAHH is a cytosolic enzyme that has been found in all cells that have been tested, with the exception of Escherichia coli and certain related bacteria (Walker, R. D. et al. (1975) Can. J. Biochem. 53:312-319; Shimizu, S. et al. (1988) FEMS Microbiol. Lett. 51:177-180; Shimizu, S. et al. (1984) Eur. J. Biochem. 141:385-392). SAHH activity is dependent on NAD⁺ as a cofactor. Deficiency of SAHH is associated with hypermethioninemia (Online Mendelian Inheritance in Man (OMIM) #180960 Hypermethioninemia), a pathologic condition characterized by neonatal cholestasis, failure to thrive, mental and motor retardation, facial dysmorphism with abnormal hair and teeth, and myocaridopathy (Labrune, P. et al. (1990) J. Pediat. 117:220-226).

Another subclass of hydrolases includes those enzymes which act on carbon-nitrogen (C—N) bonds other than peptide bonds. To this subclass belong those enzymes hydrolyzing amides, amidines, and other C—N bonds. This subclass is further subdivided on the basis of substrate specificity such as linear amides, cyclic amides, linear amidines, cyclic amidines, nitrites and other compounds. A hydrolase belonging to the sub-subclass of enzymes acting on the cyclic amidines is adenosine deaminase (ADA). ADA catalyzes the breakdown of adenosine to inosine. ADA is present in many mammalian tissues, including placenta, muscle, lung, stomach, digestive diverticulum, spleen, erythrocytes, thymus, seminal plasma, thyroid, T-cells, bone marrow stem cells, and liver. A subclass of ADAs, ADAR, act on RNA and are classified as RNA editases. An ADAR from Drosophila, DADAR, expressed in the developing nervous system, may act on para voltage-gated Na+ channel transcripts in the central nervous system (Palladino, M. J. et al. (2000) RNA 6:1004-1018). ADA deficiency causes profound lymphopenia with severe combined immunodeficiency (SCID). Cells from patients with ADA deficiency contain low, sometimes undetectable, amounts of ADA catalytic activity and ADA protein. ADA deficiency stems from genetic mutations in the ADA gene (Hershfield, M. S. (1998) Semin. Hematol. 4:291-298). Metabolic consequences of ADA deficiency are associated with defects in alveogenesis, pulmonary inflammation, and airway obstruction (Blackburn, M. R. et al. (2000) J. Exp. Med. 192:159-170).

Pancreatic ribonucleases (RNase) are pyrimidine-specific endonucleases found in high quantity in the pancreas of certain mammalian taxa and of some reptiles (Beinterna, J. J. et al (1988) Prog. Biophys. Mol. Biol. 51:165-192). Proteins in the mammalian pancreatic RNase superfamily are noncytosolic endonucleases that degrade RNA through a two-step transphosphorolytic-hydrolytic reaction (Beinterna, J. J. et al. (1986) Mol. Biol. Evol. 3:262-275). Specifically, the enzymes are involved in endonucleolytic cleavage of 3′-phosphomononucleotides and 3′-phosphooligonucleotides ending in C-P or U-P with 2′,3′-cyclic phosphate intermediates. Ribonucleases can unwind the DNA helix by complexing with single-stranded DNA; the complex arises by an extended multi-site cation-anion interaction between lysine and arginine residues of the enzyme and phosphate groups of the nucleotides. Some of the enzymes belonging to this family appear to play a purely digestive role, whereas others exhibit potent and unusual biological activities (D'Alessio, G. (1993) Trends Cell Biol. 3:106-109). Proteins belonging to the pancreatic RNase family include: bovine seminal vesicle and brain ribonucleases; kidney non-secretory ribonucleases (Beinterna, J. J. et al (1986) FEBS Lett. 194:338-343); liver-type ribonucleases (Rosenberg, H. F. et al. (1989) PNAS U.S.A. 86:4460-4464); angiogenin, which induces vascularisation of normal and malignant tissues; eosinophil cationic protein (Hofsteenge, J. et al. (1989) Biochemistry 28:9806-9813), a cytotoxin and helminthotoxin with ribonuclease activity; and frog liver ribonuclease and frog sialic acid-binding lectin. The sequences of pancreatic RNases contain 4 conserved disulfide bonds and 3 amino acid residues involved in the catalytic activity.

ADP-ribosylation is a reversible post-translational protein modification in which an ADP-ribose moiety is transferred from β.-NAD to a target amino acid such as arginine or cysteine. ADP-ribosylarginine hydrolases regenerate arginine by removing ADP-ribose from the protein, completing the ADP-ribosylation cycle (Moss, J. et al. (1997) Adv. Exp. Med. Biol. 419:25-33). ADP-ribosylation is a well-known reaction among bacterial toxins. Cholera toxin, for example, disrupts the adenylyl cyclase system by ADP-ribosylating the α-subunit of the stimulatory G-protein, causing an increase in intracellular cAMP (Moss, J. and M. Vaughan (Eds) (1990) ADP-ribosylating Toxins and G-Proteins: Insights into Signal Transduction, American Society for Microbiology, Washington, D.C.). ADP-ribosylation may also have a regulatory function in eukaryotes, affecting such processes as cytoskeletal assembly (Zhou, H. et al. (1996) Arch. Biochem. Biophys. 334:214-222) and cell proliferation in cytotoxic T-cells (Wang, J. et al. (1996) J. Immunol. 156:2819-2827). Nucleotidases catalyze the formation of free nucleosides from nucleotides. The cytosolic nucleotidase cN-I (5′ nucleotidase-I) cloned from pigeon heart catalyzes the formation of adenosine from AMP generated during ATP hydrolysis (Sala-Newby, G. B. et al. (1999) J. Biol. Chem. 274:17789-17793). Increased adenosine concentration is thought to be a signal of metabolic stress, and adenosine receptors mediate effects including vasodilation, decreased stimulatory neuron firing and ischemic preconditioning in the heart (Schrader, J. (1990) Circulation 81:389-391; Rubino, A. et al. (1992) Eur. J. Pharmacol. 220:95-98; de Jong, J. W. et al. (2000) Pharmacol. Ther. 87:141-149). Deficiency of pyrimidine 5′-nucleotidase can result in hereditary hemolytic anemia (OMIM #266120).

The lysozyme c superfamily consists of conventional lysozymes c, calcium-binding lysozymes c, and α-lactalbumin (Prager, E. M. and P. Jolles (1996) EXS 75:9-31). The proteins in this superfamily have 35-40% sequence homology and share a common three-dimensional fold, but can have different functions. Lysozymes c are ubiquitous in a variety of tissues and secretions and can lyse the cell walls of certain bacteria (McKenzie, H. A. (1996) EXS 75:365-409). Alpha-lactalbumin is a metallo-protein that binds calcium and participates in the synthesis of lactose (Iyer, L. K. and P. K. Qasba (1999) Protein Eng. 12:129-139). Alpha-lactalbumin occurs in mammalian milk and colostrum (McKenzie, supra).

Lysozymes catalyze the hydrolysis of certain mucopolysaccharides of bacterial cell walls, specifically, the beta (1-4) glycosidic linkages between N-acetylmuramic acid and N-acetylglucosamine, and cause bacterial lysis. Lysozymes occur in diverse organisms including viruses, birds, and mammals. In humans, lysozymes are found in spleen, lung, kidney, white blood cells, plasma, saliva, milk, tears, and cartilage (OMIM #153450 Lysozyme; Weaver, L. H. et al. (1985) J. Mol. Biol. 184:739-741). Lysozyme c functions in ruminants as a digestive enzyme, releasing proteins from ingested bacterial cells, and may perform the same function in human newborns (Braun, O. H. et al. (1995) Klin. Pediatr. 207:4-7).

The two known forms of lysozymes, chicken-type and goose-type, were originally isolated from chicken and goose egg white, respectively. Chicken-type and goose-type lysozymes have similar three-dimensional structures, but different amino acid sequences (Nakano, T. and T. Graf (1991) Biochim. Biophys. Acta 1090:273-276). In chickens, both forms of lysozyme are found in neutrophil granulocytes (heterophils), but only chicken-type lysozyme is found in egg white. Generally, chicken-type lysozyme mRNA is found in both adherent monocytes and macrophages and nonadherent promyelocytes and granulocytes as well as in cells of the bone marrow, spleen, bursa, and oviduct. Goose-type lysozyme mRNA is found in non-adherent cells of the bone marrow and lung. Several isozymes have been found in rabbits, including leukocytic, gastrointestinal, and possibly lymphoepithelial forms (OMIM #153450, supra; Nakano and Graf, supra; and GenBank GI 1310929). A human lysozyme gene encoding a protein similar to chicken-type lysozyme has been cloned (Yoshimura, K. et al. (1988) Biochem. Biophys. Res. Commun. 150:794-801). A consensus motif featuring regularly spaced cysteine residues has been derived from the lysozyme C enzymes of various species (PROSITE PS00128). Lysozyme C shares about 40% amino acid sequence identity with α-lactalbumin.

Lysozymes have several disease associations. Lysozymuria is observed in diabetic nephropathy (Shima, M. et al. (1986) Clin. Chem. 32:1818-1822), endemic nephropathy (Bruckner, I. et al. (1978) Med. Interne. 16:117-125), urinary tract infections (Heidegger, H. (1990) Minerva Ginecol. 42:243-250), and acute monocytic leukemia (Shaw, M. T. (1978) Am. J. Hematol. 4:97-103). Nakano and Graf (supra) suggested a role for lysozyme in host defense systems. Older rabbits with an inherited lysozyme deficiency show increased susceptibility to infections, such as subcutaneous abscesses (OMIM #153450, supra). Human lysozyme gene mutations cause hereditary systemic amyloidosis, a rare autosomal dominant disease in which amyloid deposits form in the viscera, including the kidney, adrenal glands, spleen, and liver. This disease is usually fatal by the fifth decade. The amyloid deposits contain variant forms of lysozyme. Renal amyloidosis is the most common and potentially the most serious form of organ involvement (Pepys, M. B. et al. (1993) Nature 362:553-557; OMIM #105200 Familial Visceral Amyloidosis; Cotran, R. S. et al. (1994) Robbins Pathologic Basis of Disease, W.B. Saunders Company, Philadelphia Pa., pp. 231-238). Increased levels of lysozyme and lactate have been observed in the cerebrospinal fluid of patients with bacterial meningitis (Ponka, A. et al. (1983) Infection 11:129-131). Acute monocytic leukemia is characterized by massive lysozymuria (Den Tandt, W. R. (1988) Int. J. Biochem. 20:713-719).

### Lyases

Lyases are a class of enzymes that catalyze the cleavage of C—C, C—O, C—N, C—S, C-(halide), P—O, or other bonds without hydrolysis or oxidation to form two molecules, at least one of which contains a double bond (Stryer, L. (1995) Biochemistry, W.H. Freeman and Co., New York N.Y., p. 620). Under the International Classification of Enzymes (Webb, E. C. (1992) Enzyme Nomenclature 1992: Recommendations of the Nomenclature Committee of the International Union of Biochemistry and Molecular Biology on the Nomenclature and Classification of Enzymes, Academic Press, San Diego Calif.), lyases form a distinct class designated by the numeral 4 in the first digit of the enzyme number (i.e., EC 4.x.x.x).

Further classification of lyases reflects the type of bond cleaved as well as the nature of the cleaved group. The group of C—C lyases includes carboxyl-lyases (decarboxylases), aldehyde-lyases (aldolases), oxo-acid-lyases, and other lyases. The C—O lyase group includes hydro-lyases, lyases acting on polysaccharides, and other lyases. The C—N lyase group includes ammonia-lyases, amidine-lyases, amine-lyases (deaminases), and other lyases. Lyases are critical components of cellular biochemistry, with roles in metabolic energy production, including fatty acid metabolism and the tricarboxylic acid cycle, as well as other diverse enzymatic processes.

One important family of lyases are the carbonic anhydrases (CA), also called carbonate dehydratases, which catalyze the hydration of carbon dioxide in the reaction H₂O+CO₂≅HCO₃⁻+−H⁺. CA accelerates this reaction by a factor of over 10⁶ by virtue of a zinc ion located in a deep cleft about 15.ANG. below the protein's surface and co-ordinated to the imidazole groups of three His residues. Water bound to the zinc ion is rapidly converted to HCO₃⁻.

Eight enzymatic and evolutionarily related forms of carbonic anhydrase are currently known to exist in humans: three cytosolic isozymes (CAI, CAII, and CAIII), two membrane-bound forms (CAIV and CAVII), a mitochondrial form (CAV), a secreted salivary form (CAVI) and a yet uncharacterized isozyme (PROSITE PDOC00146 Eukaryotic-type carbonic anhydrases signature). Though the isoenzymes CAI, CAII, and bovine CAIII have similar secondary structures and polypeptide-chain folds, CAI has 6 tryptophans, CAII has 7 and CAIII has 8 (Boren, K. et al. (1996) Protein Sci. 5:2479-2484). CAII is the predominant CA isoenzyme in the brain of mammals.

CAs participate in a variety of physiological processes that involve pH regulation, CO₂ and HCO₃⁻ transport, ion transport, and water and electrolyte balance. For example, CAII contributes to H⁺ secretion by gastric parietal cells, by renal tubular cells, and by osteoclasts that secrete H⁺ to acidify the bone-resorbing compartment. In addition, CAII promotes HCO₃⁻ secretion by pancreatic duct cells, cilary body epithelium, choroid plexus, salivary gland acinar cells, and distal colonal epithelium, thus playing a role in the production of pancreatic juice, aqueous humor, cerebrospinal fluid, and saliva, and contributing to electrolyte and water balance. CAII also promotes CO₂ exchange in proximal tubules in the kidney, in erythrocytes, and in lung. CAIV has roles in several tissues: it facilitates HCO₃⁻ reabsorption in the kidney; promotes CO₂ flux in tissues including brain, skeletal muscle, and heart muscle; and promotes CO₂ exchange from the blood to the alveoli in the lung. CAVI probably plays a role in pH regulation in saliva, along with CAII, and may have a protective effect in the esophagus and stomach. Mitochondrial CAV appears to play important roles in gluconeogenesis and ureagenesis, based on the effects of CA inhibitors on these pathways. (Sly, W. S, and P. Y. Hu (1995) Ann. Rev. Biochem. 64:375-401.)
A number of disease states are marked by variations in CA activity. Mutations in CAII which lead to CAII deficiency are the cause of osteopetrosis with renal tubular acidosis (OMIM #259730 Osteopetrosis with Renal Tubular Acidosis). The concentration of CAII in the cerebrospinal fluid (CSF) appears to mark disease activity in patients with brain damage. High CA concentrations have been observed in patients with brain infarction. Patients with transient ischemic attack, multiple sclerosis, or epilepsy usually have CAII concentrations in the normal range, but higher CAII levels have been observed in the CSF of those with central nervous system infection, dementia, or trigeminal neuralgia (Parkkila, A. K. et al. (1997) Eur. J. Clin. Invest. 27:392-397). Colonic adenomas and adenocarcinomas have been observed to fail to stain for CA, whereas non-neoplastic controls showed CAI and CAII in the cytoplasm of the columnar cells lining the upper half of colonic crypts. The neoplasms show staining patterns similar to less mature cells lining the base of normal crypts (Gramlich T. L. et al. (1990) Arch. Pathol. Lab. Med. 114:415-419).

Therapeutic interventions in a number of diseases involve altering CA activity. CA inhibitors such as acetazolamide are used in the treatment of glaucoma (Stewart, W. C. (1999) Curr. Opin. Opthamol. 10:99-108), essential tremor and Parkinson's disease (Uitti, R. J. (1998) Geriatrics 53:46-48, 53-57), intermittent ataxia (Singhvi, J. P. et al. (2000) Neurology India 48:78-80), and altitude related illnesses (Klocke, D. L. et al. (1998) Mayo Clin. Proc. 73:988-992).

CA activity can be particularly useful as an indicator of long-term disease conditions, since the enzyme reacts relatively slowly to physiological changes. CAI and zinc concentrations have been observed to decrease in hyperthyroid Graves' disease (Yoshida, K. (1996) Tohoku J. Exp. Med. 178:345-356) and glycosylated CAI is observed in diabetes mellitus (Kondo, T. et al. (1987) Clin. Chim. Acta 166:227-236). A positive correlation has been observed between CAI and CAII reactivity and endometriosis (Brinton, D. A. et al. (1996) Ann. Clin. Lab. Sci. 26:409-420; D'Cruz, O. J. et al. (1996) Fertil. Steril. 66:547-556).

Another important member of the lyase family is ornithine decarboxylase (ODC), the initial rate-limiting enzyme in polyamine biosynthesis. ODC catalyses the transformation of ornithine into putrescine in the reaction L-ornithine≅putrescine+CO₂. Polyamines, which include putrescine and the subsequent metabolic pathway products spermidine and spermine, are ubiquitous cell components essential for DNA synthesis, cell differentiation, and proliferation. Thus the polyamines play a key role in tumor proliferation (Medina, M. A. et al. (1999) Biochem. Pharmacol. 57:1341-1344).
ODC is a pyridoxal-5′-phosphate (PLP)-dependent enzyme which is active as a homodimer. Conserved residues include those at the PLP binding site and a stretch of glycine residues thought to be part of a substrate binding region (PROSITE PDOC00685 Orn/DAP/Arg decarboxylase family 2 signatures). Mammalian ODCs also contain PEST regions, sequence fragments enriched in proline, glutamic acid, serine, and threonine residues that act as signals for intracellular degradation (Nedina et al., supra).

Many chemical carcinogens and tumor promoters increase ODC levels and activity. Several known oncogenes may increase ODC levels by enhancing transcription of the ODC gene, and ODC itself may act as an oncogene when expressed at very high levels. A high level of ODC is found in a number of precancerous conditions, and elevation of ODC levels has been used as part of a screen for tumor-promoting compounds (Pegg, A. E. et al. (1995) J. Cell. Biochem. Suppl. 22:132-138).

Inhibitors of ODC have been used to treat tumors in animal models and human clinical trials, and have been shown to reduce development of tumors of the bladder, brain, esophagus, gastrointestinal tract, lung, oral cavity, mammary gland, stomach, skin and trachea (Pegg et al., supra; McCann, P. P. and A. E. Pegg (1992) Pharmac. Ther. 54:195-215). ODC also shows promise as a target for chemoprevention (Pegg et al., supra). ODC inhibitors have also been used to treat infections by African trypanosomes, malaria, and Pneumocystis carinii, and are potentially useful for treatment of autoimmune diseases such as lupus and rheumatoid arthritis (McCann and Pegg, supra).

Another family of pyridoxal-dependent decarboxylases are the group II decarboxylases. This family includes glutamate decarboxylase (GAD) which catalyzes the decarboxylation of glutamate into the neurotransmitter GABA; histidine decarboxylase (HDC), which catalyzes the decarboxylation of histidine to histamine; aromatic-L-amino-acid decarboxylase (DDC), also known as L-dopa decarboxylase or tryptophan decarboxylase, which catalyzes the decarboxylation of tryptophan to tryptamine and also acts on 5-hydroxy-tryptophan and dihydroxyphenylalanine (L-dopa); and cysteine sulfinic acid decarboxylase (CSD), the rate-limiting enzyme in the synthesis of taurine from cysteine (PROSITE PD0000329 DDC/GAD/HDC/TyrDC pyridoxal-phosphate attachment site). Taurine is an abundant sulfonic amino acid in brain and is thought to act as an osmoregulator in brain cells (Bitoun, M. and M. Tappaz (2000) J. Neurochem. 75:919-924).

### Isomerases

Isomerases are a class of enzymes that catalyze geometric or structural changes within a molecule to form a single product. This class includes racemases and epimerases, cis-trans-isomerases, intramolecular oxidoreductases, intramolecular transferases (mutases) and intramolecular lyases. Isomerases are critical components of cellular biochemistry with roles in metabolic energy production including glycolysis, as well as other diverse enzymatic processes (Stryer, supra, pp. 483-507).

Racemases are a subset of isomerases that catalyze inversion of a molecule's configuration around the asymmetric carbon atom in a substrate having a single center of asymmetry, thereby interconverting two racemers. Epimerases are another subset of isomerases that catalyze inversion of configuration around an asymmetric carbon atom in a substrate with more than one center of symmetry, thereby interconverting two epimers. Racemases and epimerases can act on amino acids and derivatives, hydroxy acids and derivatives, and carbohydrates and derivatives. The interconversion of UDP-galactose and UDP-glucose is catalyzed by UDP-galactose-4′-epimerase. Proper regulation and function of this epimerase is essential to the synthesis of glycoproteins and glycolipids. Elevated blood galactose levels have been correlated with UDP-galactose-4′-epimerase deficiency in screening programs of infants (Gitzelmann, R. (1972) Helv. Paediat. Acta 27:125-130).

Correct folding of newly synthesized proteins is assisted by molecular chaperones and folding catalysts, two unrelated groups of helper molecules. Chaperones suppress non-productive side reactions by stoichiometric binding to folding intermediates, whereas folding enzymes catalyze some of the multiple folding steps that enable proteins to attain their final functional configurations (Kern, G. et al. (1994) FEBS Lett. 348:145-148). One class of folding enzymes, the peptidyl prolyl cis-trans isomerases (PPIases), isomerizes certain proline imidic bonds in what is considered to be a rate limiting step in protein maturation and export. PPIases catalyze the cis to trans isomerization of certain proline imidic bonds in proteins. There are three evolutionarily unrelated families of PPIases: the cyclophilins, the FK506 binding proteins, and the newly characterized parvulin family (Rahfeld, J. U. et al. (1994) FEBS Lett. 352:180-184).

The cyclophilins (CyP) were originally identified as major receptors for the immunosuppressive drug cyclosporin A (CsA), an inhibitor of T-cell activation (Handschumacher, R. E. et al. (1984) Science 226:544-547; Harding, M. W. et al. (1986) J. Biol. Chem. 261:8547-8555). Thus, the peptidyl-prolyl isomerase activity of CyP may be part of the signaling pathway that leads to T-cell activation. Subsequent work demonstrated that CyP's isomerase activity is essential for correct protein folding and/or protein trafficking, and may also be involved in assembly/disassembly of protein complexes and regulation of protein activity. For example, in Drosophila, the CyP NinaA is required for correct localization of rhodopsins, while a mammalian CyP (Cyp40) is part of the Hsp90/Hsp70 complex that binds steroid receptors. The mammalian CyP (CypA) has been shown to bind the gag protein from human immunodeficiency virus 1 (HIV-1), an interaction that can be inhibited by cyclosporin. Since cyclosporin has potent anti-HIV-1 activity, CypA may play an essential function in HIV-1 replication. Finally, Cyp40 has been shown to bind and inactivate the transcription factor c-Myb, an effect that is reversed by cyclosporin. This effect implicates CyP in the regulation of transcription, transformation, and differentiation (Bergsma, D. J. et al (1991) J. Biol. Chem. 266:23204-23214; Hunter, T. (1998) Cell 92:141-143; and Leverson, J. D. and S. A. Ness (1998) Mol. Cell. 1:203-211).

One of the major rate limiting steps in protein folding is the thiol:disulfide exchange that is necessary for correct protein assembly. Although incubation of reduced, unfolded proteins in buffers with defined ratios of oxidized and reduced thiols can lead to native conformation, the rate of folding is slow and the attainment of native conformation decreases proportionately with the size and number of cysteines in the protein. Certain cellular compartments such as the endoplasmic reticulum of eukaryotes and the periplasmic space of prokaryotes are maintained in a more oxidized state than the surrounding cytosol. Correct disulfide formation can occur in these compartments, but at a rate that is insufficient for normal cell processes and inadequate for synthesizing secreted proteins. The protein disulfide isomerases, thioredoxins and glutaredoxins are able to catalyze the formation of disulfide bonds and regulate the redox environment in cells to enable the necessary thiol:disulfide exchanges (Loferer, H. (1995) J. Biol. Chem. 270:26178-26183).

Each of these proteins has somewhat different functions, but all belong to a group of disulfide-containing redox proteins that contain a conserved active-site sequence and are ubiquitously distributed in eukaryotes and prokaryotes. Protein disulfide isomerases are found in the endoplasmic reticulum of eukaryotes and in the periplasmic space of prokaryotes. They function by exchanging their own disulfide for a thiol in a folding peptide chain. In contrast, the reduced thioredoxins and glutaredoxins are generally found in the cytoplasm and function by directly reducing disulfides in the substrate proteins.

Oxidoreductases can be isomerases as well. Oxidoreductases catalyze the reversible transfer of electrons from a substrate that becomes oxidized to a substrate that becomes reduced. This class of enzymes includes dehydrogenases, hydroxylases, oxidases, oxygenases, peroxidases, and reductases. Proper maintenance of oxidoreductase levels is physiologically important. For example, genetically-linked deficiencies in lipoamide dehydrogenase can result in lactic acidosis (Robinson, B. H. et al. (1977) Pediat. Res. 11:1198-1202).

Another subgroup of isomerases are the transferases (or mutases). Transferases transfer a chemical group from one compound (the donor) to another compound (the acceptor). The types of groups transferred by these enzymes include acyl groups, amino groups, phosphate groups (phosphotransferases or phosphomutases), and others. The transferase carnitine palmitoyltransferase is an important component of fatty acid metabolism. Genetically-linked deficiencies in this transferase can lead to myopathy (Scriver, C. et al. (1995) The Metabolic and Molecular Basis of Inherited Disease, McGraw-Hill, New York N.Y., pp. 1501-1533).

Yet another subgroup of isomerases are the topoisomersases. Topoisomerases are enzymes that affect the topological state of DNA. For example, defects in topoisomerases or their regulation can affect normal physiology. Reduced levels of topoisomerase II have been correlated with some of the DNA processing defects associated with the disorder ataxia-telangiectasia (Singh, S. P. et al. (1988) Nucleic Acids Res. 16:3919-3929).

### Ligases

Ligases catalyze the formation of a bond between two substrate molecules. The process involves the hydrolysis of a pyrophosphate bond in ATP or a similar energy donor. Ligases are classified based on the nature of the type of bond they form, which can include carbon-oxygen, carbon-sulfur, carbon-nitrogen, carbon-carbon and phosphoric ester bonds.

Ligases forming carbon-oxygen bonds include the aminoacyl-transfer RNA (tRNA) synthetases which are important RNA-associated enzymes with roles in translation. Protein biosynthesis depends on each amino acid forming a linkage with the appropriate tRNA. The aminoacyl-tRNA synthetases are responsible for the activation and correct attachment of an amino acid with its cognate tRNA. The 20 aminoacyl-tRNA synthetase enzymes can be divided into two structural classes, and each class is characterized by a distinctive topology of the catalytic domain. Class I enzymes contain a catalytic domain based on the nucleotide-binding “Rossman fold”. Class II enzymes contain a central catalytic domain, which consists of a seven-stranded antiparallel β-sheet motif, as well as N- and C-terminal regulatory domains. Class II enzymes are separated into two groups based on the heterodimeric or homodimeric structure of the enzyme; the latter group is further subdivided by the structure of the N- and C-terminal regulatory domains (Hartlein, M. and S. Cusack, (1995) J. Mol. Evol. 40:519-530). Autoantibodies against aminoacyl-tRNAs are generated by patients with dermatomyositis and polymyositis, and correlate strongly with complicating interstitial lung disease (ILD). These antibodies appear to be generated in response to viral infection, and coxsackie virus has been used to induce experimental viral myositis in animals.

Ligases forming carbon-sulfur bonds (acid-thiol ligases) mediate a large number of cellular biosynthetic intermediary metabolism processes involving intermolecular transfer of carbon atom-containing substrates (carbon substrates). Examples of such reactions include the tricarboxylic acid cycle, synthesis of fatty acids and long-chain phospholipids, synthesis of alcohols and aldehydes, synthesis of intermediary metabolites, and reactions involved in the amino acid degradation pathways. Some of these reactions require input of energy, usually in the form of conversion of ATP to either ADP or AMP and pyrophosphate.

In many cases, a carbon substrate is derived from a small molecule containing at least two carbon atoms. The carbon substrate is often covalently bound to a larger molecule which acts as a carbon substrate carrier molecule within the cell. In the biosynthetic mechanisms described above, the carrier molecule is coenzyme A. Coenzyme A (CoA) is structurally related to derivatives of the nucleotide ADP and consists of 4′-phosphopantetheine linked via a phosphodiester bond to the alpha phosphate group of adenosine 3′,5′-bisphosphate. The terminal thiol group of 4′-phosphopantetheine acts as the site for carbon substrate bond formation. The predominant carbon substrates which utilize CoA as a carrier molecule during biosynthesis and intermediary metabolism in the cell are acetyl, succinyl, and propionyl moieties, collectively referred to as acyl groups. Other carbon substrates include enoyl lipid, which acts as a fatty acid oxidation intermediate, and carnitine, which acts as an acetyl-CoA flux regulator/mitochondrial acyl group transfer protein. Acyl-CoA and acetyl-CoA are synthesized in the cell by acyl-CoA synthetase and acetyl-CoA synthetase, respectively.

Activation of fatty acids is mediated by at least three forms of acyl-CoA synthetase activity: i) acetyl-CoA synthetase, which activates acetate and several other low molecular weight carboxylic acids and is found in muscle mitochondria and the cytosol of other tissues; ii) medium-chain acyl-CoA synthetase, which activates fatty acids containing between four and eleven carbon atoms (predominantly from dietary sources), and is present only in liver mitochondria; and iii) acyl CoA synthetase, which is specific for long chain fatty acids with between six and twenty carbon atoms, and is found in microsomes and the mitochondria. Proteins associated with acyl-CoA synthetase activity have been identified from many sources including bacteria, yeast, plants, mouse, and man. The activity of acyl-CoA synthetase may be modulated by phosphorylation of the enzyme by cAMP-dependent protein kinase.

Ligases forming carbon-nitrogen bonds include amide synthases such as glutamine synthetase (glutamate-ammonia ligase) that catalyzes the amination of glutamic acid to glutamine by ammonia using the energy of ATP hydrolysis. Glutamine is the primary source for the amino group in various amide transfer reactions involved in de novo pyrimidine nucleotide synthesis and in purine and pyrimidine ribonucleotide interconversions. Overexpression of glutamine synthetase has been observed in primary liver cancer (Christa, L. et al. (1994) Gastroent. 106:1312-1320).

Acid-amino-acid ligases (peptide synthases) are represented by the ubiquitin conjugating enzymes which are associated with the ubiquitin conjugation system (UCS), a major pathway for the degradation of cellular proteins in eukaryotic cells and some bacteria. The UCS mediates the elimination of abnormal proteins and regulates the half-lives of important regulatory proteins that control cellular processes such as gene transcription and cell cycle progression. In the UCS pathway, proteins targeted for degradation are conjugated to ubiquitin (Ub), a small heat stable protein. Ub is first activated by a ubiquitin-activating enzyme (E1), and then transferred to one of several Ub-conjugating enzymes (E2). E2 then links the Ub molecule through its C-terminal glycine to an internal lysine (acceptor lysine) of a target protein. The ubiquitinated protein is then recognized and degraded by proteasome, a large, multisubunit proteolytic enzyme complex, and ubiquitin is released for reutilization by ubiquitin protease. The UCS is implicated in the degradation of mitotic cyclic kinases, oncoproteins, tumor suppressor genes such as p53, viral proteins, cell surface receptors associated with signal transduction, transcriptional regulators, and mutated or damaged proteins (Ciechanover, A. (1994) Cell 79:13-21).

Cyclo-ligases and other carbon-nitrogen ligases comprise various enzymes and enzyme complexes that participate in the de novo pathways of purine and pyrimidine biosynthesis. Because these pathways are critical to the synthesis of nucleotides for replication of both RNA and DNA, many of these enzymes have been the targets of clinical agents for the treatment of cell proliferative disorders such as cancer and infectious diseases.

Purine biosynthesis occurs de novo from the amino acids glycine and glutamine, and other small molecules. Three of the key reactions in this process are catalyzed by a trifunctional enzyme composed of glycinamide-ribonucleotide synthetase (GARS), aminoimidazole ribonucleotide synthetase (AIRS), and glycinamide ribonucleotide transformylase (GART). Together these three enzymes combine ribosylamine phosphate with glycine to yield phosphoribosyl aminoimidazole, a precursor to both adenylate and guanylate nucleotides. This trifunctional protein has been implicated in the pathology of Downs syndrome (Aimi, J. et al. (1990) Nucleic Acid Res. 18:6665-6672). Adenylosuccinate synthetase catalyzes a later step in purine biosynthesis that converts inosinic acid to adenylosuccinate, a key step on the path to ATP synthesis. This enzyme is also similar to another carbon-nitrogen ligase, argininosuccinate synthetase, that catalyzes a similar reaction in the urea cycle (Powell, S. M. et al. (1992) FEBS Lett. 303:4-10).

Adenylosuccinate synthetase, adenylosuccinate lyase, and AMP deaminase may be considered as a functional unit, the purine nucleotide cycle. This cycle converts AMP to inosine monophosphate (IMP) and reconverts IMP to AMP via adenylosuccinate, thereby producing NH₃ and forming fumarate from aspartate. In muscle, the purine nucleotide cycle functions, during intense exercise, in the regeneration of ATP by pulling the adenylate kinase reaction in the direction of ATP formation and by providing Krebs cycle intermediates. In kidney, the purine nucleotide cycle accounts for the release of NH₃ under normal acid-base conditions. In brain, the purine nucleotide cycle may contribute to ATP recovery. Adenylosuccinate lyase deficiency provokes psychomotor retardation, often accompanied by autistic features (Van den Berghe, G. et al. (1992) Prog Neurobiol. 39:547-561). A marked imbalance in the enzymic pattern of purine metabolism is linked with transformation and/or progression in cancer cells. In rat hepatomas the specific activities of the anabolic enzymes, IMP dehydrogenase, GMP synthetase, adenylosuccinate synthetase, adenylosuccinase, AMP deaminase and amidophosphoribosyltransferase, increased to 13.5-, 3.7-, 3.1-, 1.8-, 5.5- and 2.8-fold, respectively, of those in normal liver (Weber, G. (1983) Clin. Biochem. 16:57-63).

Like the de novo biosynthesis of purines, de novo synthesis of the pyrimidine nucleotides uridylate and cytidylate also arises from a common precursor, in this instance the nucleotide orotidylate derived from orotate and phosphoribosyl pyrophosphate (PPRP). Again a trifunctional enzyme comprising three carbon-nitrogen ligases plays a key role in the process. In this case the enzymes aspartate transcarbamylase (ATCase), carbamyl phosphate synthetase II, and dihydroorotase (DHOase) are encoded by a single gene called CAD. Together these three enzymes combine the initial reactants in pyrimidine biosynthesis, glutamine, CO₂ and ATP to form dihydroorotate, the precursor to orotate and orotidylate (Iwahana, H. et al. (1996) Biochem. Biophys. Res. Commun. 219:249-255). Further steps then lead to the synthesis of uridine nucleotides from orotidylate. Cytidine nucleotides are derived from uridine-5′-triphosphate (UTP) by the amidation of UTP using glutamine as the amino donor and the enzyme CTP synthetase. Regulatory mutations in the human CTP synthetase are believed to confer multi-drug resistance to agents widely used in cancer therapy (Yamauchi, M. et al. (1990) EMBO J. 9:2095-2099).

Ligases forming carbon-carbon bonds include the carboxylases acetyl-CoA carboxylase and pyruvate carboxylase. Acetyl-CoA carboxylase catalyzes the carboxylation of acetyl-CoA from CO₂ and H₂O using the energy of ATP hydrolysis. Acetyl-CoA carboxylase is the rate-limiting enzyme in the biogenesis of long-chain fatty acids. Two isoforms of acetyl-CoA carboxylase, types I and types II, are expressed in human in a tissue-specific manner (Ha, J. et al. (1994) Eur. J. Biochem. 219:297-306). Pyruvate carboxylase is a nuclear-encoded mitochondrial enzyme that catalyzes the conversion of pyruvate to oxaloacetate, a key intermediate in the citric acid cycle.

Ligases forming phosphoric ester bonds include the DNA ligases involved in both DNA replication and repair. DNA ligases seal phosphodiester bonds between two adjacent nucleotides in a DNA chain using the energy from ATP hydrolysis to first activate the free 5′-phosphate of one nucleotide and then react it with the 3′-OH group of the adjacent nucleotide. This resealing reaction is used in DNA replication to join small DNA fragments called “Okazaki” fragments that are transiently formed in the process of replicating new DNA, and in DNA repair. DNA repair is the process by which accidental base changes, such as those produced by oxidative damage, hydrolytic attack, or uncontrolled methylation of DNA, are corrected before replication or transcription of the DNA can occur. Bloom's syndrome is an inherited human disease in which individuals are partially deficient in DNA ligation and consequently have an increased incidence of cancer (Alberts et al., supra, p. 247).

Pantothenate synthetase (D-pantoate; beta-alanine ligase (AMP-forming); EC 6.3.2.1) is the last enzyme of the pathway of pantothenate (vitamin B(5)) synthesis. It catalyzes the condensation of pantoate with beta-alanine in an ATP-dependent reaction. The enzyme is dimeric, with two well-defined domains per protomer: the N-terminal domain, a Rossmann fold, contains the active site cavity, with the C-terminal domain forming a hinged lid. The N-terminal domain is structurally very similar to class I aminoacyl-tRNA synthetases and is thus a member of the cytidylyltransferase superfamily (von Delft, F. et al. (2000) Structure (Camb) 9:439-450). Farnesyl diphosphate synthase (FPPS) is an essential enzyme that is required both for cholesterol synthesis and protein prenylation. The enzyme catalyzes the formation of farnesyl diphosphate from dimethylallyl diphosphate and isopentyl diphosphate. FPPS is inhibited by nitrogen-containing biphosphonates, which can lead to the inhibition of osteoclast-mediated bone resorption by preventing protein prenylation (Dunford, J. E. et al. (2001) J. Pharmacol. Exp. Ther. 296:235-242).

5-aminolevulinate synthase (ALAS; delta-aminolevulinate synthase; EC 2.3.1.37) catalyzes the rate-limiting step in heme biosynthesis in both erythroid and non-erythroid tissues. This enzyme is unique in the heme biosynthetic pathway in being encoded by two genes, the first encoding ALAS 1, the non-erythroid specific enzyme which is ubiquitously expressed, and the second encoding ALAS2, which is expressed exclusively in erythroid cells. The genes for ALAS 1 and ALAS2 are located, respectively, on chromosome 3 and on the X chromosome. Defects in the gene encoding ALAS2 result in X-linked sideroblastic anemia. Elevated levels of ALAS are seen in acute hepatic porphyrias and can be lowered by zinc mesoporphyrin.

### Drug Metabolizing Enzymes (DMEs)

The metabolism of a drug and its movement through the body (pharmacokinetics) are important in determining its effects, toxicity, and interactions with other drugs. The three processes governing pharmacokinetics are the absorption of the drug, distribution to various tissues, and elimination of drug metabolites. These processes are intimately coupled to drug metabolism, since a variety of metabolic modifications alter most of the physicochemical and pharmacological properties of drugs, including solubility, binding to receptors, and excretion rates. The metabolic pathways which modify drugs also accept a variety of naturally occurring substrates such as steroids, fatty acids, prostaglandins, leukotrienes, and vitamins. The enzymes in these pathways are therefore important sites of biochemical and pharmacological interaction between natural compounds, drugs, carcinogens, mutagens, and xenobiotics. It has long been appreciated that inherited differences in drug metabolism lead to drastically different levels of drug efficacy and toxicity among individuals. Advances in pharmacogenomics research, of which DMEs constitute an important part, are promising to expand the tools and information that can be brought to bear on questions of drug efficacy and toxicity (See Evans, W. E. and R. V. Relling (1999) Science 286:487-491). DMEs have broad substrate specificities, unlike antibodies, for example, which are diverse and highly specific. Since DMEs metabolize a wide variety of molecules, drug interactions may occur at the level of metabolism so that, for example, one compound may induce a DME that affects the metabolism of another compound.

Drug metabolic reactions are categorized as Phase I, which prepare the drug molecule for functioning and further metabolism, and Phase II, which are conjugative. In general, Phase I reaction products are partially or fully inactive, and Phase II reaction products are the chief excreted species. However, Phase I reaction products are sometimes more active than the original administered drugs; this metabolic activation principle is exploited by pro-drugs (e.g. L-dopa). Additionally, some nontoxic compounds (e.g. aflatoxin, benzo[α]pyrene) are metabolized to toxic intermediates through these pathways. Phase I reactions are usually rate-limiting in drug metabolism. Prior exposure to the compound, or other compounds, can induce the expression of Phase I enzymes however, and thereby increase substrate flux through the metabolic pathways. (See Klaassen, C. D. et al. (1996) Casarett and Doull's Toxicology: The Basic Science of Poisons, McGraw-Hill, New York, N.Y., pp. 113-186; Katzung, B. G. (1995) Basic and Clinical Pharmacology, Appleton and Lange, Norwalk, Conn., pp. 48-59; Gibson, G. G. and P. Skett (1994) Introduction to Drug Metabolism, Blackie Academic and Professional, London.).

The major classes of Phase I enzymes include, but are not limited to, cytochrome P450 and flavin-containing monooxygenase. Other enzyme classes involved in Phase I-type catalytic cycles and reactions include, but are not limited to, NADPH cytochrome P450 reductase (CPR), the microsomal cytochrome b5/NADH cytochrome b5 reductase system, the ferredoxin/ferredoxin reductase redox pair, aldo/keto reductases, and alcohol dehydrogenases. The major classes of Phase II enzymes include, but are not limited to, UDP glucuronyltransferase, sulfotransferase, glutathione S-transferase, N-acyltransferase, and N-acetyl transferase.

### Cytochrome P450 and P450 Catalytic Cycle-Associated Enzymes

Members of the cytochrome P450 superfamily of enzymes catalyze the oxidative metabolism of a variety of substrates, including natural compounds such as steroids, fatty acids, prostaglandins, leukotrienes, and vitamins, as well as drugs, carcinogens, mutagens, and xenobiotics. Cytochromes P450, also known as P450 heme-thiolate proteins, usually act as terminal oxidases in multi-component electron transfer chains, called P450-containing monooxygenase systems. Specific reactions catalyzed include hydroxylation, epoxidation, N-oxidation, sulfooxidation, N-, S-, and O-dealkylations, desulfation, deamination, and reduction of azo, nitro, and N-oxide groups. These reactions are involved in steroidogenesis of glucocorticoids, cortisols, estrogens, and androgens in animals; insecticide resistance in insects; herbicide resistance and flower coloring in plants; and environmental bioremediation by microorganisms. Cytochrome P450 actions on drugs, carcinogens, mutagens, and xenobiotics can result in detoxification or in conversion of the substance to a more toxic product. Cytochromes P450 are abundant in the liver, but also occur in other tissues; the enzymes are located in microsomes. (See ExPASY ENZYME EC 1.14.14.1; Prosite PDOC00081 Cytochrome P450 cysteine heme-iron ligand signature; PRINTS EP450I E-Class P450 Group I signature; Graham-Lorence, S, and J. A. Peterson (1996) FASEB J. 10:206-214.)

Four hundred cytochromes P450 have been identified in diverse organisms including bacteria, fungi, plants, and animals (Graham-Lorence and Peterson, supra). The B-class is found in prokaryotes and fungi, while the E-class is found in bacteria, plants, insects, vertebrates, and mammals. Five subclasses or groups are found within the larger family of E-class cytochromes P450 (PRINTS EP450I E-Class P450 Group I signature).

All cytochromes P450 use a heme cofactor and share structural attributes. Most cytochromes P450 are 400 to 530 amino acids in length. The secondary structure of the enzyme is about 70% alpha-helical and about 22% beta-sheet. The region around the heme-binding site in the C-terminal part of the protein is conserved among cytochromes P450. A ten amino acid signature sequence in this heme-iron ligand region has been identified which includes a conserved cysteine involved in binding the heme iron in the fifth coordination site. In eukaryotic cytochromes P450, a membrane-spanning region is usually found in the first 15-20 amino acids of the protein, generally consisting of approximately 15 hydrophobic residues followed by a positively charged residue. (See Prosite PDOC00081, supra; Graham-Lorence and Peterson, supra.)

Cytochrome P450 enzymes are involved in cell proliferation and development.

The enzymes have roles in chemical mutagenesis and carcinogenesis by metabolizing chemicals to reactive intermediates that form adducts with DNA (Nebert, D. W. and F. J. Gonzalez (1987) Ann. Rev. Biochem. 56:945-993). These adducts can cause nucleotide changes and DNA rearrangements that lead to oncogenesis. Cytochrome P450 expression in liver and other tissues is induced by xenobiotics such as polycyclic aromatic hydrocarbons, peroxisomal proliferators, phenobarbital, and the glucocorticoid dexamethasone (Dogra, S. C. et al. (1998) Clin. Exp. Pharmacol. Physiol. 25:1-9). A cytochrome P450 protein may participate in eye development as mutations in the P450 gene CYP1B1 cause primary congenital glaucoma (OMIM #601771 Cytochrome P450, subfamily I (dioxin-inducible), polypeptide 1; CYP1B1).

Cytochromes P450 are associated with inflammation and infection. Hepatic cytochrome P450 activities are profoundly affected by various infections and inflammatory stimuli, some of which are suppressed and some induced (Morgan, E. T. (1997) Drug Metab. Rev. 29:1129-1188). Effects observed in vivo can be mimicked by proinflammatory cytokines and interferons. Autoantibodies to two cytochrome P450 proteins were found in patients with autoimmune polyenodocrinopathy-candidiasis-ectodermal dystrophy (APECED), a polyglandular autoimmune syndrome (OMIM #240300 Autoimmune polyenodocrinopathy-candidiasis-ectodermal dystrophy).

Mutations in cytochromes P450 have been linked to metabolic disorders, including congenital adrenal hyperplasia, the most common adrenal disorder of infancy and childhood; pseudovitamin D-deficiency rickets; cerebrotendinous xanthomatosis, a lipid storage disease characterized by progressive neurologic dysfunction, premature atherosclerosis, and cataracts; and an inherited resistance to the anticoagulant drugs coumarin and warfarin (Isselbacher, K. J. et al. (1994) Harrison's Principles of Internal Medicine, McGraw-Hill, Inc. New York, N.Y., pp. 1968-1970; Takeyama, K. et al. (1997) Science 277:1827-1830; Kitanaka, S. et al. (1998) N. Engl. J. Med. 338:653-661; OMIM #213700 Cerebrotendinous xanthomatosis; and OMIM #122700 Coumarin resistance). Extremely high levels of expression of the cytochrome P450 protein aromatase were found in a fibrolamellar hepatocellular carcinoma from a boy with severe gynecomastia (feminization) (Agarwal, V. R. (1998) J. Clin. Endocrinol. Metab. 83:1797-1800).

The cytochrome P450 catalytic cycle is completed through reduction of cytochrome P450 by NADPH cytochrome P450 reductase (CPR). Another microsomal electron transport system consisting of cytochrome b5 and NADPH cytochrome b5 reductase has been widely viewed as a minor contributor of electrons to the cytochrome P450 catalytic cycle. However, a recent report by Lamb, D. C. et al. (1999; FEBS Lett. 462:283-288) identifies a Candida albicans cytochrome P450 (CYP51) which can be efficiently reduced and supported by the microsomal cytochrome b5/NADPH cytochrome b5 reductase system. Therefore, there are likely many cytochromes P450 which are supported by this alternative electron donor system.

Cytochrome b5 reductase is also responsible for the reduction of oxidized hemoglobin (methemoglobin, or ferrihemoglobin, which is unable to carry oxygen) to the active hemoglobin (ferrohemoglobin) in red blood cells. Methemoglobinemia results when there is a high level of oxidant drugs or an abnormal hemoglobin (hemoglobin M) which is not efficiently reduced. Methemoglobinemia can also result from a hereditary deficiency in red cell cytochrome b5 reductase (Reviewed in Mansour, A. and A. A. Lurie (1993) Am. J. Hematol. 42:7-12).

Members of the cytochrome P450 family are also closely associated with vitamin D synthesis and catabolism. Vitamin D exists as two biologically equivalent prohormones, ergocalciferol (vitamin D₂), produced in plant tissues, and cholecalciferol (vitamin D₃), produced in animal tissues. The latter form, cholecalciferol, is formed upon the exposure of 7-dehydrocholesterol to near ultraviolet light (i.e., 290-310 nm), normally resulting from even minimal periods of skin exposure to sunlight (reviewed in Miller, W. L. and A. A. Portale (2000) Trends Endocrinol. Metab. 11:315-319).

Both prohormone forms are further metabolized in the liver to 25-hydroxyvitamin D (25(OH)D) by the enzyme 25-hydroxylase. 25(OH)D is the most abundant precursor form of vitamin D which must be further metabolized in the kidney to the active form, 1α,25-dihydroxyvitami-n D (1α,25(OH)₂D), by the enzyme 25-hydroxyvitamin D 1α-hydroxylase (1α-hydroxylase). Regulation of 1α,25(OH)₂D production is primarily at this final step in the synthetic pathway. The activity of 1 α-hydroxylase depends upon several physiological factors including the circulating level of the enzyme product (1α,25(OH)₂D) and the levels of parathyroid hormone (PTH), calcitonin, insulin, calcium, phosphorus, growth hormone, and prolactin. Furthermore, extrarenal 1α.-hydroxylase activity has been reported, suggesting that tissue-specific, local regulation of 1α,25(OH)₂D production may also be biologically important. The catalysis of 1α,25(OH)₂D to 24,25-dihydroxyvitamin D (24,25(OH)₂2D), involving the enzyme 25-hydroxyvitamin D 24-hydroxylase (24-hydroxylase), also occurs in the kidney. 24-hydroxylase can also use 25(OH)D as a substrate (Shinki, T. et al. (1997) Proc. Natl. Acad. Sci. U.S.A. 94:12920-12925; Miller and Portale, supra; and references within).

Vitamin D 25-hydroxylase, 1α-hydroxylase, and 24-hydroxylase are all NADPH-dependent, type I (mitochondrial) cytochrome P450 enzymes that show a high degree of homology with other members of the family. Vitamin D 25-hydroxylase also shows a broad substrate specificity and may also perform 26-hydroxylation of bile acid intermediates and 25, 26, and 27-hydroxylation of cholesterol (Dilworth, F. J. et al. (1995) J. Biol. Chem. 270:16766-16774; Miller and Portale, supra; and references within).

The active form of vitamin D (1α,25(OH)₂D) is involved in calcium and phosphate homeostasis and promotes the differentiation of myeloid and skin cells. Vitamin D deficiency resulting from deficiencies in the enzymes involved in vitamin D metabolism (e.g., 1α-hydroxylase) causes hypocalcemia, hypophosphatemia, and vitamin D-dependent (sensitive) rickets, a disease characterized by loss of bone density and distinctive clinical features, including bandy or bow leggedness accompanied by a waddling gait. Deficiencies in vitamin D 25-hydroxylase cause cerebrotendinous xanthomatosis, a lipid-storage disease characterized by the deposition of cholesterol and cholestanol in the Achilles' tendons, brain, lungs, and many other tissues. The disease presents with progressive neurologic dysfunction, including postpubescent cerebellar ataxia, atherosclerosis, and cataracts. Vitamin D 25-hydroxylase deficiency does not result in rickets, suggesting the existence of alternative pathways for the synthesis of 25(OH)D (Griffin, J. E. and J. B. Zerwekh (1983) J. Clin. Invest. 72:1190-1199; Gamblin, G. T. et al. (1985) J. Clin. Invest. 75:954-960; and Miller and Portale, supra).

Ferredoxin and ferredoxin reductase are electron transport accessory proteins which support at least one human cytochrome P450 species, cytochrome P450c27 encoded by the CYP27 gene (Dilworth, F. J. et al. (1996) Biochem. J. 320:267-71). A Streptomyces griseus cytochrome P450, CYP104D1, was heterologously expressed in Escherichia coli and found to be reduced by the endogenous ferredoxin and ferredoxin reductase enzymes (Taylor, M. et al. (1999) Biochem. Biophys. Res. Commun. 263:838-842), suggesting that many cytochrome P450 species may be supported by the ferredoxin/ferredoxin reductase pair. Ferredoxin reductase has also been found in a model drug metabolism system to reduce actinomycin D, an antitumor antibiotic, to a reactive free radical species (Flitter, W. D. and R. P. Mason (1988) Arch. Biochem. Biophys. 267:632-639).

### Flavin-Containing Monooxygnase (FMO)

Flavin-containing monooxygenases oxidize the nucleophilic nitrogen, sulfur, and phosphorus heteroatom of an exceptional range of substrates. Like cytochromes P450, FMOs are microsomal and use NADPH and O₂; there is also a great deal of substrate overlap with cytochromes P450. The tissue distribution of FMOs includes liver, kidney, and lung.

Isoforms of FMO in mammals include FMO1, FMO2, FMO3, FMO4, and FMO5, which are expressed in a tissue-specific manner. The isoforms differ in their substrate specificities and properties such as inhibition by various compounds and stereospecificity of reaction. FMOs have a 13 amino acid signature sequence, the components of which span the N-terminal two-thirds of the sequences and include the FAD binding region and the FATGY motif found in many N-hydroxylating enzymes (Stehr, M. et al. (1998) Trends Biochem. Sci. 23:56-57; PRINTS FMOXYGENASE Flavin-containing monooxygenase signature). Specific reactions include oxidation of nucleophilic tertiary amines to N-oxides, secondary amines to hydroxylamines and nitrones, primary amines to hydroxylamines and oximes, and sulfur-containing compounds and phosphines to S- and P-oxides. Hydrazines, iodides, selenides, and boron-containing compounds are also substrates. FMOs are more heat labile and less detergent-sensitive than cytochromes P450 in vitro though FMO isoforms vary in thermal stability and detergent sensitivity.

FMOs play important roles in the metabolism of several drugs and xenobiotics. FMO (FMO3 in liver) is predominantly responsible for metabolizing (S)-nicotine to (S)-nicotine N-1′-oxide, which is excreted in urine. FMO is also involved in S-oxygenation of cimetidine, an H₂-antagonist widely used for the treatment of gastric ulcers. Liver-expressed forms of FMO are not under the same regulatory control as cytochrome P450. In rats, for example, phenobarbital treatment leads to the induction of cytochrome P450, but the repression of FMO1.

### Lysyl Oxidase

Lysyl oxidase (lysine 6-oxidase, LO) is a copper-dependent amine oxidase involved in the formation of connective tissue matrices by crosslinking collagen and elastin. LO is secreted as an N-glycosylated precursor protein of approximately 50 kDa and cleaved to the mature form of the enzyme by a metalloprotease, although the precursor form is also active. The copper atom in LO is involved in the transport of electrons to and from oxygen to facilitate the oxidative deamination of lysine residues in these extracellular matrix proteins. While the coordination of copper is essential to LO activity, insufficient dietary intake of copper does not influence the expression of the apoenzyme. However, the absence of the functional LO is linked to the skeletal and vascular tissue disorders that are associated with dietary copper deficiency. LO is also inhibited by a variety of semicarbazides, hydrazines, and amino nitrites, as well as heparin. Beta-aminopropionitrile is a commonly used inhibitor. LO activity is increased in response to ozone, cadmium, and elevated levels of hormones released in response to local tissue trauma, such as transforming growth factor-beta, platelet-derived growth factor, angiotensin II, and fibroblast growth factor. Abnormalities in LO activity have been linked to Menkes syndrome and occipital horn syndrome. Cytosolic forms of the enzyme have been implicated in abnormal cell proliferation (reviewed in Rucker, R. B. et al. (1998) Am. J. Clin. Nutr. 67:996 S-1002S and Smith-Mungo, L. I. and H. M. Kagan (1998) Matrix Biol. 16:387-398).

### Dihydrofolate Reductases

Dihydrofolate reductases (DHFR) are ubiquitous enzymes that catalyze the NADPH-dependent reduction of dihydrofolate to tetrahydrofolate, an essential step in the de novo synthesis of glycine and purines as well as the conversion of deoxyuridine monophosphate (dUMP) to deoxythymidine monophosphate (dTMP). The basic reaction is as follows:

7,8-dihydrofolate+NADPH→5,6,7,8-tetrahydrofolate+NADP

The enzymes can be inhibited by a number of dihydrofolate analogs, including trimethroprim and methotrexate. Since an abundance of dTMP is required for DNA synthesis, rapidly dividing cells require the activity of DHFR. The replication of DNA viruses (i.e., herpesvirus) also requires high levels of DHFR activity. As a result, drugs that target DHFR have been used for cancer chemotherapy and to inhibit DNA virus replication. (For similar reasons, thymidylate synthetases are also target enzymes.) Drugs that inhibit DHFR are preferentially cytotoxic for rapidly dividing cells (or DNA virus-infected cells) but have no specificity, resulting in the indiscriminate destruction of dividing cells. Furthermore, cancer cells may become resistant to drugs such as methotrexate as a result of acquired transport defects or the duplication of one or more DHFR genes (Stryer, L. (1988) Biochemistry. W.H. Freeman and Co., Inc. New York. pp. 511-519).

### Aldo/Keto Reductases

Aldo/keto reductases are monomeric NADPH-dependent oxidoreductases with broad substrate specificities (Bohren, K. M. et al. (1989) J. Biol. Chem. 264:9547-9551). These enzymes catalyze the reduction of carbonyl-containing compounds, including carbonyl-containing sugars and aromatic compounds, to the corresponding alcohols. Therefore, a variety of carbonyl-containing drugs and xenobiotics are likely metabolized by enzymes of this class.

One known reaction catalyzed by a family member, aldose reductase, is the reduction of glucose to sorbitol, which is then further metabolized to fructose by sorbitol dehydrogenase. Under normal conditions, the reduction of glucose to sorbitol is a minor pathway. In hyperglycemic states, however, the accumulation of sorbitol is implicated in the development of diabetic complications (OMIM #103880 Aldo-keto reductase family 1, member B 1). Members of this enzyme family are also highly expressed in some liver cancers (Cao, D. et al. (1998) J. Biol. Chem. 273:11429-11435).

### Alcohol Dehydrogenases

Alcohol dehydrogenases (ADHs) oxidize simple alcohols to the corresponding aldehydes. ADH is a cytosolic enzyme, prefers the cofactor NAD⁺, and also binds zinc ion. Liver contains the highest levels of ADH, with lower levels in kidney, lung, and the gastric mucosa.

Known ADH isoforms are dimeric proteins composed of 40 kDa subunits. There are five known gene loci which encode these subunits (a, b, g, p, c), and some of the loci have characterized allelic variants (b₁, b₂, b₃, g₁, g₂). The subunits can form homodimers and heterodimers; the subunit composition determines the specific properties of the active enzyme. The holoenzymes have therefore been categorized as Class I (subunit compositions aa, ab, ag, bg, gg), Class II (pp), and Class III (cc). Class I ADH isozymes oxidize ethanol and other small aliphatic alcohols, and are inhibited by pyrazole. Class II isozymes prefer longer chain aliphatic and aromatic alcohols, are unable to oxidize methanol, and are not inhibited by pyrazole. Class III isozymes prefer even longer chain aliphatic alcohols (five carbons and longer) and aromatic alcohols, and are not inhibited by pyrazole.

The short-chain alcohol dehydrogenases include a number of related enzymes with a variety of substrate specificities. Included in this group are the mammalian enzymes D-beta-hydroxybutyrate dehydrogenase, (R)-3-hydroxybutyrate dehydrogenase, 15-hydroxyprostaglandin dehydrogenase, NADPH-dependent carbonyl reductase, corticosteroid 11-beta-dehydrogenase, and estradiol 17-beta-dehydrogenase, as well as the bacterial enzymes acetoacetyl-CoA reductase, glucose 1-dehydrogenase, 3-beta-hydroxysteroid dehydrogenase, 20-beta-hydroxysteroid dehydrogenase, ribitol dehydrogenase, 3-oxoacyl reductase, 2,3-dihydro-2,3-dihydroxybenzoate dehydrogenase, sorbitol-6-phosphate 2-dehydrogenase, 7-alpha-hydroxysteroid dehydrogenase, cis-1,2-dihydroxy-3,4-cyclohexadiene-1-carboxylate dehydrogenase, cis-toluene dihydrodiol dehydrogenase, cis-benzene glycol dehydrogenase, biphenyl-2,3-dihydro-2,3-diol dehydrogenase, N-acylmannosamine 1-dehydrogenase, and 2-deoxy-D-gluconate 3-dehydrogenase (Krozowski, Z. (1994) J. Steroid Biochem. Mol. Biol. 51:125-130; Krozowski, Z. (1992) Mol. Cell. Endocrinol. 84:C25-31; and Marks, A. R. et al. (1992) J. Biol. Chem. 267:15459-15463).

### Sulfotransferases

Sulfate conjugation occurs on many of the same substrates which undergo O-glucuronidation to produce a highly water-soluble sulfuric acid ester. Sulfotransferases (ST) catalyze this reaction by transferring SO₃⁻ from the cofactor 3′-phosphoadenosine-5′-phosphosulfate (PAPS) to the substrate. ST substrates are predominantly phenols and aliphatic alcohols, but also include aromatic amines and aliphatic amines, which are conjugated to produce the corresponding sulfamates. The products of these reactions are excreted mainly in urine.

STs are found in a wide range of tissues, including liver, kidney, intestinal tract, lung, platelets, and brain. The enzymes are generally cytosolic, and multiple forms are often co-expressed. For example, there are more than a dozen forms of ST in rat liver cytosol. These biochemically characterized STs fall into five classes based on their substrate preference: arylsulfotransferase, alcohol sulfotransferase, estrogen sulfotransferase, tyrosine ester sulfotransferase, and bile salt sulfotransferase.

ST enzyme activity varies greatly with sex and age in rats. The combined effects of developmental cues and sex-related hormones are thought to lead to these differences in ST expression profiles, as well as the profiles of other DMEs such as cytochromes P450. Notably, the high expression of STs in cats partially compensates for their low level of UDP glucuronyltransferase activity.

Several forms of ST have been purified from human liver cytosol and cloned. There are two phenol sulfotransferases with different thermal stabilities and substrate preferences. The thermostable enzyme catalyzes the sulfation of phenols such as para-nitrophenol, minoxidil, and acetaminophen; the thermolabile enzyme prefers monoamine substrates such as dopamine, epinephrine, and levadopa. Other cloned STs include an estrogen sulfotransferase and an N-acetylglucosamine-6-O-sulfotransferase-. This last enzyme is illustrative of the other major role of STs in cellular biochemistry, the modification of carbohydrate structures that may be important in cellular differentiation and maturation of proteoglycans. Indeed, an inherited defect in a sulfotransferase has been implicated in macular corneal dystrophy, a disorder characterized by a failure to synthesize mature keratan sulfate proteoglycans (Nakazawa, K. et al. (1984) J. Biol. Chem. 259:13751-13757; OMIM #217800 Macular dystrophy, corneal).

### Galactosyltransferases

Galactosyltransferases are a subset of glycosyltransferases that transfer galactose (Gal) to the terminal N-acetylglucosamine (GlcNAc) oligosaccharide chains that are part of glycoproteins or glycolipids that are free in solution (Kolbinger, F. et al. (1998) J. Biol. Chem. 273:433-440; Amado, M. et al. (1999) Biochim. Biophys. Acta 1473:35-53). Galactosyltransferases have been detected on the cell surface and as soluble extracellular proteins, in addition to being present in the Golgi. P1,3-galactosyltransferases form Type I carbohydrate chains with Gal (β.1-3)GlcNAc linkages. Known human and mouse β1,3-galactosyltransferases appear to have a short cytosolic domain, a single transmembrane domain, and a catalytic domain with eight conserved regions. (Kolbinger et al., supra; and Hennet, T. et al. (1998) J. Biol. Chem. 273:58-65). In mouse UDP-galactose: β-N-acetylglucosamine β1,3-galactosyltransferase-I region 1 is located at amino acid residues 78-83, region 2 is located at amino acid residues 93-102, region 3 is located at amino acid residues 116-119, region 4 is located at amino acid residues 147-158, region 5 is located at amino acid residues 172-183, region 6 is located at amino acid residues 203-206, region 7 is located at amino acid residues 236-246, and region 8 is located at amino acid residues 264-275. A variant of a sequence found within mouse UDP-galactose: β-N-acetylglucosamine β1,3-galactosyltransferase-I region 8 is also found in bacterial galactosyltransferases, suggesting that this sequence defines a galactosyltransferase sequence motif (Hennet et al., supra). Recent work suggests that brainiac protein is a β1,3-galactosyltransferase (Yuan, Y. et al. (1997) Cell 88:9-11; and Hennet et al., supra).

UDP-Gal:GlcNAc-1,4-galactosyltransferase (−1,4-GalT) (Sato, T. et al., (1997) EMBO J. 16:1850-1857) catalyzes the formation of Type II carbohydrate chains with Gal (β1-4)GlcNAc linkages. As is the case with the β1,3-galactosyltransferase, a soluble form of the enzyme is formed by cleavage of the membrane-bound form. Amino acids conserved among β1,4-galactosyltransferases include two cysteines linked through a disulfide-bond and a putative UDP-galactose-binding site in the catalytic domain (Yadav, S, and K. Brew (1990) J. Biol. Chem. 265:14163-14169; Yadav, S. P. and K. Brew (1991) J. Biol. Chem. 266:698-703; and Shaper, N. L. et al. (1997) J. Biol. Chem. 272:31389-31399). β1,4-galactosyltransferases have several specialized roles in addition to synthesizing carbohydrate chains on glycoproteins or glycolipids. In mammals a β1,4-galactosyltransferase, as part of a heterodimer with α.-lactalbumin, functions in lactating mammary gland lactose production. A β1,4-galactosyltransferase on the surface of sperm functions as a receptor that specifically recognizes the egg. Cell surface β1,4-galactosyltransferases also function in cell adhesion, cell/basal lamina interaction, and normal and metastatic cell migration. (Shur, B. (1993) Curr. Opin. Cell Biol. 5:854-863; and Shaper, J. (1995) Adv. Exp. Med. Biol. 376:95-104).

### Gamma-Glutamyl Transpeptidase

Gamma-glutamyl transpeptidases are ubiquitously expressed enzymes that initiate extracellular glutathione (GSH) breakdown by cleaving gamma-glutamyl amide bonds. The breakdown of GSH provides cells with a regional cysteine pool for biosynthetic pathways. Gamma-glutamyl transpeptidases also contribute to cellular antioxidant defenses and expression is induced by oxidative stress. The cell surface-localized glycoproteins are expressed at high levels in cancer cells. Studies have suggested that the high level of gamma-glutamyl transpeptidase activity present on the surface of cancer cells could be exploited to activate precursor drugs, resulting in high local concentrations of anti-cancer therapeutic agents (Hanigan, M. H. (1998) Chem. Biol. Interact. 111-112:333-342; Taniguchi, N. and Y. Ikeda (1998) Adv. Enzymol. Relat. Areas Mol. Biol. 72:239-278; Chikhi, N. et al. (1999) Comp. Biochem. Physiol. B. Biochem. Mol. Biol. 122:367-380).

### Aminotransferases

Aminotransferases comprise a family of pyridoxal 5′-phosphate (PLP)-dependent enzymes that catalyze transformations of amino acids. Aspartate aminotransferase (AspAT) is the most extensively studied PLP-containing enzyme. It catalyzes the reversible transamination of dicarboxylic L-amino acids, aspartate and glutamate, and the corresponding 2-oxo acids, oxalacetate and 2-oxoglutarate. Other members of the family include pyruvate aminotransferase, branched-chain amino acid aminotransferase, tyrosine aminotransferase, aromatic aminotransferase, alanine:glyoxylate aminotransferase (AGT), and kynurenine aminotransferase (Vacca, R. A. et al. (1997) J. Biol. Chem. 272:21932-21937).

Primary hyperoxaluria type-1 is an autosomal recessive disorder resulting in a deficiency in the liver-specific peroxisomal enzyme, alanine:glyoxylate aminotransferase-1. The phenotype of the disorder is a deficiency in glyoxylate metabolism. In the absence of AGT, glyoxylate is oxidized to oxalate rather than being transaminated to glycine. The result is the deposition of insoluble calcium oxalate in the kidneys and urinary tract, ultimately causing renal failure (Lumb, M. J. et al. (1999) J. Biol. Chem. 274:20587-20596).

Kynurenine aminotransferase catalyzes the irreversible transamination of the L-tryptophan metabolite L-kynurenine to form kynurenic acid. The enzyme may also catalyze the reversible transamination reaction between L-2-aminoadipate and 2-oxoglutarate to produce 2-oxoadipate and L-glutamate. Kynurenic acid is a putative modulator of glutamatergic neurotransmission; thus a deficiency in kynurenine aminotransferase may be associated with pleotrophic effects (Buchli, R. et al. (1995) J. Biol. Chem. 270:29330-29335).

### Catechol-O-Methyltransferase

Catechol-O-methyltransferase (COMT) catalyzes the transfer of the methyl group of S-adenosyl-L-methionine (AdoMet; SAM) donor to one of the hydroxyl groups of the catechol substrate (e.g., L-dopa, dopamine, or DBA). Methylation of the 3′-hydroxyl group is favored over methylation of the 4′-hydroxyl group and the membrane bound isoform of COMT is more regiospecific than the soluble form. Translation of the soluble form of the enzyme results from utilization of an internal start codon in a full-length mRNA (1.5 kb) or from the translation of a shorter mRNA (1.3 kb), transcribed from an internal promoter. The proposed S_{N}2-like methylation reaction requires Mg⁺⁺ and is inhibited by Ca⁺⁺. The binding of the donor and substrate to COMT occurs sequentially. AdoMet first binds COMT in a Mg⁺⁺-independent manner, followed by the binding of Mg⁺⁺ and the binding of the catechol substrate.

The amount of COMT in tissues is relatively high compared to the amount of activity normally required, thus inhibition is problematic. Nonetheless, inhibitors have been developed for in vitro use (e.g., gallates, tropolone, U-0521, and 3′,4′-dihydroxy-2-methyl-propiophetropol-one) and for clinical use (e.g., nitrocatechol-based compounds and tolcapone). Administration of these inhibitors results in the increased half-life of L-dopa and the consequent formation of dopamine. Inhibition of COMT is also likely to increase the half-life of various other catechol-structure compounds, including but not limited to epinephrine/norepinephrine, isoprenaline, rimiterol, dobutamine, fenoldopam, apomorphine, and a.-methyldopa. A deficiency in norepinephrine has been linked to clinical depression, hence the use of COMT inhibitors could be useful in the treatment of depression. COMT inhibitors are generally well tolerated with minimal side effects and are ultimately metabolized in the liver with only minor accumulation of metabolites in the body (Mnnisto, P. T. and S. Kaakkola (1999) Pharmacol. Rev. 51:593-628).

### Copper-Zinc Superoxide Dismutases

Copper-zinc superoxide dismutases are compact homodimeric metalloenzymes involved in cellular defenses against oxidative damage. The enzymes contain one atom of zinc and one atom of copper per subunit and catalyze the dismutation of superoxide anions into O₂ and H₂O₂ The rate of dismutation is diffusion-limited and consequently enhanced by the presence of favorable electrostatic interactions between the substrate and enzyme active site. Examples of this class of enzyme have been identified in the cytoplasm of all the eukaryotic cells as well as in the periplasm of several bacterial species. Copper-zinc superoxide dismutases are robust enzymes that are highly resistant to proteolytic digestion and denaturing by urea and SDS. In addition to the compact structure of the enzymes, the presence of the metal ions and intrasubunit disulfide bonds is believed to be responsible for enzyme stability. The enzymes undergo reversible denaturation at temperatures as high as 70° C. (Battistoni, A. et al. (1998) J. Biol. Chem. 273:5655-5661).

Overexpression of superoxide dismutase has been implicated in enhancing freezing tolerance of transgenic alfalfa as well as providing resistance to environmental toxins such as the diphenyl ether herbicide, acifluorfen (McKersie, B. D. et al. (1993) Plant Physiol. 103:1155-1163). In addition, yeast cells become more resistant to freeze-thaw damage following exposure to hydrogen peroxide which causes the yeast cells to adapt to further peroxide stress by upregulating expression of superoxide dismutases. In this study, mutations to yeast superoxide dismutase genes had a more detrimental effect on freeze-thaw resistance than mutations which affected the regulation of glutathione metabolism, long suspected of being important in determining an organism's survival through the process of cryopreservation (Jong-In Park, J.-I. et al. (1998) J. Biol. Chem. 273:22921-22928).

Expression of superoxide dismutase is also associated with Mycobacterium tuberculosis, the organism that causes tuberculosis. Superoxide dismutase is one of the ten major proteins secreted by M. tuberculosis and its expression is upregulated approximately 5-fold in response to oxidative stress. M. tuberculosis expresses almost two orders of magnitude more superoxide dismutase than the nonpathogenic mycobacterium M. smegmatis, and secretes a much higher proportion of the expressed enzyme. The result is the secretion of .about.350-fold more enzyme by M. tuberculosis than M. smegmatis, providing substantial resistance to oxidative stress (Harth, G. and M. A. Horwitz (1999) J. Biol. Chem. 274:4281-4292).

The reduced expression of copper-zinc superoxide dismutases, as well as other enzymes with anti-oxidant capabilities, has been implicated in the early stages of cancer. The expression of copper-zinc superoxide dismutases is reduced in prostatic intraepithelial neoplasia and prostate carcinomas, (Bostwick, D. G. (2000) Cancer 89:123-134).

### Phosphoesterases

Phosphotriesterases (PTE, paraoxonases) are enzymes that hydrolyze toxic organophosphorus compounds and have been isolated from a variety of tissues. Phosphotriesterases play a central role in the detoxification of insecticides by mammals. Birds and insects lack PTE, and as a result have reduced tolerance for organophosphorus compounds (Vilanova, E. and M. A. Sogorb (1999) Crit. Rev. Toxicol. 29:21-57). Phosphotriesterase activity varies among individuals and is lower in infants than adults. PTE knockout mice are markedly more sensitive to the organophosphate-based toxins diazoxon and chlorpyrifos oxon (Furlong, C. E., et al. (2000) Neurotoxicology 21:91-100). Phosphotriesterase is also implicated in atherosclerosis and diseases involving lipoprotein metabolism.

Glycerophosphoryl diester phosphodiesterase (also known as glycerophosphodiester phosphodiesterase) is a phosphodiesterase which hydrolyzes deacetylated phospholipid glycerophosphodiesters to produce sn-glycerol-3-phosphate and an alcohol. Glycerophosphocholine, glycerophosphoethanolamine, glycerophosphoglycerol, and glycerophosphoinositol are examples of substrates for glycerophosphoryl diester phosphodiesterases. A glycerophosphoryl diester phosphodiesterase from E. coli has broad specificity for glycerophosphodiester substrates (Larson, T. J. et al. (1983) J. Biol. Chem. 248:5428-5432).

Cyclic nucleotide phosphodiesterases (PDEs) are crucial enzymes in the regulation of the cyclic nucleotides cAMP and cGMP. cAMP and cGMP function as intracellular second messengers to transduce a variety of extracellular signals including hormones, light, and neurotransmitters. PDEs degrade cyclic nucleotides to their corresponding monophosphates, thereby regulating the intracellular concentrations of cyclic nucleotides and their effects on signal transduction. Due to their roles as regulators of signal transduction, PDEs have been extensively studied as chemotherapeutic targets (Perry, M. J. and G. A. Higgs (1998) Curr. Opin. Chem. Biol. 2:472-481; Torphy, J. T. (1998) Am. J. Resp. Crit. Care Med. 157:351-370).

Families of mammalian PDEs have been classified based on their substrate specificity and affinity, sensitivity to cofactors, and sensitivity to inhibitory agents (Beavo, J. A. (1995) Physiol. Rev. 75:725-748; Conti, M. et al. (1995) Endocrine Rev. 16:370-389). Several of these families contain distinct genes, many of which are expressed in different tissues as splice variants. Within PDE families, there are multiple isozymes and multiple splice variants of these isozymes (Conti, M. and S.-L. C. Jin (1999) Prog. Nucleic Acid Res. Mol. Biol. 63:1-38). The existence of multiple PDE families, isozymes, and splice variants is an indication of the variety and complexity of the regulatory pathways involving cyclic nucleotides (Houslay, M. D. and G. Milligan (1997) Trends Biochem. Sci. 22:217-224).

Type 1 PDEs (PDE1s) are Ca²⁺/calmodulin-dependent and appear to be encoded by at least three different genes, each having at least two different splice variants (Kakkar, R. et al. (1999) Cell Mol. Life. Sci. 55:1164-1186). PDE1s have been found in the lung, heart, and brain. Some PDE1 isozymes are regulated in vitro by phosphorylation/dephosphorylation-. Phosphorylation of these PDE1 isozymes decreases the affinity of the enzyme for calmodulin, decreases PDE activity, and increases steady state levels of cAMP (Kakkar et al., supra). PDE1s may provide useful therapeutic targets for disorders of the central nervous system and the cardiovascular and immune systems, due to the involvement of PDE1s in both cyclic nucleotide and calcium signaling (Perry and Higgs, supra).

PDE2s are cGMP-stimulated PDEs that have been found in the cerebellum, neocortex, heart, kidney, lung, pulmonary artery, and skeletal muscle (Sadhu, K. et al. (1999) J. Histochem. Cytochem. 47:895-906). PDE2s are thought to mediate the effects of cAMP on catecholamine secretion, participate in the regulation of aldosterone (Beavo, supra), and play a role in olfactory signal transduction (Juilfs, D. M. et al. (1997) Proc. Natl. Acad. Sci. USA 94:3388-3395).

PDE3s have high affinity for both cGMP and cAMP, and so these cyclic nucleotides act as competitive substrates for PDE3s. PDE3s play roles in stimulating myocardial contractility, inhibiting platelet aggregation, relaxing vascular and airway smooth muscle, inhibiting proliferation of T-lymphocytes and cultured vascular smooth muscle cells, and regulating catecholamine-induced release of free fatty acids from adipose tissue. The PDE3 family of phosphodiesterases are sensitive to specific inhibitors such as cilostamide, enoximone, and lixazinone. Isozymes of PDE3 can be regulated by cAMP-dependent protein kinase, or by insulin-dependent kinases (Degerman, E. et al. (1997) J. Biol. Chem. 272:6823-6826).

PDE4s are specific for cAMP; are localized to airway smooth muscle, the vascular endothelium, and all inflammatory cells; and can be activated by cAMP-dependent phosphorylation. Since elevation of cAMP levels can lead to suppression of inflammatory cell activation and to relaxation of bronchial smooth muscle, PDE4s have been studied extensively as possible targets for novel anti-inflammatory agents, with special emphasis placed on the discovery of asthma treatments. PDE4 inhibitors are currently undergoing clinical trials as treatments for asthma, chronic obstructive pulmonary disease, and atopic eczema. All four known isozymes of PDE4 are susceptible to the inhibitor rolipram, a compound which has been shown to improve behavioral memory in mice (Barad, M. et al. (1998) Proc. Natl. Acad. Sci. USA 95:15020-15025). PDE4 inhibitors have also been studied as possible therapeutic agents against acute lung injury, endotoxemia, rheumatoid arthritis, multiple sclerosis, and various neurological and gastrointestinal indications (Doherty, A. M. (1999) Curr. Opin. Chem. Biol. 3:466-473).

PDE5 is highly selective for cGMP as a substrate (Turko, I. V. et al. (1998) Biochemistry 37:4200-4205), and has two allosteric cGMP-specific binding sites (McAllister-Lucas, L. M. et al. (1995) J. Biol. Chem. 270:30671-30679). Binding of cGMP to these allosteric binding sites seems to be important for phosphorylation of PDE5 by cGMP-dependent protein kinase rather than for direct regulation of catalytic activity. High levels of PDE5 are found in vascular smooth muscle, platelets, lung, and kidney. The inhibitor zaprinast is effective against PDE5 and PDE1s. Modification of zaprinast to provide specificity against PDE5 has resulted in sildenafil (VIAGRA; Pfizer, Inc., New York N.Y.), a treatment for male erectile dysfunction (Terrett, N. et al. (1996) Bioorg. Med. Chem. Lett. 6:1819-1824). Inhibitors of PDE5 are currently being studied as agents for cardiovascular therapy (Perry and Higgs, supra).

PDE6s, the photoreceptor cyclic nucleotide phosphodiesterases, are crucial components of the phototransduction cascade. In association with the G-protein transducin, PDE6s hydrolyze cGMP to regulate cGMP-gated cation channels in photoreceptor membranes. In addition to the cGMP-binding active site, PDE6s also have two high-affinity cGMP-binding sites which are thought to play a regulatory role in PDE6 function (Artemyev, N. O. et al. (1998) Methods 14:93-104). Defects in PDE6s have been associated with retinal disease. Retinal degeneration in the rd mouse (Yan, W. et al. (1998) Invest. Opthalmol. Vis. Sci. 39:2529-2536), autosomal recessive retinitis pigmentosa in humans (Danciger, M. et al. (1995) Genomics 30:1-7), and rod/cone dysplasia 1 in Irish Setter dogs (Suber, M. L. et al. (1993) Proc. Natl. Acad. Sci. USA 90:3968-3972) have been attributed to mutations in the PDE6B gene.

The PDE7 family of PDEs consists of only one known member having multiple splice variants (Bloom, T. J. and J. A. Beavo (1996) Proc. Natl. Acad. Sci. USA 93:14188-14192). PDE7s are cAMP specific, but little else is known about their physiological function. Although mRNAs encoding PDE7s are found in skeletal muscle, heart, brain, lung, kidney, and pancreas, expression of PDE7 proteins is restricted to specific tissue types (Han, P. et al. (1997) J. Biol. Chem. 272:16152-16157; Perry and Higgs, supra). PDE7s are very closely related to the PDE4 family; however, PDE7s are not inhibited by rolipram, a specific inhibitor of PDE4s (Beavo, supra).

PDE8s are cAMP specific, and are closely related to the PDE4 family. PDE8s are expressed in thyroid gland, testis, eye, liver, skeletal muscle, heart, kidney, ovary, and brain. The cAMP-hydrolyzing activity of PDE8s is not inhibited by the PDE inhibitors rolipram, vinpocetine, milrinone, IBMX (3-isobutyl-1-methylxanthine), or zaprinast, but PDE8s are inhibited by dipyridamole (Fisher, D. A. et al. (1998) Biochem. Biophys. Res. Commun. 246:570-577; Hayashi, M. et al. (1998) Biochem. Biophys. Res. Commun. 250:751-756; Soderling, S. H. et al. (1998) Proc. Natl. Acad. Sci. USA 95:8991-8996).

PDE9s are cGMP specific and most closely resemble the PDE8 family of PDEs. PDE9s are expressed in kidney, liver, lung, brain, spleen, and small intestine. PDE9s are not inhibited by sildenafil (VIAGRA; Pfizer, Inc., New York N.Y.), rolipram, vinpocetine, dipyridamole, or IBMX (3-isobutyl-1-methylxanthine), but they are sensitive to the PDE5 inhibitor zaprinast (Fisher, D. A. et al. (1998) J. Biol. Chem. 273:15559-15564; Soderling, S. H. et al. (1998) J. Biol. Chem. 273:15553-15558).

PDE10s are dual-substrate PDEs, hydrolyzing both cAMP and cGMP. PDE10s are expressed in brain, thyroid, and testis. (Soderling, S. H. et al. (1999) Proc. Natl. Acad. Sci. USA 96:7071-7076; Fujishige, K. et al. (1999) J. Biol. Chem. 274:18438-18445; Loughney, K. et al (1999) Gene 234:109-117).

PDEs are composed of a catalytic domain of about 270-300 amino acids, an N-terminal regulatory domain responsible for binding cofactors, and, in some cases, a hydrophilic C-terminal domain of unknown function (Conti and Jin, supra). A conserved, putative zinc-binding motif has been identified in the catalytic domain of all PDEs. N-terminal regulatory domains include non-catalytic cGMP-binding domains in PDE2s, PDE5s, and PDE6s; calmodulin-binding domains in PDE1s; and domains containing phosphorylation sites in PDE3s and PDE4s. In PDE5, the N-terminal cGMP-binding domain spans about 380 amino acid residues and comprises tandem repeats of a conserved sequence motif (McAllister-Lucas, L. M. et al. (1993) J. Biol. Chem. 268:22863-22873). The NKXnD motif has been shown by mutagenesis to be important for cGMP binding (Turko, I. V. et al. (1996) J. Biol. Chem. 271:22240-22244). PDE families display approximately 30% amino acid identity within the catalytic domain; however, isozymes within the same family typically display about 85-95% identity in this region (e.g. PDE4A vs PDE4B). Furthermore, within a family to there is extensive similarity (>60%) outside the catalytic domain; while across families, there is little or no sequence similarity outside this domain.

Many of the constituent functions of immune and inflammatory responses are inhibited by agents that increase intracellular levels of cAMP (Verghese, M. W. et al. (1995) Mol. Pharmacol. 47:1164-1171). A variety of diseases have been attributed to increased PDE activity and associated with decreased levels of cyclic nucleotides. For example, a form of diabetes insipidus in mice has been associated with increased PDE4 activity, an increase in low-Kₘ cAMP PDE activity has been reported in leukocytes of atopic patients, and PDE3 has been associated with cardiac disease.

Many inhibitors of PDEs have undergone clinical evaluation (Perry and Higgs, supra; Torphy, T. J. (1998) Am. J. Respir. Crit. Care Med. 157:351-370). PDE3 inhibitors are being developed as antithrombotic agents, antihypertensive agents, and as cardiotonic agents useful in the treatment of congestive heart failure. Rolipram, a PDE4 inhibitor, has been used in the treatment of depression, and other PDE4 inhibitors have an anti-inflammatory effect. Rolipram may inhibit HIV-1 replication (Angel, J. B. et al. (1995) AIDS 9:1137-1144). Additionally, rolipram suppresses the production of cytokines such as TNF-a and b and interferon g, and thus is effective against encephalomyelitis. Rolipram may also be effective in treating tardive dyskinesia and multiple sclerosis (Sommer, N. et al. (1995) Nat. Med. 1:244-248; Sasaki, H. et al. (1995) Eur. J. Pharmacol. 282:71-76). Theophylline is a nonspecific PDE inhibitor used in treatment of bronchial asthma and other respiratory diseases. Theophylline is believed to act on airway smooth muscle function and in an anti-inflammatory or immunomodulatory capacity Banner, K. H. and C. P. Page (1995) Eur. Respir. J. 8:996-1000). Pentoxifylline is another nonspecific PDE inhibitor used in the treatment of intermittent claudication and diabetes-induced peripheral vascular disease. Pentoxifylline is also known to block TNF-a production and may inhibit HIV-1 replication (Angel et al., supra).

PDEs have been reported to affect cellular proliferation of a variety of cell types (Conti et al. (1995) Endocrine Rev. 16:370-389) and have been implicated in various cancers. Growth of prostate carcinoma cell lines DU145 and LNCaP was inhibited by delivery of cAMP derivatives and PDE inhibitors (Bang, Y. J. et al. (1994) Proc. Natl. Acad. Sci. USA 91:5330-5334). These cells also showed a permanent conversion in phenotype from epithelial to neuronal morphology. It has also been suggested that PDE inhibitors can regulate mesangial cell proliferation (Matousovic, K. et al. (1995) J. Clin. Invest. 96:401-410) and lymphocyte proliferation (Joulain, C. et al. (1995) J. Lipid Mediat. Cell Signal. 11:63-79). One cancer treatment involves intracellular delivery of PDEs to particular cellular compartments of tumors, resulting in cell death (Deonarain, M. P. and A. A. Epenetos (1994) Br. J. Cancer 70:786-794).

Members of the UDP glucuronyltransferase family (UGTs) catalyze the transfer of a glucuronic acid group from the cofactor uridine diphosphate-glucuronic acid (UDP-glucuronic acid) to a substrate. The transfer is generally to a nucleophilic heteroatom (O, N, or S). Substrates include xenobiotics which have been functionalized by Phase I reactions, as well as endogenous compounds such as bilirubin, steroid hormones, and thyroid hormones. Products of glucuronidation are excreted in urine if the molecular weight of the substrate is less than about 250 g/mol, whereas larger glucuronidated substrates are excreted in bile.

UGTs are located in the microsomes of liver, kidney, intestine, skin, brain, spleen, and nasal mucosa, where they are on the same side of the endoplasmic reticulum membrane as cytochrome P450 enzymes and flavin-containing monooxygenases. UGTs have a C-terminal membrane-spanning domain which anchors them in the endoplasmic reticulum membrane, and a conserved signature domain of about 50 amino acid residues in their C terminal section (PROSITE PDOC00359 UDP-glycosyltransferase signature).

UGTs involved in drug metabolism are encoded by two gene families, UGT1 and UGT2. Members of the UGT1 family result from alternative splicing of a single gene locus, which has a variable substrate binding domain and constant region involved in cofactor binding and membrane insertion. Members of the UGT2 family are encoded by separate gene loci, and are divided into two families, UGT2A and UGT2B. The 2A subfamily is expressed in olfactory epithelium, and the 2B subfamily is expressed in liver microsomes. Mutations in UGT genes are associated with hyperbilirubinemia (OMIM #143500 Hyperbilirubinemia I); Crigler-Najjar syndrome, characterized by intense hyperbilirubinemia from birth (OMIM #218800 Crigler-Najjar syndrome); and a milder form of hyperbilirubinemia termed Gilbert's disease (OMIM #191740 UGT1).

### Thioesterases

Two soluble thioesterases involved in fatty acid biosynthesis have been isolated from mammalian tissues, one which is active only toward long-chain fatty-acyl thioesters and one which is active toward thioesters with a wide range of fatty-acyl chain-lengths. These thioesterases catalyze the chain-terminating step in the de novo biosynthesis of fatty acids. Chain termination involves the hydrolysis of the thioester bond which links the fatty acyl chain to the 4′-phosphopantetheine prosthetic group of the acyl carrier protein (ACP) subunit of the fatty acid synthase (Smith, S. (1981a) Methods Enzymol. 71:181-188; Smith, S. (1981b) Methods Enzymol. 71:188-200).

E. coli contains two soluble thioesterases, thioesterase I which is active only toward long-chain acyl thioesters, and thioesterase II (TEII) which has a broad chain-length specificity (Naggert, J. et al. (1991) J. Biol. Chem. 266:11044-11050). E. coli TEII does not exhibit sequence similarity with either of the two types of mammalian thioesterases which function as chain-terminating enzymes in de novo fatty acid biosynthesis. Unlike the mammalian thioesterases, E. coli TEII lacks the characteristic serine active site gly-X-ser-X-gly sequence motif and is not inactivated by the serine modifying agent diisopropyl fluorophosphate. However, modification of histidine 58 by iodoacetamide and diethylpyrocarbonate abolished TEII activity. Overexpression of TEII did not alter fatty acid content in E. coli, which suggests that it does not function as a chain-terminating enzyme in fatty acid biosynthesis (Naggert et al., supra). For that reason, Naggert et al. (supra) proposed that the physiological substrates for E. coli TEII may be coenzyme A (CoA)-fatty acid esters instead of ACP-phosphopanthetheine-fatty acid esters.

### Carboxylesterases

Mammalian carboxylesterases are a multigene family expressed in a variety of tissues and cell types. Acetylcholinesterase, butyrylcholinesterase, and carboxylesterase are grouped into the serine superfamily of esterases (B-esterases). Other carboxylesterases include thyroglobulin, thrombin, Factor IX, gliotactin, and plasminogen. Carboxylesterases catalyze the hydrolysis of ester- and amide-groups from molecules and are involved in detoxification of drugs, environmental toxins, and carcinogens. Substrates for carboxylesterases include short- and long-chain acyl-glycerols, acylcarnitine, carbonates, dipivefrin hydrochloride, cocaine, salicylates, capsaicin, palmitoyl-coenzyme A, imidapril, haloperidol, pyrrolizidine alkaloids, steroids, p-nitrophenyl acetate, malathion, butanilicaine, and isocarboxazide. Carboxylesterases are also important for the conversion of prodrugs to free acids, which may be the active form of the drug (e.g., lovastatin, used to lower blood cholesterol) (reviewed in Satoh, T. and Hosokawa, M. (1998) Annu. Rev. Pharmacol. Toxicol. 38:257-288). Neuroligins are a class of molecules that (i) have N-terminal signal sequences, (ii) resemble cell-surface receptors, (iii) contain carboxylesterase domains, (iv) are highly expressed in the brain, and (v) bind to neurexins in a calcium-dependent manner. Despite the homology to carboxylesterases, neuroligins lack the active site serine residue, implying a role in substrate binding rather than catalysis (Ichtchenko, K. et al. (1996) J. Biol. Chem. 271:2676-2682).

### Squalene Epoxidase

Squalene epoxidase (squalene monooxygenase, SE) is a microsomal membrane-bound, FAD-dependent oxidoreductase that catalyzes the first oxygenation step in the sterol biosynthetic pathway of eukaryotic cells. Cholesterol is an essential structural component of cytoplasmic membranes acquired via the LDL receptor-mediated pathway or the biosynthetic pathway. SE converts squalene to 2,3(S)oxidosqualene, which is then converted to lanosterol and then cholesterol.

High serum cholesterol levels result in the formation of atherosclerotic plaques in the arteries of higher organisms. This deposition of highly insoluble lipid material onto the walls of essential blood vessels results in decreased blood flow and potential necrosis. HMG-CoA reductase is responsible for the first committed step in cholesterol biosynthesis, conversion of 3-hydroxyl-3-methyl-glutaryl CoA (HMG-CoA) to mevalonate. HMG-CoA is the target of a number of pharmaceutical compounds designed to lower plasma cholesterol levels, but inhibition of MSG-CoA also results in the reduced synthesis of non-sterol intermediates required for other biochemical pathways. Since SE catalyzes a rate-limiting reaction that occurs later in the sterol synthesis pathway with cholesterol as the only end product, SE is a better ideal target for the design of anti-hyperlipidemic drugs (Nakamura, Y. et al. (1996) 271:8053-8056).

### Epoxide Hydrolases

Epoxide hydrolases catalyze the addition of water to epoxide-containing compounds, thereby hydrolyzing epoxides to their corresponding 1,2-diols. They are related to bacterial haloalkane dehalogenases and show sequence similarity to other members of the α/β hydrolase fold family of enzymes. This family of enzymes is important for the detoxification of xenobiotic epoxide compounds which are often highly electrophilic and destructive when introduced. Examples of epoxide hydrolase reactions include the hydrolysis of some leukotoxin to leukotoxin diol, and isoleukotoxin to isoleukotoxin diol. Leukotoxins alter membrane permeability and ion transport and cause inflammatory responses. In addition, epoxide carcinogens are produced by cytochrome P450 as intermediates in the detoxification of drugs and environmental toxins. Epoxide hydrolases possess a catalytic triad composed of Asp, Asp, and His (Arand, M. et al. (1996) J. Biol. Chem. 271:4223-4229; Rink, R. et al. (1997) J. Biol. Chem. 272:14650-14657; Argiriadi, M. A. et al. (2000) J. Biol. Chem. 275:15265-15270).

### Enzymes Involved in Tyrosine Catalysis

The degradation of the amino acid tyrosine, to either succinate and pyruvate or fumarate and acetoacetate, requires a large number of enzymes and generates a large number of intermediate compounds. In addition, many xenobiotic compounds may be metabolized using one or more reactions that are part of the tyrosine catabolic pathway. Enzymes involved in the degradation of tyrosine to succinate and pyruvate (e.g., in Arthrobacter species) include 4-hydroxyphenylpyruvate oxidase, 4-hydroxyphenylacetate 3-hydroxylase, 3,4-dihydroxyphenylacetate 2,3-dioxygenase, 5-carboxymethyl-2-hydroxymuconic semialdehyde dehydrogenase, trans,cis-5-carboxymethyl-2-hydroxymuconate isomerase, homoprotocatechuate isomerase/decarboxylase, cis-2-oxohept-3-ene-1,7-dioate hydratase, 2,4-dihydroxyhept-trans-2-ene-1,7-dioate aldolase, and succinic semialdehyde dehydrogenase. Enzymes involved in the degradation of tyrosine to fumarate and acetoacetate (e.g., in Pseudomonas species) include 4-hydroxyphenylpyruvate dioxygenase, homogentisate 1,2-dioxygenase, maleylacetoacetate isomerase, fumarylacetoacetate and 4-hydroxyphenylacetate. Additional enzymes associated with tyrosine metabolism in different organisms include 4-chlorophenylacetate-3,4-dioxygenase, aromatic aminotransferase, 5-oxopent-3-ene-1,2,5-tricarboxylate decarboxylase, 2-oxo-hept-3-ene-1,7-dioate hydratase, and 5-carboxymethyl-2-hydroxymuconate isomerase (Ellis, L. B. M. et al. (1999) Nucleic Acids Res. 27:373-376; Wackett, L. P. and Ellis, L. B. M. (1996) J. Microbiol. Meth. 25:91-93; and Schmidt, M. (1996) Amer. Soc. Microbiol. News 62:102).

In humans, acquired or inherited genetic defects in enzymes of the tyrosine degradation pathway may result in hereditary tyrosinemia. One form of this disease, hereditary tyrosinemia 1 (HT1) is caused by a deficiency in the enzyme fumarylacetoacetate hydrolase, the last enzyme in the pathway in organisms that metabolize tyrosine to fumarate and acetoacetate. HT1 is characterized by progressive liver damage beginning at infancy, and increased risk for liver cancer (Endo, F. et al. (1997) J. Biol. Chem. 272:24426-24432).

### Exemplary Agricultural Enzyme Uses

Enzymes with known function are useful in a solving a number of different agricultural problems. The following list of exemplary problems does not purport to be exhaustive.

One exemplary problem is fixation of soil nitrogen. Enzymatic solutions to this problem are described in, for example, “Management of Biological Nitrogen Fixation for the Development of More Productive and Sustainable Agricultural Systems” which presents extended versions of papers presented in the Symposium on Biological Nitrogen Fixation for Sustainable Agriculture at the 15th Congress of Soil Science, Acapulco, Mexico 1994. (Developments in Plant and Soil Sciences, Vol. 65 Ladha, J. K.; Peoples, M. B. (Eds.) published by Springer-Verlag: Reprinted from PLANT AND SOIL (1995)174:1-2, ISBN: 978-0-7923-3413-2).

Another exemplary problem is feed digestibility, for example in poultry and swine. Enzymatic solutions to this problem are described in, for example, “Enzymes in Poultry and Swine Nutrition” By Marquardt and Han (Proceedings of the first Chinese Symposium on Feed Enzymes, Nanjing Agricultural University, Nanjing, People's Republic of China, 6-8 May 1996; International Research and Development Center, Ottawa;. ISBN 088936821X). Papers presented in this reference indicate that many exciting developments can be expected regarding use of enzymes in feeds, particularly with the use of recombinant enzymes for a wide range of animals and animal feedstuffs. Enzymes not only will enable livestock and poultry producers to economically use new feedstuffs, but will also prove to be environmentally friendly, as they reduce the pollution associated with animal production.

“Enzymes in the Environment: Activity, Ecology, and Applications” edited by Burns and Dick (Books in Soils, Plants, and the Environment (2002) Volume: 84 CRC Press; ISBN: 9780824706142) points out the great unmet need for a reliable means of classifying enzymes functionally as disclosed hereinabove.

According to the Food and Agricultural Organization of the United Nations:
“Bioprocessing which involves the use of enzymes and microorganisms for the conversion of raw food materials into a diversity of products, offers tremendous opportunity for stimulating agro-industrial development in developing countries. The processes involved are scaleable, environmentally friendly, and can be economically applied and linked to existing practices in these countries. Many of the traditional food bioprocessing techniques used in developing countries however require considerable scientific and technological improvement.”

The Food and Agricultural Organization of the United Nations has also published a pamphlet entitled “SMALL-SCALE PROCESSING OF MICROBIAL PESTICIDES” Taborsky (1992) FAO AGRICULTURAL SERVICES BULLETIN No. 96; Food and Agriculture Organization of the United Nations Rome 1992) describes use of chitinase and/or other enzymes in decomposition of insect integuments.

Optionally, a bacterial polypeptide toxin, optionally an enzyme, is overpressed in plants. This strategy has previously been employed with Bacillus thurigens toxins. In an exemplary embodiment of the invention, toxins from other bacteria are identified using exemplary methods disclosed herein.

### Exemplary Formulations

In an exemplary embodiment of the invention, a polypeptide according to one or more of SEQ ID Nos.: 77,838 to 198,923 is formulated so that the enzyme(s) are efficiently presented to their substrates for substrate processing. Formulation optionally reflects intended use. In an exemplary embodiment of the invention, the formulation includes pH adjusters (e.g. buffering agents) and/or osmotic adjusters (e.g. specific salts and/or ions) to contribute to enzymatic activity The following listing of exemplary formulations does not limit the scope of the invention.

Optionally, the formulation is provided as a pharmaceutical composition.

As used herein a “pharmaceutical composition” refers to a preparation of one or more of the active ingredients described herein with other chemical components such as physiologically suitable carriers and excipients. The purpose of a pharmaceutical composition is to facilitate administration of a compound to an organism.

Herein the term “active ingredient” refers to the nucleic acid construct accountable for the biological effect.

Hereinafter, the phrases “physiologically acceptable carrier” and “pharmaceutically acceptable carrier” which may be interchangeably used refer to a carrier or a diluent that does not cause significant irritation to an organism and does not abrogate the biological activity and properties of the administered compound. An adjuvant is included under these phrases.

Herein the term “excipient” refers to an inert substance added to a pharmaceutical composition to further facilitate administration of an active ingredient. Examples, without limitation, of excipients include calcium carbonate, calcium phosphate, various sugars and types of starch, cellulose derivatives, gelatin, vegetable oils and polyethylene glycols.

Techniques for formulation and administration of drugs may be found in “Remington's Pharmaceutical Sciences,” Mack Publishing Co., Easton, Pa., latest edition, which is incorporated herein by reference.

Suitable routes of administration may, for example, include oral, rectal, transmucosal, especially transnasal, intestinal or parenteral delivery, including intramuscular, subcutaneous and intramedullary injections as well as intrathecal, direct intraventricular, intravenous, inrtaperitoneal, intranasal, or intraocular injections.

Alternately, one may administer the pharmaceutical composition in a local rather than systemic manner, for example, via injection of the pharmaceutical composition directly into a tissue region of a patient.

Pharmaceutical compositions of the present invention may be manufactured by processes well known in the art, e.g., by means of conventional mixing, dissolving, granulating, dragee-making, levigating, emulsifying, encapsulating, entrapping or lyophilizing processes.

Pharmaceutical compositions for use in accordance with the present invention thus may be formulated in conventional manner using one or more physiologically acceptable carriers comprising excipients and auxiliaries, which facilitate processing of the active ingredients into preparations which, can be used pharmaceutically. Proper formulation is dependent upon the route of administration chosen.

For injection, the active ingredients of the pharmaceutical composition may be formulated in aqueous solutions, preferably in physiologically compatible buffers such as Hank's solution, Ringer's solution, or physiological salt buffer. For transmucosal administration, penetrants appropriate to the barrier to be permeated are used in the formulation. Such penetrants are generally known in the art.

For oral administration, the pharmaceutical composition can be formulated readily by combining the active compounds with pharmaceutically acceptable carriers well known in the art. Such carriers enable the pharmaceutical composition to be formulated as tablets, pills, dragees, capsules, liquids, gels, syrups, slurries, suspensions, and the like, for oral ingestion by a patient. Pharmacological preparations for oral use can be made using a solid excipient, optionally grinding the resulting mixture, and processing the mixture of granules, after adding suitable auxiliaries if desired, to obtain tablets or dragee cores. Suitable excipients are, in particular, fillers such as sugars, including lactose, sucrose, mannitol, or sorbitol; cellulose preparations such as, for example, maize starch, wheat starch, rice starch, potato starch, gelatin, gum tragacanth, methyl cellulose, hydroxypropylmethyl-cellulose, sodium carbomethylcellulose; and/or physiologically acceptable polymers such as polyvinylpyrrolidone (PVP). If desired, disintegrating agents may be added, such as cross-linked polyvinyl pyrrolidone, agar, or alginic acid or a salt thereof such as sodium alginate.

Dragee cores are provided with suitable coatings. For this purpose, concentrated sugar solutions may be used which may optionally contain gum arabic, talc, polyvinyl pyrrolidone, carbopol gel, polyethylene glycol, titanium dioxide, lacquer solutions and suitable organic solvents or solvent mixtures. Dyestuffs or pigments may be added to the tablets or dragee coatings for identification or to characterize different combinations of active compound doses.

Pharmaceutical compositions which can be used orally, include push-fit capsules made of gelatin as well as soft, sealed capsules made of gelatin and a plasticizer, such as glycerol or sorbitol. The push-fit capsules may contain the active ingredients in admixture with filler such as lactose, binders such as starches, lubricants such as talc or magnesium stearate and, optionally, stabilizers. In soft capsules, the active ingredients may be dissolved or suspended in suitable liquids, such as fatty oils, liquid paraffin, or liquid polyethylene glycols. In addition, stabilizers may be added. All formulations for oral administration should be in dosages suitable for the chosen route of administration.

For buccal administration, the compositions may take the form of tablets or lozenges formulated in conventional manner.

For administration by nasal inhalation, the active ingredients for use according to the present invention are conveniently delivered in the form of an aerosol spray presentation from a pressurized pack or a nebulizer with the use of a suitable propellant, e.g., dichlorodifluoromethane, trichlorofluoromethane, dichloro-tetrafluoroethane or carbon dioxide. In the case of a pressurized aerosol, the dosage unit may be determined by providing a valve to deliver a metered amount. Capsules and cartridges of, e.g., gelatin for use in a dispenser may be formulated containing a powder mix of the compound and a suitable powder base such as lactose or starch.

The pharmaceutical composition described herein may be formulated for parenteral administration, e.g., by bolus injection or continuos infusion. Formulations for injection may be presented in unit dosage form, e.g., in ampoules or in multidose containers with optionally, an added preservative. The compositions may be suspensions, solutions or emulsions in oily or aqueous vehicles, and may contain formulatory agents such as suspending, stabilizing and/or dispersing agents.

Pharmaceutical compositions for parenteral administration include aqueous solutions of the active preparation in water-soluble form. Additionally, suspensions of the active ingredients may be prepared as appropriate oily or water based injection suspensions. Suitable lipophilic solvents or vehicles include fatty oils such as sesame oil, or synthetic fatty acids esters such as ethyl oleate, triglycerides or liposomes. Aqueous injection suspensions may contain substances, which increase the viscosity of the suspension, such as sodium carboxymethyl cellulose, sorbitol or dextran. Optionally, the suspension may also contain suitable stabilizers or agents which increase the solubility of the active ingredients to allow for the preparation of highly concentrated solutions.

Alternatively, the active ingredient may be in powder form for constitution with a suitable vehicle, e.g., sterile, pyrogen-free water based solution, before use.

The pharmaceutical composition of the present invention may also be formulated in rectal compositions such as suppositories or retention enemas, using, e.g., conventional suppository bases such as cocoa butter or other glycerides.

Pharmaceutical compositions suitable for use in context of the present invention include compositions wherein the active ingredients are contained in an amount effective to achieve the intended purpose. More specifically, a therapeutically effective amount means an amount of active ingredients (nucleic acid construct) effective to prevent, alleviate or ameliorate symptoms of a disorder (e.g., ischemia) or prolong the survival of the subject being treated.

Determination of a therapeutically effective amount is well within the capability of those skilled in the art, especially in light of the detailed disclosure provided herein.

For any preparation used in the methods of the invention, the therapeutically effective amount or dose can be estimated initially from in vitro and cell culture assays. For example, a dose can be formulated in animal models to achieve a desired concentration or titer. Such information can be used to more accurately determine useful doses in humans.

Toxicity and therapeutic efficacy of the active ingredients described herein can be determined by standard pharmaceutical procedures in vitro, in cell cultures or experimental animals. The data obtained from these in vitro and cell culture assays and animal studies can be used in formulating a range of dosage for use in human. The dosage may vary depending upon the dosage form employed and the route of administration utilized. The exact formulation, route of administration and dosage can be chosen by the individual physician in view of the patient's condition. (See e.g., Fingl, et al., 1975, in “The Pharmacological Basis of Therapeutics”, Ch. 1 p. 1).

Dosage amount and interval may be adjusted individually to provide plasma or brain levels of the active ingredient are sufficient to induce or suppress angiogenesis (minimal effective concentration, MEC). The MEC will vary for each preparation, but can be estimated from in vitro data. Dosages necessary to achieve the MEC will depend on individual characteristics and route of administration. Detection assays can be used to determine plasma concentrations.

Depending on the severity and responsiveness of the condition to be treated, dosing can be of a single or a plurality of administrations, with course of treatment lasting from several days to several weeks or until cure is effected or diminution of the disease state is achieved.

The amount of a composition to be administered will, of course, be dependent on the subject being treated, the severity of the affliction, the manner of administration, the judgment of the prescribing physician, etc.

Compositions of the present invention may, if desired, be presented in a pack or dispenser device, such as an FDA approved kit, which may contain one or more unit dosage forms containing the active ingredient. The pack may, for example, comprise metal or plastic foil, such as a blister pack. The pack or dispenser device may be accompanied by instructions for administration. The pack or dispenser may also be accommodated by a notice associated with the container in a form prescribed by a governmental agency regulating the manufacture, use or sale of pharmaceuticals, which notice is reflective of approval by the agency of the form of the compositions or human or veterinary administration. Such notice, for example, may be of labeling approved by the U.S. Food and Drug Administration for prescription drugs or of an approved product insert. Compositions comprising a preparation of the invention formulated in a compatible pharmaceutical carrier may also be prepared, placed in an appropriate container, and labeled for treatment of an indicated condition, as if further detailed above.

Optionally, the formulation is provided as a cosmetic preparation. The cosmetic preparation can comprise one or more topically applicable materials including, but not limited to, penetrating agents, oils, scents, colors powders. According to various exemplary embodiments of the invention, a cosmetic preparation can be provided as a cream, a lotion, a gel, an eye-shadow, foundation makeup, rouge mail polish, mascara, lip-liner or lipstick.

Optionally, the formulation is provided as an agricultural preparation. Agricultural preparations include, but are not limited to, feed additives, veterinary medications, sprays, liquids and foams.

Formulation of feed additives and veterinary medications involves similar considerations to those described hereinabove for pharmaceutical compositions.

Optionally, sprays are formulated for close application (e.g. from a tractor or using a handheld sprayer) or for application from a distance (e.g. via an irrigation system or from an airplane). In exemplary embodiments of the invention, sprays are applied to animals (e.g. for vaccination or parasite removal) or to plants (e.g. as herbicides or pesticides).

Optionally, the formulation is provided as a cleaning preparation. Cleaning preparations can include, in addition to the active polypeptide, one or more of a soap, a detergent, a surfactant, a wetting agent, an emulsifier and a solvent. The cleaning preparation can be provided in a wide variety of forms, including but not limited to, a spray (optionally with aerosol propellant), a cream, a gel and a liquid. In an exemplary embodiment of the invention, the cleaning preparation is provided in a package with dilution instructions. In other exemplary embodiments, the cleaning preparation is provided in a package at a “ready to use” concentration.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions illustrate the invention in a non limiting fashion.

The teachings of the present embodiments were used for predicting the function and/or affinity of an enzyme from its amino-acid sequence by searching therein for a motif of amino acids matching a predicting sequence of an enzyme database, and attributing to the unclassified enzyme a classifier in the form of an EC number. Example 1 below describes the procedure for the construction of an exemplary enzyme database. Example 2 below describes the procedure of classification of an first exemplary set of unclassified enzymes. Example 3 below describes the procedure for the construction of an additional exemplary enzyme database. Example 4 below describes theoretical considerations for characterization an additional set of peptides using the database of Example 3. Example 5 below describes characterization of the metagenomic dataset of Example 3. Example 6 below presents an analysis of enzyme size. Example 7 below presents a characterization of the unknown enzyme set of example 4 according to the database of example 3. Example 8 below presents a correlation of predicting sequence (PS) sequences to EC functional classifications of known enzymes. Example 9 below describes exemplary detergent compositions. Example 10 below presents exemplary food processing compositions. Example 11 below presents exemplary compositions from ethanol production. Example 12 below presents a comparison of exemplary methods according to the invention to Prosite.

### Example 1

### Exemplary Enzyme Searchable Database

### Methods

The motif extraction procedure described above was used for defining predicting sequences for almost all known enzymes and at all levels of the EC hierarchical classification. The procedure was separately applied to each one of the six EC main classes. The decrease functions D_{R} and D_{L} were defined as described hereinabove using the values η_{R}=η_{L}=0.8. The statistical significance threshold a was 0.01.

Protein sequences annotated with EC numbers were extracted from the UniProt/Swiss-Prot database (Release 48.3, Oct. 25, 2005). The following sequences were removed from the database: (i) sequences shorter than 100 amino acids or longer than 1200 amino acids; (ii) sequences with imprecise annotation (e.g., indicated as “probable”/“hypothetical”/“putative” or partially specified EC number); (iii) enzymes that catalyze more than one reaction (e.g., indicated as “bi-functional” or annotated with more than one EC number).

Table 2 summarizes the statistics of the dataset.

TABLE 2

| | | No. of | No. of |
|---|---|---|---|
| EC class | No. of sequences | subclasses | subsubclasses |
| oxidoreductases | 9437 | 21 | 81 |
| transferases | 16196 | 9 | 26 |
| hydrolases | 10901 | 10 | 47 |
| lyases | 5299 | 7 | 15 |
| isomerases | 2887 | 6 | 17 |
| ligases | 6048 | 6 | 10 |
| total | 50698 | 59 | 196 |

The motif extraction procedure was used to define predicting sequences that are specific to one, and only one, branch of the EC hierarchical classification, excluding uniqueness within its descending branches. The procedures were also applied to an older release of Swiss-Prot, release 45 dated October, 2004, with the statistics which is summarized in Table 3.

TABLE 3

| | | No. of | No. of |
|---|---|---|---|
| EC class | No. of sequences | subclasses | subsubclasses |
| oxidoreductases | 7918 | 21 | 79 |
| transferases | 12807 | 9 | 26 |
| hydrolases | 8982 | 10 | 47 |
| lyases | 4632 | 7 | 15 |
| isomerases | 2234 | 6 | 17 |
| ligases | 4692 | 6 | 10 |
| total | 41265 | 59 | 194 |

### Results

Following is a description of analysis performed to the enzyme database constructed from the data summarized in Tables 2 and 3 above. The entire enzyme database, as constructed from the 50,698 enzymes summarized in Table 2 is provided in Appendix 1 below and further in Table 11 on enclosed CD-ROM (files “Table-11. txt”). Below, a predicting sequence of level N, is conveniently denoted PSN, and is referred to a sequence which predicts its location on the EC tree at level N.

In some of the priority documents of the instant Application, PSN is referred to as SPN. Thus, SP1, SP2, SP3 and SP4 in some of the priority documents correspond to PS1, PS2, PS3 and PS4 in the instant Application, respectively.

The procedure extracted of many motifs. The procedure has been applied to each main EC class and to all the enzymes specified by the main EC class. Nonetheless, more than half of all motifs turn out to belong uniquely to single branches of the fourth level of the hierarchy, to be denoted as predicting sequence of level 4 (PS4).

It should be realized that, at the fourth level, one encounters strong homology between all amino-acid sequences. The PS4 stretches are specific motifs that are extracted from these homologs. The lower levels of predicting sequences, PS3, PS2 and PS1 do not include any of their descendants. Thus PS3 does not include predicting sequences of PS4 belonging to branches of the same subsubclass. The numbers of predicting sequences found are listed below in Tables 4 and 5 for the datasets presented in Tables 2 and 3, respectively.

TABLE 4

| EC class | No. of PS4 | No. of PS3 | No. of PS2 | No. of PS1 |
|---|---|---|---|---|
| oxidoreductases | 12781 | 868 | 379 | 1311 |
| transferases | 20043 | 918 | 488 | 2123 |
| hydrolases | 10822 | 1120 | 197 | 1153 |
| lyases | 7886 | 200 | 59 | 300 |
| isomerases | 4080 | 54 | 26 | 154 |
| ligases | 11695 | 573 | 99 | 508 |
| total | 67307 | 3733 | 1248 | 5549 |

TABLE 5

| EC class | No. of PS4 | No. of PS3 | No. of PS2 | No. of PS1 |
|---|---|---|---|---|
| oxidoreductases | 10312 | 719 | 375 | 1087 |
| transferases | 15032 | 750 | 351 | 1576 |
| hydrolases | 8575 | 920 | 159 | 962 |
| lyases | 6613 | 180 | 49 | 286 |
| isomerases | 2939 | 43 | 17 | 98 |
| ligases | 8572 | 422 | 81 | 369 |
| total | 52043 | 3034 | 1058 | 4378 |

The lists of predicting sequences in Tables 4 and 5 above contain overlaps, e.g., stretches which are parts of other stretches. No attempt was made to obtain a minimal set of predicting sequences.

To determine the usefulness of the predicting sequences the coverage of the predicting sequences as well as their cumulants was investigated. The latter were defined as unions of the former CPS3=PS3∪PS4, CPS2=PS2∪CPS3 and CPS1=PS1∪CPS2.

In some of the priority documents of the instant Application, the cumulants CPS3, CPS2 and CPS1 are referred to as CSP1, CSP2 and CSP3.

Table 6 summarizes the coverage of the 48 dataset per enzyme class.

TABLE 6

| EC class | PS4 | CPS3 | CPS2 | CPS1 |
|---|---|---|---|---|
| oxidoreductases | 8122 | 8403 | 8565 | 8859 |
| transferases | 14318 | 14695 | 14798 | 15180 |
| hydrolases | 8581 | 9067 | 9149 | 9528 |
| lyases | 4780 | 4826 | 4837 | 4886 |
| isomerases | 2643 | 2661 | 2666 | 2691 |
| ligases | 5812 | 5869 | 5879 | 5909 |
| total | 44256 | 45521 | 45894 | 47053 |

As shown in Table 6 above, functional classification at the third level of EC is provided by the 71,040 CPS3 (see Table 4) for 89.8% of the data.

Similar success values were obtained for the 45 dataset, shown in Table 7.

TABLE 7

| EC class | PS4 | CPS3 | CPS2 | CPS1 |
|---|---|---|---|---|
| oxido- | 83.2% (6587) | 86.5% (6850) | 88.3% (6995) | 91.8% (7266) |
| reduc- | | | | |
| tases | | | | |
| trans- | 85.3% (10925) | 88.1% (11281) | 88.8% (11376) | 91.8% (11753) |
| ferases | | | | |
| hydro- | 77% (6920) | 81.6% (7332) | 82.4% (7398) | 85.6% (7720) |
| lases | | | | |
| lyases | 90.2% (4180) | 91.2% (4226) | 91.4% (4235) | 92.5% (4287) |
| isom- | 89.4% (1998) | 89.8% (2007) | 90% (2010) | 91.1% (2035) |
| erases | | | | |
| ligases | 95.3% (4470) | 96.4% (4523) | 96.6% (4531) | 97.2% (4562) |
| total | 85% (35080) | 87.8% (36219) | 88.6% (36545) | 91.2% (37623) |

It is therefore demonstrated that a large fraction of the coverage is provided by the predicting sequences of level 4.

Tables 8 and 9 summarize the differential coverage of the other predicting sequences.

TABLE 8

| EC class | PS3 | PS2 | PS1 |
|---|---|---|---|
| oxidoreductases | 18% (1697) | 8.4% (792) | 41% (3869) |
| transferases | 17% (2754) | 10.3% (1668) | 39.6% (6412) |
| hydrolases | 19.9% (2172) | 6.8% (738) | 32% (3487) |
| lyases | 12.1% (631) | 4.5% (238) | 17.95% (939) |
| isomerases | 6.5% (187) | 4.3% (124) | 16.5% (476) |
| ligases | 31.25% (1889) | 6.65% (403) | 27.88% (1686) |
| total | 18.4% (9330) | 7.8% (3963) | 33.25% (16869) |

TABLE 9

| EC class | PS3 | PS2 | PS1 |
|---|---|---|---|
| oxidoreductases | 18.8% (1489) | 8.8% (699) | 39.4% (3121) |
| transferases | 16.95% (2200) | 9% (1157) | 37.75% (4836) |
| hydrolases | 19.3% (1736) | 6% (546) | 32.65% (2931) |
| lyases | 10.75% (498) | 3.45% (161) | 20.55% (953) |
| isomerases | 7.7% (172) | 4.75% (106) | 15.35% (343) |
| ligases | 30.35% (1425) | 7.1% (334) | 26.5% (1243) |
| total | 18.2% (7520) | 7.25% (3003) | 32.55% (13427) |

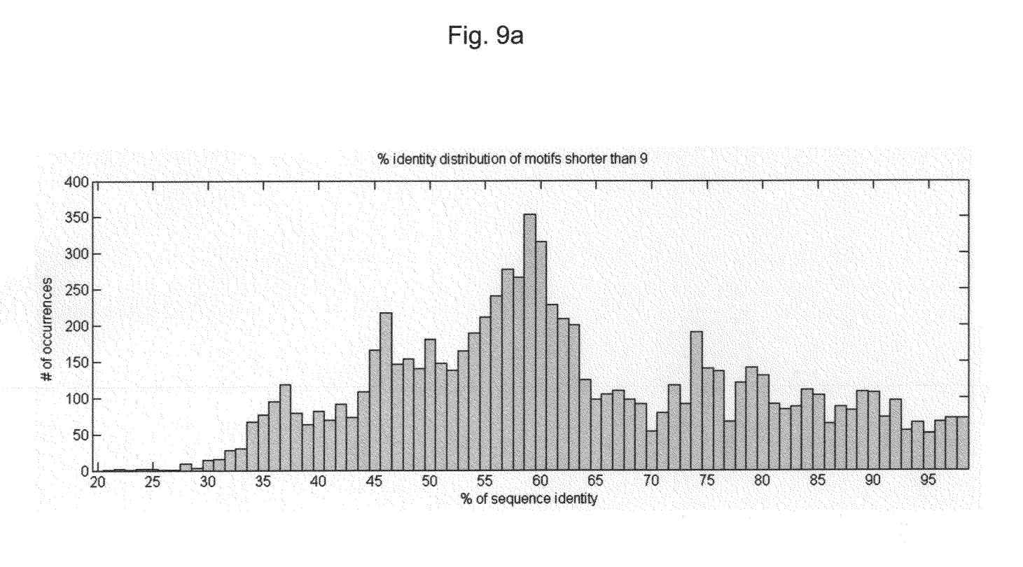

The motif extraction procedure is not limited by the length of the motifs it extracts. The resulting distribution of motif length is displayed in FIG. 8 for all six main classes of the EC hierarchical classification.

It is recognized that the longer peptides are in principle more strongly associated with homologies. This is borne out by a test carried out on randomly chosen 100 predicting sequences of the cumulant CPS3. For each predicting sequence, the set of all the enzymes on which it occurs has been extracted, and the percentages of identity along sequences of all pairs were calculated.

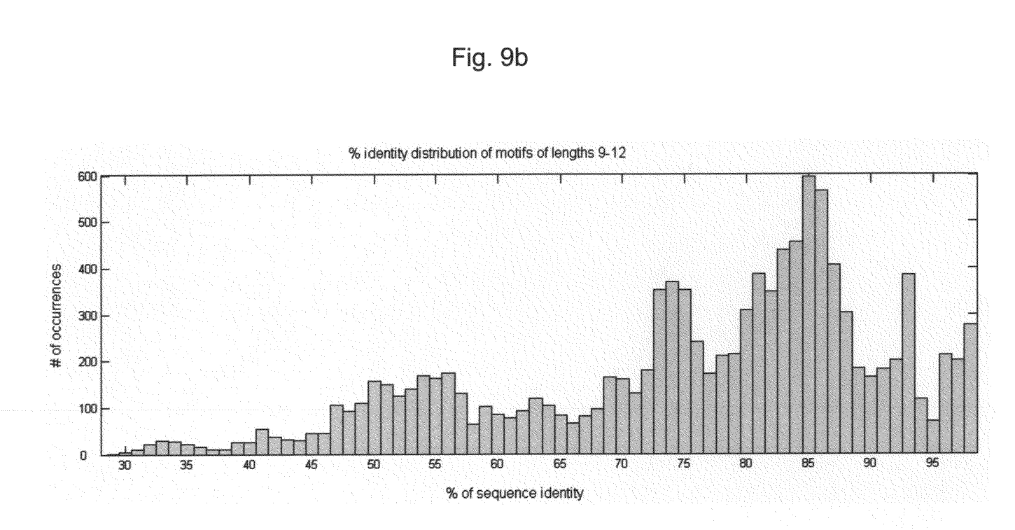

The results are shown in FIGS. 9a-c, for predicting sequences shorter than 9 amino-acids (FIG. 9a), between 9 and 12 amino-acids (FIG. 9b) and longer than 12 amino-acids (FIG. 9c). As shown in FIG. 9a, the histogram of motifs shorter than 9 amino-acids exhibits a peak at about 60% with a tail that extends well below 40%. It is thus demonstrated that short predicting sequences are useful for predicting the class to which the enzyme belongs.

### Example 2

### Classification of Unclassified Enzymes Using Predicting Sequences

In this example, the ability of the predicting sequences of the present embodiments of the invention to classify unclassified enzymes is demonstrated. To mimic a situation in which an unclassified enzyme is to be classified using the enzyme database, a reduced enzyme database was constructed solely from the dataset of release 45 (see Table 3). All sequences of the dataset of release 48.3 that did not appear in the dataset of release 45 were considered, for the sake of demonstration, as “unclassified sequences”.

The reduced enzyme database was constructed from 41,265 sequences and the group of “unclassified sequences” included 10,730 sequences (26% of the number of sequences from which the reduced database was constructed). Each unclassified sequence was searched for a motif of amino acids matching a predicting sequence present in the reduced database, and the classifier corresponding to the matched predicting sequence was used for determining the EC number of the respective enzyme.

The classification quality was quantified by means of recall-precision analysis. Recall and precision are effectiveness measures known in the art. Recall was defined as the number of novel sequences that included at least one of the PSNs, while precision was defined as the percentage of predictions, based on the PSNs of the 45 dataset that were corroborated by the assignment of the 48.3 dataset. Less than 54% of all PSNs were needed for the analysis. Precision can be defined at the predicting sequence, e.g., to what extent did the EC of a particular predicting sequence matches the true EC of the enzyme that it hits. Precision can also be defined at the enzyme level: how many enzymes are correctly identified by all predicting sequences that hit them. In other words, demanding the EC assignments of all predicting sequences to be consistent with one-another as well as with the “48.3” annotation of the enzyme. The classification method of the present embodiments classified the “unclassified sequences” with a total precision value at predicting sequence level of more than 98%, a total precision value at predicting enzyme level of more than 81%, and total recall value of more than 84%, corresponding to a success rate of about 84%. The reason form the difference between the two precision levels is that typically there is more than one predicting sequence hitting each enzyme, and the small error at the predicting sequence level is magnified by the requirement that the EC labels of all predicting sequences on the same enzyme are consistent with each other.

The results of the analysis are summarized in Table 10.

TABLE 10

| | No. of | No. of | | Precision | Precision |
|---|---|---|---|---|---|
| EC class | PSNs | sequences | Recall | (sequence) | (enzyme) |
| oxidoreductases | 5967 | 1661 | 1235 | 99.35% | 78.2% |
| | | | (74.35%) | | |
| transferases | 9680 | 3722 | 3253 | 99.3% | 84.6% |
| | | | (87.4%) | | |
| hydrolases | 4466 | 2173 | 1614 | 98.45% | 71.8% |
| | | | (74.25%) | | |
| lyases | 3838 | 1089 | 930 | 99.65% | 91.2% |
| | | | (85.4%) | | |
| isomerases | 1774 | 686 | 611 | 83% | 79.0% |
| | | | (89%) | | |
| ligases | 6685 | 1399 | 1385 | 99.55% | 87.1% |
| | | | (99%) | | |
| total | 32410 | 10730 | 9028 | 98.5% | 81.7% |
| | (53.55%) | | (84.15%) | | |

### Example 3

### An Enzyme Searchable Database for Thermophilic Bacteria

In order to establish that the predictive methods described hereinabove are generally applicable, a dataset of predicting sequences for the genomes of 25 thermophilic bacteria with genomic sequence data available at the National Center for Biotechnology Information (NCBI) of the National Institutes of Health (NIH) was compiled. The 25 thermophilic bacteria are listed in table 12.

TABLE 12

| No. | Thermophile |
|---|---|
| 1. | Aeropyrum pernix |
| 2. | Aquifex aeolicus |
| 3. | Archaeoglobus fulgidus |
| 4. | Deinococcus geothermalis DSM 11300 |
| 5. | Methanobacterium thermoautotrophicum |
| 6. | Methanosaeta thermophila PT |
| 7. | Moorella thermoacetica ATCC 39073 |
| 8. | Nanoarchaeum equitans |
| 9. | Picrophilus torridus DSM 9790 |
| 10. | Pyrobaculum aerophilum |
| 11. | Pyrococcus abyssi |
| 12. | Pyrococcus furiosus |
| 13. | Pyrococcus horikoshii |
| 14. | Sulfolobus acidocaldarius DSM 639 |
| 15. | Sulfolobus solfataricus |
| 16. | Sulfolobus tokodaii |
| 17. | Thermoanaerobacter tengcongensis |
| 18. | Thermobifida fusca YX |
| 19. | Thermococcus kodakaraensis KOD1 |
| 20. | Thermoplasma acidophilum |
| 21. | Thermoplasma volcanium |
| 22. | Thermosynechococcus elongatus |
| 23. | Thermotoga maritima |
| 24. | Thermus thermophilus HB27 |
| 25. | Thermus thermophilus HB8 |

The dataset of predicting sequences for the organisms listed in Table 12 comprises a ‘metagenomic’ set on which the methods described above can be tested. The Thermophile metagenomic dataset consists of 52,481 proteins with average length of 295±196 amino-acids.

### Example 4

### Theoretical Considerations for Characterization of Sargasso Sea Bacterial Peptides Using the Metagenomic Dataset

Venter et al (2004; Environmental Genome Shotgun Sequencing of the Sargasso Sea, Science 304: 66-74; fully incorporated herein by reference) has compiled and made publicly available genomic sequence data for bacteria isolated from the Sargasso Sea.

In order to demonstrate the utility of the metagenomic data set of Example 3, predicting sequences from the metagenomic data set were used to classify Sargasso Sea sequence data according to standard EC classification hierarchy.

The finding of predicting sequences on proteins that do not have enzymatic functions (to be termed ‘accidentals’) is modeled by predicting sequence hits on random protein sequences. For each dataset being considered (Thermophiles metagenomic set and Sargasso Sea genomic sequence data in this exemplary embodiment of the invention) ‘random protein sets’ were generated by scrambling the order of the amino-acids in every protein, thus conserving only first-order statistics.

Five such sets were produced for the Thermophiles metagenomic data set (including one that consists of inverting the sequence of each protein) in order to measure the expected accidental hits.

The outcome is presented in Table 13. The notation for 2 matches and more, distinguishes between the possibilities that some matches are consistent with one another (i.e. their EC assignments are either identical or obey parent-child relationships) and others are inconsistent.

Two consistent predicting sequence matches are denoted 2_{C} and two inconsistent ones 2_{I}. Similarly 3 hits with 2 consistent and one inconsistent are denoted 2_{C}1_{I}. For a number of predicting sequence matches n; n is denoted as X_{c}Y_{I} where X+Y=n.

TABLE 13
Probability estimates of random predicting sequence matches
Thermophiles data

| Number of predicting | | | Standard |
|---|---|---|---|
| sequence matches | | Probability | Deviation |
| | 0 | 0.78804 | 0.00253 |
| | 1 | 0.17772 | 0.00223 |
| | 2_{I} | 0.02279 | 0.00076 |
| | 2_{C} | 0.00636 | 0.00076 |
| | 3_{I} | 0.00219 | 0.00002 |
| | 2_{C}1_{I} | 0.00189 | 0.00023 |
| | 3_{C} | 0.00017 | 0.00002 |
| | 2_{C}2_{I} | 0.00042 | 0.00004 |
| | 4_{I} | 0.00019 | 0.00011 |

Table 14 contains probability estimates of random predicting sequence hits on the Sargasso Sea data. This is based on three sets of 100,000 scrambled sequences randomly chosen from the over 1 million proteins in the Sargasso Sea data using notation similar to that employed in table 13.

TABLE 14
Probability estimates of
random predicting sequence matches Sargasso Sea data

| Number of predicting | | | |
|---|---|---|---|
| sequence matches | | Probability | Standard Deviation |
| | 0 | 0.8626 | 0.0010 |
| | 1 | 0.1233 | 0.0006 |
| | 2_{C} | 0.0026 | 0.0002 |
| | 2_{I} | 0.0102 | 0.0002 |
| | 3_{I} | 0.00057 | 0.00003 |
| | 2_{C}1_{I} | 0.00052 | 0.00002 |

Both tables 13 and 14 reflect the fact that the overwhelming majority of sequences contain no predicting sequence matches (78% in table 13 and 86% in table 14). This is reflective of the fact that most proteins are not characterized by an enzymatic function.

### Error Model

Although the occurrence of accidental predicting sequence matches is low, it is desirable to know which matches are accidental. The following model for estimating the expected errors on enzyme predictions based on predicting sequence matches is proposed to distinguish between predicting sequence matches that are consistent with one-another (i.e. their EC assignments are either identical or obey parent-child relationships according to the EC tree) or not. From 4 matches onwards there is also the (rare) possibility of combinations with internal consistency and external inconsistency; two such pairs of matches are denoted as 2_{C}2_{C}.

The proposed error model presumes that, in a given dataset, there exists a prior distribution of enzymes with n (consistent) matches whose numbers are denoted by tₙ, on which there exist additional accidental predicting sequence matches according to the distribution displayed in Tables 13 or 14. According to this model, the observed predicting sequence matches Oₙ in general and/or the observed matches with internal consistency or inconsistency according to equations such as Equations 4 to 7 below

O₀=t₀*P0 (EQ. 4)

O₁=t₀*P1+t₁*P0 (EQ. 5)

O_{2C}=t₂*P0+t₀*P2_{C} (EQ. 6)

O₂₁=t₁*P1+t₀*P2_{I} (EQ. 7)
etc,
   where, in Equation 7, a simplistic assumption is made that the matches of t₁ and those created by P1 are inconsistent with each other. The data at hand have various inter-relationships among the different genes brought about by evolution. Therefore results may not always follow this model which assumes independent occurrences of accidental predicting sequence matches exactly. However, the proposed error model provides an estimate for the amount of errors involved when turning observations into predictions.

For example, in the Thermophiles data O₀=36,064 and O₁=9,377 which indicates that that t₀=45,725 (+/−105) and t₁=1,668 (+/−100). Since t₀*P1=8,064 accounts for almost all 9,377 observations of single matches, single matches are preferably insufficient for identification of a protein as an enzyme.

Continuing similarly to n=2, in Thermophiles O_{2C}=1,142, whereas the component of t₀*P2_{C}=272, hence the expected error on assigning correctly the enzyme from the observation of two consistent predicting sequence matches in this dataset is 272/1,142≈24%.

The proposed error model works well for low values of n, e.g. n<5. For higher n values it overestimates the number of inconsistent hits. This is to be expected if enzyme sequences with very low n values have undergone stronger evolutionary changes, e.g. through mutations. These changes could be the reason for the observation of low n, because they have eliminated relevant predicting sequences and, at the same time, may have inserted accidental (and inconsistent) short predicting sequences into the sequence.

### Fisher Distance Criterion

If two different enzyme domains with different activities exist within the protein, or if one enzyme domain exists and another non-enzymatic domain comprises accidental predicting sequence matches, groups of predicting sequences that are not consistent with one another are expected to result. An example of such a case would be 2_{C}2_{C}, signifying two pairs of predicting sequences that are consistent within themselves but inconsistent with each other. In these cases a two-domain hypothesis can be checked by calculating a Fisher distance between the two groups of predicting sequence matches (EQ 8).

F=2(μ₁−μ₂)/(Δ₁+Δ₂) (EQ 8)

The parameters in EQ 8 are defined as follows: determine the first index of the left-most predicting sequence match of one group of consistent predicting sequences and the last index of the right-most predicting sequence of this group on the sequence of the protein. The mean of these indices is μ₁ and the difference between them defines the total length Δ₁ of this group of consistent predicting sequences. μ₂ and Δ₂ are defined analogously using the left and right indices of the second group(s) of predicting sequences.

For data that match the description of two or more domains the Fisher distance (F) is expected to have an absolute value greater than 1, indicating that the two predicting sequence groups occupy mutually exclusive regions on the protein sequence. Strictly speaking this is not a necessary condition, since the two enzymatic domains can be spatially distinct in the folded protein as a result of secondary and/or tertiary structure even if the predicting sequences occur in overlapping domains on the primary structure. Nonetheless, The Fisher model is based upon clear separation of the predicting sequences along the primary structure of the peptide sequence which probably occurs more frequently in nature.

### Example 5

### Characterization of the Metagenomic Dataset

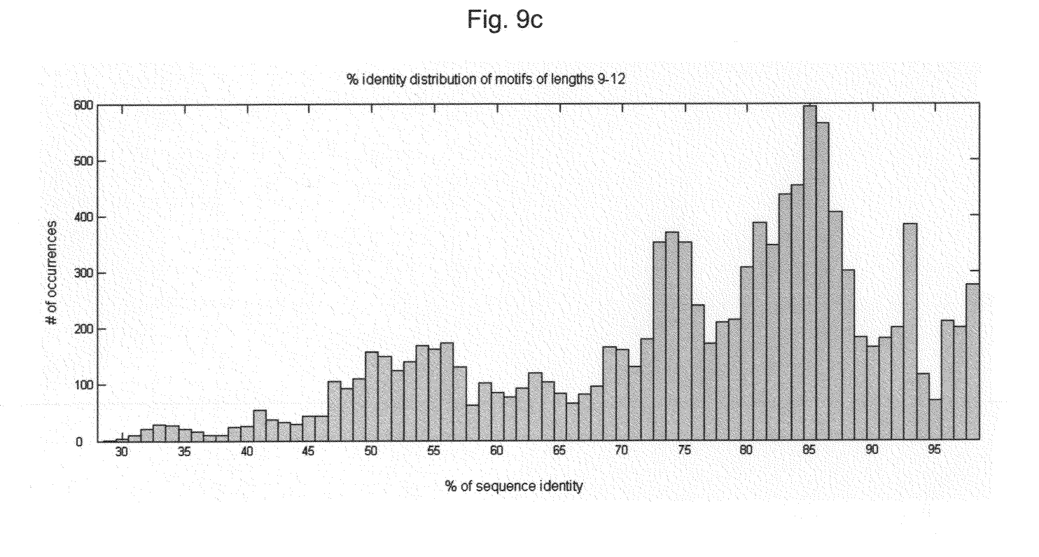

A predicting sequence search on the metagenomic thermophile dataset of Example 3 produced a distribution of predicting sequence matches summarized graphically in FIG. 10.

FIG. 10 clearly demonstrates that predicting sequence matches are present on 16,417 proteins, whereas random predicting sequence matches account for 11,124 proteins (±133) as described hereinabove. This suggests that the metagenomic thermophile dataset includes more than 5,000 enzymes.

Using preferred embodiments of the present invention, resolution of which of these proteins should be recognized as enzymes and what the EC assignments of these enzymes should be was undertaken. Low numbers of predicting sequence matches (n<5) and high numbers (n≧5) were handled separately.

For n<5, the similarity between the exponential drop observed in the random case (Table 13) and in the real data (FIG. 10), where O0:O1:02 is of order 4. These data clearly indicate that most of the n=1 data are accidentals, and the n=2 to 4 data need special study to decide which are indeed enzymes.

There is a smaller number of peptides characterized by five or more predicting sequence matches which appear to indicate bona fide enzymes. No combinations of more than five predicting sequence matches occur completely at random, and most predicting sequence hits are consistent with one another, i.e. the different EC labels of the predicting sequences observed on these proteins are consistent with there being a unique EC-number assignment to the protein. There are a smaller number of cases with two potential EC numbers, suggesting that the protein in question is characterized by two domains with two different catalytic activities.

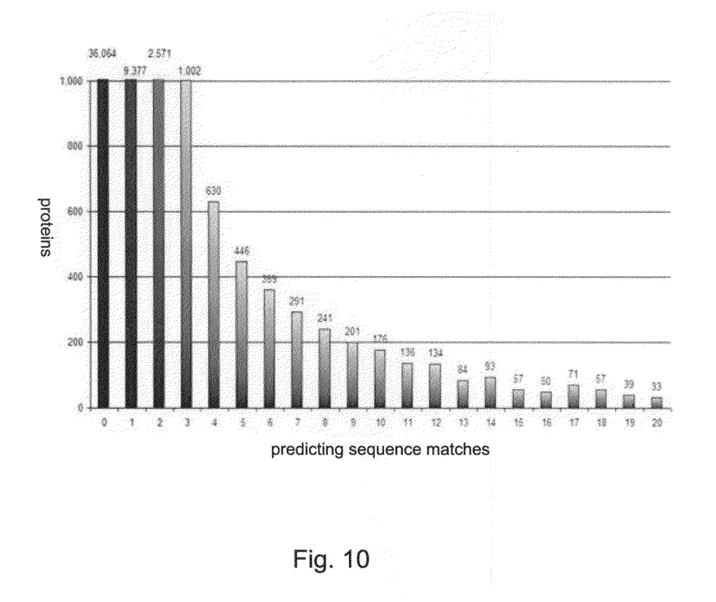

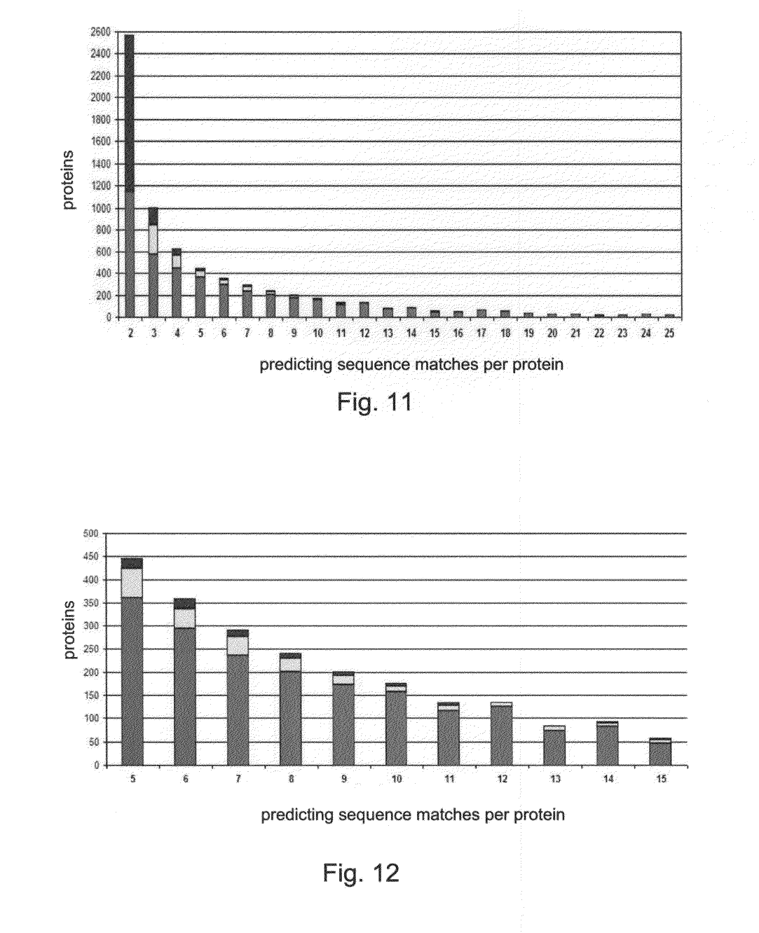

FIGS. 11 and 12 indicate graphically how many consistent matches there are and how many matches with one inconsistent predicting sequence, i.e., matches where at least one predicting sequence has an EC assignment different from the rest. In FIGS. 11 and 12, grey or red bars correspond to n consistent matches per protein, where n is shown on the horizontal axis, empty or yellow bars indicate n−1 consistent and n inconsistent matches per protein, and dark or blue bars indicate other combinations adding to n matches per protein. In FIG. 11, 2≦n≦25, and FIG. 12 is a “zoom in” of FIG. 11 for 5≦n≦15.

FIGS. 11 and 12 demonstrate that about 85% of all predicting sequence matches are completely consistent, and may therefore serve as prediction of enzymatic functions for 2,418 proteins.

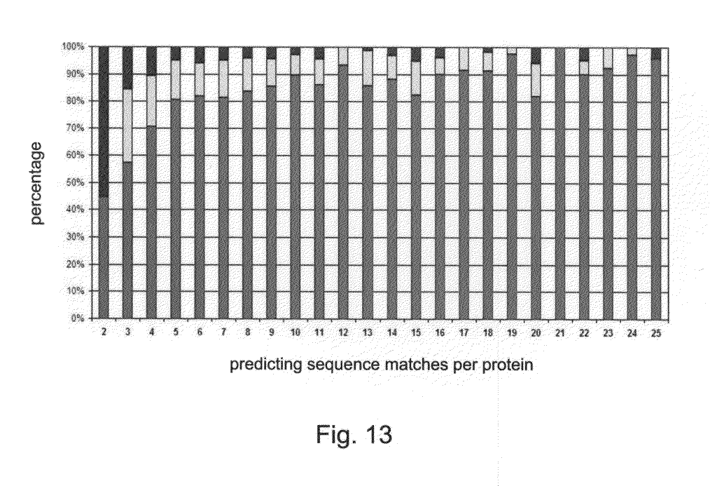

FIG. 13 displays the relative percentages of the different cases of predicting sequence matches, showing n consistent matches per protein (grey or red bars), n consistent matches and 1 inconsistent match (empty or yellow bars), and all other combinations adding to n matches per protein (dark or blue bars).

According to a preferred embodiment of the present invention when the number of motifs of the target protein which match predicting sequences in the database is sufficiently large (e.g., larger than 4) and when the number of inconsistent matches is sufficiently small (e.g., all matches but one being consistent), the inconsistent matches are disregarded for the purpose of classification.

For example, in the present example, there are altogether 419 inconsistent matches for n>4, 331 of which contain a single predicting sequence that does not match the rest. According to the presently preferred embodiment of the invention for n>4, most of the (n−1)_{C}1_{I} predicting sequence matches depicted in FIGS. 11, 12 and 13 can still serve as valid predictions by disregarding the EC assignment of the one predicting sequence that disagrees with the others. This procedure is based on the assumption that, through random evolutionary processes a subsequence has been created at a location that has nothing to do with the EC function of the enzymes. The overall ratio 331/2,418=0.14 of (single inconsistent)/(all consistent) data is smaller but not very far from P1/P0=0.22 of Table 13, the model of independent accidental predicting sequence matches. In an exemplary embodiment of the invention, 2,749 EC assignments from the data of predicting sequence n>4 can be achieved by ignoring inconsistent matches in all (n−1)_{C}1_{I}, hence basing the classifications on (n−1)_{C} predicting sequence matches.

In cases where the number of predicting sequence matches is less than 5, only predicting sequence matches that are fully consistent with one another are considered indicative of enzymatic activity and/or EC classification.

Table 15 lists the results for n=2, 3 and 4 as well as error estimates based on the error model described hereinabove. Data presented in table 15 indicate that data of fully consistent predicting sequences for n=3 and 4 are meaningful predictors of enzymatic activity with a high degree of accuracy.

TABLE 15
Match results and error estimates based on the error model (n = 2, 3 and 4)

| n | 2_{C} | 3_{C} | 4_{C} |
|---|---|---|---|
| Observations | 1,142 | 569 | 438 |
| Error estimate | 270 | 8 | 1 |

### Verification of Results

There is a group of 3,756 proteins for which EC assignments can be made with a high degree of accuracy. The group includes all n>4 predicting sequence matches which are either fully consistent or have one inconsistent predicting sequence, and all n=3 and n=4 fully consistent predicting sequences.

Comparison can be drawn for all enzymes for which NCBI annotations provide EC assignments. The agreement between the NCBI annotations and predictions based on predicting sequence matching is summarized in Table 16 with 96% true positives. In Table 16, the levels 1, 2, 3 and 4 of the EC hierarchy, are denoted EC L-1, EC L-2, EC L-3 and EC L-4, respectively.

TABLE 16
Thermophiles Analysis
Summary of EC Predictions against NCBI

| | | | | | | | | | | No EC |
|---|---|---|---|---|---|---|---|---|---|---|
| | | | | | | | | | | Avail- |
| | | | | | | | | | | able - |
| | | | True Predictions | | | | | | | Potential |
| | | | T1 | T2 | T3 | T4 | | False | EC | for |
| | TP | FP | EC | EC | EC | EC | | Posi- | Avail- | New |
| Category | [%] | [%] | L-1 | L-2 | L-3 | L-4 | Total | tives | able | Pred. |
| Total | 96 | 4 | 33 | 32 | 130 | 1,064 | 1,259 | 54 | 1,313 | 3,977 |
| 2C | 90 | 10 | 18 | 9 | 38 | 131 | 196 | 21 | 217 | 931 |
| 2C 1I | 85 | 15 | 3 | 3 | 10 | 24 | 40 | 7 | 47 | 229 |
| 3C | 98 | 2 | 4 | 4 | 14 | 105 | 127 | 2 | 129 | 442 |
| 3C 1I | 93 | 7 | 1 | 0 | 5 | 21 | 27 | 2 | 29 | 90 |
| 4C | 97 | 3 | 2 | 4 | 14 | 98 | 118 | 4 | 122 | 323 |
| 4C 1I | 86 | 14 | 0 | 1 | 1 | 17 | 19 | 3 | 22 | 42 |
| 5C | 97 | 3 | 0 | 4 | 11 | 87 | 102 | 3 | 105 | 255 |
| 5C 1I | 100 | 0 | 1 | 0 | 4 | 8 | 13 | 0 | 13 | 31 |
| 6C | 95 | 5 | 2 | 0 | 5 | 70 | 77 | 4 | 81 | 213 |
| 6C 1I | 100 | 0 | 0 | 0 | 0 | 11 | 11 | 0 | 11 | 29 |
| 7C | 100 | 0 | 0 | 0 | 5 | 60 | 65 | 0 | 65 | 172 |
| 7C 1I | 100 | 0 | 0 | 0 | 1 | 10 | 11 | 0 | 11 | 18 |
| 8C | 100 | 0 | 0 | 0 | 2 | 42 | 44 | 0 | 44 | 158 |
| 8C 1I | 100 | 0 | 0 | 1 | 1 | 8 | 10 | 0 | 10 | 10 |
| 9C | 98 | 2 | 0 | 0 | 1 | 50 | 51 | 1 | 52 | 121 |
| 9C 1I | 100 | 0 | 0 | 0 | 0 | 5 | 5 | 0 | 5 | 8 |
| 10C | 100 | 0 | 0 | 0 | 3 | 45 | 48 | 0 | 48 | 110 |
| 10C 1I | 100 | 0 | 0 | 0 | 1 | 4 | 5 | 0 | 5 | 8 |
| 11C | 97 | 3 | 0 | 1 | 0 | 37 | 38 | 1 | 39 | 77 |
| 11C 1I | 100 | 0 | 0 | 0 | 0 | 4 | 4 | 0 | 4 | 5 |
| 12C | 97 | 3 | 0 | 0 | 1 | 29 | 30 | 1 | 31 | 94 |
| 12C 1I | 100 | 0 | 0 | 1 | 0 | 4 | 5 | 0 | 5 | 6 |
| 13C | 95 | 5 | 0 | 0 | 0 | 19 | 19 | 1 | 20 | 52 |
| 13C 1I | 100 | 0 | 0 | 0 | 0 | 3 | 3 | 0 | 3 | 5 |
| 14C | 96 | 4 | 0 | 1 | 0 | 26 | 27 | 1 | 28 | 54 |
| 14C 1I | 100 | 0 | 0 | 0 | 0 | 1 | 1 | 0 | 1 | 6 |
| 15C | 100 | 0 | 1 | 0 | 0 | 13 | 14 | 0 | 14 | 33 |
| 15C 1I | | | 0 | 0 | 0 | 0 | 0 | 0 | 0 | 3 |
| 16C | 87 | 13 | 0 | 0 | 0 | 13 | 13 | 2 | 15 | 30 |
| 16C 1I | 100 | 0 | 0 | 0 | 0 | 4 | 4 | 0 | 4 | 2 |
| 17C | 100 | 0 | 1 | 0 | 3 | 11 | 15 | 0 | 15 | 50 |
| I7C 1I | 100 | 0 | 0 | 0 | 0 | 3 | 3 | 0 | 3 | 1 |
| 18C | 100 | 0 | 0 | 1 | 0 | 13 | 14 | 0 | 14 | 38 |
| 18C 1I | | | 0 | 0 | 0 | 0 | 0 | 0 | 0 | 1 |
| 19C | 89 | 11 | 0 | 1 | 1 | 6 | 8 | 1 | 9 | 29 |
| 19C 1I | 100 | 0 | 0 | 0 | 0 | 1 | 1 | 0 | 1 | 3 |
| 20C | 100 | 0 | 0 | 1 | 1 | 7 | 9 | 0 | 9 | 18 |
| 21C | 100 | 0 | 0 | 0 | 0 | 5 | 5 | 0 | 5 | 27 |
| 21C 1I | 100 | 0 | 0 | 0 | 1 | 0 | 1 | 0 | 1 | 0 |
| 22C | 100 | 0 | 0 | 0 | 1 | 6 | 7 | 0 | 7 | 11 |
| 22C 1I | 100 | 0 | 0 | 0 | 0 | 1 | 1 | 0 | 1 | 1 |
| 23C | 100 | 0 | 0 | 0 | 0 | 2 | 2 | 0 | 2 | 22 |
| 23C 1I | | | 0 | 0 | 0 | 0 | 0 | 0 | 0 | 1 |
| 24C | 100 | 0 | 0 | 0 | 0 | 5 | 5 | 0 | 5 | 28 |
| 25C | 100 | 0 | 0 | 0 | 1 | 5 | 6 | 0 | 6 | 17 |
| 25C 1I | | | 0 | 0 | 0 | 0 | 0 | 0 | 0 | 2 |
| 26C | 100 | 0 | 0 | 0 | 0 | 7 | 7 | 0 | 7 | 14 |
| 26C 1I | 100 | 0 | 0 | 0 | 0 | 2 | 2 | 0 | 2 | 2 |
| 27C | 100 | 0 | 0 | 0 | 1 | 7 | 8 | 0 | 8 | 17 |
| 27C 1I | 100 | 0 | 0 | 0 | 0 | 1 | 1 | 0 | 1 | 2 |
| 28C | 100 | 0 | 0 | 0 | 0 | 2 | 2 | 0 | 2 | 13 |
| 28C 1I | | | 0 | 0 | 0 | 0 | 0 | 0 | 0 | 1 |
| 29C | 100 | 0 | 0 | 0 | 0 | 3 | 3 | 0 | 3 | 13 |
| 29C 1I | 100 | 0 | 0 | 0 | 1 | 0 | 1 | 0 | 1 | 0 |
| 30C | 100 | 0 | 0 | 0 | 0 | 2 | 2 | 0 | 2 | 6 |
| 30C 1I | 100 | 0 | 0 | 0 | 0 | 1 | 1 | 0 | 1 | 1 |
| 31C | 100 | 0 | 0 | 0 | 0 | 2 | 2 | 0 | 2 | 12 |
| 32C | 100 | 0 | 0 | 0 | 0 | 2 | 2 | 0 | 2 | 8 |
| 33C | | | 0 | 0 | 0 | 0 | 0 | 0 | 0 | 7 |
| 33C 1I | 100 | 0 | 0 | 0 | 1 | 0 | 1 | 0 | 1 | 0 |
| 34C | 100 | 0 | 0 | 0 | 0 | 3 | 3 | 0 | 3 | 10 |
| 34C 1I | 100 | 0 | 0 | 0 | 0 | 1 | 1 | 0 | 1 | 0 |
| 35C | | | 0 | 0 | 0 | 0 | 0 | 0 | 0 | 11 |
| 36C | 100 | 0 | 0 | 0 | 0 | 1 | 1 | 0 | 1 | 7 |
| 36C 1I | | | 0 | 0 | 0 | 0 | 0 | 0 | 0 | 3 |
| 37C | | | 0 | 0 | 0 | 0 | 0 | 0 | 0 | 2 |
| 38C | 100 | 0 | 0 | 0 | 0 | 1 | 1 | 0 | 1 | 3 |
| 38C 1I | 100 | 0 | 0 | 0 | 0 | 1 | 1 | 0 | 1 | 0 |
| 39C | 100 | 0 | 0 | 0 | 0 | 1 | 1 | 0 | 1 | 8 |
| 40C | 100 | 0 | 0 | 0 | 0 | 2 | 2 | 0 | 2 | 3 |
| 41C | 100 | 0 | 0 | 0 | 0 | 2 | 2 | 0 | 2 | 3 |
| 42C | 100 | 0 | 0 | 0 | 1 | 0 | 1 | 0 | 1 | 1 |
| 43C | 100 | 0 | 0 | 0 | 0 | 3 | 3 | 0 | 3 | 5 |
| 43C 1I | 100 | 0 | 0 | 0 | 0 | 1 | 1 | 0 | 1 | 0 |
| 45C | | | 0 | 0 | 0 | 0 | 0 | 0 | 0 | 2 |
| 46C | 100 | 0 | 0 | 0 | 0 | 1 | 1 | 0 | 1 | 2 |
| 47C | | | 0 | 0 | 0 | 0 | 0 | 0 | 0 | 2 |
| 48C | 100 | 0 | 0 | 0 | 0 | 1 | 1 | 0 | 1 | 1 |
| 50C | | | 0 | 0 | 0 | 0 | 0 | 0 | 0 | 3 |
| 51C | | | 0 | 0 | 0 | 0 | 0 | 0 | 0 | 2 |
| 51C 1I | 100 | 0 | 0 | 0 | 0 | 1 | 1 | 0 | 1 | 0 |
| 52C | | | 0 | 0 | 0 | 0 | 0 | 0 | 0 | 1 |
| 53C | | | 0 | 0 | 0 | 0 | 0 | 0 | 0 | 2 |
| 55C | 100 | 0 | 0 | 0 | 0 | 1 | 1 | 0 | 1 | 1 |
| 56C | 100 | 0 | 0 | 0 | 0 | 1 | 1 | 0 | 1 | 1 |
| 62C | | | 0 | 0 | 0 | 0 | 0 | 0 | 0 | 1 |
| 63C | 100 | 0 | 0 | 0 | 1 | 0 | 1 | 0 | 1 | 0 |
| 73C | | | 0 | 0 | 0 | 0 | 0 | 0 | 0 | 1 |

The true predictions can be divided into 4 classes:

1. Correct (true positive) predictions at EC level 4 “TP4”

2. Correct (true positive) predictions at EC level 3 “TP3”

3. Correct (true positive) predictions at EC level 2 “TP2”

4. Correct (true positive) predictions at EC level 1 “TP1”

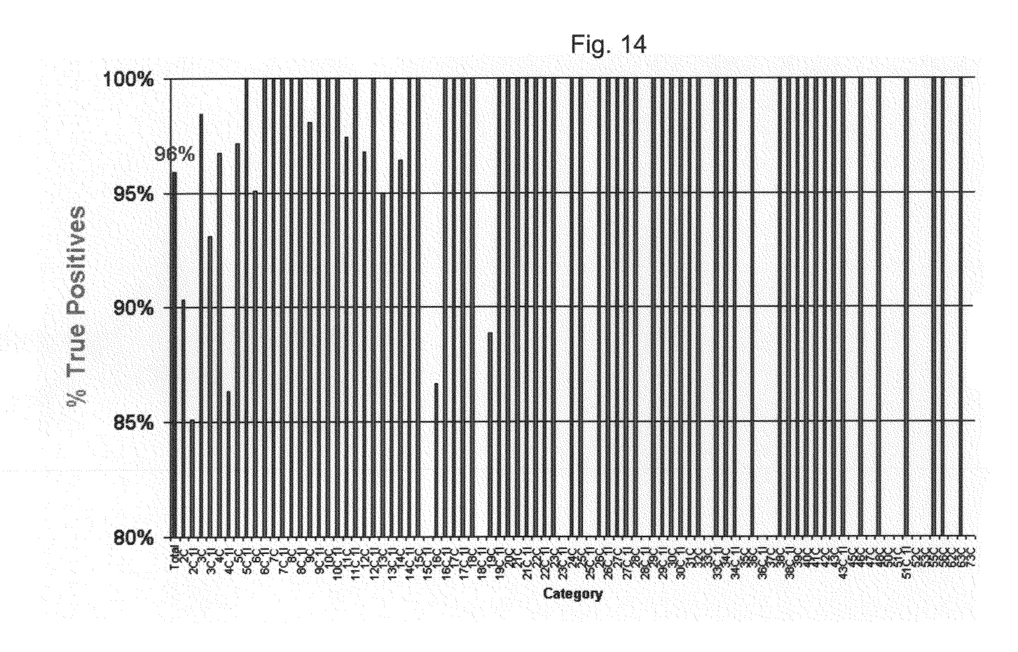

FIG. 14 depicts the True Predictions as a function of the different matches' categories (consistent vs. inconsistent for each value of n). A detailed comparison of predictions based on predicting sequence matching with annotations of NCBI is provided in Table 17 (provided on enclosed CD-ROM, file “Table-17.txt”).

The n=2 results have an estimated possible error of 24%. In an exemplary embodiment of the invention, putative EC assignments based on n=2 and/or the 2_{C}1_{I} cases of n=3 and/or the 3_{C}1_{I} cases of n=4 data can be further checked using sequence similarity and/or experimental tools to increase the number of enzymes correctly characterized. Table 18 exemplifies the 2_{C}1_{I} and 3_{C}1_{I} cases and expected errors. According to the aforementioned notations, 2_{C}1_{I} denotes 2 matches that are consistent with one another and 1 which is inconsistent with the other two. Similarly, the notation 3_{C}1_{I} denotes 3 matches that are consistent with one another and 1 which is inconsistent with the other three.

TABLE 18

| predicting sequence matches | 2_{C}1_{I} | 3_{C}1_{I} |
|---|---|---|
| Observations | 268 | 136 |
| Error estimate | 87 | 10 |

A list of all 2_{C}, 2_{C}1_{I} and 3_{C}1_{I} results is provided in Table 17 on enclosed CD-ROM, together with their NCBI assignments. The accumulated data confirm the theoretical error estimate described above.

### Example 6

### Analysis of Enzyme Size

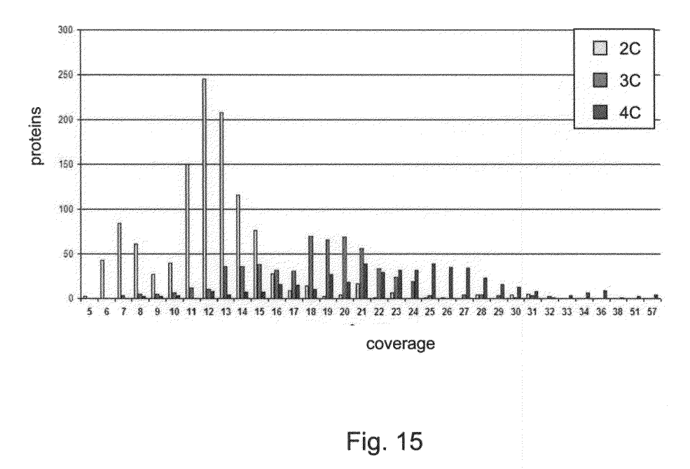

In order to determine the size of observed enzymatic domains, the total number of amino-acids covered by consistent predicting sequence matches on a protein was analyzed. This quantity is referred to as ‘length of coverage’ (L). FIG. 15 is a histogram indicating number of proteins as a function of coverage L for the classes 2_{C} (empty or yellow bars), 3_{C} (grey or red bars) and 4_{C} (dark or blue bars). In general, L increases as n increases. The parameter L is also listed in Tables 16 and 17.

Comparison of EC assignments based on predicting sequence matches to NCBI annotations in tables 16 and 17 reveals a break point at approximately L=12. Above this point, the number of correct identifications is increased. This distribution correlates well with the distributions in FIG. 10 and the expected errors in Table 20 for the different n_{C} classes. The n_{C}1_{I} classes (not depicted) have distributions similar to those of the n_{C} classes in FIG. 15 but with much lower rates of occurrence.

### Example 7

### Characterization of Sargasso Sea Bacterial Peptides Using the Metagenomic Dataset

There are 1,001,986 records in the Sargasso Sea protein data (Venter et al., 2004). The average length of the proteins is 194 amino-acids, with s.d.=109. Using three random sets of 100,000 proteins selected from these data, we have generated the randomized proteins from which we have calculated the probabilities of accidental matches in Table 14. The different statistics of the Sargasso Sea set compared to the Thermophiles set are responsible for the different corresponding probabilities observed between Tables 13 and 14.

There are predicting sequence matches on 283,835 proteins of the Sargasso Sea data. Using the error model described above, it is predicted that some 130,000 of these predicting sequence matches are accidentals (i.e. do not indicate actual enzymes), leaving over 150,000 actual enzymes.

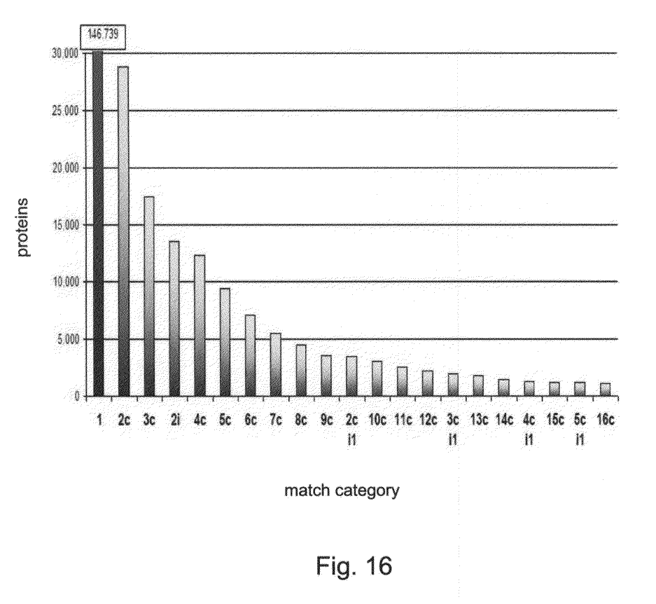

FIG. 16 graphically summarizes categories of predicting sequence matches in terms of number of matches n and consistency (c) or inconsistency (i) of predicting sequence matches within a single peptide sequence.

As indicated in FIG. 16, there is a first group of 52,615 proteins with n>4 and zero or one inconsistent predicting sequence matches. Proteins in this first group are believed to accurately reflect enzymatic activity according to the EC class indicated by the relevant predicting sequences.

FIG. 16 also indicates a second group with slightly less certainty about the prediction of enzymatic activity. This second group includes an additional 45,450 proteins with 3c or 4c predicting sequence matches. which also have a high probability of indicating an enzymatic activity corresponding to the EC class indicate by the “c” predicting sequences of the peptide based upon the error analyses described above.

The first and second groups together comprise 98,065 peptides with specific enzymatic activities predicted with a reasonable degree of certainty.

FIG. 16 also indicates a third group comprising, peptides with predicting sequence matches designated as 2_{C}, 2_{C}1_{I} and 3_{C}1_{I}. This third group comprises 34,268 peptides for which a specific enzymatic activity is predicted with a lower degree of certainty. In an exemplary embodiment of the invention, verification by alternative methods can be employed to determine which peptides actually have the predicted enzymatic activity. Table 19 summarizes the expected error rates for each type of predicting sequence matching in the third group of peptides.

TABLE 19
Expected error rates for predicting sequence match types 2_{C}, 2_{C}1_{I} and 3_{C}1_{I}

| predicting sequence | | | |
|---|---|---|---|
| Match Type | 2_{C} | 2_{C}1_{I} | 3_{C}1_{I} |
| Number of Matches | 28,811 | 3,507 | 1,950 |
| Expected errors | 1,870 | 868 | 557 |
| Expected accuracy (%) | 93.5 | 75.3 | 71.4 |

Data summarized in Table 19 suggests that even the “unreliable” predictions of the third group are valuable. For any peptide in this group it is possible to use the EC class suggested by the predicting sequence matches and screen for activity using a single suitable substrate. Results of a screening conducted in this way are expected to produce at least 71.4% verified enzymes (for 3c1i predicting sequence matches) and as much as 93.5% verified enzymes (for 2c predicting sequence matches).

These degrees of expected verification are high for any enzyme screening process. They are unprecedentedly high for a screening plan in which each candidate enzyme is assayed against a single substrate.

Table 20 summarizes peptides with two putative enzymatic activities based upon EC classifications suggested by predicting sequence matches. (predicting sequence match types suggesting multiple enzymatic activities with less than 10 peptides are not presented)

TABLE 20
Multiple consistent set of predicting sequence matches on Sargasso Sea data

| predicting sequence | |
|---|---|
| Match Type | Peptides |
| 2_{C} 2_{C} | 86 |
| 2_{C} 3_{C} | 88 |
| 2_{C} 4_{C} | 48 |
| 2_{C} 5_{C} | 39 |
| 2_{C} 6_{C} | 31 |
| 2_{C} 7_{C} | 21 |
| 2_{C}8_{C} | 17 |
| 2_{C} 11_{C} | 13 |
| 2_{C} 13_{C} | 10 |
| 3_{C} 3_{C} | 10 |
| 2_{C} 2_{C} 1_{I} | 21 |
| 2_{C} 3_{C} 1_{I} | 10 |

Peptides with putative multiple enzymatic activities are of special interest. In The positions of the different predicting sequence matches on the protein sequence have been evaluated using the Fisher distance model described above. Those peptides with a sufficient Fisher distance are believed to comprise two enzymatically active domains on the same peptide. In many cases, the molecules characterized by two EC classifications are large proteins (as opposed to peptides), which makes the multiple domains with separate functions seems plausible.

Table 21, provided on enclosed CD-ROM (file “Table-21.txt”), presents Predictions for Sargasso Sea data, with predicting sequence matches n>4: Categories 5_{C}, 5_{C}1_{I}, 6_{C}, 6_{C}1_{I} and up

Table 22, provided on enclosed CD-ROM (file “Table-22.txt”), presents Predictions for Sargasso Sea data, with predicting sequence matches in Categories 3_{C}, 3_{C}1_{I}, 4_{C} and 4_{C}1_{I}

Table 23, provided on enclosed CD-ROM (file “Table-23.txt”), presents Predictions for Sargasso Sea data, with predicting sequence matches in Categories 2c and 2c1i.

In each of Tables 21-23, the first column from the left lists the Sargasso ID numbers of the proteins, the second column from the left lists the EC numbers found according to a preferred embodiment of the present invention, the third column from the left lists the descriptions of the EC classifications, the forth column from the left lists the coherent predicting sequence coverages and the rightmost columns lists the TAU protein number.

### Example 8

### Correlation of Predicting Sequence (PS) Sequences to EC Functional Classifications of Known Enzymes

The motif extraction procedure described above was used for defining predicting sequences from the Swiss-Prot enzymes as described in Example 1, using the values η=0.8 and α=0.01.

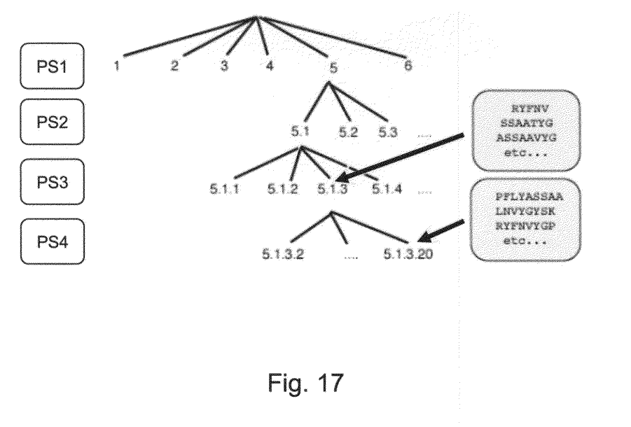

The deterministic sequence-motifs extracted by the motif extraction procedure were further subjected to a screening process, selecting predicting sequences (PS) that are specific to a single branch of the EC hierarchical classification and can be used as predicting sequences. More than half of all motifs turn out to belong uniquely to single branches of the fourth level of the hierarchy, to be denoted as predicting sequences of level 4 (PS4) (see FIG. 17) and predicting sequences of higher hierarchy (lower N; i.e. PS3, PS2 and PS1) do not include PS4s isolated from non-relevant classes. Thus if a peptide is shared by two or more level 4 groups that belong to the same 3rd EC level, and appears no where else, it is assigned to predicting sequence level 3. The predicting sequences were further screened to eliminate any peptide that includes within its sequence another peptide carrying the same predicting sequence N(N=1,2,3,4) label. The majority of predicting sequences occur at level 4 of the EC hierarchy, probably due to high homology within this level, that often includes orthologous genes). Thousands of predicting sequences occur at higher levels of hierarchy, reflecting functional similarity within enzymes with lower sequence similarity.

The occurrence of any one predicting sequence on the sequence of an enzyme specifies its EC functionality according to the specific branch N of its PSN. For example, enzyme P45048 (see FIG. 18) contains SSAATYG, a PS3 specific to 5.1.3, and LNVYGYSK, a PS4 specific to 5.1.3.20. The relationship of these predicting sequences to the EC hierarchy of predicting sequence families is shown in FIG. 17. Table 24 shows that the predicting sequences cover (i.e., appear on the sequence of) most enzymes in of Swiss-Prot release 48.3. The coverage columns display the cumulative coverage of all predicting sequences to their left. Coverage is a measure of the success of the predicting sequence approach of the present embodiments. Thus, from the sixth column one can deduce that functional classification at the third level of EC is specified by 45,819 peptides of PS3 PS4, covering 89.8% of the data. Information about the separate coverage of each PSN group is provided in Table 27, hereinunder.

TABLE 24
Occurrences of predicting sequences in all six EC classes in the analysis of all
enzymes in Swiss-Prot release 48.3.

| | No. of | | coverage | | coverage | | coverage | | coverage |
|---|---|---|---|---|---|---|---|---|---|
| ECclass | enzymes | SP4 | [%] | SP3 | [%] | SP2 | [%] | SP1 | [%] |
| oxidoreductases | 9,437 | 8,314 | 86.1 | 681 | 89 | 310 | 90.8 | 1,260 | 93.9 |
| transferases | 16,196 | 12,708 | 88.4 | 726 | 90.7 | 476 | 91.4 | 2,068 | 93.7 |
| hydrolases | 10,901 | 7,535 | 78.7 | 809 | 83.2 | 196 | 83.9 | 1,136 | 87.4 |
| lyases | 5,229 | 4,728 | 91.4 | 186 | 92.3 | 59 | 92.3 | 296 | 93.4 |
| isomerases | 2,887 | 2,588 | 91.5 | 48 | 92.2 | 25 | 92.3 | 154 | 93.2 |
| ligases | 6,048 | 6,974 | 96.1 | 495 | 97.1 | 93 | 97.3 | 500 | 98.2 |
| total | 50,698 | 42,874 | 87.3 | 2,945 | 89.8 | 1,159 | 90.5 | 5,414 | 92.9 |

### Coverage

The occurrence of any one predicting sequence on the sequence of an enzyme specifies its EC functionality according to the specific branch N of the predicting sequence N. Tables 25 and 26 demonstrate that the predicting sequences cover (i.e. appear on the sequence of) most enzymes in the dataset. Shown in Tables 26 and 26 are the coverage in percentage of both the predicting sequences per EC level (Table 25) and of their cumulants (Table 26). The latter are defined as unions of the former CPS3=PS3∪PS4, CPS2=PS2∪CPS3 and CPS1=PS1∪CPS2, and are relevant for functional assignments. Thus, for instance, the functional classification at the third level of EC is specified by 45,819 peptides of CPS3=PS3∪PS4, covering about 89.8% of the data. Note that the coverages of the various predicting sequence at levels N are not additive (e.g., the coverage of CPS3 is much smaller than the sum of the coverages of PS3 and PS4) because predicting sequences on higher branches of the hierarchy (lower N) are encountered on sequences that possess already sites of lower branches (higher N).

The distribution of the length of predicting sequences is displayed in FIG. 8 for all enzyme classes. The average length of the predicting sequences is 8.4±4.5. Enzymes that share large predicting sequences are highly homologous, while enzymes sharing shorter predicting sequences are characterized by a lower degree of sequence similarity. This is displayed, for short, medium and long motifs, in FIGS. 9a-c.

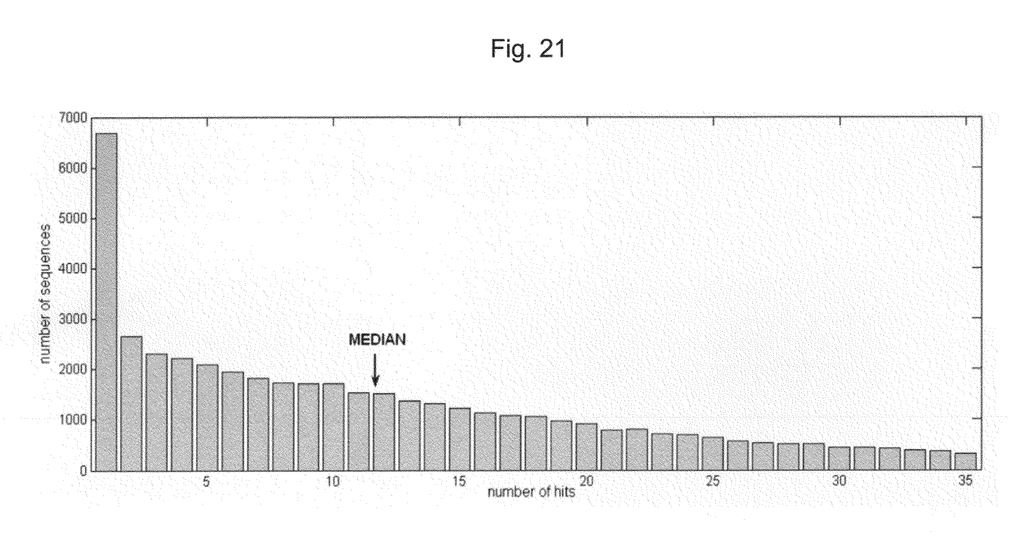

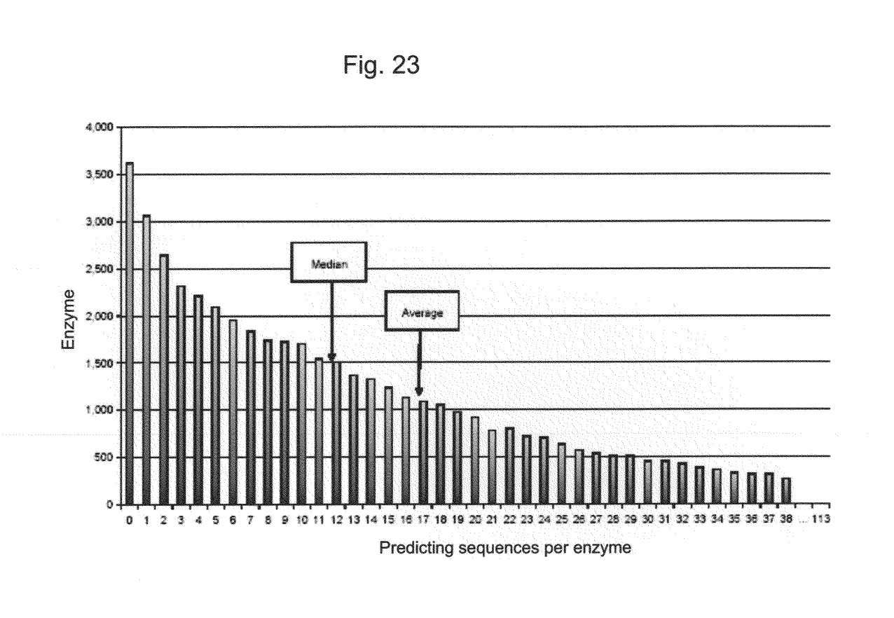

The distribution of the number of predicting sequences occurring on enzymes is given in FIG. 21. FIG. 23 is a histogram indicating distribution of the numbers of PSs occurring on enzymes with mean and median indicated.

TABLE 25
Coverage by predicting sequences of enzymes in Swiss-Prot release 48.3

| EC class | PS4 | PS3 | PS2 | PS1 |
|---|---|---|---|---|
| oxidoreductases | 86.1% | 27.6% | 18% | 75% |
| transferases | 88.4% | 33.7% | 27.4% | 70% |
| hydrolases | 78.7% | 27.7% | 19% | 57.8% |
| lyases | 91.4% | 29.7% | 15.5% | 48.2% |
| isomerases | 91.5% | 16.8% | 9.7% | 39.9% |
| ligases | 96.1% | 55% | 18.2% | 64.1% |
| total | 87.3% | 32.47% | 20.52% | 63.8% |

TABLE 26
Coverage by cumulants

| EC class | PS4 | CPS3 | CPS2 | CPS1 |
|---|---|---|---|---|
| oxidoreductases | 86.1% | 89% | 90.8% | 93.9% |
| transferases | 88.4% | 90.7% | 91.4% | 93.7% |
| hydrolases | 78.7% | 83.2% | 83.9% | 87.4% |
| lyases | 91.4% | 92.3% | 92.3% | 93.4% |
| isomerases | 91.5% | 92.2% | 92.3% | 93.2% |
| ligases | 96.1% | 97.1% | 97.3% | 94.2% |
| total | 87.3% | 89.8% | 90.5% | 92.8% |

### Generalization of Enzyme Class Prediction

The SwissProt 48.3 dataset contains 260 enzymes that have more than one annotation, and, therefore, have been excluded from the training set. Using them as a test set, 849 hits of PSs on 157 of these enzymes were found. 711 of the 849 hits agree with one of the given annotations and 138 do not, thus obtaining an accuracy of 84%. The results are displayed in Table 27, comparing the Swiss-Prot EC annotations with PS predictions. For example, the first protein on the list, has Swiss-Prot EC annotations of 2.7.2.4 and 1.1.1.3. Its sequence matches two PSs, one PS1 of class 1 and one PS4 of 2.7.2.4. This is counted as two correct matches. The columns in Table 27 indicate the protein id according to Swiss-Prot, its two EC assignments, the EC assignments according to SP predictions, and the number of SP matches that have the same EC prediction (separated into correct and false predictions)

TABLE 27

| | | | PS | # correct | # false |
|---|---|---|---|---|---|
| ID | EC1 | EC2 | Prediction | matches | matches |
| P00561 | 2.7.2.4 | 1.1.1.3 | 1 | 1 | |
| P00561 | 2.7.2.4 | 1.1.1.3 | 2.7.2.4 | 1 | |
| P00561 Total | | | | 2 | 0 |
| P27725 | 2.7.2.4 | 1.1.1.3 | 1 | 1 | |
| P27725 | 2.7.2.4 | 1.1.1.3 | 2.7.2.4 | 1 | |
| P27725 | 2.7.2.4 | 1.1.1.3 | 6.3.4.2 | 0 | 1 |
| P27725 Total | | | | 2 | 1 |
| P44505 | 2.7.2.4 | 1.1.1.3 | 1 | 1 | |
| P44505 Total | | | | 1 | 0 |
| Q9K3D6 | 4.3.2.1 | 2.3.1.1 | 4 | 1 | |
| Q9K3D6 | 4.3.2.1 | 2.3.1.1 | 4.3.2.1 | 27 | |
| Q9K3D6 Total | | | | 28 | 0 |
| Q9K3D7 | 4.3.2.1 | 2.3.1.1 | 4 | 1 | |
| Q9K3D7 | 4.3.2.1 | 2.3.1.1 | 4.3.2.1 | 27 | |
| Q9K3D7 Total | | | | 28 | 0 |
| Q5E2E8 | 4.3.2.1 | 2.3.1 | 4 | 1 | |
| Q5E2E8 | 4.3.2.1 | 2.3.1 | 4.3.2.1 | 22 | |
| Q5E2E8 Total | | | | 23 | 0 |
| P59620 | 4.3.2.1 | 2.3.1 | 4 | 1 | |
| P59620 | 4.3.2.1 | 2.3.1 | 4.3.2.1 | 27 | |
| P59620 Total | | | | 28 | 0 |
| Q8DCM9 | 4.3.2.1 | 2.3.1 | 4 | 1 | |
| Q8DCM9 | 4.3.2.1 | 2.3.1 | 4.3.2.1 | 27 | |
| Q8DCM9 Total | | | | 28 | 0 |
| Q7MH73 | 4.3.2.1 | 2.3.1 | 4 | 1 | |
| Q7MH73 | 4.3.2.1 | 2.3.1 | 4.3.2.1 | 27 | |
| Q7MH73 Total | | | | 28 | 0 |
| Q8XDZ3 | 4.1.1 | 2.1.2 | 2.1.2.9 | 2 | |
| Q8XDZ3 Total | | | | 2 | 0 |
| P77398 | 4.1.1 | 2.1.2 | 2.1.2.9 | 2 | |
| P77398 Total | | | | 2 | 0 |
| Q8Z540 | 4.1.1 | 2.1.2 | 2 | 1 | |
| Q8Z540 | 4.1.1 | 2.1.2 | 2.1.2.9 | 1 | |
| Q8Z540 | 4.1.1 | 2.1.2 | 3 | 0 | 1 |
| Q8Z540 Total | | | | 2 | 1 |
| O52325 | 4.1.1 | 2.1.2 | 2 | 1 | |
| O52325 | 4.1.1 | 2.1.2 | 2.1.2.9 | 1 | |
| O52325 | 4.1.1 | 2.1.2 | 3 | 0 | 1 |
| O52325 Total | | | | 2 | 1 |
| Q8RF47 | 4.2.3.4 | 3.6.1 | 3.6.1.11 | 1 | |
| Q8RF47 | 4.2.3.4 | 3.6.1 | 4.2.3.4 | 2 | |
| Q8RF47 Total | | | | 3 | 0 |
| Q8G5X4 | 2.7.1.71 | 4.2.3.4 | 4.2 | 1 | |
| Q8G5X4 | 2.7.1.71 | 4.2.3.4 | 4.2.3.4 | 6 | |
| Q8G5X4 Total | | | | 7 | 0 |
| Q9WYI3 | 2.7.1.71 | 4.2.3.4 | 4 | 1 | |
| Q9WYI3 | 2.7.1.71 | 4.2.3.4 | 4.2 | 1 | |
| Q9WYI3 | 2.7.1.71 | 4.2.3.4 | 4.2.3.4 | 2 | |
| Q9WYI3 Total | | | | 4 | 0 |
| P52081 | 3.5.1.28 | 3.2.1.96 | 2.7.2.3 | 0 | 1 |
| P52081 | 3.5.1.28 | 3.2.1.96 | 3 | 1 | |
| P52081 Total | | | | 1 | 1 |
| Q9Y8G7 | 1.14.14.1 | 1.6.2.4 | 1 | 1 | |
| Q9Y8G7 | 1.14.14.1 | 1.6.2.4 | 1.4 | 0 | 1 |
| Q9Y8G7 Total | | | | 1 | 1 |
| P23473 | 3.2.1.14 | 3.2.1.17 | 3.2.1 | 1 | |
| P23473 Total | | | | 1 | 0 |
| Q13057 | 2.7.7.3 | 2.7.1.24 | 2 | 1 | |
| Q13057 Total | | | | 1 | 0 |
| Q9DBL7 | 2.7.7.3 | 2.7.1.24 | 1 | 0 | 1 |
| Q9DBL7 | 2.7.7.3 | 2.7.1.24 | 2 | 1 | |
| Q9DBL7 | 2.7.7.3 | 2.7.1.24 | 3 | 0 | 1 |
| Q9DBL7 Total | | | | 1 | 2 |
| P14779 | 1.14.14.1 | 1.6.2.4 | 1 | 4 | |
| P14779 Total | | | | 4 | 0 |
| Q9ACU1 | 2.5.1 | 2.5.1.31 | 2 | 2 | |
| Q9ACU1 | 2.5.1 | 2.5.1.31 | 2.5.1.31 | 2 | |
| Q9ACU1 Total | | | | 4 | 0 |
| Q57506 | 4.6.1.1 | | 3.6.3.14 | 0 | 1 |
| Q57506 Total | | | | 0 | 1 |
| P15318 | 4.6.1.1 | | 3.6.3.14 | 0 | 1 |
| P15318 Total | | | | 0 | 1 |
| Q05762 | 1.5.1.3 | 2.1.1.45 | 2 | 3 | |
| Q05762 | 1.5.1.3 | 2.1.1.45 | 2.1.1 | 1 | |
| Q05762 | 1.5.1.3 | 2.1.1.45 | 2.1.1.45 | 8 | |
| Q05762 Total | | | | 12 | 0 |
| Q05763 | 1.5.1.3 | 2.1.1.45 | 2 | 2 | |
| Q05763 | 1.5.1.3 | 2.1.1.45 | 2.1.1 | 1 | |
| Q05763 | 1.5.1.3 | 2.1.1.45 | 2.1.1.45 | 8 | |
| Q05763 | 1.5.1.3 | 2.1.1.45 | 5.1.1.7 | 0 | 1 |
| Q05763 Total | | | | 11 | 1 |
| Q23695 | 1.5.1.3 | 2.1.1.45 | 2.1.1 | 1 | |
| Q23695 | 1.5.1.3 | 2.1.1.45 | 2.1.1.45 | 5 | |
| Q23695 Total | | | | 6 | 0 |
| P45350 | 1.5.1.3 | 2.1.1.45 | 1.5.1.3 | 1 | |
| P45350 | 1.5.1.3 | 2.1.1.45 | 2 | 3 | |
| P45350 | 1.5.1.3 | 2.1.1.45 | 2.1.1.45 | 9 | |
| P45350 | 1.5.1.3 | 2.1.1.45 | 5.1.1.7 | 0 | 1 |
| P45350 Total | | | | 13 | 1 |
| P16126 | 1.5.1.3 | 2.1.1.45 | 2 | 2 | |
| P16126 | 1.5.1.3 | 2.1.1.45 | 2.1 | 1 | |
| P16126 | 1.5.1.3 | 2.1.1.45 | 2.1.1 | 1 | |
| P16126 | 1.5.1.3 | 2.1.1.45 | 2.1.1.45 | 8 | |
| P16126 Total | | | | 12 | 0 |
| P07382 | 1.5.1.3 | 2.1.1.45 | 2 | 2 | |
| P07382 | 1.5.1.3 | 2.1.1.45 | 2.1.1 | 1 | |
| P07382 | 1.5.1.3 | 2.1.1.45 | 2.1.1.45 | 8 | |
| P07382 | 1.5.1.3 | 2.1.1.45 | 6.1.1 | 0 | 1 |
| P07382 Total | | | | 11 | 1 |
| O81395 | 1.5.1.3 | 2.1.1.45 | 1.5.1.3 | 1 | |
| O81395 | 1.5.1.3 | 2.1.1.45 | 2 | 2 | |
| O81395 | 1.5.1.3 | 2.1.1.45 | 2.1 | 1 | |
| O81395 | 1.5.1.3 | 2.1.1.45 | 2.1.1 | 1 | |
| O81395 | 1.5.1.3 | 2.1.1.45 | 2.1.1.45 | 9 | |
| O81395 Total | | | | 14 | 0 |
| Q5UQG3 | 1.5.1.3 | 2.1.1.45 | 2.1.1.45 | 1 | |
| Q5UQG3 Total | | | | 1 | 0 |
| Q27828 | 1.5.1.3 | 2.1.1.45 | 1.5.1.3 | 1 | |
| Q27828 | 1.5.1.3 | 2.1.1.45 | 2 | 1 | |
| Q27828 | 1.5.1.3 | 2.1.1.45 | 2.1.1 | 1 | |
| Q27828 | 1.5.1.3 | 2.1.1.45 | 2.1.1.45 | 8 | |
| Q27828 Total | | | | 11 | 0 |
| Q27713 | 1.5.1.3 | 2.1.1.45 | 1.5.1.3 | 1 | |
| Q27713 | 1.5.1.3 | 2.1.1.45 | 2 | 2 | |
| Q27713 | 1.5.1.3 | 2.1.1.45 | 2.1 | 1 | |
| Q27713 | 1.5.1.3 | 2.1.1.45 | 2.1.1 | 1 | |
| Q27713 | 1.5.1.3 | 2.1.1.45 | 2.1.1.45 | 8 | |
| Q27713 Total | | | | 13 | 0 |
| P20712 | 1.5.1.3 | 2.1.1.45 | 2 | 2 | |
| P20712 | 1.5.1.3 | 2.1.1.45 | 2.1 | 1 | |
| P20712 | 1.5.1.3 | 2.1.1.45 | 2.1.1 | 1 | |
| P20712 | 1.5.1.3 | 2.1.1.45 | 2.1.1.45 | 8 | |
| P20712 Total | | | | 12 | 0 |
| P13922 | 1.5.1.3 | 2.1.1.45 | 2 | 2 | |
| P13922 | 1.5.1.3 | 2.1.1.45 | 2.1 | 1 | |
| P13922 | 1.5.1.3 | 2.1.1.45 | 2.1.1 | 1 | |
| P13922 | 1.5.1.3 | 2.1.1.45 | 2.1.1.45 | 8 | |
| P13922 Total | | | | 12 | 0 |
| O02604 | 1.5.1.3 | 2.1.1.45 | 2 | 1 | |
| O02604 | 1.5.1.3 | 2.1.1.45 | 2.1 | 1 | |
| O02604 | 1.5.1.3 | 2.1.1.45 | 2.1.1 | 1 | |
| O02604 | 1.5.1.3 | 2.1.1.45 | 2.1.1.45 | 8 | |
| O02604 | 1.5.1.3 | 2.1.1.45 | 4 | 0 | 1 |
| O02604 Total | | | | 11 | 1 |
| P51820 | 1.5.1.3 | 2.1.1.45 | 2 | 3 | |
| P51820 | 1.5.1.3 | 2.1.1.45 | 2.1.1 | 1 | |
| P51820 | 1.5.1.3 | 2.1.1.45 | 2.1.1.45 | 11 | |
| P51820 | 1.5.1.3 | 2.1.1.45 | 5.1.1.7 | 0 | 1 |
| P51820 Total | | | | 15 | 1 |
| Q07422 | 1.5.1.3 | 2.1.1.45 | 1.1.1.1 | 0 | 1 |
| Q07422 | 1.5.1.3 | 2.1.1.45 | 2 | 1 | |
| Q07422 | 1.5.1.3 | 2.1.1.45 | 2.1.1 | 1 | |
| Q07422 | 1.5.1.3 | 2.1.1.45 | 2.1.1.45 | 7 | |
| Q07422 Total | | | | 9 | 1 |
| Q27783 | 1.5.1.3 | 2.1.1.45 | 2 | 2 | |
| Q27783 | 1.5.1.3 | 2.1.1.45 | 2.1.1 | 1 | |
| Q27783 | 1.5.1.3 | 2.1.1.45 | 2.1.1.45 | 7 | |
| Q27783 Total | | | | 10 | 0 |
| Q27793 | 1.5.1.3 | 2.1.1.45 | 2 | 2 | |
| Q27793 | 1.5.1.3 | 2.1.1.45 | 2.1.1 | 1 | |
| Q27793 | 1.5.1.3 | 2.1.1.45 | 2.1.1.45 | 7 | |
| Q27793 Total | | | | 10 | 0 |
| Q9CGE3 | 2.7.6.3 | 3.5.4.16 | 3.5.4.16 | 3 | |
| Q9CGE3 Total | | | | 3 | 0 |
| Q8GJP4 | 2.7.6.3 | 3.5.4.16 | 3.5.4.16 | 3 | |
| Q8GJP4 Total | | | | 3 | 0 |
| Q10663 | 4.1.3.1 | 2.3.3.9 | 2 | 1 | |
| Q10663 | 4.1.3.1 | 2.3.3.9 | 2.3 | 1 | |
| Q10663 | 4.1.3.1 | 2.3.3.9 | 2.3.3.9 | 5 | |
| Q10663 | 4.1.3.1 | 2.3.3.9 | 4.1 | 1 | |
| Q10663 | 4.1.3.1 | 2.3.3.9 | 4.1.3 | 1 | |
| Q10663 | 4.1.3.1 | 2.3.3.9 | 4.1.3.1 | 4 | |
| Q10663 Total | | | | 13 | 0 |
| Q7TQ49 | 5.1.3.14 | 2.7.1.60 | 2.7.1 | 1 | |
| Q7TQ49 Total | | | | 1 | 0 |
| Q9Y223 | 5.1.3.14 | 2.7.1.60 | 2.7.1 | 1 | |
| Q9Y223 Total | | | | 1 | 0 |
| Q91WG8 | 5.1.3.14 | 2.7.1.60 | 2.7.1 | 1 | |
| Q91WG8 Total | | | | 1 | 0 |
| O35826 | 5.1.3.14 | 2.7.1.60 | 2.7.1 | 1 | |
| O35826 Total | | | | 1 | 0 |
| P17114 | 2.7.7.23 | 2.3.1.157 | 2.7.1.40 | 0 | 1 |
| P17114 Total | | | | 0 | 1 |
| P43675 | 6.3.1.8 | 3.5.1.78 | 2 | 0 | 1 |
| P43675 Total | | | | 0 | 1 |
| Q92G13 | 2.1.1 | 2.1.1.33 | 2 | 2 | |
| Q92G13 | 2.1.1 | 2.1.1.33 | 2.1.1.33 | 2 | |
| Q92G13 | 2.1.1 | 2.1.1.33 | 2.4 | 0 | 1 |
| Q92G13 | 2.1.1 | 2.1.1.33 | 3.1.3.48 | 0 | 1 |
| Q92G13 Total | | | | 4 | 2 |
| Q9ZCB3 | 2.1.1 | 2.1.1.33 | 2 | 1 | |
| Q9ZCB3 | 2.1.1 | 2.1.1.33 | 2.1.1.33 | 2 | |
| Q9ZCB3 Total | | | | 3 | 0 |
| Q83B60 | 2.7.1 | 2.7.7 | 2.1.2.9 | 0 | 1 |
| Q83B60 Total | | | | 0 | 1 |
| Q7AAQ7 | 2.7.1 | 2.7.7 | 3.6.3 | 0 | 1 |
| Q7AAQ7 Total | | | | 0 | 1 |
| Q8FDH5 | 2.7.1 | 2.7.7 | 3.6.3 | 0 | 1 |
| Q8FDH5 Total | | | | 0 | 1 |
| P76658 | 2.7.1 | 2.7.7 | 3.6.3 | 0 | 1 |
| P76658 Total | | | | 0 | 1 |
| Q74BF6 | 2.7.1 | 2.7.7 | 5 | 0 | 1 |
| Q74BF6 | 2.7.1 | 2.7.7 | 6 | 0 | 1 |
| Q74BF6 Total | | | | 0 | 2 |
| Q9ZKZ0 | 2.7.1 | 2.7.7 | 1 | 0 | 1 |
| Q9ZKZ0 Total | | | | 0 | 1 |
| Q9CME6 | 2.7.1 | 2.7.7 | 3.4.21 | 0 | 1 |
| Q9CME6 Total | | | | 0 | 1 |
| Q88D93 | 2.7.1 | 2.7.7 | 2.7 | 1 | |
| Q88D93 Total | | | | 1 | 0 |
| Q87VF4 | 2.7.1 | 2.7.7 | 2.7 | 1 | |
| Q87VF4 Total | | | | 1 | 0 |
| Q98I54 | 2.7.1 | 2.7.7 | 1 | 0 | 1 |
| Q98I54 Total | | | | 0 | 1 |
| Q6N2R5 | 2.7.1 | 2.7.7 | 1.18.6.1 | 0 | 1 |
| Q6N2R5 Total | | | | 0 | 1 |
| Q8XEW9 | 2.7.1 | 2.7.7 | 3.6.3 | 0 | 1 |
| Q8XEW9 Total | | | | 0 | 1 |
| Q7CPR9 | 2.7.1 | 2.7.7 | 3.6.3 | 0 | 1 |
| Q7CPR9 Total | | | | 0 | 1 |
| Q7UBI8 | 2.7.1 | 2.7.7 | 3.6.3 | 0 | 1 |
| Q7UBI8 Total | | | | 0 | 1 |
| Q9Z5B5 | 2.7.1 | 2.7.7 | 6.1.1.7 | 0 | 1 |
| Q9Z5B5 Total | | | | 0 | 1 |
| Q8YD09 | 3.5.2.7 | 4.3.1.3 | 3 | 1 | |
| Q8YD09 | 3.5.2.7 | 4.3.1.3 | 3.5.2.7 | 10 | |
| Q8YD09 | 3.5.2.7 | 4.3.1.3 | 4 | 1 | |
| Q8YD09 | 3.5.2.7 | 4.3.1.3 | 4.3.1 | 1 | |
| Q8YD09 | 3.5.2.7 | 4.3.1.3 | 4.3.1.3 | 16 | |
| Q8YD09 Total | | | | 29 | 0 |
| Q58270 | 2.5.1.1 | 2.5.1.10 | 6.1.1.19 | 0 | 1 |
| Q58270 Total | | | | 0 | 1 |
| Q58999 | 2.7.1.147 | 2.7.1.146 | 2 | 1 | |
| Q58999 | 2.7.1.147 | 2.7.1.146 | 2.7.1 | 1 | |
| Q58999 | 2.7.1.147 | 2.7.1.146 | 2.7.1.146 | 1 | |
| Q58999 Total | | | | 3 | 0 |
| Q55928 | 2.7.7.1 | 3.6.1 | 2 | 1 | |
| Q55928 | 2.7.7.1 | 3.6.1 | 2.7.7.1 | 1 | |
| Q55928 Total | | | | 2 | 0 |
| O54820 | 2.7.7.4 | 2.7.1.25 | 2.7.1.25 | 1 | |
| O54820 | 2.7.7.4 | 2.7.1.25 | 3.4.11.18 | 0 | 1 |
| O54820 | 2.7.7.4 | 2.7.1.25 | 6 | 0 | 1 |
| O54820 Total | | | | 1 | 2 |
| O43252 | 2.7.7.4 | 2.7.1.25 | 2.7.1.25 | 1 | |
| O43252 | 2.7.7.4 | 2.7.1.25 | 3.4.11.18 | 0 | 1 |
| O43252 | 2.7.7.4 | 2.7.1.25 | 6 | 0 | 1 |
| O043252 Total | | | | 1 | 2 |
| Q60967 | 2.7.7.4 | 2.7.1.25 | 2.7.1.25 | 1 | |
| Q60967 | 2.7.7.4 | 2.7.1.25 | 3.4.11.18 | 0 | 1 |
| Q60967 | 2.7.7.4 | 2.7.1.25 | 6 | 0 | 1 |
| Q60967 Total | | | | 1 | 2 |
| O95340 | 2.7.7.4 | 2.7.1.25 | 2.7 | 1 | |
| O95340 | 2.7.7.4 | 2.7.1.25 | 2.7.1.25 | 2 | |
| O95340 | 2.7.7.4 | 2.7.1.25 | 6 | 0 | 1 |
| O95340 Total | | | | 3 | 1 |
| O88428 | 2.7.7.4 | 2.7.1.25 | 2.7 | 1 | |
| O88428 | 2.7.7.4 | 2.7.1.25 | 2.7.1.25 | 2 | |
| O88428 | 2.7.7.4 | 2.7.1.25 | 6 | 0 | 1 |
| O88428 Total | | | | 3 | 1 |
| Q27128 | 2.7.7.4 | 2.7.1.25 | 2.7 | 1 | |
| Q27128 | 2.7.7.4 | 2.7.1.25 | 2.7.1 | 1 | |
| Q27128 | 2.7.7.4 | 2.7.1.25 | 2.7.1.25 | 4 | |
| Q27128 | 2.7.7.4 | 2.7.1.25 | 3.1 | 0 | 1 |
| Q27128 | 2.7.7.4 | 2.7.1.25 | 6 | 0 | 1 |
| Q27128 Total | | | | 6 | 2 |
| P36204 | 2.7.2.3 | 5.3.1.1 | 2 | 4 | |
| P36204 | 2.7.2.3 | 5.3.1.1 | 2.7 | 4 | |
| P36204 | 2.7.2.3 | 5.3.1.1 | 2.7.2.3 | 29 | |
| P36204 | 2.7.2.3 | 5.3.1.1 | 5.3.1.1 | 11 | |
| P36204 Total | | | | 48 | 0 |
| O13911 | 3.1.3.32 | 2.7.1.78 | 3 | 1 | |
| O13911 | 3.1.3.32 | 2.7.1.78 | 3.1.3.18 | 0 | 1 |
| O13911 Total | | | | 1 | 1 |
| Q96T60 | 3.1.3.32 | 2.7.1.78 | 1.17.4.3 | 0 | 1 |
| Q96T60 | 3.1.3.32 | 2.7.1.78 | 3 | 1 | |
| Q96T60 Total | | | | 1 | 1 |
| Q9JLV6 | 3.1.3.32 | 2.7.1.78 | 3 | 1 | |
| Q9JLV6 | 3.1.3.32 | 2.7.1.78 | 3.1.3.18 | 0 | 1 |
| Q9JLV6 Total | | | | 1 | 1 |
| P20772 | 6.3.4.13 | 6.3.3.1 | 2.6.1.52 | 0 | 1 |
| P20772 | 6.3.4.13 | 6.3.3.1 | 6 | 1 | |
| P20772 | 6.3.4.13 | 6.3.3.1 | 6.3 | 1 | |
| P20772 | 6.3.4.13 | 6.3.3.1 | 6.3.3.1 | 9 | |
| P20772 | 6.3.4.13 | 6.3.3.1 | 6.3.4.13 | 6 | |
| P20772 Total | | | | 17 | 1 |
| Q99148 | 6.3.4.13 | 6.3.3.1 | 6 | 1 | |
| Q99148 | 6.3.4.13 | 6.3.3.1 | 6.3 | 1 | |
| Q99148 | 6.3.4.13 | 6.3.3.1 | 6.3.3.1 | 10 | |
| Q99148 | 6.3.4.13 | 6.3.3.1 | 6.3.4.13 | 6 | |
| Q99148 Total | | | | 18 | 0 |
| P07244 | 6.3.4.13 | 6.3.3.1 | 6 | 1 | |
| P07244 | 6.3.4.13 | 6.3.3.1 | 6.3.3.1 | 11 | |
| P07244 | 6.3.4.13 | 6.3.3.1 | 6.3.4.13 | 4 | |
| P07244 Total | | | | 16 | 0 |
| Q8A155 | 2.1.2.3 | 3.5.4.10 | 2 | 1 | |
| Q8A155 Total | | | | 1 | 0 |
| Q89WU7 | 2.1.2.3 | 3.5.4.10 | 4.2.1.24 | 0 | 1 |
| Q89WU7 Total | | | | 0 | 1 |
| P57143 | 2.1.2.3 | 3.5.4.10 | 2 | 1 | |
| P57143 Total | | | | 1 | 0 |
| Q8KA70 | 2.1.2.3 | 3.5.4.10 | 2 | 1 | |
| Q8KA70 Total | | | | 1 | 0 |
| Q9ABY4 | 2.1.2.3 | 3.5.4.10 | 4.2.1.24 | 0 | 1 |
| Q9ABY4 Total | | | | 0 | 1 |
| P31335 | 2.1.2.3 | 3.5.4.10 | 2 | 1 | |
| P31335 Total | | | | 1 | 0 |
| Q892X3 | 2.1.2.3 | 3.5.4.10 | 2.7.1.37 | 0 | 1 |
| Q892X3 Total | | | | 0 | 1 |
| Q9RHX6 | 2.1.2.3 | 3.5.4.10 | 3.6.3.14 | 0 | 1 |
| Q9RHX6 | 2.1.2.3 | 3.5.4.10 | 5.3.1.16 | 0 | 1 |
| Q9RHX6 Total | | | | 0 | 2 |
| Q8X611 | 2.1.2.3 | 3.5.4.10 | 2 | 1 | |
| Q8X611 | 2.1.2.3 | 3.5.4.10 | 2.5.1 | 0 | 1 |
| Q8X611 | 2.1.2.3 | 3.5.4.10 | 4.2.1.24 | 0 | 1 |
| Q8X611 | 2.1.2.3 | 3.5.4.10 | 5 | 0 | 1 |
| Q8X611 Total | | | | 1 | 3 |
| Q8FB68 | 2.1.2.3 | 3.5.4.10 | 2 | 1 | |
| Q8FB68 | 2.1.2.3 | 3.5.4.10 | 2.5.1 | 0 | 1 |
| Q8FB68 | 2.1.2.3 | 3.5.4.10 | 4.2.1.24 | 0 | 1 |
| Q8FB68 | 2.1.2.3 | 3.5.4.10 | 5 | 0 | 1 |
| Q8FB68 Total | | | | 1 | 3 |
| P15639 | 2.1.2.3 | 3.5.4.10 | 2 | 1 | |
| P15639 | 2.1.2.3 | 3.5.4.10 | 2.5.1 | 0 | 1 |
| P15639 | 2.1.2.3 | 3.5.4.10 | 4.2.1.24 | 0 | 1 |
| P15639 | 2.1.2.3 | 3.5.4.10 | 5 | 0 | 1 |
| P15639 Total | | | | 1 | 3 |
| P43852 | 2.1.2.3 | 3.5.4.10 | 2 | 1 | |
| P43852 | 2.1.2.3 | 3.5.4.10 | 4.2.1.24 | 0 | 1 |
| P43852 | 2.1.2.3 | 3.5.4.10 | 5.3.1.9 | 0 | 1 |
| P43852 Total | | | | 1 | 2 |
| P31939 | 2.1.2.3 | 3.5.4.10 | 2 | 1 | |
| P31939 | 2.1.2.3 | 3.5.4.10 | 5.99.1.3 | 0 | 1 |
| P31939 Total | | | | 1 | 1 |
| Q9CWJ9 | 2.1.2.3 | 3.5.4.10 | 2 | 1 | |
| Q9CWJ9 Total | | | | 1 | 0 |
| P67542 | 2.1.2.3 | 3.5.4.10 | 6.1.1.20 | 0 | 1 |
| P67542 Total | | | | 0 | 1 |
| Q9RAJ5 | 2.1.2.3 | 3.5.4.10 | 2.7.1.37 | 0 | 1 |
| Q9RAJ5 | 2.1.2.3 | 3.5.4.10 | 6.1.1.20 | 0 | 1 |
| Q9RAJ5 Total | | | | 0 | 2 |
| P67541 | 2.1.2.3 | 3.5.4.10 | 6.1.1.20 | 0 | 1 |
| P67541 Total | | | | 0 | 1 |
| P57828 | 2.1.2.3 | 3.5.4.10 | 2 | 1 | |
| P57828 | 2.1.2.3 | 3.5.4.10 | 4.2.1.24 | 0 | 1 |
| P57828 Total | | | | 1 | 1 |
| Q9HUV9 | 2.1.2.3 | 3.5.4.10 | 4.2.1.24 | 0 | 1 |
| Q9HUV9 Total | | | | 0 | 1 |
| Q88DK3 | 2.1.2.3 | 3.5.4.10 | 4.2.1.24 | 0 | 1 |
| Q88DK3 Total | | | | 0 | 1 |
| Q87VR9 | 2.1.2.3 | 3.5.4.10 | 4.2.1.24 | 0 | 1 |
| Q87VR9 Total | | | | 0 | 1 |
| Q8Z335 | 2.1.2.3 | 3.5.4.10 | 2 | 1 | |
| Q8Z335 | 2.1.2.3 | 3.5.4.10 | 2.5.1 | 0 | 1 |
| Q8Z335 | 2.1.2.3 | 3.5.4.10 | 4.2.1.24 | 0 | 1 |
| Q8Z335 | 2.1.2.3 | 3.5.4.10 | 5 | 0 | 1 |
| Q8Z335 Total | | | | 1 | 3 |
| P26978 | 2.1.2.3 | 3.5.4.10 | 2 | 1 | |
| P26978 | 2.1.2.3 | 3.5.4.10 | 2.5.1 | 0 | 1 |
| P26978 | 2.1.2.3 | 3.5.4.10 | 4.2.1.24 | 0 | 1 |
| P26978 | 2.1.2.3 | 3.5.4.10 | 5 | 0 | 1 |
| P26978 Total | | | | 1 | 3 |
| O74928 | 2.1.2.3 | 3.5.4.10 | 4.2.1.11 | 0 | 1 |
| O74928 Total | | | | 0 | 1 |
| Q5HH11 | 2.1.2.3 | 3.5.4.10 | 2.1 | 1 | |
| Q5HH11 Total | | | | 1 | 0 |
| P67543 | 2.1.2.3 | 3.5.4.10 | 2.1 | 1 | |
| P67543 Total | | | | 1 | 0 |
| P67544 | 2.1.2.3 | 3.5.4.10 | 2.1 | 1 | |
| P67544 Total | | | | 1 | 0 |
| Q6GI11 | 2.1.2.3 | 3.5.4.10 | 2.1 | 1 | |
| Q6GI11 Total | | | | 1 | 0 |
| Q6GAE0 | 2.1.2.3 | 3.5.4.10 | 2.1 | 1 | |
| Q6GAE0 Total | | | | 1 | 0 |
| Q8NX88 | 2.1.2.3 | 3.5.4.10 | 2.1 | 1 | |
| Q8NX88 Total | | | | 1 | 0 |
| P67545 | 2.1.2.3 | 3.5.4.10 | 4.2.1.24 | 0 | 1 |
| P67545 Total | | | | 0 | 1 |
| P67546 | 2.1.2.3 | 3.5.4.10 | 4.2.1.24 | 0 | 1 |
| P67546 Total | | | | 0 | 1 |
| Q8DWK8 | 2.1.2.3 | 3.5.4.10 | 4.2.1.24 | 0 | 1 |
| Q8DWK8 Total | | | | 0 | 1 |
| Q8K8Y6 | 2.1.2.3 | 3.5.4.10 | 4.2.1.24 | 0 | 1 |
| Q8K8Y6 Total | | | | 0 | 1 |
| Q5XEF2 | 2.1.2.3 | 3.5.4.10 | 4.2.1.24 | 0 | 1 |
| Q5XEF2 Total | | | | 0 | 1 |
| Q8P310 | 2.1.2.3 | 3.5.4.10 | 4.2.1.24 | 0 | 1 |
| Q8P310 Total | | | | 0 | 1 |
| Q97T99 | 2.1.2.3 | 3.5.4.10 | 4.2.1.24 | 0 | 1 |
| Q97T99 Total | | | | 0 | 1 |
| Q8DRM1 | 2.1.2.3 | 3.5.4.10 | 4.2.1.24 | 0 | 1 |
| Q8DRM1 Total | | | | 0 | 1 |
| Q9F1T4 | 2.1.2.3 | 3.5.4.10 | 4.2.1.24 | 0 | 1 |
| Q9F1T4 Total | | | | 0 | 1 |
| Q9KV80 | 2.1.2.3 | 3.5.4.10 | 2 | 1 | |
| Q9KV80 | 2.1.2.3 | 3.5.4.10 | 4.2.1.24 | 0 | 1 |
| Q9KV80 Total | | | | 1 | 1 |
| Q5E257 | 2.1.2.3 | 3.5.4.10 | 4.2.1.24 | 0 | 1 |
| Q5E257 Total | | | | 0 | 1 |
| Q87KT0 | 2.1.2.3 | 3.5.4.10 | 4.2.1.24 | 0 | 1 |
| Q87KT0 Total | | | | 0 | 1 |
| Q8DD06 | 2.1.2.3 | 3.5.4.10 | 4.2.1.24 | 0 | 1 |
| Q8DD06 Total | | | | 0 | 1 |
| Q7MGT5 | 2.1.2.3 | 3.5.4.10 | 4.2.1.24 | 0 | 1 |
| Q7MGT5 Total | | | | 0 | 1 |
| Q8PQ19 | 2.1.2.3 | 3.5.4.10 | 4.2.1.24 | 0 | 1 |
| Q8PQ19 | 2.1.2.3 | 3.5.4.10 | 6.3.4.5 | 0 | 1 |
| Q8PQ19 Total | | | | 0 | 2 |
| Q8PD47 | 2.1.2.3 | 3.5.4.10 | 4.2.1.24 | 0 | 1 |
| Q8PD47 Total | | | | 0 | 1 |
| Q9PC10 | 2.1.2.3 | 3.5.4.10 | 2 | 1 | |
| Q9PC10 | 2.1.2.3 | 3.5.4.10 | 4.2.1.24 | 0 | 1 |
| Q9PC10 Total | | | | 1 | 1 |
| Q87D58 | 2.1.2.3 | 3.5.4.10 | 2 | 1 | |
| Q87D58 | 2.1.2.3 | 3.5.4.10 | 4.2.1.24 | 0 | 1 |
| Q87D58 Total | | | | 1 | 1 |
| Q8ZAR3 | 2.1.2.3 | 3.5.4.10 | 2 | 1 | |
| Q8ZAR3 | 2.1.2.3 | 3.5.4.10 | 4.2.1.24 | 0 | 1 |
| Q8ZAR3 Total | | | | 1 | 1 |
| P09546 | 1.5.99.8 | 1.5.1.12 | 1 | 1 | |
| P09546 | 1.5.99.8 | 1.5.1.12 | 1.2.1 | 0 | 2 |
| P09546 Total | | | | 1 | 2 |
| O52485 | 1.5.99.8 | 1.5.1.12 | 1 | 1 | |
| O52485 | 1.5.99.8 | 1.5.1.12 | 1.2.1 | 0 | 2 |
| O52485 | 1.5.99.8 | 1.5.1.12 | 4.2.1.20 | 0 | 1 |
| O52485 Total | | | | 1 | 3 |
| P95629 | 1.5.99.8 | 1.5.1.12 | 1 | 1 | |
| P95629 | 1.5.99.8 | 1.5.1.12 | 1.2.1 | 0 | 1 |
| P95629 | 1.5.99.8 | 1.5.1.12 | 2 | 0 | 1 |
| P95629 Total | | | | 1 | 2 |
| P10503 | 1.5.99.8 | 1.5.1.12 | 1 | 1 | |
| P10503 | 1.5.99.8 | 1.5.1.12 | 1.2.1 | 0 | 1 |
| P10503 Total | | | | 1 | 1 |
| Q7VJ82 | 2.7.7.6 | | 1 | 0 | 1 |
| Q7VJ82 | 2.7.7.6 | | 2 | 2 | |
| Q7VJ82 | 2.7.7.6 | | 2.4.1.1 | 0 | 1 |
| Q7VJ82 | 2.7.7.6 | | 2.7 | 3 | |
| Q7VJ82 | 2.7.7.6 | | 2.7.7.6 | 9 | |
| Q7VJ82 Total | | | | 14 | 2 |
| Q9ZK23 | 2.7.7.6 | | 1 | 0 | 2 |
| Q9ZK23 | 2.7.7.6 | | 2 | 1 | |
| Q9ZK23 | 2.7.7.6 | | 2.4.1.1 | 0 | 1 |
| Q9ZK23 | 2.7.7.6 | | 2.7 | 3 | |
| Q9ZK23 | 2.7.7.6 | | 2.7.7.6 | 9 | |
| Q9ZK23 | 2.7.7.6 | | 5.3.1.16 | 0 | 1 |
| Q9ZK23 | 2.7.7.6 | | 6.1.1.4 | 0 | 1 |
| Q9ZK23 | 2.7.7.6 | | 6.2.1.1 | 0 | 1 |
| Q9ZK23 Total | | | | 13 | 6 |
| O25806 | 2.7.7.6 | | 1 | 0 | 2 |
| O25806 | 2.7.7.6 | | 2 | 1 | |
| O25806 | 2.7.7.6 | | 2.4.1.1 | 0 | 1 |
| O25806 | 2.7.7.6 | | 2.7 | 3 | |
| O25806 | 2.7.7.6 | | 2.7.7.6 | 9 | |
| O25806 | 2.7.7.6 | | 5.3.1.16 | 0 | 1 |
| O25806 | 2.7.7.6 | | 6.1.1.4 | 0 | 1 |
| O25806 Total | | | | 13 | 5 |
| Q7MA56 | 2.7.7.6 | | 1 | 0 | 1 |
| Q7MA56 | 2.7.7.6 | | 2 | 1 | |
| Q7MA56 | 2.7.7.6 | | 2.7 | 3 | |
| Q7MA56 | 2.7.7.6 | | 2.7.7.6 | 9 | |
| Q7MA56 | 2.7.7.6 | | 6.2.1.1 | 0 | 1 |
| Q7MA56 Total | | | | 13 | 2 |
| Q85FR6 | 2.7.7.6 | | 2 | 2 | |
| Q85FR6 | 2.7.7.6 | | 2.7 | 4 | |
| Q85FR6 | 2.7.7.6 | | 2.7.1 | 0 | 1 |
| Q85FR6 | 2.7.7.6 | | 2.7.7.6 | 24 | |
| Q85FR6 Total | | | | 30 | 1 |
| P28668 | 6.1.1.17 | 6.1.1.15 | 2 | 0 | 1 |
| P28668 | 6.1.1.17 | 6.1.1.15 | 2.4.2.29 | 0 | 1 |
| P28668 | 6.1.1.17 | 6.1.1.15 | 6 | 1 | |
| P28668 | 6.1.1.17 | 6.1.1.15 | 6.1.1 | 3 | |
| P28668 Total | | | | 4 | 2 |
| P07814 | 6.1.1.17 | 6.1.1.15 | 2 | 0 | 1 |
| P07814 | 6.1.1.17 | 6.1.1.15 | 6 | 1 | |
| P07814 | 6.1.1.17 | 6.1.1.15 | 6.1.1 | 2 | |
| P07814 | 6.1.1.17 | 6.1.1.15 | 6.1.1.18 | 0 | 1 |
| P07814 Total | | | | 3 | 2 |
| Q8CGC7 | 6.1.1.17 | 6.1.1.15 | 2 | 0 | 1 |
| Q8CGC7 | 6.1.1.17 | 6.1.1.15 | 6 | 1 | |
| Q8CGC7 | 6.1.1.17 | 6.1.1.15 | 6.1.1 | 2 | |
| Q8CGC7 | 6.1.1.17 | 6.1.1.15 | 6.1.1.18 | 0 | 1 |
| Q8CGC7 Total | | | | 3 | 2 |
| Q58635 | 6.1.1.15 | 6.1.1.16 | 6.1.1 | 1 | |
| Q58635 Total | | | | 1 | 0 |
| P61422 | 2.5.1.3 | 2.7.4.7 | 2.5.1.3 | 1 | |
| P61422 | 2.5.1.3 | 2.7.4.7 | 2.7.4.7 | 1 | |
| P61422 Total | | | | 2 | 0 |
| Q8YRC9 | 1.5.3 | | 1 | 1 | |
| Q8YRC9 Total | | | | 1 | 0 |
| Q92F56 | 6.3.4 | 2.4.2.8 | 2 | 1 | |
| Q92F56 | 6.3.4 | 2.4.2.8 | 2.4.2.8 | 4 | |
| Q92F56 Total | | | | 5 | 0 |
| Q724J4 | 6.3.4 | 2.4.2.8 | 2 | 1 | |
| Q724J4 | 6.3.4 | 2.4.2.8 | 2.4.2.8 | 4 | |
| Q724J4 Total | | | | 5 | 0 |
| Q8YAC7 | 6.3.4 | 2.4.2.8 | 2 | 1 | |
| Q8YAC7 | 6.3.4 | 2.4.2.8 | 2.4.2.8 | 4 | |
| Q8YAC7 Total | | | | 5 | 0 |
| Q8R6G8 | 2 | 2.1.1.33 | 2.1.1.33 | 1 | |
| Q8R6G8 Total | | | | 1 | 0 |
| P46843 | 1.8.1.9 | 1.6.4.5 | 1 | 1 | |
| P46843 | 1.8.1.9 | 1.6.4.5 | 1.8.1.9 | 4 | |
| P46843 Total | | | | 5 | 0 |
| P31625 | 3.4.23 | 3.6.1.23 | 3.6.1.23 | 1 | |
| P31625 Total | | | | 1 | 0 |
| P29127 | 3.2.1.8 | | 3.2.1.8 | 2 | |
| P29127 | 3.2.1.8 | | 6.3.5.2 | 0 | 2 |
| P29127 Total | | | | 2 | 2 |
| P29126 | 3.2.1.8 | | 3 | 1 | |
| P29126 | 3.2.1.8 | | 3.2.1.8 | 1 | |
| P29126 Total | | | | 2 | 0 |
| Grand Total | | | | 719 | 132 |

The ability to generalize using the exemplary MEX algorithm was tested on several cross-validation choices of training and test sets within the class of oxidoreductases and found to be of the order of 85% (see Table 28).

TABLE 28
generalization tests on Oxidoreductase class.

| test set size | level 2 Jaccard score | level 3 Jaccard score |
|---|---|---|
| 10% | 0.86 ± 0.04 | 0.86 ± 0.07 |
| 20% | 0.86 ± 0.03 | 0.85 ± 0.05 |
| 25% | 0.85 ± 0.03 | 0.85 ± 0.04 |

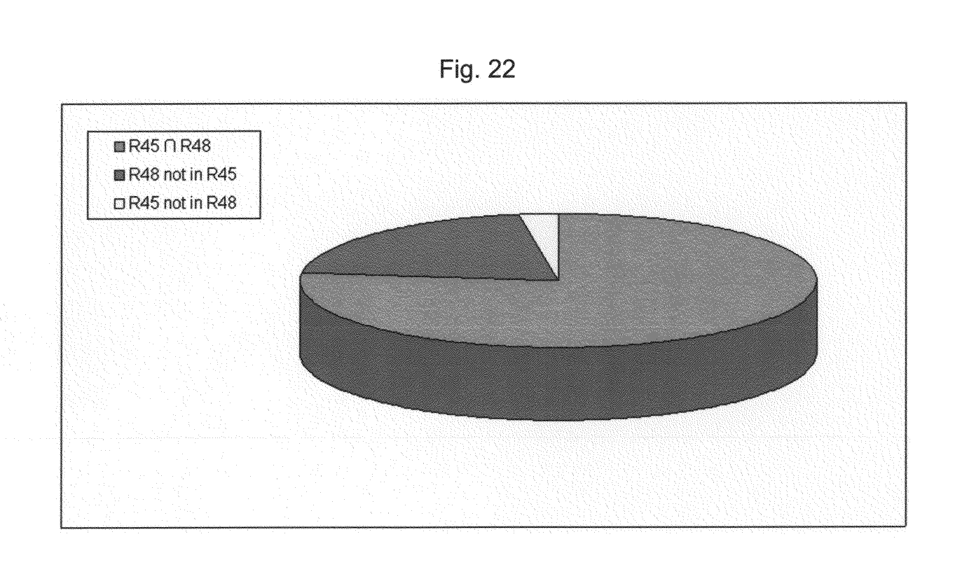

Additionally, MEX was run on the Swiss-Prot 45 release (October 2004) and testing its predictions on 10,000 novel enzymes that are listed in the Swiss-Prot 48.3 release (for the relation between these two sets see FIG. 22 and Table 29.) results were similar to those described above, as shown in Table 31).

TABLE 29
Numbers of enzymes in Swiss-Prot release 48.3and Swiss-Prot
release 45.

| EC class | R45 ∩ R48 | R48 ∩ not in R45 | R45 ∩ not in R48 |
|---|---|---|---|
| Oxidoreductases | 7776 | 1661 | 142 |
| Transferases | 12474 | 3722 | 333 |
| Hydrolases | 8728 | 2173 | 254 |
| Lyases | 4140 | 1089 | 492 |
| Isomerases | 2348 | 541 | 33 |
| Ligases | 4649 | 1399 | 43 |
| Total | 40115 | 10585 | 1297 |

Table 30 summarizes results of a generalization test on all levels of the EC hierarchy. Recall specifies the coverage of the novel sequences (i.e. R48 ∩ not in R45) by PSs extracted from Swiss-Prot release 45. Precision denotes the number of correct assignments according to the EC hierarchy.

TABLE 30
Generalization test on all levels of EC.

| EC class | # of sequences | Recall | Precision |
|---|---|---|---|
| Oxidoreductases | 1661 | 1235 (74.35%) | 99.35% |
| Transferases | 3722 | 3253 (87.4%) | 99.3% |
| Hydrolases | 2173 | 1614 (74.25%) | 98.45% |
| Lyases | 1089 | 930 (85.4%) | 99.65% |
| Isomerases | 686 | 611 (89%) | 83% |
| Ligases | 1399 | 1385 (99%) | 99.55% |
| Total | 10730 | 9028 (84.15%) | 98.5% |

Both generalization tests suffer from a bias problem, i.e., there exist enzymes in the test sets that have high sequence similarity to some enzymes in the training sets.

In conventional machine-learning approaches to analysis of sequence to function problems bias in data sets is often accounted for by by avoiding high sequence similarity between proteins in the test set and proteins in the training set. In this case, this type of avoidance is practically infeasible, because such avoidance effectively calls for eliminating all enzymes that have the same 4-digit EC number as the one being tested from the training set.

Therefore, bias was handled by the following procedure:

(a) start with the test set consisting of all sequences of SwissProt release 48.3 that do not appear in release 45.

(b) blast each sequence with the sequences of the training set (SwissProt release 45) that do not have the same 4-digit EC number.

(c) include in the non-redundant test set only sequences whose BLAST score (Altschul et al.(1997) Gapped blast and psi-blst: a new generation of protein database search programs. Nucl. Acids Res., 25:3389-3402). with all other training sequences (including those with the same first 3 EC digits) is larger than 10⁻³. A representative Example of a non-redundant database is provided in Appendix 1 below and further in Table 37 on enclosed CD-ROM. (d) test generalization on this non-redundant set only for motifs in PS1, PS2, and PS3, thus avoiding the PS4 motifs that were extracted from the same 4th level EC sequences as those of the non-redundant test set. The results of this non-biased generalization test are presented in Table 34 which indicates that 440 (about 40%) of the test-set enzymes contain predicting sequences that fit the correct classification with an accuracy of 88%.

In table 34, numbers in the three PSN columns indicate the number of sequences been covered by PSs. Numbers in brackets indicate the numbers of PSs observed to occur on the sequences. Columns of tp and fp display true-positive and false-positive predictions, where tp corresponds to the PS indicating correctly the EC classification and fp indicates contradiction with the EC classification.

TABLE 34
Coverage of non-redundant test set by motifs in PS1, PS2 and PS3.

| class | # of seq | PS1 | tp₁ | fp₁ | PS2 | tp₂ | fp₂ | PS3 | tp₃ | fp₃ |
|---|---|---|---|---|---|---|---|---|---|---|
| Oxidoreductases | 36 | 15(35) | 34 | 1 | 0 | 0 | 0 | 0 | 0 | 0 |
| Transferases | 15 | 7(13) | 13 | 0 | 2(2) | 2 | 0 | 2(2) | 2 | 0 |
| Hydrolases | 98 | 30(41) | 39 | 2 | 5(5) | 4 | 1 | 4(4) | 2 | 2 |
| Lyases | 134 | 22(23) | 23 | 0 | 10(12) | 11 | 1 | 13(18) | 18 | 0 |
| Isomerases | 147 | 38(42) | 26 | 16 | 6(6) | 6 | 0 | 9(14) | 8 | 6 |
| Ligases | 10 | 3(5) | 5 | 0 | 4(10) | 10 | 0 | 0 | 0 | 0 |
| total | 440 | 115(159) | 140 | 19 | 27(35) | 33 | 2 | 28(38) | 30 | 8 |

### Remote Homology

Results presented hereinabove suggest that short predictive sequence motifs, although often extracted from homology, may be better alternatives for functional specification of proteins. Data summarized in Table 35 suggests that Relying on sequence identity within long aligned sections may turn out to be fortuitous, while shorter motifs appear to tell the true story. Table 35 displays pairs of enzymes that have large sequence identity yet different functional assignments. All displayed EC assignments are substantiated by corresponding predictive sequences located on these enzymes, most belonging to PS4. The numbers of predictive sequences per enzyme varies from one (in the cases of GTFB_STRMU and GABT_ECOLI, the latter having only one PS3 peptide) to 24 for AMY3B_ORYSA. Thus the pair of enzymes GTFB_STRMU and AMY3B_ORYSA contains both extremes. Note that in spite of the reported 42% sequence identity along an alignment of 105 amino-acids, none of the 24 predicting sequences occurring on AMY3B_ORYSA had an exact match on GTFB_STRMU, and a single PS4 (GGAFLE; SEQ ID No.: 29308) found on the latter determines correctly its EC classification. Table 35 summarizes data for enzymes with high sequence similarity and different EC assignments. Alignment and identity were calculated according to the Smith-Waterman method. EC assignments agree with PSs occurring on the enzymes.

TABLE 35
Enzymes with high sequence similarity and different EC assignments.

| | | sequence | alignment | |
|---|---|---|---|---|
| enzyme 1 | enzyme 2 | identity | length | e-value |
| GUNA_PSEFL | MDHP_FLABI | 71% | 28 | 1.6e−03 |
| EC 3.2.1.4 | EC 1.1.1.82 | | | |
| PLB1_YEAST | METB_ARATH | 60% | 30 | 5.9e−05 |
| EC 3.1.1.5 | EC 2.5.1.48 | | | |
| RPB1_PLAFD | UBC2_YEAST | 63% | 27 | 18e−05 |
| EC 2.7.7.6 | EC 6.3.2.19 | | | |
| CHIB_POPTR | KDGE_DROME | 58% | 24 | 6.0e−06 |
| EC 3.2.1.14 | EC 2.7.1.107 | | | |
| ODO2_FUGRU | PP2BB_HUMAN | 53% | 39 | 1.1e−06 |
| EC 2.3.1.61 | EC 3.1.3.16 | | | |
| GTFB_STRMU | AMY3B_ORYSA | 42% | 105 | 7.4e−08 |
| EC 2.4.1.5 | EC 3.2.1.1 | | | |
| RPB1_PLAFD | BDE3B_RAT | 58% | 36 | 84e−08 |
| EC 2.7.7.6 | EC 3.1.4.17 | | | |
| IGF1R_HUMAN | PTPRU_HUMAN | 34% | 157 | 1.5e−09 |
| EC 2.7.10.1 | EC 3.1.3.48 | | | |

### Biological Roles of Predicting Sequences

An analysis of correlation between predictive sequences and previously characterized active sites was undertaken in order to ascertain whether the predictive sequences play an important role in the active and binding sites of enzymes.

The Inventors of the present invention have constructed a database of 26,931 predicting sequence from 21,228 enzymes the Swiss-Prot 48.3 dataset which carry annotations of loci of active sites and binding sites. These enzymes constitute about 42% of the 48.3 dataset. It was found by the present Inventors that 65% of all active and binding sites are covered by predicting sequences. This can be compared with the coverage of random positions on the same enzyme sequences which, on average, is only 27%. Such average was found to be off by about 80 standard deviations. To validate the ability of the database of the present embodiments to cover binding and active sites a non-redundant database was constructed from a reduced set of 582 enzymes, one enzyme for each EC number. This non-redundant database included 6,660 predicting sequences which covered about 52% of the active and binding sites. The coverage of random positions on the same enzyme sequences was, on average, 21% (off by about 33 standard deviations). It is recognized that the non-redundant database is unbiased and therefore allows estimating active and binding site coverage had the annotations existed for all enzymes (rather than 42%). The present Inventors have succeeded to estimate a 12% coverage with a high statistical significance.

In analyzing the significance of predicting sequence coverage of active and/or binding sites, the coverage was compared with that of randomly chosen residues on enzyme sequences. This was carried out on all annotated enzymes with predicting sequence hits, as well as on the non-redundant set. The deviations of the measurements from random distributions were very high, and are quoted below in quanta of standard deviations (SDs). The corresponding p-values were found to be practically zero (bellow 10⁻³⁰⁸).

The results are presented in Table 31.

TABLE 31

| | | active | random | | | PSs |
|---|---|---|---|---|---|---|
| | | sites hit | sites hit | No. of | No. of | hitting |
| database | enzymes | by SPs | by SPs | SDs | PSs | sites |
| all | 21,228 | 65% | 27% | 80 | 26,931 | 8% |
| non redundant | 582 | 52% | 21% | 33 | 6,660 | 12% |

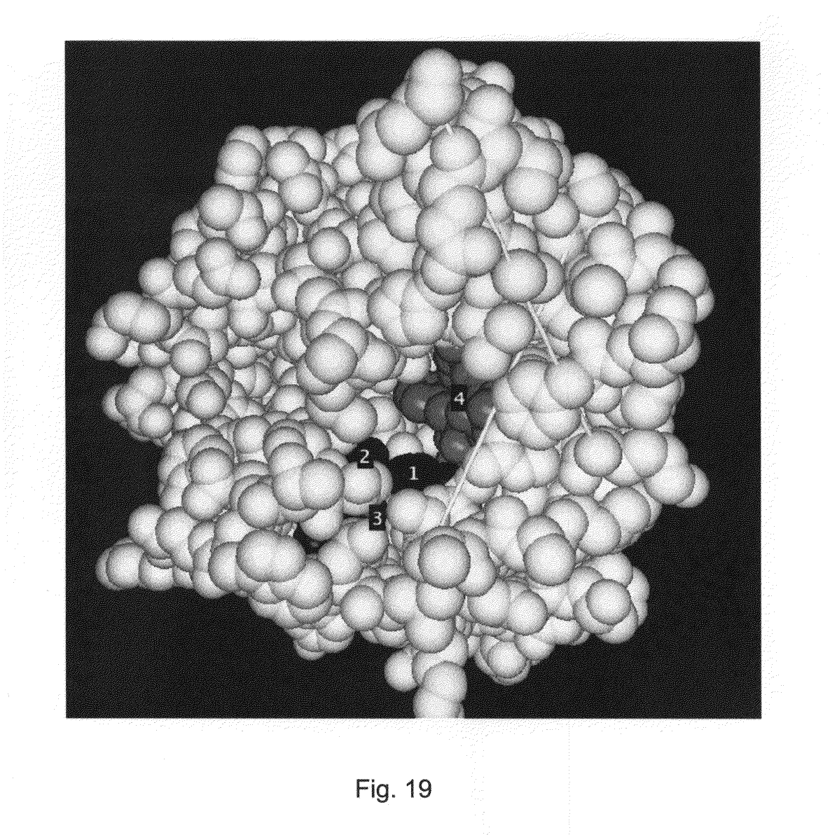

FIG. 19 displays aligned subsequences of enzymes, belonging to the same 3rd level but to different 4th levels of the EC hierarchy: 6 out of 35 enzymes of 5.1.3.2 and 7 out of 29 enzymes of 5.1.3.20. Shown are strings belonging to the sequences that include active sites and binding sites as indicated in Swiss-Prot annotations with bold-faced substrings denoting predicting sequences from our lists. Whereas in 5.1.3.20 most active sites are flanked by predicting sequences, this is not the case for the active site of 5.1.3.2. FIG. 19 displays a 3D picture of one of the enzymes of 5.1.3.20. The motif RYFNV (SEQ ID No.: 64741) can be seen to lie in proximity to both the S and Y active sites, sharing the same pocket.

An example stressing the relationships among predicting sequence and spatial structures is presented in FIGS. 20a-c. This enzyme belongs to 5.4.9.12 and it contains many predictive sequences. Shown here are predictive sequences that maintain a fixed sequence-distance from the active site for many of the enzymes in this level 4 class. Two predicting sequences flank the active site, one—HMVRNI-(SEQ ID no.: 64382) shares a pocket with the active site and the two binding sites, and the other—FHARF-(SEQ ID No.: 64294) plays the role of RNA binding in this tRNA pseudouridine synthase I. FHARF (SEQ ID No.: 64294) is one example of previously discovered motifs. Some other examples are: a. GFGRIG (SEQ ID No.: 14612; predicting sequence of 1) a conserved region of GAPDH that is active in the glycolytic pathway; b. HRDLKP (SEQ ID No.: 35399; predicting sequence of 2.7.1) appearing in protein kinases; c. IFIDEID (SEQ ID No.: 44623; predicting sequence of 3.6.4.3), the Walker B motif of ATPase; to name a few. However, most of the predicting sequences have not been studied before.

These results raise the question how many predicting sequences can be found in the neighborhood of active sites, as defined by the pockets in the spatial structures of enzymes. The statistical significance of the occurrence of predicting sequences in 3D pockets that include active sites was analyzed using the database of CASTp (Binkowski et al (2003) Castp: computed atlas of surface topography of proteins. Nucleic Acid Research, 31:3352-3355).

CASTp lists all amino-acids belonging to pockets appearing in spatial structures of proteins. 1031 enzymes that possess pockets including active (or binding) site annotations were selected. There are 8860 predicting sequences that occur on these enzymes, 31% of which lie within the active pockets in the sense that they have at least four amino-acids that reside in the pocket. Defining a background model of random peptides selected for each event of an predicting sequence hitting an active pocket in a particular enzyme, an estimate of 11% of all predicting sequences belong to events that pass an FDR [P. Bork and E. V. Koonin. Protein sequence motifs. Curr. Op. Structural Biology, 6:366-376, 1996] limit of 0.05 was obtained. Most of them (about 70%) do not contain an active site, hence they are of potential interest for experimental verification of their importance in defining and maintaining the enzymatic function.

Table 32 lists the number of enzymes that were analyzed and the number of SPs that are located on these enzymes. This is followed by numbers of predicting sequences lying (with at least four residues) in pockets including active sites. Requiring high significance of the latter, through a background model, and using the FDR limit of 0.05, the results displayed in the following column were obtained. The last column displays the number of significant predicting sequences that lie in the pocket but do not contain the amino-acid with active site annotation.

TABLE 32

| | | | | Significant |
|---|---|---|---|---|
| | | | Significant PSs | PSs without |
| enzymes | PS | PS in pockets | (FDR = 0.05) | sites |
| 1031 | 8860 | 2487 (28%) | 1622 (18%) | 1422 (16%) |

A list of these predicting sequences and the enzymes on which they occur is provided in Table 33.

TABLE 33
PSs found in 3D pockets shared by active sites.
Lines marked by asterisk denote the
occurence of an active site within the PS.

| | P-value | PDB id | Predicting Sequence |
|---|---|---|---|
| | 0.00e+00 | 1cy0 | AHEAIRP |
| * | 0.00e+00 | 1a0e | FHDRD |
| * | 0.00e+00 | 1cy0 | ITYMRTD |
| * | 0.00e+00 | 1pmi | SDNVVRAG |
| * | 4.80e−11 | 1pmi | RAGFTPKFKDV |
| * | 1.17e−10 | 1btm | GNWKMH |
| * | 2.46e−08 | 1btm | IAGNWKM |
| | 1.50e−07 | 1a0e | AQVKKALE |
| * | 6.25e−07 | 1btm | PIIAGNWK |
| * | 7.90e−07 | 1ejj | MGNSE |
| | 8.10e−07 | 1bq3 | NLFTGW |
| | 8.29e−07 | 1gzd | DWVGGR |
| | 8.29e−07 | 1iat | DWVGGR |
| | 8.29e−07 | 1gzd | SKTFTT |
| | 8.29e−07 | 1iat | SKTFTT |
| | 8.29e−07 | 1gzd | TEDRAV |
| | 1.34e−06 | 1q50 | DWVGGR |
| | 1.34e−06 | 1q50 | SKTFTT |
| | 5.03e−06 | 1fzt | NLFTGW |
| | 7.88e−06 | 1gzd | WVGGRYS |
| | 7.88e−06 | 1iat | WVGGRYS |
| | 9.03e−06 | 1ejj | VYQSLT |
| | 9.48e−06 | 1q50 | WVGGRYS |
| | 2.62e−05 | 1rii | NLFTGW |
| * | 3.05e−05 | 1bq3 | LVLVRHG |
| | 3.81e−05 | 1dxi | IEPKP |
| | 3.95e−05 | 1q50 | VNIGIGGS |
| | 5.90e−05 | 1bwz | MGNPH |
| * | 8.04e−05 | 1ejj | GNSEVGH |
| | 8.05e−05 | 1muw | IEPKP |
| * | 1.05e−04 | 1hg3 | LLNHSE |
| * | 1.07e−04 | 1aw1 | NWKLNG |
| | 1.11e−04 | 1b0z | SKSGTT |
| | 1.13e−04 | 1c47 | GTSGLR |
| | 1.13e−04 | 1c47 | HPDPNL |
| | 1.13e−04 | 1c47 | RYDYEE |
| * | 1.13e−04 | 1c47 | TASHNP |
| * | 1.15e−04 | 1fzt | AHGNSLR |
| * | 1.42e−04 | 1r2r | GHSERRH |
| * | 1.42e−04 | 1r2r | GNWKMNG |
| | 1.42e−04 | 1r2r | LGHSERR |
| | 1.70e−04 | 1fui | GFQGQRHWTD |
| | 1.76e−04 | 1dqr | DWVGGR |
| | 1.76e−04 | 1dqr | SKTFTT |
| | 1.76e−04 | 1dqr | TEDRAV |
| | 1.98e−04 | 1ag1 | LYGGSV |
| | 1.98e−04 | 1ag1 | YGGSVN |
| | 2.12e−04 | 1m6j | YGGSVN |
| * | 2.16e−04 | 1hti | GHSERRH |
| * | 2.16e−04 | 1hti | GNWKMNG |
| * | 2.16e−04 | 1hti | LGHSERR |
| * | 2.22e−04 | 1mo0 | GHSERRH |
| * | 2.22e−04 | 1mo0 | GNWKMNG |
| * | 2.22e−04 | 1mo0 | LGHSERR |
| * | 2.22e−04 | 1mo0 | VILGHSE |
| * | 2.36e−04 | 1bq3 | RHGQSEWN |
| * | 3.06e−04 | 1rii | LVLLRHG |
| | 3.24e−04 | 1btm | LVGGASLEPASFL |
| | 3.85e−04 | 1c47 | GATIRLY |
| | 3.85e−04 | 1c47 | PTGWKFF |
| | 3.85e−04 | 1c47 | RLSGTGS |
| | 4.56e−04 | 1r2r | LVGGASLK |
| | 5.05e−04 | 1tmh | GGASLKA |
| * | 5.05e−04 | 1tmh | IGHSERR |
| | 5.36e−04 | 1vzw | ASGGVS |
| | 5.42e−04 | 1nu5 | WTLASGDT |
| * | 6.10e−04 | 1dqr | QHAFYQL |
| | 6.10e−04 | 1dqr | WVGGRYS |
| | 6.20e−04 | 1hti | LVGGASLK |
| | 6.66e−04 | 1eq2 | NNYQY |
| | 6.66e−04 | 1eq2 | RYFNV |
| * | 7.15e−04 | 1bwz | ACGSGA |
| | 7.15e−04 | 1bwz | GLGNDF |
| * | 7.64e−04 | 1ag1 | LGHSERR |
| | 7.97e−04 | 1d6m | GRVQTP |
| * | 7.97e−04 | 1d6m | ITYPRS |
| | 7.97e−04 | 1d6m | PEKWQL |
| | 8.04e−04 | 1b0z | EPAIAFR |
| | 8.04e−04 | 1b0z | NPFDQPG |
| | 8.20e−04 | 1dxi | WGGREG |
| | 8.43e−04 | 1mo0 | LVGGASLK |
| * | 8.60e−04 | 1aw1 | IGHSERR |
| | 8.60e−04 | 1aw1 | YGGSVKP |
| * | 9.29e−04 | 1fzt | RHGESEWN |
| | 9.53e−04 | 6xia | DQDLRFG |
| | 9.53e−04 | 6xia | GRDPFGD |
| * | 9.53e−04 | 6xia | TFHDDDL |
| * | 9.55e−04 | 1c47 | ASHNPGGP |
| | 9.67e−04 | 1gw9 | IEPKP |
| | 9.68e−04 | 1e58 | RFTGW |
| * | 9.82e−04 | 1m6j | LGHSERR |
| * | 9.82e−04 | 1m6j | VILGHSE |
| * | 1.06e−03 | 1spq | GHSERRH |
| * | 1.06e−03 | 1spq | GNWKMNG |
| * | 1.06e−03 | 1spq | LGHSERR |
| | 1.06e−03 | 1spq | VIACIGE |
| * | 1.06e−03 | 1spq | VILGHSE |
| | 1.20e−03 | 1ci1 | LYGGSV |
| | 1.20e−03 | 1ci1 | YGGSVT |
| * | 1.35e−03 | 1hg3 | EPPELIG |
| | 1.35e−03 | 1muw | WGGREG |
| | 1.44e−03 | 1tmh | LVGGASLK |
| * | 1.54e−03 | 1amk | LGHSERR |
| * | 1.54e−03 | 1amk | VILGHSE |
| | 1.97e−03 | 1ag1 | LVGGASLK |
| | 2.09e−03 | 1c47 | CGEESFGTG |
| * | 2.15e−03 | 1a41 | VGHTPSISKRAY |
| | 2.39e−03 | 1vzw | IVGKALY |
| * | 2.56e−03 | 1dqr | DQWGVELGK |
| * | 2.61e−03 | 1dj0 | CAGRTD |
| | 2.76e−03 | 1hx3 | WPGVWTNS |
| * | 3.00e−03 | 1aw1 | GHSERREY |
| | 3.29e−03 | 1b0z | GIGGSYLGA |
| | 3.36e−03 | 1bwz | ERGAGET |
| | 3.84e−03 | 1dxi | DQDLRFG |
| | 3.84e−03 | 1dxi | GRDPFGD |
| * | 3.84e−03 | 1dxi | TFHDDDL |
| | 4.23e−03 | 1tmh | GALVGGASL |
| * | 4.23e−03 | 1tmh | GHSERRTYH |
| | 4.52e−03 | 1bd0 | ICMDQ |
| | 4.73e−03 | 1muw | DQDLRFG |
| | 4.73e−03 | 1muw | GRDPFGD |
| * | 4.73e−03 | 1muw | TFHDDDL |
| | 4.79e−03 | 1spq | LVGGASLK |
| | 5.42e−03 | 1clk | WGGREG |
| | 5.48e−03 | 1gw9 | WGGREG |
| | 5.49e−03 | 1rcq | GRVSMD |
| | 5.49e−03 | 1rcq | LRPVMT |
| * | 5.73e−03 | 1ci1 | LGHSERR |
| | 6.26e−03 | 1c47 | DQKPGTSGLRK |
| | 6.90e−03 | 1u0e | DWVGGR |
| | 6.90e−03 | 1u0e | GEPGTN |
| * | 6.90e−03 | 1u0e | GTNGQH |
| | 6.90e−03 | 1u0e | KINYTE |
| | 6.90e−03 | 1u0e | SKTFTT |
| | 6.90e−03 | 1u0e | TEALKP |
| | 6.90e−03 | 1u0e | TEDRAV |
| | 7.03e−03 | 1vzw | HLVDLDAA |
| | 7.10e−03 | 1fui | WGFNGTERPGAVYLAA |
| | 8.06e−03 | 1bhw | WGGREG |
| | 8.27e−03 | 1dj0 | HHMVRNI |
| * | 8.27e−03 | 1dj0 | RTDAGVH |
| * | 9.57e−03 | 1bwz | QCGNGARC |
| | 1.05e−02 | 1eq2 | LKGRYQ |
| * | 1.18e−02 | 1snz | VNLTNHSYFNL |
| | 1.21e−02 | 1ci1 | LVGGASLK |
| | 1.24e−02 | 1gw9 | DQDLRFG |
| | 1.24e−02 | 1gw9 | GRDPFGD |
| * | 1.24e−02 | lgw9 | TFHDDDL |
| * | 1.25e−02 | 1e58 | RHGESQWN |
| * | 1.27e−02 | 1i45 | LGHSERR |
| * | 1.27e−02 | 1i45 | VILGHSE |
| | 1.30e−02 | 1clk | GRDPFGD |
| * | 1.30e−02 | 1clk | TFHDDDL |
| * | 1.33e−02 | 1w0m | IINFKAY |
| | 1.55e−02 | 6xia | EPKPNEPRGDI |
| | 1.66e−02 | 1a9y | GIPNNL |
| * | 1.69e−02 | 1snz | YPKHSGFCLETQ |
| | 1.75e−02 | 1d6m | VTWCIGHLLEQ |
| | 1.79e−02 | 1bwz | DFHYRIFNA |
| * | 1.84e−02 | 1bhw | TFHDDDL |
| | 1.92e−02 | 1u0e | GGSDLGP |
| * | 1.92e−02 | 1u0e | QHAFYQL |
| | 1.92e−02 | 1u0e | WVGGRYS |
| | 2.45e−02 | 1i45 | LVGGASLK |
| | 2.55e−02 | 1eq2 | FHEGACS |
| | 2.55e−02 | 1eq2 | MASVAFH |
| | 2.55e−02 | 1eq2 | PKLFEGS |
| * | 2.55e−02 | 1eq2 | SSAATYG |
| | 2.67e−02 | 1a9y | LLRYFNP |
| | 2.83e−02 | 1a41 | KDLRTYGVNYTFLYNFWTNVKS |
| | 2.88e−02 | 1qo2 | QIGGGI |
| | 2.93e−02 | 1e58 | SEAKAAGKLLK |
| | 2.99e−02 | 1xfc | DTGLNRNGV |
| | 3.12e−02 | 1bxc | DQDLRFG |
| | 3.12e−02 | 1bxc | GRDPFGD |
| | 3.15e−02 | 1bwz | YRIFNADGSEV |

### Statistical Significance

The results presented in Example 8 use enzymes preciously classified functionally (by the EC system) as an example of how to approach the general problem of predicting function from sequence. Application of the exemplary MEX algorithm to the data, and filtering the results by requiring predicting sequences within the EC hierarchy, classification of all enzymes by predicting sequences occurring on them produces a coverage between 87% to 93% depending on the EC level that is being looked for (see Table 26).

Classification success of novel sequences that belong to the same type of data is of order 84-86% (see Tables 28 and 30), similar to what is expected from function assignments based on Smith-Waterman sequence similarity (Liao and Noble (2003) Combining pairwise sequence analysis and support vector machines for detecting remote protein evolutionary and structural relationships. J. of Comp. Biology, 10:857-868).

Even when a low bias restriction is imposed, as in the analysis of Table 34, precision of 88% on the enzymes that are covered by predicting sequences is achieved.

It should be noted that all the predicting sequences were extracted by an unsupervised motif-search algorithm, applied to each one of the six EC classes. The supervised selection of classification specificity is imposed on the motifs extracted by MEX, thus leading to the predicting sequences. Conventional classification methods rely on homology. While homology is also at the root of success for most predicting sequences of level 4, (see some examples in FIG. 19) Table 35 demonstrates that predicting sequences can also be of importance in remote homology, where straightforward comparison of an enzyme to another one with large sequence similarity is often misleading.

Alternatively, or additionally, Example 8 demonstrates that predicting sequences of level 4 are well correlated to active and binding sites at the level of primary sequence. Moreover, the occurrence of predicting sequences in pockets of active sites has been established. An analysis of randomly chosen isomerases whose 3D structure is known has shown that these results are highly significant.

In conclusion, Example 8 establishes a comprehensive and accurate classification scheme for enzymes based on the occurrence of predicting sequences on their sequences. The predicting sequences contain, on average, just 8.5 amino acids, and yet they suffice to correctly classify an overwhelming majority of the known enzymes. Many of these predicting sequences are located at active sites or in their 3D proximity, suggesting important functional roles. Hence it seems that PSs distill some of the essence of homology, and represent what evolution has regarded to be of importance.

### Significance of Predicting Sequence Occurrence in Active Pockets

In order to evaluate the biological significance of predicting sequences, as indicated by their occurrence in active 3D pockets of enzymes, a background model for each enzyme and each predicting sequence of length k, based on random drawings of k-mers existing on the sequence of this enzyme was prepared and used to calculat their probability of lying (with at least four amino-acids) within active pockets. For each event of a predicting sequence lying within an active pocket a p-value on the basis of the background model was calculated (i.e. a probability that this event could be random). The data included 1098 events of predicting sequences occurring on specific enzymes, out of which there were 271 events in which the predicting sequences lie within active pockets.

### Example 9

### Exemplary Detergent Compositions

In an exemplary embodiment of the invention, detergent compositions comprise a detergent and an enzyme, Optionally, the enzyme is provided as an enzyme additive (e.g. a protease, such as a serine protease). All enzymes identified according to the present invention may be found in Table 38 and Table 39 of enclosed CD-ROM (files “Table 38 complete protein part 1.txt” and “Table complete protein part 2.txt” respectively). Tables 38 and 39 provide, for each entry, a Sargasso sea database ID number, a Tel-Aviv University (TAU) ID number, an EC classification number, a EC description, a corresponding SEQ ID No. and a complete polynucleotide sequence.

Table 38 comprises SEQ ID Nos.: 77,838 to 137,952; and

Table 39 comprises SEQ ID Nos.: 137,953 to 198,923.

Table 40 and Table 41 provided on CD-ROM (files “Table 40 complete nucleic acid sequence part 1.txt” and “Table 41 complete nucleic acid sequence part 2.txt” respectively) are similar to Tables 38 and 39 respectively except that they present nucleid acid sequences corresponding to the polypeptide sequences and the Sargasso protein ID and the corresponding expression contig ID no.

Table 40 comprises SEQ ID Nos.: 198,933 to 259039; and

Table 41 comprises SEQ ID Nos.: 259,040 to 320,010.

Tables 38 to 41 establish that, using exemplary embodiments of analytic methods according to the invention, it is possible to classify a large body of sequence data with unknown function according to a functional classification system (e.g. the EC hierarchy). While analysis of enzymes is presented as an illustrative example, according to various embodiments of the invention polypeptide and/or polynucleotide sequences which do cont comprise or encode enzymatic activity can be classified in a similar fashion

### XXX SEQ ID Numbers of Those Relative to Detergents.

Proteases: Suitable proteases include those of animal, vegetable or microbial origin. Microbial origin is preferred. Chemically or genetically modified mutants are included. The protease may be a serine protease, preferably an alkaline microbial protease or a trypsin-like protease.

Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are tryp-sin(e.g. of porcine or bovine origin) and the Fusarium pro-tease described in WO 89/06270. In a particular embodiment of the present invention the protease is a serine protease. Serine proteases or serine endopeptidases (newer name) are a class of peptidases which are characterized by the presence of a serine residue in the active center of the enzyme.

Serine proteases: A serine protease is an enzyme which catalyzes the hydrolysis of peptide bonds, and in which there is an essential serine residue at the active site (White, Handler, and Smith, 1973 “Principles of Biochemistry,” Fifth Edition, McGraw-Hill Book Company, NY, pp. 271-272). The bacterial serine proteases have molecular weights in the 20,000 to 45,000 Daltons range. They are inhibited by diisopropylfluorophosphate. They hydrolyze simple terminal esters and are similar in activity to eukaryotic chymotrypsin, also a serine protease. A more narrow term, alkaline protease, covering a sub group, reflects the high pH optimum of some of the serine proteases, from pH 9.0 to 11.0 (for review, see Priest (1977) Bacteriological Rev. 41 711-753).

Subtilases: A sub-group of the serine proteases tentatively designated subtilases has been proposed by Siezen et al. (1991), Protein Eng., 4 719-737. They are defined by homology analysis of more than 40 amino acid sequences of serine proteases previously referred to as subtilisin-like proteases. A subtilisin was previously defined as a serine protease produced by Gram-positive bacteria or fungi, and according to Siezen et al. now is a subgroup of the subtilases. A wide variety of subtilisins have been identified, and the amino acid sequence of a number of subtilisins have been determined. These include more than six subtilisins from Bacillus strains, namely, subtilisin 168, subtilisin BPN′, subtilisin Carlsberg, subtilisin Y, subtitisin amylosacchariticus, and mesentericopeptidase (Kurihara et at. (1972) J. Biol. Chem. 247 5629-5631; Wells et at. (1983) Nucleic Acids Res. 11 7911-7925; Stahl and Ferrari (1984) J. Bacteriol. 159 811-819, Jacobs et at. (1985) Nucl. Acids Res. 13 8913-8926; Nedkov et al. (1985) Biot. Chem. Hoppe-Seyler 366 421-430, Svendsen et at. (1986) FEBS Lett. 196 228-232), one subtilisin from an actinomycetales, thermitase from Thermoactinomyces vulgaris (Meloun et at. (1985) FEBS Lett. 198 195-200), and one fungal subtitisin, proteinase K from Tritirachium album (Jany and Mayer (1985) Biol. Chem. Hoppe-Seyler 366 584-492). for further reference Table I from Siezen et at. has been reproduced below.

Subtilisins are well-characterized physically and chemically. In addition to knowledge of the primary structure (amino acid sequence) of these enzymes, over 50 high resolution X-ray structures of subtitisins have been determined which delineate the binding of substrate, transition state, products, at least three different protease inhibitors, and define the structural consequences for natural variation (Kraut (1977) Ann. Rev. Biochem. 46 331-358).

One subgroup of the subtilases, I-SI, comprises the “classical” subtitisins, such as subtilisin 168, subtilisin BPN′, subtitisin Carlsberg (ALCALASE®, Novozymes A/S), and subtitisin DY.

A further subgroup of the subtilases I-S2, is recognised by Siezen et at. (supra). Sub-group I-S2 proteases are described as highly alkaline subtitisins and comprise enzymes such as subtilisin PB92 (MAXACAL®, Gist-Brocades NV), subtilisin 309 (SAVINASE®, Novozymes NS), subtilisin 147 (ESPERASE®, Novozymes NS), and alkaline elastase YaB.

Lipases: Suitable lipases include those of bacterial or fungal origin. Chemically or genetically modified mutants are included.

Other types of lipolytic enzymes such as cutinases may also be useful.

Amylases: Suitable amylases (a and/or R) include those of bacterial or fungal origin.

Cellulases: Suitable cellulases include those of bacterial or fungal origin. Chemically or genetically modified mu-tants are included. Suitable cellulases are disclosed in U.S. Pat. No. 4,435,307, which discloses fungal cellulases produced from Humicola insolens. Especially suitable cellulases are the cellulases having color care benefits. Examples of such cellulases are cellulases described in European patent application No. 0 495 257.

Oxidoreductases: Any oxidoreductase suitable for use in a liquid composition, e.g., peroxidases or oxidases such as laccases, can be used herein. Suitable peroxidases herein include those of plant, bacterial or fungal origin. Suitable laccases herein include those of bacterial or fungal origin. Chemically or genetically modified mutants are included.

The types of enzymes which may be present in the liquid of the invention include oxidoreductases (EC I.-.-.-), transferases (EC 2.-.-.-), hydrolases (EC 3.-.-.-), lyases (EC 4.-.-20.-), isomerases (EC 5.-.-.-) and ligases (EC 6.-.-.-).

Preferred oxidoreductases in the context of the invention are peroxidases (EC 1.11.1), laccases (EC 1.10.3.2) and glucose oxidases (EC 1.1.3.4). An Example of a commercially available oxidoreductase (EC 1.-.-.-) is Gluzyme™ (enzyme available from Novozymes A/S).

Further oxidoreductases are available from other suppliers. Preferred transferases are transferases in any of the following sub-classes: a Transferases transferring one-carbon groups (EC 2.1); b transferases transferring aldehyde or ketone residues (EC 2.2); acyltransferases (EC 2.3); c glycosyltransferases (EC 2.4); d transferases transferring alkyl or aryl groups, other that methyl groups (EC 2.5); and e transferases transferring nitrogeneous groups (EC 2.6).

A most preferred type of transferase in the context of the invention is a transglutaminase (protein-glutamine y-glutamyltransferase; EC 2.3.2.13).

Preferred hydrolases in the context of the invention are: carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as a-amylases (EC 3.2.1.1); peptidases (EC 3.4, also known as proteases); and other carbonyl hydrolases.

In the present context, the term “carbohydrase” is used to denote not only enzymes capable of breaking down carbohydrate chains (e.g. starches or cellulose) of especially five- and six-membered ring structures (i.e. glycosidases, EC 3.2), but also enzymes capable of isomerizing carbohydrates, e.g. six-membered ring structures such as D-glucose to five-membered ring structures such as D-fructose.

Carbohydrases of relevance include the following (EC numbers in parentheses): a-amylases (EC 3.2.1.1), 3-amylases (EC 3.2.1.2), glucan 1,4-a-glucosidases (EC 3.2.1.3), endo-1,4-beta-glucanase (cellulases, EC 3.2.1.4), endo-1,3(4)-3-glucanases (EC 3.2.1.6), endo-1, 4-3-xylanases (EC 3.2.1.8), dextranases (EC 3.2.1.11), chitinases (EC 3.2.1.14), poly-galacturonases (EC 3.2.1.15), lysozymes (EC 3.2.1.17), f3-glucosidases (EC 3.2.1.21), a-galactosidases (EC 3.2.1.22), 3-galactosidases (EC 3.2.1.23), amylo-1,6-glucosidases (EC 3.2.1.33), xylan 1,4-f3-xylosidases (EC 3.2.1.37), glucan endo-1, 3-3-D-glucosidases (EC 3.2.1.39), a-dextrin endo-1,6-a-glucosidases (EC3.2.1.41), sucrose a-glucosidases (EC 3.2.1.48), glucan endo-1,3-a-glucosidases (EC 3.2.1.59), glucan 1,4-3-glucosidases (EC 3.2.1.74), glucan endo-1, 6-3-glucosidases (EC 3.2.1.75), galactanases (EC 3.2.1.89), arabinan endo-1,5-a-L-arabinosidases (EC 3.2.1.99), laccases (EC 3.2.1.108), chitosanases (EC 3.2.1.132) and xylose isomerases (EC 5.3.1.5).

Surfactant—Suitable surfactants to avoid precipitation in the enzyme additive may be any surfactant.

The surfactant of the present invention may be anionic, nonionic, cationic, or amphoteric (zwitterionic).

It has been found that particularly surfactants with a HLB value above 8 are suitable. In a particular embodiment of the present invention the HLB value of the surfactant is at least 9 such as at least 10. In a more particular embodiment the HLB value is between 10 and 20. In a more particular embodiment the HLB value of the surfactant is between 11 and 15.

In a particular embodiment of the present invention the surfactant is soluble in the enzyme liquid additive in the temperature range of 0 to 40° C. and do not phase separate. In a more particular embodiment the surfactant can be added as a mixture of two or more surfactants.

The amount of surfactant added is in particular 0.1 to 10% w/w of the total liquid additive more particular 0.25 to 8% w/w such as even more particular 0.5 to 5% w/w.

In a particular embodiment of the present invention the amount of surfactant is less than 1% w/w of the total enzyme additive. In a particular embodiment of the present invention the amount of surfactant is less than 0.7% w/w of the total enzyme additive.

In a particular embodiment of the present invention the amount of surfactant added to the enzyme additive is at least 0.1% w/w. In a more particular embodiment of the present invention the surfactant is added to the enzyme additive is at least 0.25% w/w.

In an even more particular embodiment the surfactant is added to the enzyme additive is at least 0.5% w/w. In a most particular embodiment of the present invention the surfactant is added to the enzyme additive is at least 1% w/w.

In a particular embodiment of the present invention the amount of surfactant added to the enzyme additive is less than 20% w/w. In a more particular embodiment of the present invention the amount of surfactant added to the enzyme additive is less than 15% w/w. In an even more particular embodiment of the present invention the amount of surfactant added to the enzyme liquid additive is less than 10% w/w. In a most particular embodiment of the present invention the amount of surfactant added to the enzyme liquid additive is less than 5%.

In a particular embodiment of the present invention the surfactant is a non-ionic surfactant.

The nonionic surfactants are alcohol ethoxylate (AEO or AE), alcohol propoxylate, carboxylated alcohol ethoxylates, nonylphenol ethoxylate, alkylpolyglycoside, alkyldimethylamine oxide, ethoxylated fatty acid monoethanolamide, fatty acid monoethanolamide, or polyhydroxy alkyl fatty acid amide (e.g. as described in WO 92/06154).

Polyethylene, polypropylene, and polybutylene oxide condensates of alkyl phenols. These compounds include the condensation products of alkyl phenols having an alkyl group containing from about 6 to about 14 carbon atoms, preferably from about 8 to about 14 carbon atoms, in either a straight chain or branched-chain configuration with the alkylene oxide. In a preferred embodiment, the ethylene oxide is present in an amount equal to from about 2 to about 25 moles, more preferably from about 3 to about 15 moles, of ethylene oxide per mole of alkyl phenol. Commercially available nonionic surfactants of this type include Triton™ X-45, X-114, X-100 and X-102, all marketed by the Rohm & Haas Company. These surfactants are commonly referred to as alkylphenol alkoxylates (e.g., alkyl phenol ethoxylates).

The condensation products of primary and secondary atiphatic alcohols with about 1 to about moles of ethylene oxide are preferred as the nonionic surfactant. The alkyl chain of the aliphatic alcohol can either be straight or branched, primary or secondary, and generally contains from about 8 to about 22 carbon atoms. Preferred are the condensation products of alcohols having an alkyl group containing from about 8 to about 20 carbon atoms, more preferably from about 10 to about 18 carbon atoms, with from about 3 moles of ethylene oxide per mole of alcohol. Examples of commercially available nonionic surfactants of this type include Tergitol™ 15-S-9 (The condensation product of C11-C15 linear alcohol with 9 moles ethylene oxide), Tergitol™ 24-L-6 NMW (the condensation product of C12-C14 primary alcohol with 6 moles ethylene oxide with a narrow molecular weight distribution), both marketed by Union Carbide Corporation; Neodol™ 45-9 (the condensation product of C14-C 15 linear alcohol with 9 moles of ethylene oxide), Neodol™ 23-3 (the condensation product of C12-C13 linear alcohol with 3.0 moles of ethylene oxide), Neodol™ 45-7 (the condensation product of C14-C15 linear alcohol with 7 moles of ethylene oxide), Neodol™ 45-5 (the condensation product of C14-C15 linear alcohol with 5 moles of ethylene oxide) marketed by Shell Chemical Company, Kyro™ EOB (the condensation product of C13-C15 alcohol with 9 moles ethylene oxide), marketed by The Procter & Gamble Company, and Genapol LA 050 (the condensation product of C12-C14 alcohol with 5 moles of ethylene oxide) marketed by Hoechst. Lutensol® AN, AT, AO and TO types marketed by BASF. Preferred range of HLB in these products is from 8-20 and most preferred from 8-18.

Examples of other commercially available nonionic surfactants include Softanol® from Ineos Oxide, Belgium.

Also useful as the nonionic surfactant of the present invention are alkylpolysaccharides disclosed in U.S. Pat. No. 4,565,647, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6-positions on the preceding saccharide units.

The condensation products of ethylene oxide with a hydrophobic base formed by the condensation of propylene oxide with propylene glycol are also suitable as surfactant. The hydrophobic portion of these compounds will preferably have a molecular weight from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic™ surfactants, marketed by BASF.

Also suitable for use as the nonionic surfactant of the nonionic surfactant system of the present invention, are the condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available Tetronic™ compounds, marketed by BASF.

Other suitable surfactants may be polyethylene oxide condensates of alkyl phenols, condensation products of primary and secondary aliphatic alcohols with from about 1 to about 25 moles of ethyleneoxide, alkylpolysaccharides, and mixtures hereof. Most preferred are C8-C14 alkyl phenol ethoxylates having from 3 to 15 ethoxy groups.

Other suitable nonionic surfactants may be polyhydroxy fatty acid amide surfactants.

Exemplary compositions for dishwashing detergent and/or clothes detergent may be found for example in US20070093400, hereby incorporated by reference as if fully set forth herein, or any other suitable composition.

### Example 10

### Exemplary Food Processing Compositions

Food processing compositions which use enzymes are known in the art. Exemplary classifications of enzymes which may optionally and preferably be used to prepare compositions for use in food processing include but are not limited to oxidative enzymes, proteases, lipases, cell wall degrading enzymes (pectinases, cellulases) as well as transferases. For example with regard to oxidoreductases, non-limiting examples of enzyme categories include peroxidases, laccases and tyrosinase. With regard to transferases, a non-limiting example is transglutaminase. Non-limiting examples of hydrolases include pectinase, xylanase and lactase (beta-galactosidase). Non-limiting examples of lyases include pectinylase. Non-limiting examples of isomerases include glucose isomerase. Non-limiting examples of at least some of these enzyme classifications with regard to these categories are given above.

XXX Add SEQ Id Nos of Relevant Enzymes

Food processing enzymes are preferably selected for being stable in the pH range of from about 3 to about 9, although certain food processes fall outside of this range as is known to one of ordinary skill in the art. The preferred temperature range is from about 15 C to about 8° C.

As a non-limiting example of a use of such enzymes, a cross-linking enzyme, preferably a transglutaminase, may optionally be used in baking, particularly for “weak” flours (a term in the art relating to flours which do not rise well). The use of this enzyme improves the structure of the resultant product and also improves the process as well. The enzyme is added to the batter (dough) as part of the baking process.

Table 36 provides non-limiting examples of enzymes used in the commercial baking industry.

TABLE 36
enzymes used in the commercial baking industry

| Enzyme type | Enzyme name | Mode of action | E3xpected result |
|---|---|---|---|
| Poteolytic | Protease | Protein cleavage | Aroma formation; |
| | peptidase | to peptides | gluten network |
| | | | modification |
| | | | Aroma formation |
| Crosslinking | Transglutaminase | Isopeptide Bond | Structure |
| | Polyphemol | Formation | strengthening |
| | oxidase, peroxidase | Oxidation of | Protein and |
| | Hexose oxidase | Tyrosine Residues | carbohydrate |
| | Glucose oxidase | Oxidation of | crosslinking |
| | | glucose and | Protein |
| | | maltose to lactone | crosslinking |
| | | and hydrogen | |
| | | peroxide | |
| Hydrolytic | Xylanase; β- | Hydrolysis of | Structure softening |
| | glucanase | pentosans and | of rye based |
| | | glucans | products |
| Lipid | Lipase | Hydrolysis of | Bleaching of flour; |
| modifying | Lipoxygenase | triglycerides | indirect protein |
| | | Oxidation of | crosslinking |
| | | conjugated fatty | |
| | | acids | |

### Example 11

### Compositions for Ethanol Production

Some exemplary embodiments of the invention relate to compositions for production of ethanol and use of these compositions thereof, for the production of desired end-products of in vitro and/or in vivo bioconversion of biomass-based feed stock substrates, including but not limited to such materials as starch and cellulose. In particularly preferred embodiments, the methods of the present invention do not require gelatinization and/or liquefaction of the substrate. In particularly preferred embodiments, the present invention provides means for the production of ethanol. In some particularly preferred embodiments, the present invention provides means for the production of ethanol directly from granular starch, in which altered catabolite repression is involved.

XXX Add Seq ID Nos of Relevant Enzymes

In particular, the present invention provides means for making ethanol in a manner that is characterized by having altered levels of catabolite repression and enzymatic inhibition, thus increasing the process efficiency. The methods of the present invention comprise the steps of contacting a carbon substrate and a substrate converting enzyme to produce an intermediate; and contacting the intermediate with an intermediate producing enzyme in a reactor vessel, wherein the intermediate is substantially all bioconverted by an end-product producing microorganism. By maintaining a low concentration of the intermediate in a conversion medium, the catabolite repressive or enzymatic inhibitive effects of the intermediate on the process are altered.

The present invention also provides methods in which starches or biomass and hydrolyzing enzymes are used to convert starch or cellulose to glucose. In addition, the present invention provides methods in which these substrates are provided at such a rate that the conversion of starch to glucose matches the glucose feed rate required for the respective fermentative product formation. Thus, the present invention provides key glucose-limited fermentative conditions, as well as avoiding many of the metabolic regulations and inhibitions.

In some preferred embodiments, the present invention provides means for making desired end-products, in which a continuous supply of glucose is provided under controlled rate conditions, providing such benefits as reduced raw material cost, lower viscosity, improved oxygen transfer for metabolic efficiency, improved bioconversion efficiency, higher yields, altered levels of catabolite repression and enzymatic inhibition, and lowered overall manufacturing costs.

Starch is a plant-based fermentation carbon source. Corn starch and wheat starch are carbon sources that are much cheaper than glucose carbon feedstock for fermentation. Conversion of liquefied starch to glucose is known in the art and is generally carried out using enzymes such alpha-amylase, pullulanase, and glucoamylase. A large number of processes have been described for converting liquefied starch to the monosaccharide, glucose. Glucose has value in itself, and also as a precursor for other saccharides such as fructose. In addition, glucose may also be fermented to ethanol or other fermentation products. However the ability of the enzymatic conversion of a first carbon source to the intermediate, especially glucose, may be impaired by the presence of the intermediate.

Exemplary carbon substrates include, but are not limited to biomass, starches, dextrins and sugars.

As used herein, “biomass” refers to cellulose- and/or starch-containing raw materials, including but not limited to wood chips, corn stover, rice, grasses, forages, perrie-grass, potatoes, tubers, roots, whole ground corn, cobs, grains, wheat, barley, rye, milo, brans, cereals, sugar-containing raw materials (e.g., molasses, fruit materials, sugar cane or sugar beets), wood, and plant residues. Indeed, it is not intended that the present invention be limited to any particular material used as biomass. In preferred embodiments of the present invention, the raw materials are starch-containing raw materials (e.g., cobs, whole ground corns, corns, grains, milo, and/or cereals, and mixtures thereof). In particularly preferred embodiments, the term refers to any starch-containing material originally obtained from any plant source.

As used herein, “starch” refers to any starch-containing materials. In particular, the term refers to various plant-based materials, including but not limited to wheat, barley, potato, sweet potato, tapioca, corn, maize, cassaya, milo, rye, and brans. Indeed, it is not intended that the present invention be limited to any particular type and/or source of starch. In general, the term refers to any material comprised of the complex polysaccharide carbohydrates of plants, comprised of amylose and amylopectin, with the formula (C6H10O5)x, wherein “x” can be any number.

As used herein, “cellulose” refers to any cellulose-containing materials. In particular, the term refers to the polymer of glucose (or “cellobiose”).

As used herein, the term “substrate converting enzyme” refers to any enzyme that converts the substrate (e.g., granular starch) to an intermediate, (e.g., glucose). Substrate converting enzymes include, but are not limited to alpha-amylases, glucoamylases, pullulanases, starch hydrolyzing enzymes, and various combinations thereof.

As used herein, the term “intermediate converting enzyme” refers to any enzyme that converts an intermediate (e.g., D-glucose, D-fructose, etc.), to the desired end-product. In preferred embodiments, this conversion is accomplished through hydrolysis, while in other embodiments, the conversion involves the metabolism of the intermediate to the end-product by a microorganism. However, it is not intended that the present invention be limited to any particular enzyme or means of conversion. Indeed, it is intended that any appropriate enzyme will find use in the various embodiments of the present invention.

Enzymes that find use in some embodiments of the present invention to convert a carbon substrate to an intermediate include, but are not limited to alpha-amylase, glucoamylase, starch hydrolyzing glucoamylase, and pullulanase. Enzymes that find use in the conversion of an intermediate to an end-product depend largely on the actual desired end-product. For example enzymes useful for the conversion of a sugar to 1,3-propanediol include, but are not limited to enzymes produced by E. coli and other microorganisms. For example enzymes useful for the conversion of a sugar to lactic acid include, but are not limited to those produced by Lactobacillus and Zymomonas. Enzymes useful for the conversion of a sugar to ethanol include, but are not limited to alcohol dehydrogenase and pyruvate decarboxylase. Enzymes useful for the conversion of a sugar to ascorbic acid intermediates include, but are not limited to glucose dehydrogenase, gluconic acid dehydrogenase, 2,5-diketo-D-gluconate reductase, and various other enzymes. Enzymes useful for the conversion of a sugar to gluconic acid include, but are not limited to glucose oxidase and catalase.

Non-limiting examples of these enzymes are given above.

### Example 12

### Exemplary Methods of the Invention Vs. Prosite

In order to give an idea of the utility of exemplary analytic methods of the invention, a comparison between Pro-Site date available in Swiss-Prot and enzymatic characterization as described above was conducted.

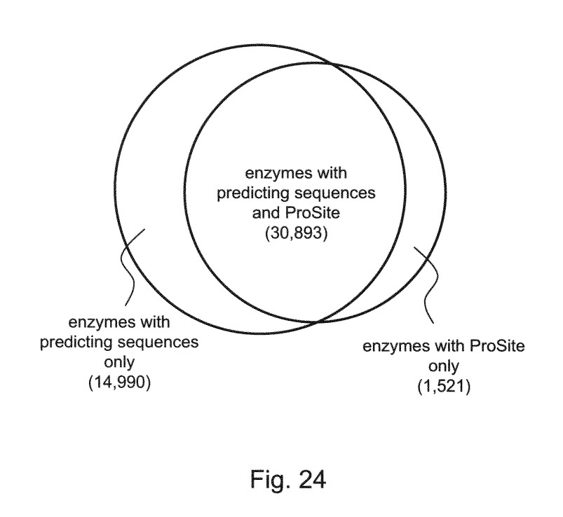

FIG. 24 is a Venn diagram illustrating the intersection of enzymes characterized by an exemplary embodiment of the invention and ProSite motifs listed in the Swiss-Prot data-base as standard motif annotations on 63% of the enzymes. The ProSite motifs are expressed as regular expressions or weight matrices (of average length 18.3 amino-acids) while the predicting sequences of the present embodiments are deterministic motifs (with average length of 8.4). All appearances of ProSite regular expression motifs on enzymes were searched. Each such appearance was noted on the enzyme sequence and checked whether it is also (partially) covered by a predicting sequence. The diagram clearly illustrates that there to is a good correlation between the two systems (30,893 enzymes classified by both systems). A small number of enzymes (1521) include Prosite notations but were not classified using exemplary methods according to the invention. Exemplary methods according to the invention classified 14,990 enzymes for which no Prosite classification is available.

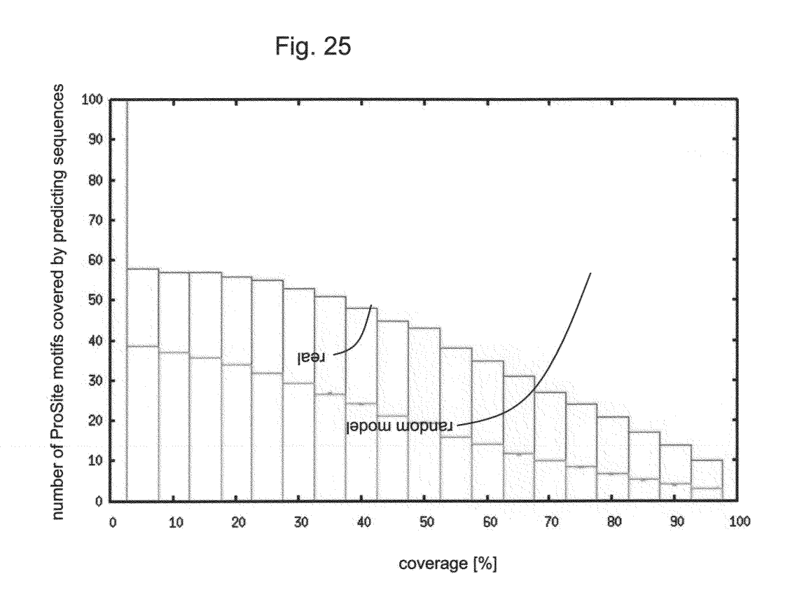

FIG. 25 is a histogram illustrating the relative coverage of ProSite motifs the by predicting sequences of the present embodiments as function of the minimal percentage of amino-acids belonging to the ProSite motif that are also located on the predicting sequences.

It was found that, if at least 40% of the amino acids of the ProSite motif also belong to predicting sequences, which may be appropriate for an average predicting sequence to be located within an average ProSite motif, then the predicting sequences cover 48% of all ProSite motif occurrences.

In accordance with preferred embodiments of the present invention a random model was developed to assess of the statistical significance of predicting sequence hit on the ProSite motifs. In the random model, for each given enzyme, random peptides are selected with the same lengths as those of the predicting sequences that hit this enzyme. The random model provides a probability distribution which serves as a zero-model for calculating the statistical significance. This comparison was made for each enzyme and for varying fractions of amino-acids that are shared by the predicting sequence with the ProSite motif. It was found that the random model of the present embodiments covered on average only 24% of ProSite motif occurrences, with a standard deviation of 0.06%. This results is extremely significant (400 standard deviations) compared to the 48% coverage quoted above. The random coverage is also shown in FIG. 29.

It is therefore demonstrated that the predicting sequences of the present embodiments carry information that is highly correlated with that of ProSite motifs.

This example illustrate the power of analytic methods described hereinabove and claimed hereinbelow in attributing function to polypeptide sequences without exhausting assays of activity using numerous substrates.

### APPENDIX 1

Table 11 on enclosed CD-ROM (file “Table-11.txt”) presents an to exemplified database prepared in accordance with a preferred embodiment of the present invention using enzyme sequences obtained from the UniProt/Swiss-Prot database, Release 48.3, Oct. 25, 2005.

Table 11 includes 77,837 entries. The middle column in Table 11 lists the predicting sequences Sⱼ (j=1, 2, . . . , 77,837), and the right column lists the classifiers Cⱼ which respectively correspond to the predicting sequences Sⱼ. The classifiers are expressed in the form of EC numbers as explained throughout the specification (see also Appendix 2 below).

The left column in Table 11 lists the SEQ IDs of the respective predicting sequences. The sequence listing is provided on enclosed CD-ROM (file “38280 (final)_ST25.txt”).

Table 11 or any portion thereof is contemplated as a protein database according to an embodiment of the present invention. “Portion of Table 11” refers to any number of consecutive or non-consecutive entries of Table 11. For example, a protein database according to an embodiment of the present invention can comprise all the entries of Table 11 for which the predicting sequence has a sufficiently short length, e.g., a length shorter then L, where L is an integer which is typically not larger than 15, as further detailed hereinabove.

Yet, it is to be understood that Table 11 serves for illustrating the protein database of the present embodiments in a non limiting fashion, and it is not intended to limit the scope of the present invention to the entries presented in Table 11 in any way. Many modifications can be made to the database presented in Table 11. In various exemplary embodiments of the invention another database which is a reduced version of a larger database presented in is provided. For example, a larger database can be reduced by keeping only entries corresponding to sequences which cover binding and active sites in known proteins while removing all other entries.

Thus, in accordance with preferred embodiments of the present invention an enzyme database of 52,365 predicting sequences and corresponding protein classifiers was extracted from 50,698 enzymes of the SwissProt, Release 48.3, Oct. 25, 2005 dataset. During the construction of the database, the handling procedure described hereinabove was employed. The obtained database is provided in Table 37 on enclosed CD-ROM (file “Table-37.txt”).

Table 37 includes 52,365 entries. The middle column lists the predicting sequences Sⱼ (j=1, 2, . . . , 52,365), and the right column lists the classifiers Cⱼ which respectively correspond to the predicting sequences Sⱼ. The classifiers are expressed in the form of EC numbers as explained throughout the specification (see also Appendix 2 below). The left column in Table 37 lists the SEQ IDs of the respective predicting sequences. The sequence listing is provided on enclosed CD-ROM (file “38280 (final)_ST25.txt”).

The predicting sequences provided coverage of about 93% of all 50,698 enzymes of the dataset. 21,228 enzymes of the 48.3 dataset carry active or binding site annotations. Of the 52,365 predicting sequences, 26,931 predicting sequences hit the 21,228 enzymes carrying active or binding site annotations, and 2,337 predicting sequences (about 8.6% of 26,931) the cover the active or binding sites. These 2,337 predicting sequence are found to occur on 79% of the 21,228 enzymes. Thus, a database of size 52,365 was reduced to a database of size 2,337 while maintaining a similar level of classification accuracy. In terms of ratios, instead of the approximately 1:1 ratio between the number of entries and the number of enzymes they cover, an order of magnitude parsimonious ratio, of about 1:8, was obtained.

The obtained database with 2,337 entries is provided in Table 42 on enclosed CD-ROM (file “Table-42.txt”). The predicting sequences listed in Table 42 constitute about 4.5% of the total number of extracted predicting sequences (52,365) but cover 36% of the 50,698 enzymes of the 48.3 dataset.

Performing a similar analysis on Release 45 of Swiss-Prot (dated October 2004), it was found by the present Inventors that the 2,014 predicting sequences (out of 21,676 predicting sequences, about 9.3%) covering the 17,005 annotated enzymes in it, hit 75% of the relevant set of enzymes. Moreover, using the same predicting sequence to classify the 10,585 novel enzymes contained in the 48.3 release and absent from the 45 release, one obtains coverage of 28% of them. This demonstrates that the relatively large coverage reached by the reduced database is not limited to the training set from which the dataset was extracted.

Many other replacements, modifications, deletions and/or additions to the entries presented in Tables 11, 37 and 42 will be apparent to those skilled in the art provided with the details described herein, and it is intended to embrace all the replacements, modifications and/or additions that fall within the spirit and broad scope of the appended claims.

### APPENDIX 2

### The EC Hierarchical Classification (EC Tree)

During the late 1950's, in a period when the number of newly discovered enzymes was increasing rapidly, researchers and scientific unions and committees became aware of the absence of any guiding authority which will handle the nomenclature of enzymology. The naming of enzymes by individual researchers had proved far from satisfactory in practice, as in many cases some enzymes became known by several different names, while conversely the same name was sometimes given to different enzymes. Many of the names conveyed little or no idea of the nature of the reactions these enzymes catalyzed, while misleadingly similar names were given to enzymes of quite different biochemical activities. In view of this state of affairs, the General Assembly of the International Union of Biochemistry (IUB) decided, in consultation with the International Union of Pure and Applied Chemistry (IUPAC) in August, 1955, to set up an internationally recognized authority to mitigate the confusing situation pertaining to nomenclature of enzymes. The International Commission on Enzymes, also known as the Enzyme Commission (EC) was hence established in 1956. The mission of the EC included the objectives formulating of a code of systematic rules for the classification and nomenclature of enzymes and coenzymes, their units of activity and standard methods of assay, together with the symbols used in the description of enzyme kinetics. The first version of the EC database, accompanied by a set of rules which are referred to as “recommendations”, became official and publicly available in 1961 and included 712 enzymes, and have been profoundly revised and updated over the years.

The first Enzyme Commission, in its report in 1961, devised a hierarchical classification system for enzymes. The hierarchical classification also serves as a basis for assigning a systematic name and corresponding code numbers, also known as EC numbers, to the enzymes so as to correlate the names to the enzymatic activity of each member. These code numbers, prefixed by EC, which are now widely in use, contain four numbers separated by points and represent a progressively finer classification of the enzyme, with the following meaning. The first number in the EC hierarchical classification represents the class of the enzyme. Each class represents a type of a chemical reaction which the enzyme catalyzes. There are six classes in the EC hierarchical classification as further detailed hereinunder. The second number in the EC hierarchical classification indicates the subclass of the reaction, namely a type of bond or moiety which undergoes the chemical reaction. The third number in the EC hierarchical classification indicates the sub-subclass, relating to the family of substrate which undergo the chemical reaction. The fourth number in number in the EC hierarchical classification is the serial number of the enzyme in its sub-subclass, relating to a specific substrate.

Thus for example, the enzyme cyanuric acid amidohydrolase has the code EC 3.5.2.15 which is constructed as follows: 3 stands for hydrolases (enzymes that use water to break up some other molecule), 3.5 for hydrolases that act on carbon-nitrogen bonds, other than peptide bonds, 3.5.2 for those that act on carbon-nitrogen bonds in cyclic amides, and 3.5.2.15 for those that act on the carbon-nitrogen bond in the cyclic amide in cyanuric acid.

Following are the main classes and subclasses of the EC hierarchical classification.

### Class 1: Oxidoreductases

To this class belong all enzymes catalyzing oxidoreduction reactions. The substrate that is oxidized is regarded as hydrogen donor. The systematic name is based on donor:acceptor oxidoreductase.

The second number in the code number of the oxidoreductases, unless it is 11, 13, 14 or 15, indicates the group in the hydrogen (or electron) donor that undergoes oxidation. For example, the number 1 denotes a —CHOH— group, the number 2 denotes a —CHO or —CO—COOH group or carbon monoxide, and so on, as specified in the EC key.

The third number, except in subclasses EC 1.11, EC 1.13, EC 1.14 and EC 1.15, indicates the type of acceptor involved. For example, the number 1 denotes NAD(P)+, the number 2 denotes a cytochrome, the number 3 denotes molecular oxygen, the number 4 denotes a disulfide, the number 5 denotes a quinone or similar compound, the number 6 denotes a nitrogenous group, the number 7 denotes an iron-sulfur protein and the number 8 denotes a flavin.

In subclasses EC 1.13 and EC 1.14 a different classification scheme is used and sub-subclasses are numbered from 11 onwards.

Scheme 1 illustrates a reaction catalyzed by an exemplary enzyme from the first class of oxidoreductases, having the systematic name β-D-glucose:oxygen 1-oxidoreductase and the code number EC 1.1.3.4.

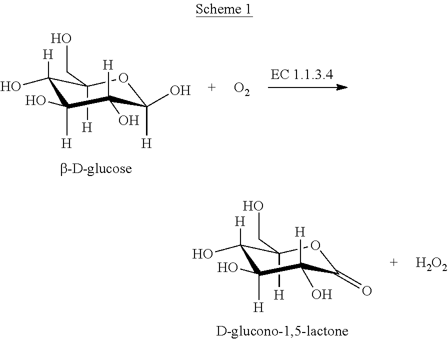

### Class 2—Transferases

Transferases are enzymes which catalyze the transferring of a group, such as a methyl group or a glycosyl group, from one compound, generally regarded as donor, to another compound, generally regarded as acceptor. The systematic names are formed according to the scheme donor:acceptor group-transferase.

The second number in the code number of transferases indicates the group transferred. For example, a one-carbon group in EC 2.1, an aldehyde or ketone group in EC 2.2, an acyl group in EC 2.3 and so on.

The third number gives further information on the group transferred, such as subclass EC 2.1 is subdivided into methyltransferases (EC 2.1.1), hydroxymethyl- and formyltransferases (EC 2.1.2) and so on. Only in subclass EC 2.7, does the third number indicate the nature of the acceptor group.

Scheme 2 illustrates a reaction catalyzed by an exemplary enzyme from the second class of transferases, having the systematic name L-aspartate:2-oxoglutarate aminotransferase and also called by its common name aspartate aminotransferase or glutamic-oxaloacetic transaminase (GOT), and the code number EC 2.6.1.1.

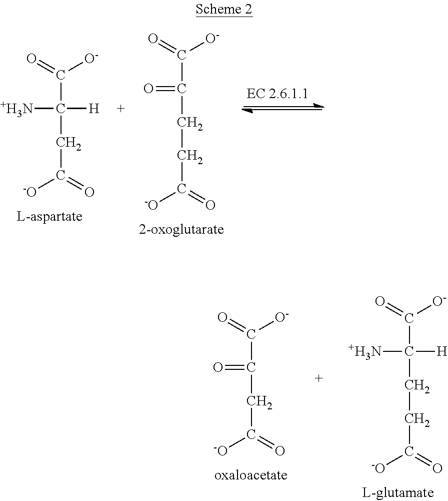

### Class 3—Hydrolases

These enzymes catalyze the hydrolytic cleavage of C—O, C—N, C—C and some other bonds, including phosphoric anhydride bonds. The systematic name always includes hydrolase and the name of the substrate with this suffix means a hydrolytic enzyme. A number of hydrolases acting on ester, glycosyl, peptide, amide or other bonds are known to catalyze not only hydrolytic removal of a particular group from their substrates, but likewise the transfer of this group to suitable acceptor molecules. In principle, all hydrolytic enzymes might be classified as transferases, since hydrolysis itself can be regarded as transfer of a specific group to water as the acceptor. Yet, in most cases, the reaction with water as the acceptor was discovered earlier and is considered as the main physiological function of the enzyme. This is why such enzymes are classified as hydrolases rather than as transferases.

The second number in the code number of the hydrolases indicates the nature of the bond hydrolysed. For example, enzymes codes which start with EC 3.1 represent esterases, enzymes codes which start with EC 3.2 represent glycosylases, and so on.

The third number normally specifies the nature of the substrate, for example, in the esterases the carboxylic ester hydrolases (EC 3.1.1), thiolester hydrolases (EC 3.1.2), phosphoric monoester hydrolases (EC 3.1.3), O-glycosidases (EC 3.2.1), N-glycosylases (EC 3.2.2) and so on. Exceptionally, in the case of the peptidyl-peptide hydrolases the third number is based on the catalytic mechanism as shown by active centre studies or the effect of pH.

Scheme 3 illustrates a reaction catalyzed by an exemplary enzyme from the third class of hydrolases, having the common name chymosin and also called rennin (no systematic name declared), and the code number EC 3.4.23.4.

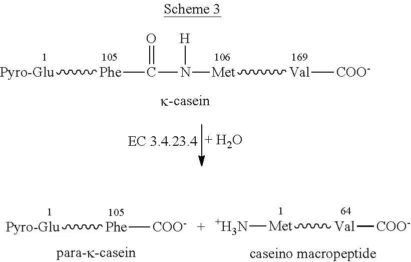

Class 4—Lyases

Lyases are enzymes cleaving C—C, C—O, C—N, and other bonds by elimination, leaving double bonds or rings, or conversely adding groups to double bonds. The systematic name is formed according to the pattern substrate group-lyase.

The second number in the code number indicates the bond broken. For example, EC 4.1 are carbon-carbon lyases, EC 4.2 carbon-oxygen lyases and so on.

The third number gives further information on the group eliminated, such as CO2 in EC 4.1.1 or H2O in EC 4.2.1.

Scheme 4 illustrates a reaction catalyzed by an exemplary enzyme from the fourth class of lyases, having the systematic name L-histidine ammonia-lyase and also called by its common name histidine ammonia-lyase or histidase, and the code number EC 4.3.1.3.

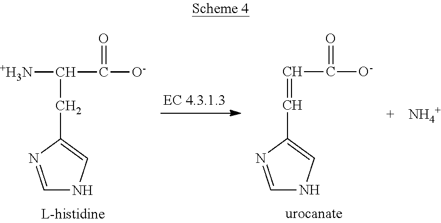 [SMILES: [NH3+]C(Cc1c[nH]cn1)C(=O)[O-] ; O=C([O-])C=Cc1c[nH]cn1 ; [NH4+]]

### Class 5—Isomerases

These enzymes catalyze geometric or structural changes within one molecule. According to the type of isomerism, they may be called racemases, epimerases, cis-trans-isomerases, isomerases, tautomerases, mutases or cycloisomerases. In some cases, the interconversion in the substrate is brought about by an intramolecular oxidoreduction (EC 5.3). Since the hydrogen donor and the acceptor are the same molecule, and no oxidized product is formed, they are not classified as oxidoreductases, even though they may contain firmly bound NAD(P)+.

The subclasses are formed according to the type of isomerism, the sub-subclasses to the type of substrates.

Scheme 5 illustrates a reaction catalyzed by an exemplary enzyme from the fifth class of isomerases, having the systematic name D-xylose ketol-isomerase and also called by its common name xylose isomerase or glucose isomerase, and the code number EC 5.3.1.5.

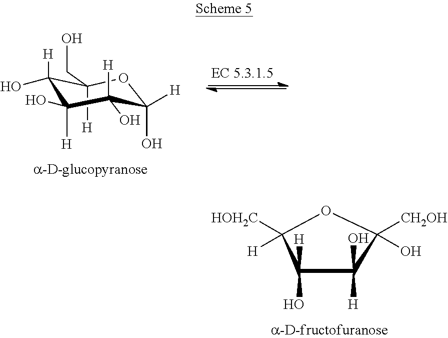

### Class 6—Ligases

Ligases are enzymes catalyzing the joining together of two molecules coupled with the hydrolysis of a diphosphate bond in ATP or a similar triphosphate. The systematic names are formed on the system X:Y ligase (ADP-forming).

The second number in the code number indicates the bond formed. For example, EC 6.1 for C—O bonds (enzymes acylating tRNA), EC 6.2 for C—S bonds (acyl-CoA derivatives) and so on. Sub-subclasses are only in use in the C—N ligases.

Scheme 6 illustrates a reaction catalyzed by an exemplary enzyme from the sixth class of ligases, having the systematic name □-L-glutamyl-L-cysteine:glycine ligase (ADP-forming) and also called by its common name glutathione synthase or glutathione synthetase, and the code number EC 6.3.2.3.

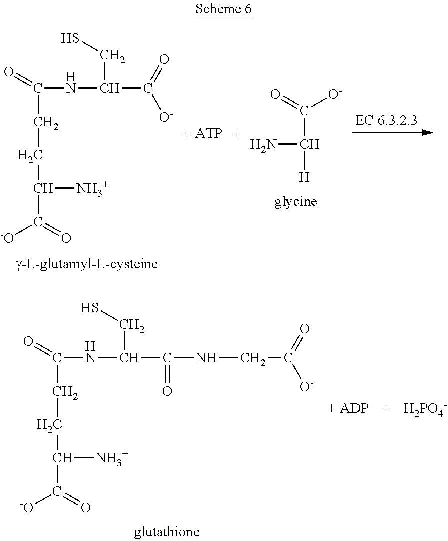

In an attempt to achieve practical classification and nomenclature of enzymes by the reactions they catalyze, the EC issued and maintains a set of rules pertaining to the systematic and common names of enzymes, with accordance to the code numbers, which considers and refers to historical, trivial and other factors which influence the names of various enzymes.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Alternatively, or additionally, the sequence of described processes within a claim is exemplary only so that if multiple processes are recited, performance of the processes in any order is within the scope of the claim unless otherwise stated in the claims.

Optionally, features described in the context of a method can be used to characterize an apparatus and features described in the context of an apparatus can be used to characterize a method.

Optionally, functions described or depicted as being performed by a single component can be divided among two or more alternate components which act in concert to perform the described/depicted function and/or functions described or depicted as being performed by a two or more components can be integrated and performed by a single alternate component.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims and Annex 1. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-10. (canceled)

11. A method of classifying a protein sequence, comprising searching the protein sequence for a motif of amino acids matching a predicting sequence present in a protein database, and using the protein classifier corresponding to said predicting sequence for classifying the protein sequence;
said protein database having a plurality of entries, each having a predicting sequence which comprises less than L amino acids and a protein classifier corresponding to said predicting sequence.

12. The method of claim 11, further comprising repeating said step of searching at least once, thereby providing a plurality of motifs of amino acids matching predicting sequences present in said protein database.

13. The method of claim 11, further comprising issuing a report containing classification of the protein sequence.

14. The method of claim 11, wherein said classifying the protein sequence comprises determining presence or absence of at least one active pocket or active site on the protein sequence.

15. The method of claim 14, further comprising determining the location of said at least one active pocket or active site.

16. Apparatus for classifying a protein sequence, comprising:
a searcher, capable of accessing a protein database, said searcher being operable to search the protein sequence for a motif of amino acids matching a predicting sequence present in said protein database, said protein database having a plurality of entries, each having a predicting sequence which comprises less than L amino acids and a protein classifier corresponding to said predicting sequence; and
a classification functionality capable of accessing said protein database and providing a protein classifier corresponding to said predicting sequence, so as to classify the protein sequence by said protein classifier.

17. The apparatus of claim 16, wherein said classification functionality is operable to determine presence or absence of at least one active pocket or active site on the protein sequence.

18. The apparatus of claim 17, wherein said classification functionality is operable to determine the location of said at least one active pocket or active site.

19. A method of characterizing a predetermined collection of protein classes defining a classification system for classifying a plurality of proteins, the method comprising:
(a) extracting repeatedly occurring motifs from amino acid sequences of the plurality of proteins, thereby providing a set of motifs; and
(b) for each protein class:
searching said set of motifs for at least one motif which comprises less than L amino acids, said at least one motif being present in at least a few proteins belonging to said protein class but not in proteins belonging to other protein classes, and
defining said at least one motif as a predicting sequence characterizing said protein class;
thereby characterizing the collection of protein classes.

20. The method of claim 19, wherein said plurality of proteins comprises a plurality of enzymes.

21. The method of claim 20, wherein the classification system is an EC hierarchical classification system, hence said protein class is a branch of said EC hierarchical classification system.

22. The method of claim 19, further comprising employing a screening procedure for reducing the number of predicting sequences.

23. A method of classifying a plurality of proteins into protein classes, comprising:
(a) extracting repeatedly occurring motifs from the sequences of the plurality of proteins, thereby providing a set of motifs; and
(b) using said set of motifs for defining protein classes, each being characterized by at least one motif which comprises less than L amino acids;
thereby classifying the plurality of proteins according to said protein classes.

24. The method of claim 23, wherein said plurality of proteins comprises a plurality of enzymes.

25. The method of claim 24, wherein said protein classes are branches of an EC hierarchical classification system.

26. The method of claim 19, wherein said L is selected from the group consisting of 5, 6, 7, 8, 9, 10, 11, 12, 13, 14 and 15.

27. The method of claim 19, wherein said protein classes comprise affinity classes, and said predicting sequence predicts protein affinity.

28. The method of claim 19, wherein said protein classes comprise functional classes, and said predicting sequence predicts protein function.

29. The method of claim 19, wherein said extracting said repeatedly occurring motifs comprises, for each sequence of the plurality of proteins: searching for partial overlaps between said sequence and other sequences, applying a significance test on said partial overlaps, and defining a most significant partial overlap as a repeatedly occurring motif.

30-33. (canceled)

34. Apparatus for characterizing a predetermined protein class being a member of a collection of protein classes defining a classification system for classifying a plurality of proteins, the apparatus comprising:
(a) a motif extraction unit capable of extracting repeatedly occurring motifs from amino acid sequences of the plurality of proteins, thereby providing a set of motifs;
(b) a searcher capable of searching said set of motifs for at least one motif which comprises less than L amino acids, said at least one motif being present in at least a few proteins belonging to the predetermined protein class but not in proteins belonging to other protein classes of said collection; and
(c) a characterization unit capable of defining said at least one motif as a predicting sequence characterizing the predetermined protein class.

35-36. (canceled)

37. Apparatus for classifying a plurality of proteins into protein classes, comprising:
(a) a motif extraction unit capable of extracting repeatedly occurring motifs from amino acid sequences of the plurality of proteins, thereby providing a set of motifs; and
(b) a protein class definition unit, capable of defining protein classes using said set of motifs, wherein each protein class is characterized by at least one motif which comprises less than L amino acids.

38-42. (canceled)

43. The apparatus of claim 34, wherein said motif extraction unit is operable to search each sequence for partial overlaps between said sequence and other sequences, to apply a significance test on said partial overlaps, and to define a most significant partial overlap as a repeatedly occurring motif.

44-77. (canceled)

78. The method of claim 11, wherein said protein database comprises at least one table or a portion thereof, said table being selected from the group consisting of Table 11, Table 37 and Table 42 in enclosed CD-ROM 1.

79. The apparatus of claim 16, wherein said protein database comprises at least one table or a portion thereof, said table being selected from the group consisting of Table 11, Table 37 and Table 42 in enclosed CD-ROM 1.
